(19) United States
(12) Patent Application Publication
(10) Pub. No.: US 2025/0172405 A1
(43) Pub. Date: May 29, 2025

(54) Systems and Methods for Clustering Objects

(71) Applicant: MOBILEYE VISION TECHNOLOGIES LTD., Jerusalem (IL)

(72) Inventors: Avigdor Eldar, Modiin (IL); Ido Ben-Shachar, Raanana (IL); Barak Shaashua, Revava (IL)

(73) Assignee: MOBILEYE VISION TECHNOLOGIES LTD., Jerusalem (IL)

(21) Appl. No.: 19/039,884

(22) Filed: Jan. 29, 2025

Related U.S. Application Data
(63) Continuation of application No. PCT/US2024/015740, filed on Feb. 14, 2024.
(60) Provisional application No. 63/445,395, filed on Feb. 14, 2023.

(51) Int. Cl. G01C 21/36; B60W 60/00; G01C 21/00; G01C 21/34

(52) U.S. Cl. CPC G01C 21/3644; B60W 60/001; G01C 21/3476; G01C 21/3885

(57) ABSTRACT

Systems and methods may detect objects. In one implementation, a method may include obtaining drive information captured during drives by a plurality of vehicles traversing or having traversed a road segment. The drive information for each of the plurality of vehicles may include a drive identifier and landmark detection information corresponding to one or more landmark detections. The landmark detection information included in the obtained drive information from the plurality of vehicles may be aggregated, and based on the aggregated landmark detection information, at least two landmark clusters may be identified. The method may determine, based on the drive identifier associated with the drive information received from each of the plurality of vehicles, a distribution of drive identifiers relative to the at least two landmark cluster and determine, based on the distribution of drive identifiers, a location identifier for one or more actual landmarks positioned along the road segment.

### CROSS REFERENCE TO RELATED APPLICATION

This application claims the benefit of priority of U.S. Provisional Application No. 63/445,395, filed Feb. 14, 2023. The foregoing application is incorporated herein by reference in its entirety.

### BACKGROUND

### Technical Field

The present disclosure relates generally to vehicle navigation and, more specifically, to systems and methods for detecting and/or classifying various objects in an environment of a vehicle.

### Background Information

As technology continues to advance, the goal of a fully autonomous vehicle that is capable of navigating on roadways is on the horizon. Autonomous vehicles may need to take into account a variety of factors and make appropriate decisions based on those factors to safely and accurately reach an intended destination. For example, an autonomous vehicle may need to process and interpret visual information (e.g., information captured from a camera) and may also use information obtained from other sources (e.g., from a GPS device, a speed sensor, an accelerometer, a suspension sensor, etc.). At the same time, in order to navigate to a destination, an autonomous vehicle may also need to identify its location within a particular roadway (e.g., a specific lane within a multi-lane road), navigate alongside other vehicles, avoid obstacles and pedestrians, observe traffic signals and signs, and travel from one road to another road at appropriate intersections or interchanges. Harnessing and interpreting vast volumes of information collected by an autonomous vehicle as the vehicle travels to its destination poses a multitude of design challenges. The sheer quantity of data (e.g., captured image data, map data, GPS data, sensor data, etc.) that an autonomous vehicle may need to analyze, access, and/or store poses challenges that can in fact limit or even adversely affect autonomous navigation. Furthermore, if an autonomous vehicle relies on traditional mapping technology to navigate, the sheer volume of data needed to store and update the map poses daunting challenges.

### SUMMARY

Embodiments consistent with the present disclosure provide systems and methods for vehicle navigation.

In an embodiment, a method for determining one or more harvested landmarks may include obtaining drive information captured during drives by a plurality of vehicles traversing or having traversed a road segment, the drive information for each of the plurality of vehicles comprising a drive identifier and landmark detection information corresponding to one or more landmark detections; aggregating the landmark detection information included in the obtained drive information from the plurality of vehicles, and based on the aggregated landmark detection information, identifying at least two landmark clusters, each of the at least two landmark clusters being representative of a potential real world location of an actual landmark positioned along the road segment; determining, based on the drive identifier associated with the drive information received from each of the plurality of vehicles, a distribution of drive identifiers relative to the at least two landmark clusters; determining, based on the distribution of drive identifiers, a location identifier for one or more actual landmarks positioned along the road segment; storing the location identifier for the one or more actual landmarks in a map; and distributing the map to one or more autonomous vehicles for use in navigating along the road segment, the navigating comprising determining at least one navigational response based on the location identifier for the one or more actual landmarks.

In an embodiment, a system for determining one or more harvested landmarks may include a memory comprising instructions, and at least one processor. The at least one processor may be programmed to obtain drive information captured during drives by a plurality of vehicles traversing or having traversed a road segment, the drive information for each of the plurality of vehicles comprising a drive identifier and landmark detection information corresponding to one or more landmark detections; aggregate the landmark detection information included in the obtained drive information from the plurality of vehicles, and based on the aggregated landmark detection information, identifying at least two landmark clusters, each of the at least two landmark clusters being representative of a potential real world location of an actual landmark positioned along the road segment; determine, based on the drive identifier associated with the drive information received from each of the plurality of vehicles, a distribution of drive identifiers relative to the at least two landmark clusters; determine, based on the distribution of drive identifiers, a location identifier for one or more actual landmarks positioned along the road segment; store the location identifier for the one or more actual landmarks in a map; and distribute the map to one or more autonomous vehicles for use in navigating along the road segment, the navigating comprising determining at least one navigational response based on the location identifier for the one or more actual landmarks.

In an embodiment, a system for updating a map based on a presence of a landmark associated with a road segment may include at least one processor. The at least one processor may be programmed to receive drive information captured by one or more vehicles traversing or having traversed the road segment, the drive information comprising detection information indicative of a detected landmark in an environment of a respective vehicle at a location along the road segment on a capture date; determine an indicator of an expected landmark for the location along the road segment from stored map information; store, as a landmark history, an indication of an identification of the expected landmark on a respective capture date based on the detection information; determine a change in a status of the expected landmark based on analysis of the landmark history; update the stored map information based on the determined change in the status of the expected landmark; and distribute the stored map information to one or more autonomous vehicles for use in navigating along the road segment.

In an embodiment, a method for updating a map based on a presence of a landmark associated with a road segment may include receiving drive information captured by one or more vehicles traversing or having traversed the road segment, the drive information comprising detection information indicative of a detected landmark in an environment of a respective vehicle at a location along the road segment on a capture date; determining an indicator of an expected landmark for the location along the road segment from stored map information; storing, as a landmark history, an indication of an identification of the expected landmark on a respective capture date based on the detection information; determining a change in a status of the expected landmark based on analysis of the landmark history; updating the stored map information based on the determined change in the status of the expected landmark; and distributing the stored map information to one or more autonomous vehicles for use in navigating along the road segment.

In an embodiment, a system for determining landmark orientation may include at least one processor. The at least one processor may be programmed to execute operations comprising receiving drive information obtained by a plurality of vehicles traversing or having traversed a road segment, the drive information comprising landmark detection information corresponding to a landmark located along the road segment, wherein the landmark detection information includes at least a first location indicator associated with the landmark and a second location indicator associated with the landmark; aggregating the drive information obtained from the plurality of vehicles to determine a refined first location indicator and a refined second location indicator associated with the landmark; determining a landmark orientation for at least one feature of the landmark based on the refined first location indicator and the refined second location indicator; storing the landmark orientation in a map; and distributing the map to one or more autonomous vehicles for use in navigating along the road segment, the navigating comprising determining at least one navigational response based on the stored landmark orientation.

In an embodiment, a method for determining landmark orientation may include receiving drive information obtained by a plurality of vehicles traversing or having traversed a road segment, the drive information comprising landmark detection information corresponding to a landmark located along the road segment, wherein the landmark detection information includes at least a first location indicator associated with the landmark and a second location indicator associated with the landmark; aggregating the drive information obtained from the plurality of vehicles to determine a refined first location indicator and a refined second location indicator associated with the landmark; determining a landmark orientation for at least one feature of the landmark based on the refined first location indicator and the refined second location indicator; storing the landmark orientation in a map; and distributing the map to one or more autonomous vehicles for use in navigating along the road segment, the navigating comprising determining at least one navigational response based on the stored landmark orientation.

In an embodiment, a navigation system for a host vehicle may include at least one processor comprising circuitry and a memory. The memory may include instructions executable by the circuitry to cause the at least one processor to perform operations comprising receiving map data corresponding to a road segment on which the host vehicle is navigating or will navigate, wherein the map data comprises a landmark orientation for a landmark positioned relative to the road segment. The landmark orientation may have been determined based on: drive information obtained by a plurality of vehicles traversing or having traversed the road segment, the drive information comprising landmark detection information corresponding to the landmark, wherein the landmark detection information includes at least a first location indicator associated with the landmark and a second location indicator associated with the landmark; aggregating the drive information obtained from the plurality of vehicles to determine a refined first location indicator and a refined second location indicator associated with the landmark; and determining the landmark orientation for at least one feature of the landmark based on the refined first location indicator and the refined second location indicator. The operations may further comprise determining, based at least on the map data and host vehicle sensor data, a presence of a target landmark in an environment of the host vehicle; determining, based on at least the map data, that the target landmark in the environment of the host vehicle corresponds to the landmark; determining at least one navigational response based on the landmark orientation stored in the map data in association with the landmark; and causing the host vehicle to implement the at least one navigational response.

In an embodiment, a system for determining traffic light orientation may include at least one processor. The at least one processor may be programmed to execute operations comprising receiving drive information obtained by each of a plurality of vehicles traversing or having traversed a road segment, wherein the drive information obtained by each of the plurality of vehicles includes traffic light detection information, and wherein the traffic light detection information includes traffic light color state information and vehicle location information; identifying, based on the drive information, a plurality of traffic light detection events relative to a traffic light positioned relative to the road segment; determining, for each of the plurality of traffic light detection events and based on the traffic light detection information included in the received drive information, a color state indicator and a traffic light detection distance for the traffic light; determining, based on the color state indictor and the traffic light detection distance determined for each of the plurality of traffic light detection events, an orientation indicator for the traffic light; storing the orientation indicator for the traffic light in at least one map; and distributing the map to one or more autonomous vehicles for use in navigating along the road segment, wherein the navigating includes determining at least one navigational response based on the stored orientation indicator for the traffic light.

In an embodiment, a method for determining traffic light orientation may include receiving drive information obtained by each of a plurality of vehicles traversing or having traversed a road segment, wherein the drive information obtained by each of the plurality of vehicles includes traffic light detection information, and wherein the traffic light detection information includes traffic light color state information and vehicle location information; identifying, based on the drive information, a plurality of traffic light detection events relative to a traffic light positioned relative to the road segment; determining, for each of the plurality of traffic light detection events and based on the traffic light detection information included in the received drive information, a color state indicator and a traffic light detection distance for the traffic light; determining, based on the color state indictor and the traffic light detection distance determined for each of the plurality of traffic light detection events, an orientation indicator for the traffic light; storing the orientation indicator for the traffic light in at least one map; and distributing the map to one or more autonomous vehicles for use in navigating along the road segment, wherein the navigating includes determining at least one navigational response based on the stored orientation indicator for the traffic light.

In an embodiment, a navigation system for a host vehicle may include at least one processor comprising circuitry and a memory. The memory may include instructions executable by the circuitry to cause the at least one processor to perform operations comprising receiving map data corresponding to a road segment on which the host vehicle is navigating or will navigate, wherein the map data comprises an orientation indicator for a traffic light positioned relative to the road segment. The orientation indicator may have been determined based on: drive information obtained by each of a plurality of vehicles traversing or having traversed the road segment, wherein the drive information obtained by each of the plurality of vehicles includes traffic light detection information, and wherein the traffic light detection information includes traffic light color state information and vehicle location information; identifying, based on the drive information, a plurality of traffic light detection events relative to the traffic light; determining, for each of the plurality of traffic light detection events and based on the traffic light detection information included in the received drive information, a color state indicator and a traffic light detection distance for the traffic light; and determining, based on the color state indictor and the traffic light detection distance determined for each of the plurality of traffic light detection events, the orientation indicator for the traffic light. The operations may further comprise determining a presence of a target traffic light in an environment of the host vehicle; determining, based on at least the map data, that the target traffic light in the environment of the host vehicle corresponds to the traffic light; determining at least one navigational response for the host vehicle based on the orientation indicator for the traffic light; and causing the host vehicle to implement the at least one navigational response.

Consistent with other disclosed embodiments, non-transitory computer readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic representation of an exemplary system consistent with the disclosed embodiments.

FIG. 2A is a diagrammatic side view representation of an exemplary vehicle including a system consistent with the disclosed embodiments.

FIG. 2B is a diagrammatic top view representation of the vehicle and system shown in FIG. 2A consistent with the disclosed embodiments.

FIG. 2C is a diagrammatic top view representation of another embodiment of a vehicle including a system consistent with the disclosed embodiments.

FIG. 2D is a diagrammatic top view representation of yet another embodiment of a vehicle including a system consistent with the disclosed embodiments.

FIG. 2E is a diagrammatic top view representation of yet another embodiment of a vehicle including a system consistent with the disclosed embodiments.

FIG. 2F is a diagrammatic representation of exemplary vehicle control systems consistent with the disclosed embodiments.

FIG. 3A is a diagrammatic representation of an interior of a vehicle including a rearview mirror and a user interface for a vehicle imaging system consistent with the disclosed embodiments.

FIG. 3B is an illustration of an example of a camera mount that is configured to be positioned behind a rearview mirror and against a vehicle windshield consistent with the disclosed embodiments.

FIG. 3C is an illustration of the camera mount shown in FIG. 3B from a different perspective consistent with the disclosed embodiments.

FIG. 3D is an illustration of an example of a camera mount that is configured to be positioned behind a rearview mirror and against a vehicle windshield consistent with the disclosed embodiments.

FIG. 4 is an exemplary block diagram of a memory configured to store instructions for performing one or more operations consistent with the disclosed embodiments.

FIG. 5A is a flowchart showing an exemplary process for causing one or more navigational responses based on monocular image analysis consistent with disclosed embodiments.

FIG. 5B is a flowchart showing an exemplary process for detecting one or more vehicles and/or pedestrians in a set of images consistent with the disclosed embodiments.

FIG. 5C is a flowchart showing an exemplary process for detecting road marks and/or lane geometry information in a set of images consistent with the disclosed embodiments.

FIG. 5D is a flowchart showing an exemplary process for detecting traffic lights in a set of images consistent with the disclosed embodiments.

FIG. 5E is a flowchart showing an exemplary process for causing one or more navigational responses based on a vehicle path consistent with the disclosed embodiments.

FIG. 5F is a flowchart showing an exemplary process for determining whether a leading vehicle is changing lanes consistent with the disclosed embodiments.

FIG. 6 is a flowchart showing an exemplary process for causing one or more navigational responses based on stereo image analysis consistent with the disclosed embodiments.

FIG. 7 is a flowchart showing an exemplary process for causing one or more navigational responses based on an analysis of three sets of images consistent with the disclosed embodiments.

FIG. 8 shows a sparse map for providing autonomous vehicle navigation, consistent with the disclosed embodiments.

FIG. 9A illustrates a polynomial representation of a portions of a road segment consistent with the disclosed embodiments.

FIG. 9B illustrates a curve in three-dimensional space representing a target trajectory of a vehicle, for a particular road segment, included in a sparse map consistent with the disclosed embodiments.

FIG. 10 illustrates example landmarks that may be included in sparse map consistent with the disclosed embodiments.

FIG. 11A shows polynomial representations of trajectories consistent with the disclosed embodiments.

FIGS. 11B and 11C show target trajectories along a multi-lane road consistent with disclosed embodiments.

FIG. 11D shows an example road signature profile consistent with disclosed embodiments.

FIG. 12 is a schematic illustration of a system that uses crowd sourcing data received from a plurality of vehicles for autonomous vehicle navigation, consistent with the disclosed embodiments.

FIG. 13 illustrates an example autonomous vehicle road navigation model represented by a plurality of three-dimensional splines, consistent with the disclosed embodiments.

FIG. 14 shows a map skeleton generated from combining location information from many drives, consistent with the disclosed embodiments.

FIG. 15 shows an example of a longitudinal alignment of two drives with example signs as landmarks, consistent with the disclosed embodiments.

FIG. 16 shows an example of a longitudinal alignment of many drives with an example sign as a landmark, consistent with the disclosed embodiments.

FIG. 17 is a schematic illustration of a system for generating drive data using a camera, a vehicle, and a server, consistent with the disclosed embodiments.

FIG. 18 is a schematic illustration of a system for crowdsourcing a sparse map, consistent with the disclosed embodiments.

FIG. 19 is a flowchart showing an exemplary process for generating a sparse map for autonomous vehicle navigation along a road segment, consistent with the disclosed embodiments.

FIG. 20 illustrates a block diagram of a server consistent with the disclosed embodiments.

FIG. 21 illustrates a block diagram of a memory consistent with the disclosed embodiments.

FIG. 22 illustrates a process of clustering vehicle trajectories associated with vehicles, consistent with the disclosed embodiments.

FIG. 23 illustrates a navigation system for a vehicle, which may be used for autonomous navigation, consistent with the disclosed embodiments.

FIGS. 24A, 24B, 24C, and 24D illustrate exemplary lane marks that may be detected consistent with the disclosed embodiments.

FIG. 24E shows exemplary mapped lane marks consistent with the disclosed embodiments.

FIG. 24F shows an exemplary anomaly associated with detecting a lane mark consistent with the disclosed embodiments.

FIG. 25A shows an exemplary image of a vehicle's surrounding environment for navigation based on the mapped lane marks consistent with the disclosed embodiments.

FIG. 25B illustrates a lateral localization correction of a vehicle based on mapped lane marks in a road navigation model consistent with the disclosed embodiments.

FIGS. 25C and 25D provide conceptual representations of a localization technique for locating a host vehicle along a target trajectory using mapped features included in a sparse map.

FIG. 26A is a flowchart showing an exemplary process for mapping a lane mark for use in autonomous vehicle navigation consistent with disclosed embodiments.

FIG. 26B is a flowchart showing an exemplary process for autonomously navigating a host vehicle along a road segment using mapped lane marks consistent with disclosed embodiments.

FIG. 27A is an exemplary illustration of a plurality of vehicles traversing a road segment including a plurality of landmarks along the road segment consistent with disclosed embodiments.

FIG. 27B is an exemplary illustration of a conceptual aggregation of drive information obtained by the plurality of vehicles of FIG. 27A consistent with disclosed embodiments.

FIG. 28A is another exemplary illustration of a plurality of vehicles traversing a road segment including a plurality of landmarks along the road segment consistent with disclosed embodiments.

FIG. 28B is an exemplary illustration of a conceptual aggregation of drive information obtained by the plurality of vehicles of FIG. 28A consistent with disclosed embodiments.

FIG. 29 is a flowchart showing an exemplary process for determining one or more landmarks consistent with disclosed embodiments.

FIG. 30 is a schematic illustration of a system that uses crowd-sourced detection information received from a plurality of vehicles for autonomous vehicle navigation, consistent with the disclosed embodiments.

FIGS. 31A, 31B, 31C, and 31D are exemplary depictions of different landmark contextual settings, consistent with the disclosed embodiments.

FIG. 32 is a flowchart showing an exemplary process for updating a map based on a presence of a landmark associated with a road segment, consistent with the disclosed embodiments.

FIG. 33 illustrates an example environment of a host vehicle for determining landmark orientation consistent with the disclosed embodiments.

FIGS. 34A and 34B illustrate various location indicators that may be identified for a landmark, consistent with the disclosed embodiments.

FIG. 34C illustrates example refined location indicators that may be determined relative to a landmark, consistent with the disclosed embodiments.

FIG. 34D is a diagrammatic illustration of an example road segment along which vehicles may navigate based on stored orientations of landmarks, consistent with the disclosed embodiments.

FIG. 35 is a flowchart showing an example process for determining landmark orientation, consistent with the disclosed embodiments.

FIG. 36 is a flowchart showing an example process for navigating a host vehicle, consistent with the disclosed embodiments.

FIG. 37 illustrates an example environment of a host vehicle for determining traffic light orientation, consistent with the disclosed embodiments.

FIGS. 38A and 38B illustrate various images from which traffic light color state information may be ascertained, consistent with the disclosed embodiments.

FIG. 39 is a diagrammatic representation of various traffic light detection events that may be used to determine an orientation indicator for the traffic light, consistent with the disclosed embodiments.

FIG. 40 is a flowchart showing an example process for determining traffic light orientation, consistent with the disclosed embodiments.

FIG. 41 is a flowchart showing an example process for navigating a host vehicle, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Autonomous Vehicle (AV) Overview

As used throughout this disclosure, the term “autonomous vehicle” refers to a vehicle capable of implementing at least one navigational change without driver input. A “navigational change” refers to a change in one or more of steering, braking, or acceleration of the vehicle. To be autonomous, a vehicle need not be fully automatic (e.g., fully operational without a driver or without driver input). Rather, an autonomous vehicle includes those that can operate under driver control during certain time periods and without driver control during other time periods. Autonomous vehicles may also include vehicles that control only some aspects of vehicle navigation, such as steering (e.g., to maintain a vehicle course between vehicle lane constraints), but may leave other aspects to the driver (e.g., braking). In some cases, autonomous vehicles may handle some or all aspects of braking, speed control, and/or steering of the vehicle.

As human drivers typically rely on visual cues and observations to control a vehicle, transportation infrastructures are built accordingly, with lane markings, traffic signs, and traffic lights, all designed to provide visual information to drivers. In view of these design characteristics of transportation infrastructures, an autonomous vehicle may include a camera and a processing unit that analyzes visual information captured from the environment of the vehicle. The visual information may include, for example, components of the transportation infrastructure (e.g., lane markings, traffic signs, traffic lights, etc.) that are observable by drivers and other obstacles (e.g., other vehicles, pedestrians, debris, etc.). Additionally, an autonomous vehicle may also use stored information, such as information that provides a model of the vehicle's environment when navigating. For example, the vehicle may use GPS data, sensor data (e.g., from an accelerometer, a speed sensor, a suspension sensor, etc.), and/or other map data to provide information related to its environment while the vehicle is traveling, and the vehicle (as well as other vehicles) may use the information to localize itself on the model.

In some embodiments in this disclosure, an autonomous vehicle may use information obtained while navigating (e.g., from a camera, GPS device, an accelerometer, a speed sensor, a suspension sensor, etc.). In other embodiments, an autonomous vehicle may use information obtained from past navigations by the vehicle (or by other vehicles) while navigating. In yet other embodiments, an autonomous vehicle may use a combination of information obtained while navigating and information obtained from past navigations. The following sections provide an overview of a system consistent with the disclosed embodiments, followed by an overview of a forward-facing imaging system and methods consistent with the system. The sections that follow disclose systems and methods for constructing, using, and updating a sparse map for autonomous vehicle navigation.

### System Overview

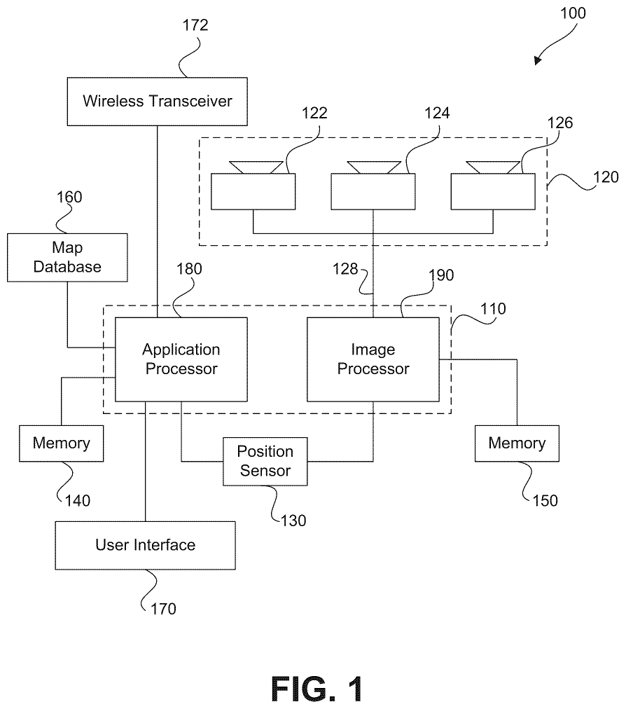

FIG. 1 is a block diagram representation of a system 100 consistent with the exemplary disclosed embodiments. System 100 may include various components depending on the requirements of a particular implementation. In some embodiments, system 100 may include a processing unit 110, an image acquisition unit 120, a position sensor 130, one or more memory units 140, 150, a map database 160, a user interface 170, and a wireless transceiver 172. Processing unit 110 may include one or more processing devices. In some embodiments, processing unit 110 may include an applications processor 180, an image processor 190, or any other suitable processing device. Similarly, image acquisition unit 120 may include any number of image acquisition devices and components depending on the requirements of a particular application. In some embodiments, image acquisition unit 120 may include one or more image capture devices (e.g., cameras), such as image capture device 122, image capture device 124, and image capture device 126. System 100 may also include a data interface 128 communicatively connecting processing unit 110 to image acquisition unit 120. For example, data interface 128 may include any wired and/or wireless link or links for transmitting image data acquired by image accusation unit 120 to processing unit 110.

Wireless transceiver 172 may include one or more devices configured to exchange transmissions over an air interface to one or more networks (e.g., cellular, the Internet, etc.) by use of a radio frequency, infrared frequency, magnetic field, or an electric field. Wireless transceiver 172 may use any known standard to transmit and/or receive data (e.g., Wi-Fi, Bluetooth®, Bluetooth Smart, 802.15.4, ZigBee, etc.). Such transmissions can include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 180 and image processor 190 may include various types of processing devices. For example, either or both of applications processor 180 and image processor 190 may include a microprocessor, preprocessors (such as an image preprocessor), a graphics processing unit (GPU), a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures (e.g., x86 processor, ARM®, etc.).

In some embodiments, applications processor 180 and/or image processor 190 may include any of the EyeQ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture consists of two floating point, hyper-thread 32-bit RISC CPUs (MIPS32® 34K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP™ and the DMA, the second MIPS34K CPU and the multi-channel DMA as well as the other peripherals. The five VCEs, three VMP® and the MIPS34K CPU can perform intensive vision computations required by multi-function bundle applications. In another example, the EyeQ3®, which is a third generation processor and is six times more powerful that the EyeQ2®, may be used in the disclosed embodiments. In other examples, the EyeQ4® and/or the EyeQ5® may be used in the disclosed embodiments. Of course, any newer or future EyeQ processing devices may also be used together with the disclosed embodiments.

Any of the processing devices disclosed herein may be configured to perform certain functions. Configuring a processing device, such as any of the described EyeQ processors or other controller or microprocessor, to perform certain functions may include programming of computer executable instructions and making those instructions available to the processing device for execution during operation of the processing device. In some embodiments, configuring a processing device may include programming the processing device directly with architectural instructions. For example, processing devices such as field-programmable gate arrays (FPGAs), application-specific integrated circuits (ASICs), and the like may be configured using, for example, one or more hardware description languages (HDLs).

In other embodiments, configuring a processing device may include storing executable instructions on a memory that is accessible to the processing device during operation. For example, the processing device may access the memory to obtain and execute the stored instructions during operation. In either case, the processing device configured to perform the sensing, image analysis, and/or navigational functions disclosed herein represents a specialized hardware-based system in control of multiple hardware based components of a host vehicle.

While FIG. 1 depicts two separate processing devices included in processing unit 110, more or fewer processing devices may be used. For example, in some embodiments, a single processing device may be used to accomplish the tasks of applications processor 180 and image processor 190. In other embodiments, these tasks may be performed by more than two processing devices. Further, in some embodiments, system 100 may include one or more of processing unit 110 without including other components, such as image acquisition unit 120.

Processing unit 110 may comprise various types of devices. For example, processing unit 110 may include various devices, such as a controller, an image preprocessor, a central processing unit (CPU), a graphics processing unit (GPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The GPU may also comprise any number of microcontrollers or microprocessors. The support circuits may be any number of circuits generally well known in the art, including cache, power supply, clock and input-output circuits. The memory may store software that, when executed by the processor, controls the operation of the system. The memory may include databases and image processing software. The memory may comprise any number of random access memories, read only memories, flash memories, disk drives, optical storage, tape storage, removable storage and other types of storage. In one instance, the memory may be separate from the processing unit 110. In another instance, the memory may be integrated into the processing unit 110.

Each memory 140, 150 may include software instructions that when executed by a processor (e.g., applications processor 180 and/or image processor 190), may control operation of various aspects of system 100. These memory units may include various databases and image processing software, as well as a trained system, such as a neural network, or a deep neural network, for example. The memory units may include random access memory (RAM), read only memory (ROM), flash memory, disk drives, optical storage, tape storage, removable storage and/or any other types of storage. In some embodiments, memory units 140, 150 may be separate from the applications processor 180 and/or image processor 190. In other embodiments, these memory units may be integrated into applications processor 180 and/or image processor 190.

Position sensor 130 may include any type of device suitable for determining a location associated with at least one component of system 100. In some embodiments, position sensor 130 may include a GPS receiver. Such receivers can determine a user position and velocity by processing signals broadcasted by global positioning system satellites. Position information from position sensor 130 may be made available to applications processor 180 and/or image processor 190.

In some embodiments, system 100 may include components such as a speed sensor (e.g., a tachometer, a speedometer) for measuring a speed of vehicle 200 and/or an accelerometer (either single axis or multi-axis) for measuring acceleration of vehicle 200.

User interface 170 may include any device suitable for providing information to or for receiving inputs from one or more users of system 100. In some embodiments, user interface 170 may include user input devices, including, for example, a touchscreen, microphone, keyboard, pointer devices, track wheels, cameras, knobs, buttons, etc. With such input devices, a user may be able to provide information inputs or commands to system 100 by typing instructions or information, providing voice commands, selecting menu options on a screen using buttons, pointers, or eye-tracking capabilities, or through any other suitable techniques for communicating information to system 100.

User interface 170 may be equipped with one or more processing devices configured to provide and receive information to or from a user and process that information for use by, for example, applications processor 180. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 170 may include a display, speaker, tactile device, and/or any other devices for providing output information to a user.

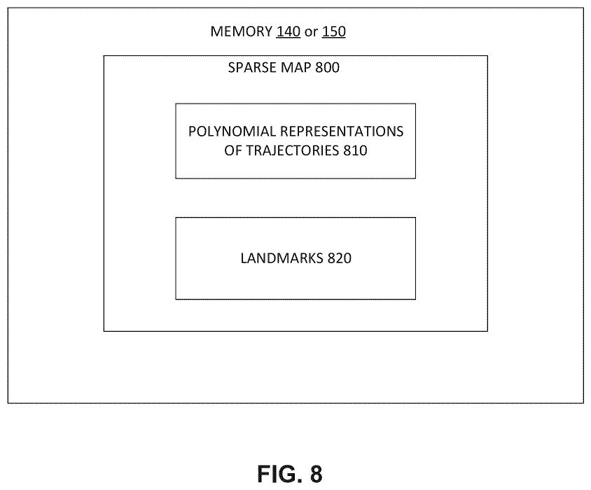

Map database 160 may include any type of database for storing map data useful to system 100. In some embodiments, map database 160 may include data relating to the position, in a reference coordinate system, of various items, including roads, water features, geographic features, businesses, points of interest, restaurants, gas stations, etc. Map database 160 may store not only the locations of such items, but also descriptors relating to those items, including, for example, names associated with any of the stored features. In some embodiments, map database 160 may be physically located with other components of system 100. Alternatively or additionally, map database 160 or a portion thereof may be located remotely with respect to other components of system 100 (e.g., processing unit 110). In such embodiments, information from map database 160 may be downloaded over a wired or wireless data connection to a network (e.g., over a cellular network and/or the Internet, etc.). In some cases, map database 160 may store a sparse data model including polynomial representations of certain road features (e.g., lane markings) or target trajectories for the host vehicle. Systems and methods of generating such a map are discussed below with references to FIGS. 8-19.

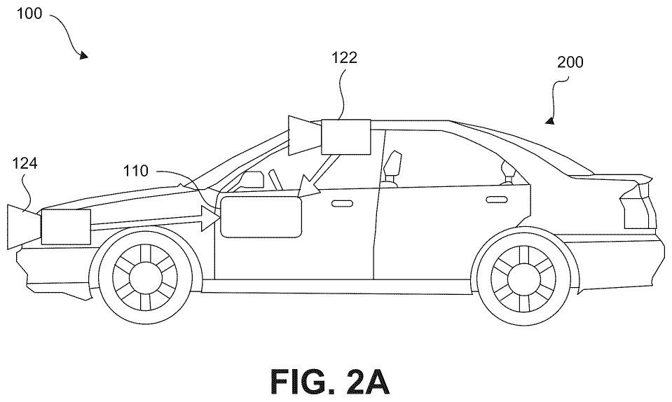

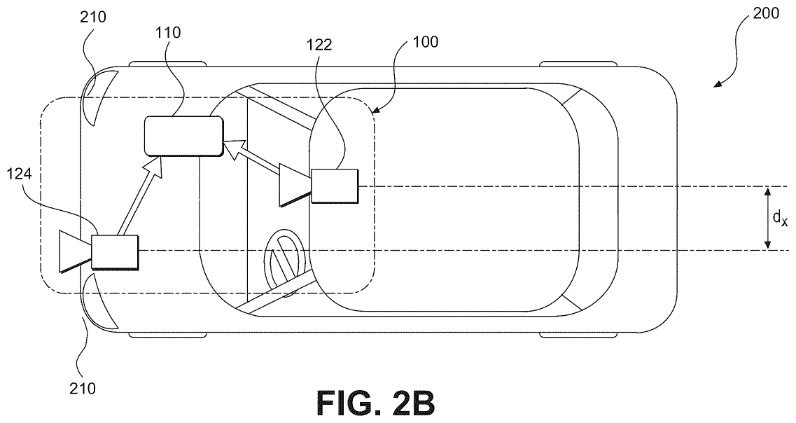

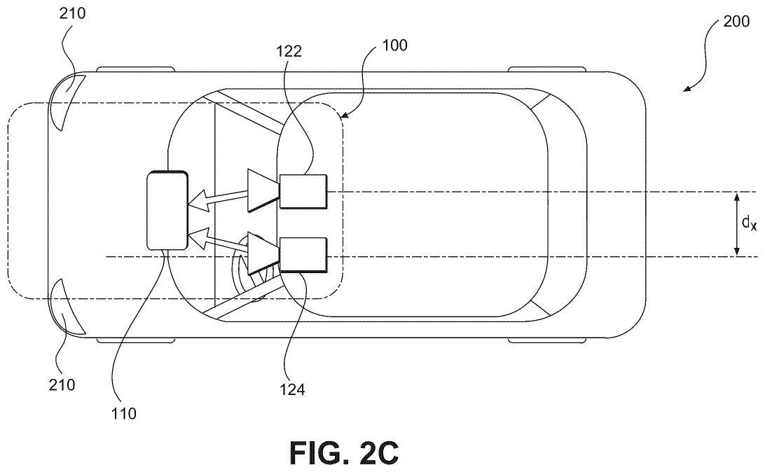

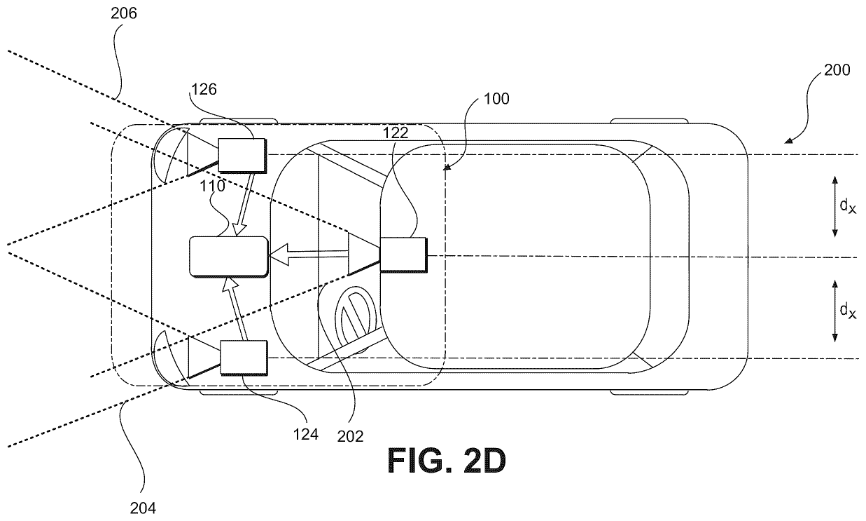

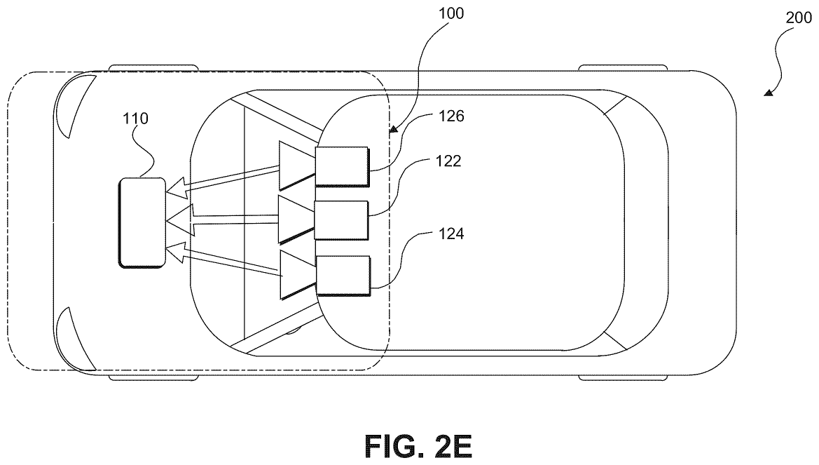

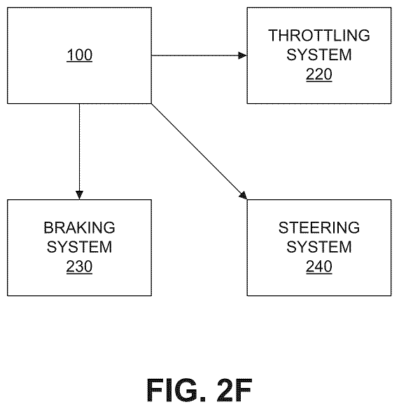

Image capture devices 122, 124, and 126 may each include any type of device suitable for capturing at least one image from an environment. Moreover, any number of image capture devices may be used to acquire images for input to the image processor. Some embodiments may include only a single image capture device, while other embodiments may include two, three, or even four or more image capture devices. Image capture devices 122, 124, and 126 will be further described with reference to FIGS. 2B-2E, below.

System 100, or various components thereof, may be incorporated into various different platforms. In some embodiments, system 100 may be included on a vehicle 200, as shown in FIG. 2A. For example, vehicle 200 may be equipped with a processing unit 110 and any of the other components of system 100, as described above relative to FIG. 1. While in some embodiments vehicle 200 may be equipped with only a single image capture device (e.g., camera), in other embodiments, such as those discussed in connection with FIGS. 2B-2E, multiple image capture devices may be used. For example, either of image capture devices 122 and 124 of vehicle 200, as shown in FIG. 2A, may be part of an ADAS (Advanced Driver Assistance Systems) imaging set.

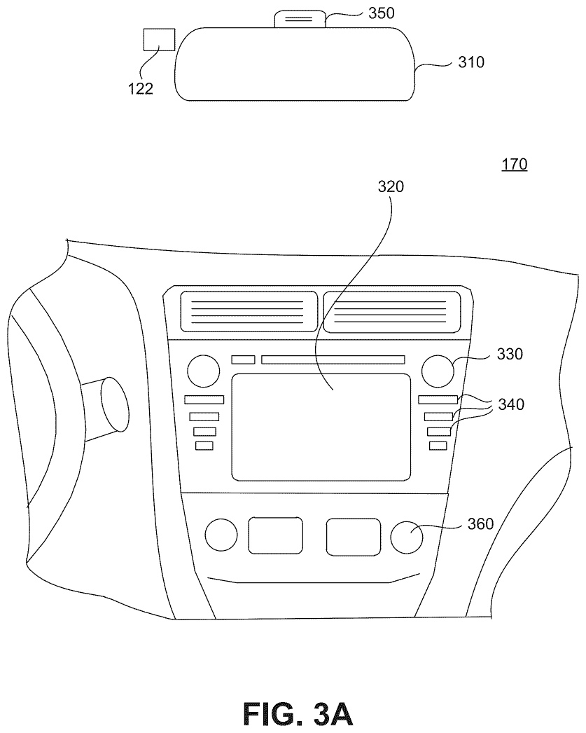

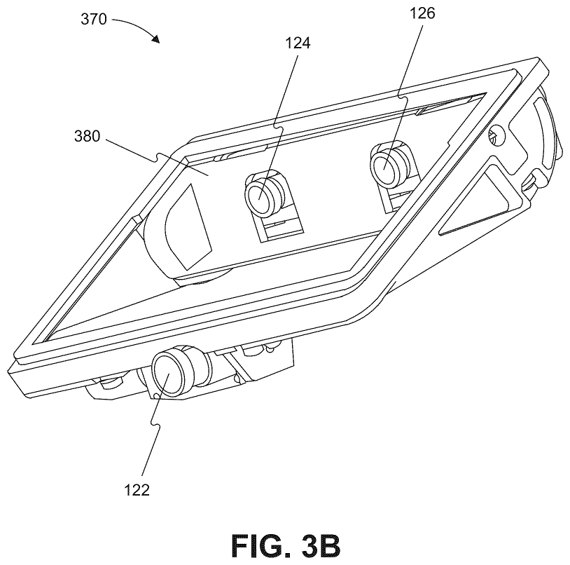

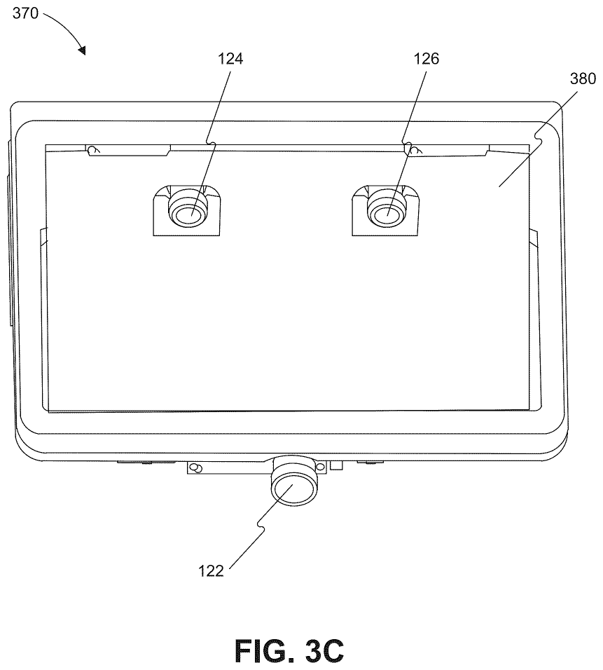

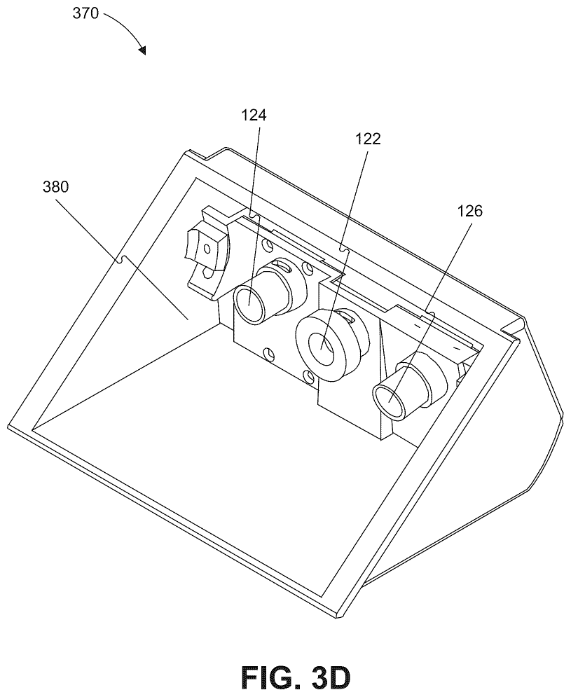

The image capture devices included on vehicle 200 as part of the image acquisition unit 120 may be positioned at any suitable location. In some embodiments, as shown in FIGS. 2A-2E and 3A-3C, image capture device 122 may be located in the vicinity of the rearview mirror. This position may provide a line of sight similar to that of the driver of vehicle 200, which may aid in determining what is and is not visible to the driver. Image capture device 122 may be positioned at any location near the rearview mirror, but placing image capture device 122 on the driver side of the mirror may further aid in obtaining images representative of the driver's field of view and/or line of sight.

Other locations for the image capture devices of image acquisition unit 120 may also be used. For example, image capture device 124 may be located on or in a bumper of vehicle 200. Such a location may be especially suitable for image capture devices having a wide field of view. The line of sight of bumper-located image capture devices can be different from that of the driver and, therefore, the bumper image capture device and driver may not always see the same objects. The image capture devices (e.g., image capture devices 122, 124, and 126) may also be located in other locations. For example, the image capture devices may be located on or in one or both of the side mirrors of vehicle 200, on the roof of vehicle 200, on the hood of vehicle 200, on the trunk of vehicle 200, on the sides of vehicle 200, mounted on, positioned behind, or positioned in front of any of the windows of vehicle 200, and mounted in or near light figures on the front and/or back of vehicle 200, etc.

In addition to image capture devices, vehicle 200 may include various other components of system 100. For example, processing unit 110 may be included on vehicle 200 either integrated with or separate from an engine control unit (ECU) of the vehicle. Vehicle 200 may also be equipped with a position sensor 130, such as a GPS receiver and may also include a map database 160 and memory units 140 and 150.

As discussed earlier, wireless transceiver 172 may and/or receive data over one or more networks (e.g., cellular networks, the Internet, etc.). For example, wireless transceiver 172 may upload data collected by system 100 to one or more servers, and download data from the one or more servers. Via wireless transceiver 172, system 100 may receive, for example, periodic or on demand updates to data stored in map database 160, memory 140, and/or memory 150. Similarly, wireless transceiver 172 may upload any data (e.g., images captured by image acquisition unit 120, data received by position sensor 130 or other sensors, vehicle control systems, etc.) from by system 100 and/or any data processed by processing unit 110 to the one or more servers.

System 100 may upload data to a server (e.g., to the cloud) based on a privacy level setting. For example, system 100 may implement privacy level settings to regulate or limit the types of data (including metadata) sent to the server that may uniquely identify a vehicle and or driver/owner of a vehicle. Such settings may be set by user via, for example, wireless transceiver 172, be initialized by factory default settings, or by data received by wireless transceiver 172.

In some embodiments, system 100 may upload data according to a “high” privacy level, and under setting a setting, system 100 may transmit data (e.g., location information related to a route, captured images, etc.) without any details about the specific vehicle and/or driver/owner. For example, when uploading data according to a “high” privacy setting, system 100 may not include a vehicle identification number (VIN) or a name of a driver or owner of the vehicle, and may instead of transmit data, such as captured images and/or limited location information related to a route.

Other privacy levels are contemplated. For example, system 100 may transmit data to a server according to an “intermediate” privacy level and include additional information not included under a “high” privacy level, such as a make and/or model of a vehicle and/or a vehicle type (e.g., a passenger vehicle, sport utility vehicle, truck, etc.). In some embodiments, system 100 may upload data according to a “low” privacy level. Under a “low” privacy level setting, system 100 may upload data and include information sufficient to uniquely identify a specific vehicle, owner/driver, and/or a portion or entirely of a route traveled by the vehicle. Such “low” privacy level data may include one or more of, for example, a VIN, a driver/owner name, an origination point of a vehicle prior to departure, an intended destination of the vehicle, a make and/or model of the vehicle, a type of the vehicle, etc.

FIG. 2A is a diagrammatic side view representation of an exemplary vehicle imaging system consistent with the disclosed embodiments. FIG. 2B is a diagrammatic top view illustration of the embodiment shown in FIG. 2A. As illustrated in FIG. 2B, the disclosed embodiments may include a vehicle 200 including in its body a system 100 with a first image capture device 122 positioned in the vicinity of the rearview mirror and/or near the driver of vehicle 200, a second image capture device 124 positioned on or in a bumper region (e.g., one of bumper regions 210) of vehicle 200, and a processing unit 110.

As illustrated in FIG. 2C, image capture devices 122 and 124 may both be positioned in the vicinity of the rearview mirror and/or near the driver of vehicle 200. Additionally, while two image capture devices 122 and 124 are shown in FIGS. 2B and 2C, it should be understood that other embodiments may include more than two image capture devices. For example, in the embodiments shown in FIGS. 2D and 2E, first, second, and third image capture devices 122, 124, and 126, are included in the system 100 of vehicle 200.

As illustrated in FIG. 2D, image capture device 122 may be positioned in the vicinity of the rearview mirror and/or near the driver of vehicle 200, and image capture devices 124 and 126 may be positioned on or in a bumper region (e.g., one of bumper regions 210) of vehicle 200. And as shown in FIG. 2E, image capture devices 122, 124, and 126 may be positioned in the vicinity of the rearview mirror and/or near the driver seat of vehicle 200. The disclosed embodiments are not limited to any particular number and configuration of the image capture devices, and the image capture devices may be positioned in any appropriate location within and/or on vehicle 200.

It is to be understood that the disclosed embodiments are not limited to vehicles and could be applied in other contexts. It is also to be understood that disclosed embodiments are not limited to a particular type of vehicle 200 and may be applicable to all types of vehicles including automobiles, trucks, trailers, and other types of vehicles.

The first image capture device 122 may include any suitable type of image capture device. Image capture device 122 may include an optical axis. In one instance, the image capture device 122 may include an Aptina M9V024 WVGA sensor with a global shutter. In other embodiments, image capture device 122 may provide a resolution of 1280×960 pixels and may include a rolling shutter. Image capture device 122 may include various optical elements. In some embodiments one or more lenses may be included, for example, to provide a desired focal length and field of view for the image capture device. In some embodiments, image capture device 122 may be associated with a 6 mm lens or a 12 mm lens. In some embodiments, image capture device 122 may be configured to capture images having a desired field-of-view (FOV) 202, as illustrated in FIG. 2D. For example, image capture device 122 may be configured to have a regular FOV, such as within a range of 40 degrees to 56 degrees, including a 46 degree FOV, 50 degree FOV, 52 degree FOV, or greater. Alternatively, image capture device 122 may be configured to have a narrow FOV in the range of 23 to 40 degrees, such as a 28 degree FOV or 36 degree FOV. In addition, image capture device 122 may be configured to have a wide FOV in the range of 100 to 180 degrees. In some embodiments, image capture device 122 may include a wide angle bumper camera or one with up to a 180 degree FOV. In some embodiments, image capture device 122 may be a 7.2M pixel image capture device with an aspect ratio of about 2:1 (e.g., H×V=3800×1900 pixels) with about 100 degree horizontal FOV. Such an image capture device may be used in place of a three image capture device configuration. Due to significant lens distortion, the vertical FOV of such an image capture device may be significantly less than 50 degrees in implementations in which the image capture device uses a radially symmetric lens. For example, such a lens may not be radially symmetric which would allow for a vertical FOV greater than 50 degrees with 100 degree horizontal FOV.

The first image capture device 122 may acquire a plurality of first images relative to a scene associated with the vehicle 200. Each of the plurality of first images may be acquired as a series of image scan lines, which may be captured using a rolling shutter. Each scan line may include a plurality of pixels.

The first image capture device 122 may have a scan rate associated with acquisition of each of the first series of image scan lines. The scan rate may refer to a rate at which an image sensor can acquire image data associated with each pixel included in a particular scan line.

Image capture devices 122, 124, and 126 may contain any suitable type and number of image sensors, including CCD sensors or CMOS sensors, for example. In one embodiment, a CMOS image sensor may be employed along with a rolling shutter, such that each pixel in a row is read one at a time, and scanning of the rows proceeds on a row-by-row basis until an entire image frame has been captured. In some embodiments, the rows may be captured sequentially from top to bottom relative to the frame.

In some embodiments, one or more of the image capture devices (e.g., image capture devices 122, 124, and 126) disclosed herein may constitute a high resolution imager and may have a resolution greater than 5M pixel, 7M pixel, 10M pixel, or greater.

The use of a rolling shutter may result in pixels in different rows being exposed and captured at different times, which may cause skew and other image artifacts in the captured image frame. On the other hand, when the image capture device 122 is configured to operate with a global or synchronous shutter, all of the pixels may be exposed for the same amount of time and during a common exposure period. As a result, the image data in a frame collected from a system employing a global shutter represents a snapshot of the entire FOV (such as FOV 202) at a particular time. In contrast, in a rolling shutter application, each row in a frame is exposed and data is capture at different times. Thus, moving objects may appear distorted in an image capture device having a rolling shutter. This phenomenon will be described in greater detail below.

The second image capture device 124 and the third image capturing device 126 may be any type of image capture device. Like the first image capture device 122, each of image capture devices 124 and 126 may include an optical axis. In one embodiment, each of image capture devices 124 and 126 may include an Aptina M9V024 WVGA sensor with a global shutter. Alternatively, each of image capture devices 124 and 126 may include a rolling shutter. Like image capture device 122, image capture devices 124 and 126 may be configured to include various lenses and optical elements. In some embodiments, lenses associated with image capture devices 124 and 126 may provide FOVs (such as FOVs 204 and 206) that are the same as, or narrower than, a FOV (such as FOV 202) associated with image capture device 122. For example, image capture devices 124 and 126 may have FOVs of 40 degrees, 30 degrees, 26 degrees, 23 degrees, 20 degrees, or less.

Image capture devices 124 and 126 may acquire a plurality of second and third images relative to a scene associated with the vehicle 200. Each of the plurality of second and third images may be acquired as a second and third series of image scan lines, which may be captured using a rolling shutter. Each scan line or row may have a plurality of pixels. Image capture devices 124 and 126 may have second and third scan rates associated with acquisition of each of image scan lines included in the second and third series.

Each image capture device 122, 124, and 126 may be positioned at any suitable position and orientation relative to vehicle 200. The relative positioning of the image capture devices 122, 124, and 126 may be selected to aid in fusing together the information acquired from the image capture devices. For example, in some embodiments, a FOV (such as FOV 204) associated with image capture device 124 may overlap partially or fully with a FOV (such as FOV 202) associated with image capture device 122 and a FOV (such as FOV 206) associated with image capture device 126.

Image capture devices 122, 124, and 126 may be located on vehicle 200 at any suitable relative heights. In one instance, there may be a height difference between the image capture devices 122, 124, and 126, which may provide sufficient parallax information to enable stereo analysis. For example, as shown in FIG. 2A, the two image capture devices 122 and 124 are at different heights. There may also be a lateral displacement difference between image capture devices 122, 124, and 126, giving additional parallax information for stereo analysis by processing unit 110, for example. The difference in the lateral displacement may be denoted by dx, as shown in FIGS. 2C and 2D. In some embodiments, fore or aft displacement (e.g., range displacement) may exist between image capture devices 122, 124, and 126. For example, image capture device 122 may be located 0.5 to 2 meters or more behind image capture device 124 and/or image capture device 126. This type of displacement may enable one of the image capture devices to cover potential blind spots of the other image capture device(s).

Image capture devices 122 may have any suitable resolution capability (e.g., number of pixels associated with the image sensor), and the resolution of the image sensor(s) associated with the image capture device 122 may be higher, lower, or the same as the resolution of the image sensor(s) associated with image capture devices 124 and 126. In some embodiments, the image sensor(s) associated with image capture device 122 and/or image capture devices 124 and 126 may have a resolution of 640×480, 1024×768, 1280×960, or any other suitable resolution.

The frame rate (e.g., the rate at which an image capture device acquires a set of pixel data of one image frame before moving on to capture pixel data associated with the next image frame) may be controllable. The frame rate associated with image capture device 122 may be higher, lower, or the same as the frame rate associated with image capture devices 124 and 126. The frame rate associated with image capture devices 122, 124, and 126 may depend on a variety of factors that may affect the timing of the frame rate. For example, one or more of image capture devices 122, 124, and 126 may include a selectable pixel delay period imposed before or after acquisition of image data associated with one or more pixels of an image sensor in image capture device 122, 124, and/or 126. Generally, image data corresponding to each pixel may be acquired according to a clock rate for the device (e.g., one pixel per clock cycle). Additionally, in embodiments including a rolling shutter, one or more of image capture devices 122, 124, and 126 may include a selectable horizontal blanking period imposed before or after acquisition of image data associated with a row of pixels of an image sensor in image capture device 122, 124, and/or 126. Further, one or more of image capture devices 122, 124, and/or 126 may include a selectable vertical blanking period imposed before or after acquisition of image data associated with an image frame of image capture device 122, 124, and 126.

These timing controls may enable synchronization of frame rates associated with image capture devices 122, 124, and 126, even where the line scan rates of each are different. Additionally, as will be discussed in greater detail below, these selectable timing controls, among other factors (e.g., image sensor resolution, maximum line scan rates, etc.) may enable synchronization of image capture from an area where the FOV of image capture device 122 overlaps with one or more FOVs of image capture devices 124 and 126, even where the field of view of image capture device 122 is different from the FOVs of image capture devices 124 and 126.

Frame rate timing in image capture device 122, 124, and 126 may depend on the resolution of the associated image sensors. For example, assuming similar line scan rates for both devices, if one device includes an image sensor having a resolution of 640×480 and another device includes an image sensor with a resolution of 1280×960, then more time will be required to acquire a frame of image data from the sensor having the higher resolution.

Another factor that may affect the timing of image data acquisition in image capture devices 122, 124, and 126 is the maximum line scan rate. For example, acquisition of a row of image data from an image sensor included in image capture device 122, 124, and 126 will require some minimum amount of time. Assuming no pixel delay periods are added, this minimum amount of time for acquisition of a row of image data will be related to the maximum line scan rate for a particular device. Devices that offer higher maximum line scan rates have the potential to provide higher frame rates than devices with lower maximum line scan rates. In some embodiments, one or more of image capture devices 124 and 126 may have a maximum line scan rate that is higher than a maximum line scan rate associated with image capture device 122. In some embodiments, the maximum line scan rate of image capture device 124 and/or 126 may be 1.25, 1.5, 1.75, or 2 times or more than a maximum line scan rate of image capture device 122.

In another embodiment, image capture devices 122, 124, and 126 may have the same maximum line scan rate, but image capture device 122 may be operated at a scan rate less than or equal to its maximum scan rate. The system may be configured such that one or more of image capture devices 124 and 126 operate at a line scan rate that is equal to the line scan rate of image capture device 122. In other instances, the system may be configured such that the line scan rate of image capture device 124 and/or image capture device 126 may be 1.25, 1.5, 1.75, or 2 times or more than the line scan rate of image capture device 122.

In some embodiments, image capture devices 122, 124, and 126 may be asymmetric. That is, they may include cameras having different fields of view (FOV) and focal lengths. The fields of view of image capture devices 122, 124, and 126 may include any desired area relative to an environment of vehicle 200, for example. In some embodiments, one or more of image capture devices 122, 124, and 126 may be configured to acquire image data from an environment in front of vehicle 200, behind vehicle 200, to the sides of vehicle 200, or combinations thereof.

Further, the focal length associated with each image capture device 122, 124, and/or 126 may be selectable (e.g., by inclusion of appropriate lenses etc.) such that each device acquires images of objects at a desired distance range relative to vehicle 200. For example, in some embodiments image capture devices 122, 124, and 126 may acquire images of close-up objects within a few meters from the vehicle. Image capture devices 122, 124, and 126 may also be configured to acquire images of objects at ranges more distant from the vehicle (e.g., 25 m, 50 m, 100 m, 150 m, or more). Further, the focal lengths of image capture devices 122, 124, and 126 may be selected such that one image capture device (e.g., image capture device 122) can acquire images of objects relatively close to the vehicle (e.g., within 10 m or within 20 m) while the other image capture devices (e.g., image capture devices 124 and 126) can acquire images of more distant objects (e.g., greater than 20 m, 50 m, 100 m, 150 m, etc.) from vehicle 200.

According to some embodiments, the FOV of one or more image capture devices 122, 124, and 126 may have a wide angle. For example, it may be advantageous to have a FOV of 140 degrees, especially for image capture devices 122, 124, and 126 that may be used to capture images of the area in the vicinity of vehicle 200. For example, image capture device 122 may be used to capture images of the area to the right or left of vehicle 200 and, in such embodiments, it may be desirable for image capture device 122 to have a wide FOV (e.g., at least 140 degrees).

The field of view associated with each of image capture devices 122, 124, and 126 may depend on the respective focal lengths. For example, as the focal length increases, the corresponding field of view decreases.

Image capture devices 122, 124, and 126 may be configured to have any suitable fields of view. In one particular example, image capture device 122 may have a horizontal FOV of 46 degrees, image capture device 124 may have a horizontal FOV of 23 degrees, and image capture device 126 may have a horizontal FOV in between 23 and 46 degrees. In another instance, image capture device 122 may have a horizontal FOV of 52 degrees, image capture device 124 may have a horizontal FOV of 26 degrees, and image capture device 126 may have a horizontal FOV in between 26 and 52 degrees. In some embodiments, a ratio of the FOV of image capture device 122 to the FOVs of image capture device 124 and/or image capture device 126 may vary from 1.5 to 2.0. In other embodiments, this ratio may vary between 1.25 and 2.25.

System 100 may be configured so that a field of view of image capture device 122 overlaps, at least partially or fully, with a field of view of image capture device 124 and/or image capture device 126. In some embodiments, system 100 may be configured such that the fields of view of image capture devices 124 and 126, for example, fall within (e.g., are narrower than) and share a common center with the field of view of image capture device 122. In other embodiments, the image capture devices 122, 124, and 126 may capture adjacent FOVs or may have partial overlap in their FOVs. In some embodiments, the fields of view of image capture devices 122, 124, and 126 may be aligned such that a center of the narrower FOV image capture devices 124 and/or 126 may be located in a lower half of the field of view of the wider FOV image capture device 122.

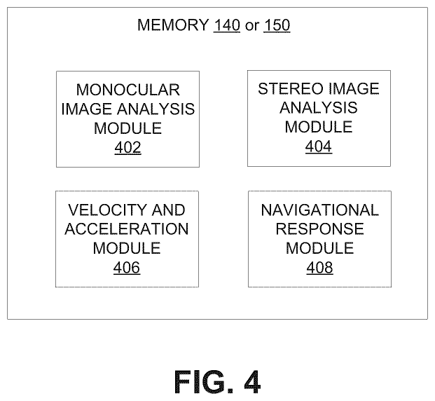

FIG. 2F is a diagrammatic representation of exemplary vehicle control systems, consistent with the disclosed embodiments. As indicated in FIG. 2F, vehicle 200 may include throttling system 220, braking system 230, and steering system 240. System 100 may provide inputs (e.g., control signals) to one or more of throttling system 220, braking system 230, and steering system 240 over one or more data links (e.g., any wired and/or wireless link or links for transmitting data). For example, based on analysis of images acquired by image capture devices 122, 124, and/or 126, system 100 may provide control signals to one or more of throttling system 220, braking system 230, and steering system 240 to navigate vehicle 200 (e.g., by causing an acceleration, a turn, a lane shift, etc.). Further, system 100 may receive inputs from one or more of throttling system 220, braking system 230, and steering system 24 indicating operating conditions of vehicle 200 (e.g., speed, whether vehicle 200 is braking and/or turning, etc.). Further details are provided in connection with FIGS. 4-7, below.

As shown in FIG. 3A, vehicle 200 may also include a user interface 170 for interacting with a driver or a passenger of vehicle 200. For example, user interface 170 in a vehicle application may include a touch screen 320, knobs 330, buttons 340, and a microphone 350. A driver or passenger of vehicle 200 may also use handles (e.g., located on or near the steering column of vehicle 200 including, for example, turn signal handles), buttons (e.g., located on the steering wheel of vehicle 200), and the like, to interact with system 100. In some embodiments, microphone 350 may be positioned adjacent to a rearview mirror 310. Similarly, in some embodiments, image capture device 122 may be located near rearview mirror 310. In some embodiments, user interface 170 may also include one or more speakers 360 (e.g., speakers of a vehicle audio system). For example, system 100 may provide various notifications (e.g., alerts) via speakers 360.

FIGS. 3B-3D are illustrations of an exemplary camera mount 370 configured to be positioned behind a rearview mirror (e.g., rearview mirror 310) and against a vehicle windshield, consistent with disclosed embodiments. As shown in FIG. 3B, camera mount 370 may include image capture devices 122, 124, and 126. Image capture devices 124 and 126 may be positioned behind a glare shield 380, which may be flush against the vehicle windshield and include a composition of film and/or anti-reflective materials. For example, glare shield 380 may be positioned such that the shield aligns against a vehicle windshield having a matching slope. In some embodiments, each of image capture devices 122, 124, and 126 may be positioned behind glare shield 380, as depicted, for example, in FIG. 3D. The disclosed embodiments are not limited to any particular configuration of image capture devices 122, 124, and 126, camera mount 370, and glare shield 380. FIG. 3C is an illustration of camera mount 370 shown in FIG. 3B from a front perspective.

As will be appreciated by a person skilled in the art having the benefit of this disclosure, numerous variations and/or modifications may be made to the foregoing disclosed embodiments. For example, not all components are essential for the operation of system 100. Further, any component may be located in any appropriate part of system 100 and the components may be rearranged into a variety of configurations while providing the functionality of the disclosed embodiments. Therefore, the foregoing configurations are examples and, regardless of the configurations discussed above, system 100 can provide a wide range of functionality to analyze the surroundings of vehicle 200 and navigate vehicle 200 in response to the analysis.

As discussed below in further detail and consistent with various disclosed embodiments, system 100 may provide a variety of features related to autonomous driving and/or driver assist technology. For example, system 100 may analyze image data, position data (e.g., GPS location information), map data, speed data, and/or data from sensors included in vehicle 200. System 100 may collect the data for analysis from, for example, image acquisition unit 120, position sensor 130, and other sensors. Further, system 100 may analyze the collected data to determine whether or not vehicle 200 should take a certain action, and then automatically take the determined action without human intervention. For example, when vehicle 200 navigates without human intervention, system 100 may automatically control the braking, acceleration, and/or steering of vehicle 200 (e.g., by sending control signals to one or more of throttling system 220, braking system 230, and steering system 240). Further, system 100 may analyze the collected data and issue warnings and/or alerts to vehicle occupants based on the analysis of the collected data. Additional details regarding the various embodiments that are provided by system 100 are provided below.

### Forward-Facing Multi-Imaging System

As discussed above, system 100 may provide drive assist functionality that uses a multi-camera system. The multi-camera system may use one or more cameras facing in the forward direction of a vehicle. In other embodiments, the multi-camera system may include one or more cameras facing to the side of a vehicle or to the rear of the vehicle. In one embodiment, for example, system 100 may use a two-camera imaging system, where a first camera and a second camera (e.g., image capture devices 122 and 124) may be positioned at the front and/or the sides of a vehicle (e.g., vehicle 200). The first camera may have a field of view that is greater than, less than, or partially overlapping with, the field of view of the second camera. In addition, the first camera may be connected to a first image processor to perform monocular image analysis of images provided by the first camera, and the second camera may be connected to a second image processor to perform monocular image analysis of images provided by the second camera. The outputs (e.g., processed information) of the first and second image processors may be combined. In some embodiments, the second image processor may receive images from both the first camera and second camera to perform stereo analysis. In another embodiment, system 100 may use a three-camera imaging system where each of the cameras has a different field of view. Such a system may, therefore, make decisions based on information derived from objects located at varying distances both forward and to the sides of the vehicle. References to monocular image analysis may refer to instances where image analysis is performed based on images captured from a single point of view (e.g., from a single camera). Stereo image analysis may refer to instances where image analysis is performed based on two or more images captured with one or more variations of an image capture parameter. For example, captured images suitable for performing stereo image analysis may include images captured: from two or more different positions, from different fields of view, using different focal lengths, along with parallax information, etc.

For example, in one embodiment, system 100 may implement a three camera configuration using image capture devices 122, 124, and 126. In such a configuration, image capture device 122 may provide a narrow field of view (e.g., 34 degrees, or other values selected from a range of about 20 to 45 degrees, etc.), image capture device 124 may provide a wide field of view (e.g., 150 degrees or other values selected from a range of about 100 to about 180 degrees), and image capture device 126 may provide an intermediate field of view (e.g., 46 degrees or other values selected from a range of about 35 to about 60 degrees). In some embodiments, image capture device 126 may act as a main or primary camera. Image capture devices 122, 124, and 126 may be positioned behind rearview mirror 310 and positioned substantially side-by-side (e.g., 6 cm apart). Further, in some embodiments, as discussed above, one or more of image capture devices 122, 124, and 126 may be mounted behind glare shield 380 that is flush with the windshield of vehicle 200. Such shielding may act to minimize the impact of any reflections from inside the car on image capture devices 122, 124, and 126.

In another embodiment, as discussed above in connection with FIGS. 3B and 3C, the wide field of view camera (e.g., image capture device 124 in the above example) may be mounted lower than the narrow and main field of view cameras (e.g., image capture devices 122 and 126 in the above example). This configuration may provide a free line of sight from the wide field of view camera. To reduce reflections, the cameras may be mounted close to the windshield of vehicle 200, and may include polarizers on the cameras to damp reflected light.

A three camera system may provide certain performance characteristics. For example, some embodiments may include an ability to validate the detection of objects by one camera based on detection results from another camera. In the three camera configuration discussed above, processing unit 110 may include, for example, three processing devices (e.g., three EyeQ series of processor chips, as discussed above), with each processing device dedicated to processing images captured by one or more of image capture devices 122, 124, and 126.

In a three camera system, a first processing device may receive images from both the main camera and the narrow field of view camera, and perform vision processing of the narrow FOV camera to, for example, detect other vehicles, pedestrians, lane marks, traffic signs, traffic lights, and other road objects. Further, the first processing device may calculate a disparity of pixels between the images from the main camera and the narrow camera and create a 3D reconstruction of the environment of vehicle 200. The first processing device may then combine the 3D reconstruction with 3D map data or with 3D information calculated based on information from another camera.

The second processing device may receive images from main camera and perform vision processing to detect other vehicles, pedestrians, lane marks, traffic signs, traffic lights, and other road objects. Additionally, the second processing device may calculate a camera displacement and, based on the displacement, calculate a disparity of pixels between successive images and create a 3D reconstruction of the scene (e.g., a structure from motion). The second processing device may send the structure from motion based 3D reconstruction to the first processing device to be combined with the stereo 3D images.

The third processing device may receive images from the wide FOV camera and process the images to detect vehicles, pedestrians, lane marks, traffic signs, traffic lights, and other road objects. The third processing device may further execute additional processing instructions to analyze images to identify objects moving in the image, such as vehicles changing lanes, pedestrians, etc.

In some embodiments, having streams of image-based information captured and processed independently may provide an opportunity for providing redundancy in the system. Such redundancy may include, for example, using a first image capture device and the images processed from that device to validate and/or supplement information obtained by capturing and processing image information from at least a second image capture device.

In some embodiments, system 100 may use two image capture devices (e.g., image capture devices 122 and 124) in providing navigation assistance for vehicle 200 and use a third image capture device (e.g., image capture device 126) to provide redundancy and validate the analysis of data received from the other two image capture devices. For example, in such a configuration, image capture devices 122 and 124 may provide images for stereo analysis by system 100 for navigating vehicle 200, while image capture device 126 may provide images for monocular analysis by system 100 to provide redundancy and validation of information obtained based on images captured from image capture device 122 and/or image capture device 124. That is, image capture device 126 (and a corresponding processing device) may be considered to provide a redundant sub-system for providing a check on the analysis derived from image capture devices 122 and 124 (e.g., to provide an automatic emergency braking (AEB) system). Furthermore, in some embodiments, redundancy and validation of received data may be supplemented based on information received from one more sensors (e.g., radar, lidar, acoustic sensors, information received from one or more transceivers outside of a vehicle, etc.).

One of skill in the art will recognize that the above camera configurations, camera placements, number of cameras, camera locations, etc., are examples only. These components and others described relative to the overall system may be assembled and used in a variety of different configurations without departing from the scope of the disclosed embodiments. Further details regarding usage of a multi-camera system to provide driver assist and/or autonomous vehicle functionality follow below.

FIG. 4 is an exemplary functional block diagram of memory 140 and/or 150, which may be stored/programmed with instructions for performing one or more operations consistent with the disclosed embodiments. Although the following refers to memory 140, one of skill in the art will recognize that instructions may be stored in memory 140 and/or 150.

As shown in FIG. 4, memory 140 may store a monocular image analysis module 402, a stereo image analysis module 404, a velocity and acceleration module 406, and a navigational response module 408. The disclosed embodiments are not limited to any particular configuration of memory 140. Further, application processor 180 and/or image processor 190 may execute the instructions stored in any of modules 402, 404, 406, and 408 included in memory 140. One of skill in the art will understand that references in the following discussions to processing unit 110 may refer to application processor 180 and image processor 190 individually or collectively. Accordingly, steps of any of the following processes may be performed by one or more processing devices.

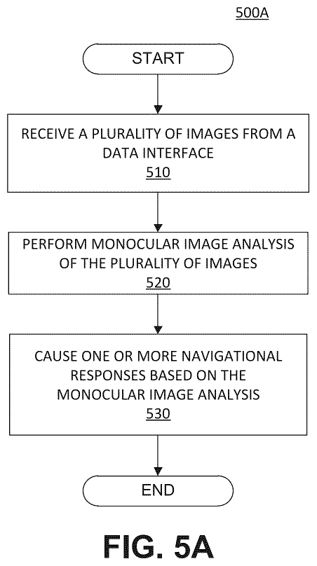

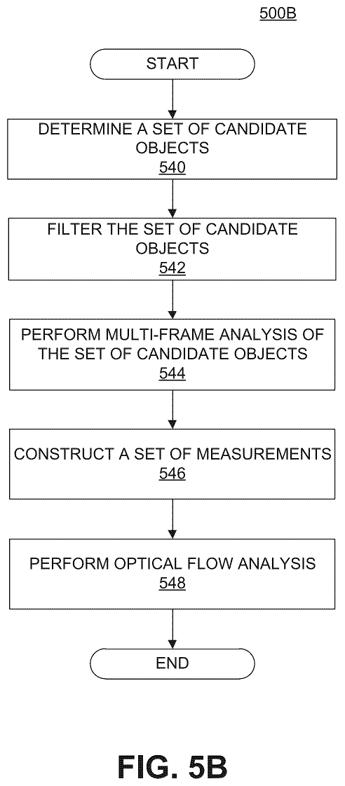

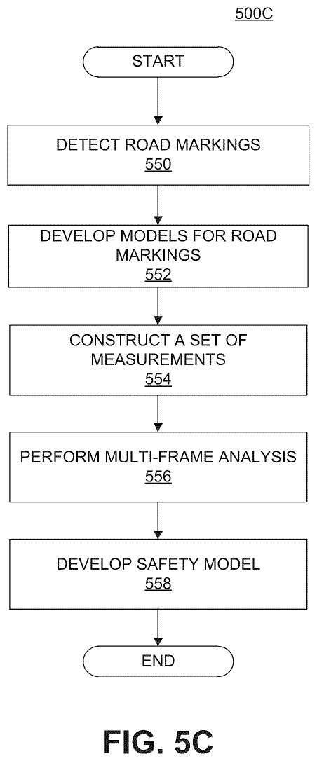

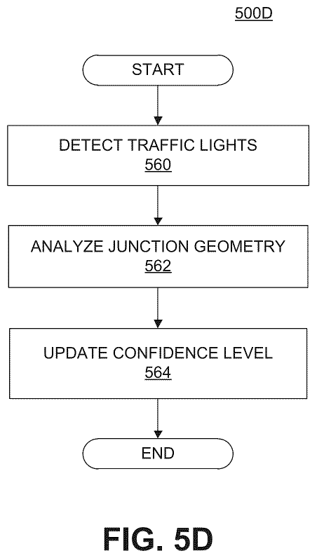

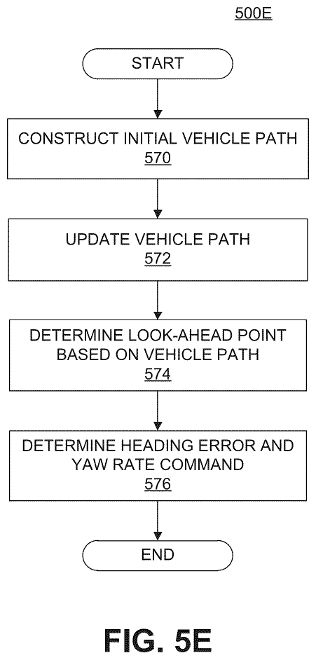

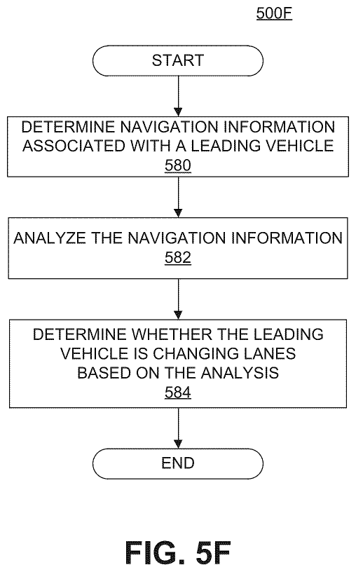

In one embodiment, monocular image analysis module 402 may store instructions (such as computer vision software) which, when executed by processing unit 110, performs monocular image analysis of a set of images acquired by one of image capture devices 122, 124, and 126. In some embodiments, processing unit 110 may combine information from a set of images with additional sensory information (e.g., information from radar, lidar, etc.) to perform the monocular image analysis. As described in connection with FIGS. 5A-5D below, monocular image analysis module 402 may include instructions for detecting a set of features within the set of images, such as lane markings, vehicles, pedestrians, road signs, highway exit ramps, traffic lights, hazardous objects, and any other feature associated with an environment of a vehicle. Based on the analysis, system 100 (e.g., via processing unit 110) may cause one or more navigational responses in vehicle 200, such as a turn, a lane shift, a change in acceleration, and the like, as discussed below in connection with navigational response module 408.

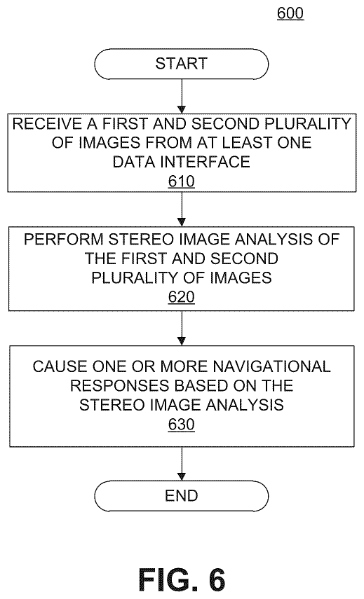

In one embodiment, stereo image analysis module 404 may store instructions (such as computer vision software) which, when executed by processing unit 110, performs stereo image analysis of first and second sets of images acquired by a combination of image capture devices selected from any of image capture devices 122, 124, and 126. In some embodiments, processing unit 110 may combine information from the first and second sets of images with additional sensory information (e.g., information from radar) to perform the stereo image analysis. For example, stereo image analysis module 404 may include instructions for performing stereo image analysis based on a first set of images acquired by image capture device 124 and a second set of images acquired by image capture device 126. As described in connection with FIG. 6 below, stereo image analysis module 404 may include instructions for detecting a set of features within the first and second sets of images, such as lane markings, vehicles, pedestrians, road signs, highway exit ramps, traffic lights, hazardous objects, and the like. Based on the analysis, processing unit 110 may cause one or more navigational responses in vehicle 200, such as a turn, a lane shift, a change in acceleration, and the like, as discussed below in connection with navigational response module 408. Furthermore, in some embodiments, stereo image analysis module 404 may implement techniques associated with a trained system (such as a neural network or a deep neural network) or an untrained system, such as a system that may be configured to use computer vision algorithms to detect and/or label objects in an environment from which sensory information was captured and processed. In one embodiment, stereo image analysis module 404 and/or other image processing modules may be configured to use a combination of a trained and untrained system.

In one embodiment, velocity and acceleration module 406 may store software configured to analyze data received from one or more computing and electromechanical devices in vehicle 200 that are configured to cause a change in velocity and/or acceleration of vehicle 200. For example, processing unit 110 may execute instructions associated with velocity and acceleration module 406 to calculate a target speed for vehicle 200 based on data derived from execution of monocular image analysis module 402 and/or stereo image analysis module 404. Such data may include, for example, a target position, velocity, and/or acceleration, the position and/or speed of vehicle 200 relative to a nearby vehicle, pedestrian, or road object, position information for vehicle 200 relative to lane markings of the road, and the like. In addition, processing unit 110 may calculate a target speed for vehicle 200 based on sensory input (e.g., information from radar) and input from other systems of vehicle 200, such as throttling system 220, braking system 230, and/or steering system 240 of vehicle 200. Based on the calculated target speed, processing unit 110 may transmit electronic signals to throttling system 220, braking system 230, and/or steering system 240 of vehicle 200 to trigger a change in velocity and/or acceleration by, for example, physically depressing the brake or casing up off the accelerator of vehicle 200.

In one embodiment, navigational response module 408 may store software executable by processing unit 110 to determine a desired navigational response based on data derived from execution of monocular image analysis module 402 and/or stereo image analysis module 404. Such data may include position and speed information associated with nearby vehicles, pedestrians, and road objects, target position information for vehicle 200, and the like. Additionally, in some embodiments, the navigational response may be based (partially or fully) on map data, a predetermined position of vehicle 200, and/or a relative velocity or a relative acceleration between vehicle 200 and one or more objects detected from execution of monocular image analysis module 402 and/or stereo image analysis module 404. Navigational response module 408 may also determine a desired navigational response based on sensory input (e.g., information from radar) and inputs from other systems of vehicle 200, such as throttling system 220, braking system 230, and steering system 240 of vehicle 200. Based on the desired navigational response, processing unit 110 may transmit electronic signals to throttling system 220, braking system 230, and steering system 240 of vehicle 200 to trigger a desired navigational response by, for example, turning the steering wheel of vehicle 200 to achieve a rotation of a predetermined angle. In some embodiments, processing unit 110 may use the output of navigational response module 408 (e.g., the desired navigational response) as an input to execution of velocity and acceleration module 406 for calculating a change in speed of vehicle 200.

Furthermore, any of the modules (e.g., modules 402, 404, and 406) disclosed herein may implement techniques associated with a trained system (such as a neural network or a deep neural network) or an untrained system.

FIG. 5A is a flowchart showing an exemplary process 500A for causing one or more navigational responses based on monocular image analysis, consistent with disclosed embodiments. At step 510, processing unit 110 may receive a plurality of images via data interface 128 between processing unit 110 and image acquisition unit 120. For instance, a camera included in image acquisition unit 120 (such as image capture device 122 having field of view 202) may capture a plurality of images of an area forward of vehicle 200 (or to the sides or rear of a vehicle, for example) and transmit them over a data connection (e.g., digital, wired, USB, wireless, Bluetooth, etc.) to processing unit 110. Processing unit 110 may execute monocular image analysis module 402 to analyze the plurality of images at step 520, as described in further detail in connection with FIGS. 5B-5D below. By performing the analysis, processing unit 110 may detect a set of features within the set of images, such as lane markings, vehicles, pedestrians, road signs, highway exit ramps, traffic lights, and the like.

Processing unit 110 may also execute monocular image analysis module 402 to detect various road hazards at step 520, such as, for example, parts of a truck tire, fallen road signs, loose cargo, small animals, and the like. Road hazards may vary in structure, shape, size, and color, which may make detection of such hazards more challenging. In some embodiments, processing unit 110 may execute monocular image analysis module 402 to perform multi-frame analysis on the plurality of images to detect road hazards. For example, processing unit 110 may estimate camera motion between consecutive image frames and calculate the disparities in pixels between the frames to construct a 3D-map of the road. Processing unit 110 may then use the 3D-map to detect the road surface, as well as hazards existing above the road surface.

At step 530, processing unit 110 may execute navigational response module 408 to cause one or more navigational responses in vehicle 200 based on the analysis performed at step 520 and the techniques as described above in connection with FIG. 4. Navigational responses may include, for example, a turn, a lane shift, a change in acceleration, and the like. In some embodiments, processing unit 110 may use data derived from execution of velocity and acceleration module 406 to cause the one or more navigational responses. Additionally, multiple navigational responses may occur simultaneously, in sequence, or any combination thereof. For instance, processing unit 110 may cause vehicle 200 to shift one lane over and then accelerate by, for example, sequentially transmitting control signals to steering system 240 and throttling system 220 of vehicle 200. Alternatively, processing unit 110 may cause vehicle 200 to brake while at the same time shifting lanes by, for example, simultaneously transmitting control signals to braking system 230 and steering system 240 of vehicle 200.

FIG. 5B is a flowchart showing an exemplary process 500B for detecting one or more vehicles and/or pedestrians in a set of images, consistent with disclosed embodiments. Processing unit 110 may execute monocular image analysis module 402 to implement process 500B. At step 540, processing unit 110 may determine a set of candidate objects representing possible vehicles and/or pedestrians. For example, processing unit 110 may scan one or more images, compare the images to one or more predetermined patterns, and identify within each image possible locations that may contain objects of interest (e.g., vehicles, pedestrians, or portions thereof). The predetermined patterns may be designed in such a way to achieve a high rate of “false hits” and a low rate of “misses.” For example, processing unit 110 may use a low threshold of similarity to predetermined patterns for identifying candidate objects as possible vehicles or pedestrians. Doing so may allow processing unit 110 to reduce the probability of missing (e.g., not identifying) a candidate object representing a vehicle or pedestrian.

At step 542, processing unit 110 may filter the set of candidate objects to exclude certain candidates (e.g., irrelevant or less relevant objects) based on classification criteria. Such criteria may be derived from various properties associated with object types stored in a database (e.g., a database stored in memory 140). Properties may include object shape, dimensions, texture, position (e.g., relative to vehicle 200), and the like. Thus, processing unit 110 may use one or more sets of criteria to reject false candidates from the set of candidate objects.

At step 544, processing unit 110 may analyze multiple frames of images to determine whether objects in the set of candidate objects represent vehicles and/or pedestrians. For example, processing unit 110 may track a detected candidate object across consecutive frames and accumulate frame-by-frame data associated with the detected object (e.g., size, position relative to vehicle 200, etc.). Additionally, processing unit 110 may estimate parameters for the detected object and compare the object's frame-by-frame position data to a predicted position.

At step 546, processing unit 110 may construct a set of measurements for the detected objects. Such measurements may include, for example, position, velocity, and acceleration values (relative to vehicle 200) associated with the detected objects. In some embodiments, processing unit 110 may construct the measurements based on estimation techniques using a series of time-based observations such as Kalman filters or linear quadratic estimation (LQE), and/or based on available modeling data for different object types (e.g., cars, trucks, pedestrians, bicycles, road signs, etc.). The Kalman filters may be based on a measurement of an object's scale, where the scale measurement is proportional to a time to collision (e.g., the amount of time for vehicle 200 to reach the object). Thus, by performing steps 540-546, processing unit 110 may identify vehicles and pedestrians appearing within the set of captured images and derive information (e.g., position, speed, size) associated with the vehicles and pedestrians. Based on the identification and the derived information, processing unit 110 may cause one or more navigational responses in vehicle 200, as described in connection with FIG. 5A, above.

At step 548, processing unit 110 may perform an optical flow analysis of one or more images to reduce the probabilities of detecting a “false hit” and missing a candidate object that represents a vehicle or pedestrian. The optical flow analysis may refer to, for example, analyzing motion patterns relative to vehicle 200 in the one or more images associated with other vehicles and pedestrians, and that are distinct from road surface motion. Processing unit 110 may calculate the motion of candidate objects by observing the different positions of the objects across multiple image frames, which are captured at different times. Processing unit 110 may use the position and time values as inputs into mathematical models for calculating the motion of the candidate objects. Thus, optical flow analysis may provide another method of detecting vehicles and pedestrians that are nearby vehicle 200. Processing unit 110 may perform optical flow analysis in combination with steps 540-546 to provide redundancy for detecting vehicles and pedestrians and increase the reliability of system 100.

FIG. 5C is a flowchart showing an exemplary process 500C for detecting road marks and/or lane geometry information in a set of images, consistent with disclosed embodiments. Processing unit 110 may execute monocular image analysis module 402 to implement process 500C. At step 550, processing unit 110 may detect a set of objects by scanning one or more images. To detect segments of lane markings, lane geometry information, and other pertinent road marks, processing unit 110 may filter the set of objects to exclude those determined to be irrelevant (e.g., minor potholes, small rocks, etc.). At step 552, processing unit 110 may group together the segments detected in step 550 belonging to the same road mark or lane mark. Based on the grouping, processing unit 110 may develop a model to represent the detected segments, such as a mathematical model.

At step 554, processing unit 110 may construct a set of measurements associated with the detected segments. In some embodiments, processing unit 110 may create a projection of the detected segments from the image plane onto the real-world plane. The projection may be characterized using a 3rd-degree polynomial having coefficients corresponding to physical properties such as the position, slope, curvature, and curvature derivative of the detected road. In generating the projection, processing unit 110 may take into account changes in the road surface, as well as pitch and roll rates associated with vehicle 200. In addition, processing unit 110 may model the road elevation by analyzing position and motion cues present on the road surface. Further, processing unit 110 may estimate the pitch and roll rates associated with vehicle 200 by tracking a set of feature points in the one or more images.

At step 556, processing unit 110 may perform multi-frame analysis by, for example, tracking the detected segments across consecutive image frames and accumulating frame-by-frame data associated with detected segments. As processing unit 110 performs multi-frame analysis, the set of measurements constructed at step 554 may become more reliable and associated with an increasingly higher confidence level. Thus, by performing steps 550, 552, 554, and 556, processing unit 110 may identify road marks appearing within the set of captured images and derive lane geometry information. Based on the identification and the derived information, processing unit 110 may cause one or more navigational responses in vehicle 200, as described in connection with FIG. 5A, above.

At step 558, processing unit 110 may consider additional sources of information to further develop a safety model for vehicle 200 in the context of its surroundings. Processing unit 110 may use the safety model to define a context in which system 100 may execute autonomous control of vehicle 200 in a safe manner. To develop the safety model, in some embodiments, processing unit 110 may consider the position and motion of other vehicles, the detected road edges and barriers, and/or general road shape descriptions extracted from map data (such as data from map database 160). By considering additional sources of information, processing unit 110 may provide redundancy for detecting road marks and lane geometry and increase the reliability of system 100.

FIG. 5D is a flowchart showing an exemplary process 500D for detecting traffic lights in a set of images, consistent with disclosed embodiments. Processing unit 110 may execute monocular image analysis module 402 to implement process 500D. At step 560, processing unit 110 may scan the set of images and identify objects appearing at locations in the images likely to contain traffic lights. For example, processing unit 110 may filter the identified objects to construct a set of candidate objects, excluding those objects unlikely to correspond to traffic lights. The filtering may be done based on various properties associated with traffic lights, such as shape, dimensions, texture, position (e.g., relative to vehicle 200), and the like. Such properties may be based on multiple examples of traffic lights and traffic control signals and stored in a database. In some embodiments, processing unit 110 may perform multi-frame analysis on the set of candidate objects reflecting possible traffic lights. For example, processing unit 110 may track the candidate objects across consecutive image frames, estimate the real-world position of the candidate objects, and filter out those objects that are moving (which are unlikely to be traffic lights). In some embodiments, processing unit 110 may perform color analysis on the candidate objects and identify the relative position of the detected colors appearing inside possible traffic lights.

At step 562, processing unit 110 may analyze the geometry of a junction. The analysis may be based on any combination of: (i) the number of lanes detected on either side of vehicle 200, (ii) markings (such as arrow marks) detected on the road, and (iii) descriptions of the junction extracted from map data (such as data from map database 160). Processing unit 110 may conduct the analysis using information derived from execution of monocular analysis module 402. In addition, Processing unit 110 may determine a correspondence between the traffic lights detected at step 560 and the lanes appearing near vehicle 200.

As vehicle 200 approaches the junction, at step 564, processing unit 110 may update the confidence level associated with the analyzed junction geometry and the detected traffic lights. For instance, the number of traffic lights estimated to appear at the junction as compared with the number actually appearing at the junction may impact the confidence level. Thus, based on the confidence level, processing unit 110 may delegate control to the driver of vehicle 200 in order to improve safety conditions. By performing steps 560, 562, and 564, processing unit 110 may identify traffic lights appearing within the set of captured images and analyze junction geometry information. Based on the identification and the analysis, processing unit 110 may cause one or more navigational responses in vehicle 200, as described in connection with FIG. 5A, above.

FIG. 5E is a flowchart showing an exemplary process 500E for causing one or more navigational responses in vehicle 200 based on a vehicle path, consistent with the disclosed embodiments. At step 570, processing unit 110 may construct an initial vehicle path associated with vehicle 200. The vehicle path may be represented using a set of points expressed in coordinates (x, z), and the distance di between two points in the set of points may fall in the range of 1 to 5 meters. In one embodiment, processing unit 110 may construct the initial vehicle path using two polynomials, such as left and right road polynomials. Processing unit 110 may calculate the geometric midpoint between the two polynomials and offset each point included in the resultant vehicle path by a predetermined offset (e.g., a smart lane offset), if any (an offset of zero may correspond to travel in the middle of a lane). The offset may be in a direction perpendicular to a segment between any two points in the vehicle path. In another embodiment, processing unit 110 may use one polynomial and an estimated lane width to offset each point of the vehicle path by half the estimated lane width plus a predetermined offset (e.g., a smart lane offset).

At step 572, processing unit 110 may update the vehicle path constructed at step 570. Processing unit 110 may reconstruct the vehicle path constructed at step 570 using a higher resolution, such that the distance de between two points in the set of points representing the vehicle path is less than the distance di described above. For example, the distance de may fall in the range of 0.1 to 0.3 meters. Processing unit 110 may reconstruct the vehicle path using a parabolic spline algorithm, which may yield a cumulative distance vector S corresponding to the total length of the vehicle path (i.e., based on the set of points representing the vehicle path).

At step 574, processing unit 110 may determine a look-ahead point (expressed in coordinates as (x₁, z₁)) based on the updated vehicle path constructed at step 572. Processing unit 110 may extract the look-ahead point from the cumulative distance vector S, and the look-ahead point may be associated with a look-ahead distance and look-ahead time. The look-ahead distance, which may have a lower bound ranging from 10 to 20 meters, may be calculated as the product of the speed of vehicle 200 and the look-ahead time. For example, as the speed of vehicle 200 decreases, the look-ahead distance may also decrease (e.g., until it reaches the lower bound). The look-ahead time, which may range from 0.5 to 1.5 seconds, may be inversely proportional to the gain of one or more control loops associated with causing a navigational response in vehicle 200, such as the heading error tracking control loop. For example, the gain of the heading error tracking control loop may depend on the bandwidth of a yaw rate loop, a steering actuator loop, car lateral dynamics, and the like. Thus, the higher the gain of the heading error tracking control loop, the lower the look-ahead time.

At step 576, processing unit 110 may determine a heading error and yaw rate command based on the look-ahead point determined at step 574. Processing unit 110 may determine the heading error by calculating the arctangent of the look-ahead point, e.g., arctan (x₁/z₁). Processing unit 110 may determine the yaw rate command as the product of the heading error and a high-level control gain. The high-level control gain may be equal to: (2/look-ahead time), if the look-ahead distance is not at the lower bound. Otherwise, the high-level control gain may be equal to: (2*speed of vehicle 200/look-ahead distance).

FIG. 5F is a flowchart showing an exemplary process 500F for determining whether a leading vehicle is changing lanes, consistent with the disclosed embodiments. At step 580, processing unit 110 may determine navigation information associated with a leading vehicle (e.g., a vehicle traveling ahead of vehicle 200). For example, processing unit 110 may determine the position, velocity (e.g., direction and speed), and/or acceleration of the leading vehicle, using the techniques described in connection with FIGS. 5A and 5B, above. Processing unit 110 may also determine one or more road polynomials, a look-ahead point (associated with vehicle 200), and/or a snail trail (e.g., a set of points describing a path taken by the leading vehicle), using the techniques described in connection with FIG. 5E, above.

At step 582, processing unit 110 may analyze the navigation information determined at step 580. In one embodiment, processing unit 110 may calculate the distance between a snail trail and a road polynomial (e.g., along the trail). If the variance of this distance along the trail exceeds a predetermined threshold (for example, 0.1 to 0.2 meters on a straight road, 0.3 to 0.4 meters on a moderately curvy road, and 0.5 to 0.6 meters on a road with sharp curves), processing unit 110 may determine that the leading vehicle is likely changing lanes. In the case where multiple vehicles are detected traveling ahead of vehicle 200, processing unit 110 may compare the snail trails associated with each vehicle. Based on the comparison, processing unit 110 may determine that a vehicle whose snail trail does not match with the snail trails of the other vehicles is likely changing lanes. Processing unit 110 may additionally compare the curvature of the snail trail (associated with the leading vehicle) with the expected curvature of the road segment in which the leading vehicle is traveling. The expected curvature may be extracted from map data (e.g., data from map database 160), from road polynomials, from other vehicles' snail trails, from prior knowledge about the road, and the like. If the difference in curvature of the snail trail and the expected curvature of the road segment exceeds a predetermined threshold, processing unit 110 may determine that the leading vehicle is likely changing lanes.

In another embodiment, processing unit 110 may compare the leading vehicle's instantaneous position with the look-ahead point (associated with vehicle 200) over a specific period of time (e.g., 0.5 to 1.5 seconds). If the distance between the leading vehicle's instantaneous position and the look-ahead point varies during the specific period of time, and the cumulative sum of variation exceeds a predetermined threshold (for example, 0.3 to 0.4 meters on a straight road, 0.7 to 0.8 meters on a moderately curvy road, and 1.3 to 1.7 meters on a road with sharp curves), processing unit 110 may determine that the leading vehicle is likely changing lanes. In another embodiment, processing unit 110 may analyze the geometry of the snail trail by comparing the lateral distance traveled along the trail with the expected curvature of the snail trail. The expected radius of curvature may be determined according to the calculation: (δ_{z}²+δₓ²)/2/(δₓ), where δₓ represents the lateral distance traveled and δ_{z} represents the longitudinal distance traveled. If the difference between the lateral distance traveled and the expected curvature exceeds a predetermined threshold (e.g., 500 to 700 meters), processing unit 110 may determine that the leading vehicle is likely changing lanes. In another embodiment, processing unit 110 may analyze the position of the leading vehicle. If the position of the leading vehicle obscures a road polynomial (e.g., the leading vehicle is overlaid on top of the road polynomial), then processing unit 110 may determine that the leading vehicle is likely changing lanes. In the case where the position of the leading vehicle is such that, another vehicle is detected ahead of the leading vehicle and the snail trails of the two vehicles are not parallel, processing unit 110 may determine that the (closer) leading vehicle is likely changing lanes.

At step 584, processing unit 110 may determine whether or not leading vehicle 200 is changing lanes based on the analysis performed at step 582. For example, processing unit 110 may make the determination based on a weighted average of the individual analyses performed at step 582. Under such a scheme, for example, a decision by processing unit 110 that the leading vehicle is likely changing lanes based on a particular type of analysis may be assigned a value of “1” (and “0” to represent a determination that the leading vehicle is not likely changing lanes). Different analyses performed at step 582 may be assigned different weights, and the disclosed embodiments are not limited to any particular combination of analyses and weights.

FIG. 6 is a flowchart showing an exemplary process 600 for causing one or more navigational responses based on stereo image analysis, consistent with disclosed embodiments. At step 610, processing unit 110 may receive a first and second plurality of images via data interface 128. For example, cameras included in image acquisition unit 120 (such as image capture devices 122 and 124 having fields of view 202 and 204) may capture a first and second plurality of images of an area forward of vehicle 200 and transmit them over a digital connection (e.g., USB, wireless, Bluetooth, etc.) to processing unit 110. In some embodiments, processing unit 110 may receive the first and second plurality of images via two or more data interfaces. The disclosed embodiments are not limited to any particular data interface configurations or protocols.

At step 620, processing unit 110 may execute stereo image analysis module 404 to perform stereo image analysis of the first and second plurality of images to create a 3D map of the road in front of the vehicle and detect features within the images, such as lane markings, vehicles, pedestrians, road signs, highway exit ramps, traffic lights, road hazards, and the like. Stereo image analysis may be performed in a manner similar to the steps described in connection with FIGS. 5A-5D, above. For example, processing unit 110 may execute stereo image analysis module 404 to detect candidate objects (e.g., vehicles, pedestrians, road marks, traffic lights, road hazards, etc.) within the first and second plurality of images, filter out a subset of the candidate objects based on various criteria, and perform multi-frame analysis, construct measurements, and determine a confidence level for the remaining candidate objects. In performing the steps above, processing unit 110 may consider information from both the first and second plurality of images, rather than information from one set of images alone. For example, processing unit 110 may analyze the differences in pixel-level data (or other data subsets from among the two streams of captured images) for a candidate object appearing in both the first and second plurality of images. As another example, processing unit 110 may estimate a position and/or velocity of a candidate object (e.g., relative to vehicle 200) by observing that the object appears in one of the plurality of images but not the other or relative to other differences that may exist relative to objects appearing if the two image streams. For example, position, velocity, and/or acceleration relative to vehicle 200 may be determined based on trajectories, positions, movement characteristics, etc. of features associated with an object appearing in one or both of the image streams.

At step 630, processing unit 110 may execute navigational response module 408 to cause one or more navigational responses in vehicle 200 based on the analysis performed at step 620 and the techniques as described above in connection with FIG. 4. Navigational responses may include, for example, a turn, a lane shift, a change in acceleration, a change in velocity, braking, and the like. In some embodiments, processing unit 110 may use data derived from execution of velocity and acceleration module 406 to cause the one or more navigational responses. Additionally, multiple navigational responses may occur simultaneously, in sequence, or any combination thereof.

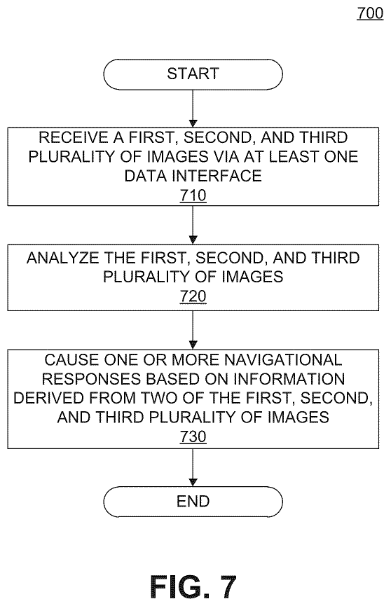

FIG. 7 is a flowchart showing an exemplary process 700 for causing one or more navigational responses based on an analysis of three sets of images, consistent with disclosed embodiments. At step 710, processing unit 110 may receive a first, second, and third plurality of images via data interface 128. For instance, cameras included in image acquisition unit 120 (such as image capture devices 122, 124, and 126 having fields of view 202, 204, and 206) may capture a first, second, and third plurality of images of an area forward and/or to the side of vehicle 200 and transmit them over a digital connection (e.g., USB, wireless, Bluetooth, etc.) to processing unit 110. In some embodiments, processing unit 110 may receive the first, second, and third plurality of images via three or more data interfaces. For example, each of image capture devices 122, 124, 126 may have an associated data interface for communicating data to processing unit 110. The disclosed embodiments are not limited to any particular data interface configurations or protocols.

At step 720, processing unit 110 may analyze the first, second, and third plurality of images to detect features within the images, such as lane markings, vehicles, pedestrians, road signs, highway exit ramps, traffic lights, road hazards, and the like. The analysis may be performed in a manner similar to the steps described in connection with FIGS. 5A-5D and 6, above. For instance, processing unit 110 may perform monocular image analysis (e.g., via execution of monocular image analysis module 402 and based on the steps described in connection with FIGS. 5A-5D, above) on each of the first, second, and third plurality of images. Alternatively, processing unit 110 may perform stereo image analysis (e.g., via execution of stereo image analysis module 404 and based on the steps described in connection with FIG. 6, above) on the first and second plurality of images, the second and third plurality of images, and/or the first and third plurality of images. The processed information corresponding to the analysis of the first, second, and/or third plurality of images may be combined. In some embodiments, processing unit 110 may perform a combination of monocular and stereo image analyses. For example, processing unit 110 may perform monocular image analysis (e.g., via execution of monocular image analysis module 402) on the first plurality of images and stereo image analysis (e.g., via execution of stereo image analysis module 404) on the second and third plurality of images. The configuration of image capture devices 122, 124, and 126—including their respective locations and fields of view 202, 204, and 206—may influence the types of analyses conducted on the first, second, and third plurality of images. The disclosed embodiments are not limited to a particular configuration of image capture devices 122, 124, and 126, or the types of analyses conducted on the first, second, and third plurality of images.

In some embodiments, processing unit 110 may perform testing on system 100 based on the images acquired and analyzed at steps 710 and 720. Such testing may provide an indicator of the overall performance of system 100 for certain configurations of image capture devices 122, 124, and 126. For example, processing unit 110 may determine the proportion of “false hits” (e.g., cases where system 100 incorrectly determined the presence of a vehicle or pedestrian) and “misses.”

At step 730, processing unit 110 may cause one or more navigational responses in vehicle 200 based on information derived from two of the first, second, and third plurality of images. Selection of two of the first, second, and third plurality of images may depend on various factors, such as, for example, the number, types, and sizes of objects detected in each of the plurality of images. Processing unit 110 may also make the selection based on image quality and resolution, the effective field of view reflected in the images, the number of captured frames, the extent to which one or more objects of interest actually appear in the frames (e.g., the percentage of frames in which an object appears, the proportion of the object that appears in each such frame, etc.), and the like.

In some embodiments, processing unit 110 may select information derived from two of the first, second, and third plurality of images by determining the extent to which information derived from one image source is consistent with information derived from other image sources. For example, processing unit 110 may combine the processed information derived from each of image capture devices 122, 124, and 126 (whether by monocular analysis, stereo analysis, or any combination of the two) and determine visual indicators (e.g., lane markings, a detected vehicle and its location and/or path, a detected traffic light, etc.) that are consistent across the images captured from each of image capture devices 122, 124, and 126. Processing unit 110 may also exclude information that is inconsistent across the captured images (e.g., a vehicle changing lanes, a lane model indicating a vehicle that is too close to vehicle 200, etc.). Thus, processing unit 110 may select information derived from two of the first, second, and third plurality of images based on the determinations of consistent and inconsistent information.

Navigational responses may include, for example, a turn, a lane shift, a change in acceleration, and the like. Processing unit 110 may cause the one or more navigational responses based on the analysis performed at step 720 and the techniques as described above in connection with FIG. 4. Processing unit 110 may also use data derived from execution of velocity and acceleration module 406 to cause the one or more navigational responses. In some embodiments, processing unit 110 may cause the one or more navigational responses based on a relative position, relative velocity, and/or relative acceleration between vehicle 200 and an object detected within any of the first, second, and third plurality of images. Multiple navigational responses may occur simultaneously, in sequence, or any combination thereof.

### Sparse Road Model for Autonomous Vehicle Navigation

In some embodiments, the disclosed systems and methods may use a sparse map for autonomous vehicle navigation. In particular, the sparse map may be for autonomous vehicle navigation along a road segment. For example, the sparse map may provide sufficient information for navigating an autonomous vehicle without storing and/or updating a large quantity of data. As discussed below in further detail, an autonomous vehicle may use the sparse map to navigate one or more roads based on one or more stored trajectories.

### Sparse Map for Autonomous Vehicle Navigation

In some embodiments, the disclosed systems and methods may generate a sparse map for autonomous vehicle navigation. For example, the sparse map may provide sufficient information for navigation without requiring excessive data storage or data transfer rates. As discussed below in further detail, a vehicle (which may be an autonomous vehicle) may use the sparse map to navigate one or more roads. For example, in some embodiments, the sparse map may include data related to a road and potentially landmarks along the road that may be sufficient for vehicle navigation, but which also exhibit small data footprints. For example, the sparse data maps described in detail below may require significantly less storage space and data transfer bandwidth as compared with digital maps including detailed map information, such as image data collected along a road.

For example, rather than storing detailed representations of a road segment, the sparse data map may store three-dimensional polynomial representations of preferred vehicle paths along a road. These paths may require very little data storage space. Further, in the described sparse data maps, landmarks may be identified and included in the sparse map road model to aid in navigation. These landmarks may be located at any spacing suitable for enabling vehicle navigation, but in some cases, such landmarks need not be identified and included in the model at high densities and short spacings. Rather, in some cases, navigation may be possible based on landmarks that are spaced apart by at least 50 meters, at least 100 meters, at least 500 meters, at least 1 kilometer, or at least 2 kilometers. As will be discussed in more detail in other sections, the sparse map may be generated based on data collected or measured by vehicles equipped with various sensors and devices, such as image capture devices, Global Positioning System sensors, motion sensors, etc., as the vehicles travel along roadways. In some cases, the sparse map may be generated based on data collected during multiple drives of one or more vehicles along a particular roadway. Generating a sparse map using multiple drives of one or more vehicles may be referred to as “crowdsourcing” a sparse map.

Consistent with disclosed embodiments, an autonomous vehicle system may use a sparse map for navigation. For example, the disclosed systems and methods may distribute a sparse map for generating a road navigation model for an autonomous vehicle and may navigate an autonomous vehicle along a road segment using a sparse map and/or a generated road navigation model. Sparse maps consistent with the present disclosure may include one or more three-dimensional contours that may represent predetermined trajectories that autonomous vehicles may traverse as they move along associated road segments.

Sparse maps consistent with the present disclosure may also include data representing one or more road features. Such road features may include recognized landmarks, road signature profiles, and any other road-related features useful in navigating a vehicle. Sparse maps consistent with the present disclosure may enable autonomous navigation of a vehicle based on relatively small amounts of data included in the sparse map. For example, rather than including detailed representations of a road, such as road edges, road curvature, images associated with road segments, or data detailing other physical features associated with a road segment, the disclosed embodiments of the sparse map may require relatively little storage space (and relatively little bandwidth when portions of the sparse map are transferred to a vehicle) but may still adequately provide for autonomous vehicle navigation. The small data footprint of the disclosed sparse maps, discussed in further detail below, may be achieved in some embodiments by storing representations of road-related elements that require small amounts of data but still enable autonomous navigation.

For example, rather than storing detailed representations of various aspects of a road, the disclosed sparse maps may store polynomial representations of one or more trajectories that a vehicle may follow along the road. Thus, rather than storing (or having to transfer) details regarding the physical nature of the road to enable navigation along the road, using the disclosed sparse maps, a vehicle may be navigated along a particular road segment without, in some cases, having to interpret physical aspects of the road, but rather, by aligning its path of travel with a trajectory (e.g., a polynomial spline) along the particular road segment. In this way, the vehicle may be navigated based mainly upon the stored trajectory (e.g., a polynomial spline) that may require much less storage space than an approach involving storage of roadway images, road parameters, road layout, etc.

In addition to the stored polynomial representations of trajectories along a road segment, the disclosed sparse maps may also include small data objects that may represent a road feature. In some embodiments, the small data objects may include digital signatures, which are derived from a digital image (or a digital signal) that was obtained by a sensor (e.g., a camera or other sensor, such as a suspension sensor) onboard a vehicle traveling along the road segment. The digital signature may have a reduced size relative to the signal that was acquired by the sensor. In some embodiments, the digital signature may be created to be compatible with a classifier function that is configured to detect and to identify the road feature from the signal that is acquired by the sensor, for example, during a subsequent drive. In some embodiments, a digital signature may be created such that the digital signature has a footprint that is as small as possible, while retaining the ability to correlate or match the road feature with the stored signature based on an image (or a digital signal generated by a sensor, if the stored signature is not based on an image and/or includes other data) of the road feature that is captured by a camera onboard a vehicle traveling along the same road segment at a subsequent time.

In some embodiments, a size of the data objects may be further associated with a uniqueness of the road feature. For example, for a road feature that is detectable by a camera onboard a vehicle, and where the camera system onboard the vehicle is coupled to a classifier that is capable of distinguishing the image data corresponding to that road feature as being associated with a particular type of road feature, for example, a road sign, and where such a road sign is locally unique in that area (e.g., there is no identical road sign or road sign of the same type nearby), it may be sufficient to store data indicating the type of the road feature and its location.

As will be discussed in further detail below, road features (e.g., landmarks along a road segment) may be stored as small data objects that may represent a road feature in relatively few bytes, while at the same time providing sufficient information for recognizing and using such a feature for navigation. In one example, a road sign may be identified as a recognized landmark on which navigation of a vehicle may be based. A representation of the road sign may be stored in the sparse map to include, e.g., a few bytes of data indicating a type of landmark (e.g., a stop sign) and a few bytes of data indicating a location of the landmark (e.g., coordinates). Navigating based on such data-light representations of the landmarks (e.g., using representations sufficient for locating, recognizing, and navigating based upon the landmarks) may provide a desired level of navigational functionality associated with sparse maps without significantly increasing the data overhead associated with the sparse maps. This lean representation of landmarks (and other road features) may take advantage of the sensors and processors included onboard such vehicles that are configured to detect, identify, and/or classify certain road features.

When, for example, a sign or even a particular type of a sign is locally unique (e.g., when there is no other sign or no other sign of the same type) in a given area, the sparse map may use data indicating a type of a landmark (a sign or a specific type of sign), and during navigation (e.g., autonomous navigation) when a camera onboard an autonomous vehicle captures an image of the area including a sign (or of a specific type of sign), the processor may process the image, detect the sign (if indeed present in the image), classify the image as a sign (or as a specific type of sign), and correlate the location of the image with the location of the sign as stored in the sparse map.

The sparse map may include any suitable representation of objects identified along a road segment. In some cases, the objects may be referred to as semantic objects or non-semantic objects. Semantic objects may include, for example, objects associated with a predetermined type classification. This type classification may be useful in reducing the amount of data required to describe the semantic object recognized in an environment, which can be beneficial both in the harvesting phase (e.g., to reduce costs associated with bandwidth use for transferring drive information from a plurality of harvesting vehicles to a server) and during the navigation phase (e.g., reduction of map data can speed transfer of map tiles from a server to a navigating vehicle and can also reduce costs associated with bandwidth use for such transfers). Semantic object classification types may be assigned to any type of objects or features that are expected to be encountered along a roadway.

Semantic objects may further be divided into two or more logical groups. For example, in some cases, one group of semantic object types may be associated with predetermined dimensions. Such semantic objects may include certain speed limit signs, yield signs, merge signs, stop signs, traffic lights, directional arrows on a roadway, manhole covers, or any other type of object that may be associated with a standardized size. One benefit offered by such semantic objects is that very little data may be needed to represent/fully define the objects. For example, if a standardized size of a speed limit size is known, then a harvesting vehicle may need only identify (through analysis of a captured image) the presence of a speed limit sign (a recognized type) along with an indication of a position of the detected speed limit sign (e.g., a 2D position in the captured image (or, alternatively, a 3D position in real world coordinates) of a center of the sign or a certain corner of the sign) to provide sufficient information for map generation on the server side. Where 2D image positions are transmitted to the server, a position associated with the captured image where the sign was detected may also be transmitted so the server can determine a real-world position of the sign (e.g., through structure in motion techniques using multiple captured images from one or more harvesting vehicles). Even with this limited information (requiring just a few bytes to define each detected object), the server may construct the map including a fully represented speed limit sign based on the type classification (representative of a speed limit sign) received from one or more harvesting vehicles along with the position information for the detected sign.

Semantic objects may also include other recognized object or feature types that are not associated with certain standardized characteristics. Such objects or features may include potholes, tar scams, light poles, non-standardized signs, curbs, trees, tree branches, or any other type of recognized object type with one or more variable characteristics (e.g., variable dimensions). In such cases, in addition to transmitting to a server an indication of the detected object or feature type (e.g., pothole, pole, etc.) and position information for the detected object or feature, a harvesting vehicle may also transmit an indication of a size of the object or feature. The size may be expressed in 2D image dimensions (e.g., with a bounding box or one or more dimension values) or real-world dimensions (determined through structure in motion calculations, based on LIDAR or RADAR system outputs, based on trained neural network outputs, etc.).

Non-semantic objects or features may include any detectable objects or features that fall outside of a recognized category or type, but that still may provide valuable information in map generation. In some cases, such non-semantic features may include a detected corner of a building or a corner of a detected window of a building, a unique stone or object near a roadway, a concrete splatter in a roadway shoulder, or any other detectable object or feature. Upon detecting such an object or feature one or more harvesting vehicles may transmit to a map generation server a location of one or more points (2D image points or 3D real world points) associated with the detected object/feature. Additionally, a compressed or simplified image segment (e.g., an image hash) may be generated for a region of the captured image including the detected object or feature. This image hash may be calculated based on a predetermined image processing algorithm and may form an effective signature for the detected non-semantic object or feature. Such a signature may be useful for navigation relative to a sparse map including the non-semantic feature or object, as a vehicle traversing the roadway may apply an algorithm similar to the algorithm used to generate the image hash in order to confirm/verify the presence in a captured image of the mapped non-semantic feature or object. Using this technique, non-semantic features may add to the richness of the sparse maps (e.g., to enhance their usefulness in navigation) without adding significant data overhead.

As noted, target trajectories may be stored in the sparse map. These target trajectories (e.g., 3D splines) may represent the preferred or recommended paths for each available lane of a roadway, each valid pathway through a junction, for merges and exits, etc. In addition to target trajectories, other road feature may also be detected, harvested, and incorporated in the sparse maps in the form of representative splines. Such features may include, for example, road edges, lane markings, curbs, guardrails, or any other objects or features that extend along a roadway or road segment.

### Generating a Sparse Map

In some embodiments, a sparse map may include at least one line representation of a road surface feature extending along a road segment and a plurality of landmarks associated with the road segment. In certain aspects, the sparse map may be generated via “crowdsourcing,” for example, through image analysis of a plurality of images acquired as one or more vehicles traverse the road segment.

FIG. 8 shows a sparse map 800 that one or more vehicles, e.g., vehicle 200 (which may be an autonomous vehicle), may access for providing autonomous vehicle navigation. Sparse map 800 may be stored in a memory, such as memory 140 or 150. Such memory devices may include any types of non-transitory storage devices or computer-readable media. For example, in some embodiments, memory 140 or 150 may include hard drives, compact discs, flash memory, magnetic based memory devices, optical based memory devices, etc. In some embodiments, sparse map 800 may be stored in a database (e.g., map database 160) that may be stored in memory 140 or 150, or other types of storage devices.

In some embodiments, sparse map 800 may be stored on a storage device or a non-transitory computer-readable medium provided onboard vehicle 200 (e.g., a storage device included in a navigation system onboard vehicle 200). A processor (e.g., processing unit 110) provided on vehicle 200 may access sparse map 800 stored in the storage device or computer-readable medium provided onboard vehicle 200 in order to generate navigational instructions for guiding the autonomous vehicle 200 as the vehicle traverses a road segment.

Sparse map 800 need not be stored locally with respect to a vehicle, however. In some embodiments, sparse map 800 may be stored on a storage device or computer-readable medium provided on a remote server that communicates with vehicle 200 or a device associated with vehicle 200. A processor (e.g., processing unit 110) provided on vehicle 200 may receive data included in sparse map 800 from the remote server and may execute the data for guiding the autonomous driving of vehicle 200. In such embodiments, the remote server may store all of sparse map 800 or only a portion thereof. Accordingly, the storage device or computer-readable medium provided onboard vehicle 200 and/or onboard one or more additional vehicles may store the remaining portion(s) of sparse map 800.

Furthermore, in such embodiments, sparse map 800 may be made accessible to a plurality of vehicles traversing various road segments (e.g., tens, hundreds, thousands, or millions of vehicles, etc.). It should be noted also that sparse map 800 may include multiple sub-maps. For example, in some embodiments, sparse map 800 may include hundreds, thousands, millions, or more, of sub-maps (e.g., map tiles) that may be used in navigating a vehicle. Such sub-maps may be referred to as local maps or map tiles, and a vehicle traveling along a roadway may access any number of local maps relevant to a location in which the vehicle is traveling. The local map sections of sparse map 800 may be stored with a Global Navigation Satellite System (GNSS) key as an index to the database of sparse map 800. Thus, while computation of steering angles for navigating a host vehicle in the present system may be performed without reliance upon a GNSS position of the host vehicle, road features, or landmarks, such GNSS information may be used for retrieval of relevant local maps.

In general, sparse map 800 may be generated based on data (e.g., drive information) collected from one or more vehicles as they travel along roadways. For example, using sensors aboard the one or more vehicles (e.g., cameras, speedometers, GPS, accelerometers, etc.), the trajectories that the one or more vehicles travel along a roadway may be recorded, and the polynomial representation of a preferred trajectory for vehicles making subsequent trips along the roadway may be determined based on the collected trajectories travelled by the one or more vehicles. Similarly, data collected by the one or more vehicles may aid in identifying potential landmarks along a particular roadway. Data collected from traversing vehicles may also be used to identify road profile information, such as road width profiles, road roughness profiles, traffic line spacing profiles, road conditions, etc. Using the collected information, sparse map 800 may be generated and distributed (e.g., for local storage or via on-the-fly data transmission) for use in navigating one or more autonomous vehicles. However, in some embodiments, map generation may not end upon initial generation of the map. As will be discussed in greater detail below, sparse map 800 may be continuously or periodically updated based on data collected from vehicles as those vehicles continue to traverse roadways included in sparse map 800.

Data recorded in sparse map 800 may include position information based on Global Positioning System (GPS) data. For example, location information may be included in sparse map 800 for various map elements, including, for example, landmark locations, road profile locations, etc. Locations for map elements included in sparse map 800 may be obtained using GPS data collected from vehicles traversing a roadway. For example, a vehicle passing an identified landmark may determine a location of the identified landmark using GPS position information associated with the vehicle and a determination of a location of the identified landmark relative to the vehicle (e.g., based on image analysis of data collected from one or more cameras on board the vehicle). Such location determinations of an identified landmark (or any other feature included in sparse map 800) may be repeated as additional vehicles pass the location of the identified landmark. Some or all of the additional location determinations may be used to refine the location information stored in sparse map 800 relative to the identified landmark. For example, in some embodiments, multiple position measurements relative to a particular feature stored in sparse map 800 may be averaged together. Any other mathematical operations, however, may also be used to refine a stored location of a map element based on a plurality of determined locations for the map element.

In a particular example, harvesting vehicles may traverse a particular road segment. Each harvesting vehicle captures images of their respective environments. The images may be collected at any suitable frame capture rate (e.g., 9 Hz, etc.). Image analysis processor(s) aboard each harvesting vehicle analyze the captured images to detect the presence of semantic and/or non-semantic features/objects. At a high level, the harvesting vehicles transmit to a mapping-server indications of detections of the semantic and/or non-semantic objects/features along with positions associated with those objects/features. In more detail, type indicators, dimension indicators, etc. may be transmitted together with the position information. The position information may include any suitable information for enabling the mapping server to aggregate the detected objects/features into a sparse map useful in navigation. In some cases, the position information may include one or more 2D image positions (e.g., X-Y pixel locations) in a captured image where the semantic or non-semantic features/objects were detected. Such image positions may correspond to a center of the feature/object, a corner, etc. In this scenario, to aid the mapping server in reconstructing the drive information and aligning the drive information from multiple harvesting vehicles, each harvesting vehicle may also provide the server with a location (e.g., a GPS location) where each image was captured.

In other cases, the harvesting vehicle may provide to the server one or more 3D real world points associated with the detected objects/features. Such 3D points may be relative to a predetermined origin (such as an origin of a drive segment) and may be determined through any suitable technique. In some cases, a structure in motion technique may be used to determine the 3D real world position of a detected object/feature. For example, a certain object such as a particular speed limit sign may be detected in two or more captured images. Using information such as the known ego motion (speed, trajectory, GPS position, etc.) of the harvesting vehicle between the captured images, along with observed changes of the speed limit sign in the captured images (change in X-Y pixel location, change in size, etc.), the real-world position of one or more points associated with the speed limit sign may be determined and passed along to the mapping server. Such an approach is optional, as it requires more computation on the part of the harvesting vehicle systems. The sparse map of the disclosed embodiments may enable autonomous navigation of a vehicle using relatively small amounts of stored data. In some embodiments, sparse map 800 may have a data density (e.g., including data representing the target trajectories, landmarks, and any other stored road features) of less than 2 MB per kilometer of roads, less than 1 MB per kilometer of roads, less than 500 KB per kilometer of roads, or less than 100 KB per kilometer of roads. In some embodiments, the data density of sparse map 800 may be less than 10 KB per kilometer of roads or even less than 2 kB per kilometer of roads (e.g., 1.6 kB per kilometer), or no more than 10 kB per kilometer of roads, or no more than 20 kB per kilometer of roads. In some embodiments, most, if not all, of the roadways of the United States may be navigated autonomously using a sparse map having a total of 4 GB or less of data. These data density values may represent an average over an entire sparse map 800, over a local map within sparse map 800, and/or over a particular road segment within sparse map 800.

As noted, sparse map 800 may include representations of a plurality of target trajectories 810 for guiding autonomous driving or navigation along a road segment. Such target trajectories may be stored as three-dimensional splines. The target trajectories stored in sparse map 800 may be determined based on two or more reconstructed trajectories of prior traversals of vehicles along a particular road segment, for example. A road segment may be associated with a single target trajectory or multiple target trajectories. For example, on a two lane road, a first target trajectory may be stored to represent an intended path of travel along the road in a first direction, and a second target trajectory may be stored to represent an intended path of travel along the road in another direction (e.g., opposite to the first direction). Additional target trajectories may be stored with respect to a particular road segment. For example, on a multi-lane road one or more target trajectories may be stored representing intended paths of travel for vehicles in one or more lanes associated with the multi-lane road. In some embodiments, each lane of a multi-lane road may be associated with its own target trajectory. In other embodiments, there may be fewer target trajectories stored than lanes present on a multi-lane road. In such cases, a vehicle navigating the multi-lane road may use any of the stored target trajectories to guides its navigation by taking into account an amount of lane offset from a lane for which a target trajectory is stored (e.g., if a vehicle is traveling in the left most lane of a three lane highway, and a target trajectory is stored only for the middle lane of the highway, the vehicle may navigate using the target trajectory of the middle lane by accounting for the amount of lane offset between the middle lane and the left-most lane when generating navigational instructions).

In some embodiments, the target trajectory may represent an ideal path that a vehicle should take as the vehicle travels. The target trajectory may be located, for example, at an approximate center of a lane of travel. In other cases, the target trajectory may be located elsewhere relative to a road segment. For example, a target trajectory may approximately coincide with a center of a road, an edge of a road, or an edge of a lane, etc. In such cases, navigation based on the target trajectory may include a determined amount of offset to be maintained relative to the location of the target trajectory. Moreover, in some embodiments, the determined amount of offset to be maintained relative to the location of the target trajectory may differ based on a type of vehicle (e.g., a passenger vehicle including two axles may have a different offset from a truck including more than two axles along at least a portion of the target trajectory).

Sparse map 800 may also include data relating to a plurality of predetermined landmarks 820 associated with particular road segments, local maps, etc. As discussed in greater detail below, these landmarks may be used in navigation of the autonomous vehicle. For example, in some embodiments, the landmarks may be used to determine a current position of the vehicle relative to a stored target trajectory. With this position information, the autonomous vehicle may be able to adjust a heading direction to match a direction of the target trajectory at the determined location.

The plurality of landmarks 820 may be identified and stored in sparse map 800 at any suitable spacing. In some embodiments, landmarks may be stored at relatively high densities (e.g., every few meters or more). In some embodiments, however, significantly larger landmark spacing values may be employed. For example, in sparse map 800, identified (or recognized) landmarks may be spaced apart by 10 meters, 20 meters, 50 meters, 100 meters, 1 kilometer, or 2 kilometers. In some cases, the identified landmarks may be located at distances of even more than 2 kilometers apart.

Between landmarks, and therefore between determinations of vehicle position relative to a target trajectory, the vehicle may navigate based on dead reckoning in which the vehicle uses sensors to determine its ego motion and estimate its position relative to the target trajectory. Because errors may accumulate during navigation by dead reckoning, over time the position determinations relative to the target trajectory may become increasingly less accurate. The vehicle may use landmarks occurring in sparse map 800 (and their known locations) to remove the dead reckoning-induced errors in position determination. In this way, the identified landmarks included in sparse map 800 may serve as navigational anchors from which an accurate position of the vehicle relative to a target trajectory may be determined. Because a certain amount of error may be acceptable in position location, an identified landmark need not always be available to an autonomous vehicle. Rather, suitable navigation may be possible even based on landmark spacings, as noted above, of 10 meters, 20 meters, 50 meters, 100 meters, 500 meters, 1 kilometer, 2 kilometers, or more. In some embodiments, a density of 1 identified landmark every 1 km of road may be sufficient to maintain a longitudinal position determination accuracy within 1 m. Thus, not every potential landmark appearing along a road segment need be stored in sparse map 800.

Moreover, in some embodiments, lane markings may be used for localization of the vehicle during landmark spacings. By using lane markings during landmark spacings, the accumulation of errors during navigation by dead reckoning may be minimized.

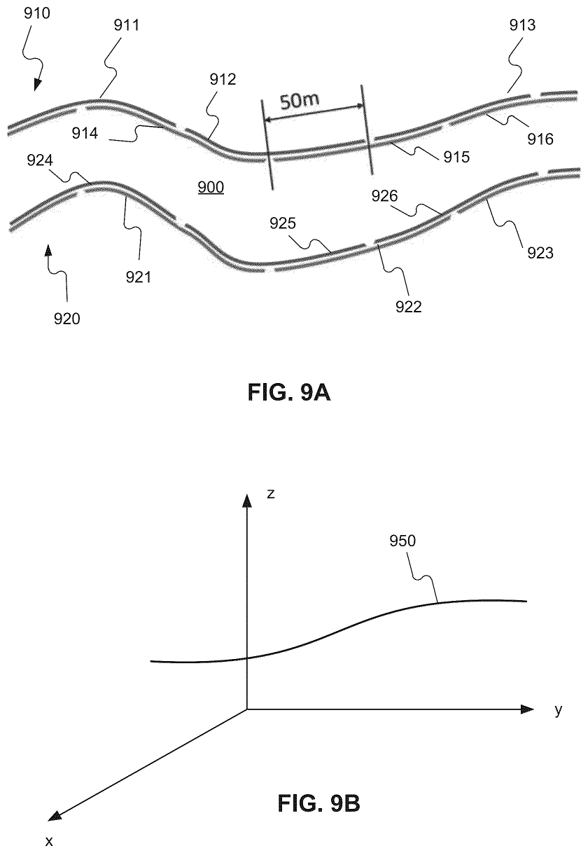

In addition to target trajectories and identified landmarks, sparse map 800 may include information relating to various other road features. For example, FIG. 9A illustrates a representation of curves along a particular road segment that may be stored in sparse map 800. In some embodiments, a single lane of a road may be modeled by a three-dimensional polynomial description of left and right sides of the road. Such polynomials representing left and right sides of a single lane are shown in FIG. 9A. Regardless of how many lanes a road may have, the road may be represented using polynomials in a way similar to that illustrated in FIG. 9A. For example, left and right sides of a multi-lane road may be represented by polynomials similar to those shown in FIG. 9A, and intermediate lane markings included on a multi-lane road (e.g., dashed markings representing lane boundaries, solid yellow lines representing boundaries between lanes traveling in different directions, etc.) may also be represented using polynomials such as those shown in FIG. 9A.

As shown in FIG. 9A, a lane 900 may be represented using polynomials (e.g., a first order, second order, third order, or any suitable order polynomials). For illustration, lane 900 is shown as a two-dimensional lane and the polynomials are shown as two-dimensional polynomials. As depicted in FIG. 9A, lane 900 includes a left side 910 and a right side 920. In some embodiments, more than one polynomial may be used to represent a location of each side of the road or lane boundary. For example, each of left side 910 and right side 920 may be represented by a plurality of polynomials of any suitable length. In some cases, the polynomials may have a length of about 100 m, although other lengths greater than or less than 100 m may also be used. Additionally, the polynomials can overlap with one another in order to facilitate seamless transitions in navigating based on subsequently encountered polynomials as a host vehicle travels along a roadway. For example, each of left side 910 and right side 920 may be represented by a plurality of third order polynomials separated into segments of about 100 meters in length (an example of the first predetermined range), and overlapping each other by about 50 meters. The polynomials representing the left side 910 and the right side 920 may or may not have the same order. For example, in some embodiments, some polynomials may be second order polynomials, some may be third order polynomials, and some may be fourth order polynomials.

In the example shown in FIG. 9A, left side 910 of lane 900 is represented by two groups of third order polynomials. The first group includes polynomial segments 911, 912, and 913. The second group includes polynomial segments 914, 915, and 916. The two groups, while substantially parallel to each other, follow the locations of their respective sides of the road. Polynomial segments 911, 912, 913, 914, 915, and 916 have a length of about 100 meters and overlap adjacent segments in the series by about 50 meters. As noted previously, however, polynomials of different lengths and different overlap amounts may also be used. For example, the polynomials may have lengths of 500 m, 1 km, or more, and the overlap amount may vary from 0 to 50 m, 50 m to 100 m, or greater than 100 m. Additionally, while FIG. 9A is shown as representing polynomials extending in 2D space (e.g., on the surface of the paper), it is to be understood that these polynomials may represent curves extending in three dimensions (e.g., including a height component) to represent elevation changes in a road segment in addition to X-Y curvature. In the example shown in FIG. 9A, right side 920 of lane 900 is further represented by a first group having polynomial segments 921, 922, and 923 and a second group having polynomial segments 924, 925, and 926.

Returning to the target trajectories of sparse map 800, FIG. 9B shows a three-dimensional polynomial representing a target trajectory for a vehicle traveling along a particular road segment. The target trajectory represents not only the X-Y path that a host vehicle should travel along a particular road segment, but also the elevation change that the host vehicle will experience when traveling along the road segment. Thus, each target trajectory in sparse map 800 may be represented by one or more three-dimensional polynomials, like the three-dimensional polynomial 950 shown in FIG. 9B. Sparse map 800 may include a plurality of trajectories (e.g., millions or billions or more to represent trajectories of vehicles along various road segments along roadways throughout the world). In some embodiments, each target trajectory may correspond to a spline connecting three-dimensional polynomial segments.

Regarding the data footprint of polynomial curves stored in sparse map 800, in some embodiments, each third degree polynomial may be represented by four parameters, each requiring four bytes of data. Suitable representations may be obtained with third degree polynomials requiring about 192 bytes of data for every 100 m. This may translate to approximately 200 kB per hour in data usage/transfer requirements for a host vehicle traveling approximately 100 km/hr.

Sparse map 800 may describe the lanes network using a combination of geometry descriptors and meta-data. The geometry may be described by polynomials or splines as described above. The meta-data may describe the number of lanes, special characteristics (such as a car pool lane), and possibly other sparse labels. The total footprint of such indicators may be negligible.

Accordingly, a sparse map according to embodiments of the present disclosure may include at least one line representation of a road surface feature extending along the road segment, each line representation representing a path along the road segment substantially corresponding with the road surface feature. In some embodiments, as discussed above, the at least one line representation of the road surface feature may include a spline, a polynomial representation, or a curve. Furthermore, in some embodiments, the road surface feature may include at least one of a road edge or a lane marking. Moreover, as discussed below with respect to “crowdsourcing,” the road surface feature may be identified through image analysis of a plurality of images acquired as one or more vehicles traverse the road segment.

As previously noted, sparse map 800 may include a plurality of predetermined landmarks associated with a road segment. Rather than storing actual images of the landmarks and relying, for example, on image recognition analysis based on captured images and stored images, each landmark in sparse map 800 may be represented and recognized using less data than a stored, actual image would require. Data representing landmarks may still include sufficient information for describing or identifying the landmarks along a road. Storing data describing characteristics of landmarks, rather than the actual images of landmarks, may reduce the size of sparse map 800.

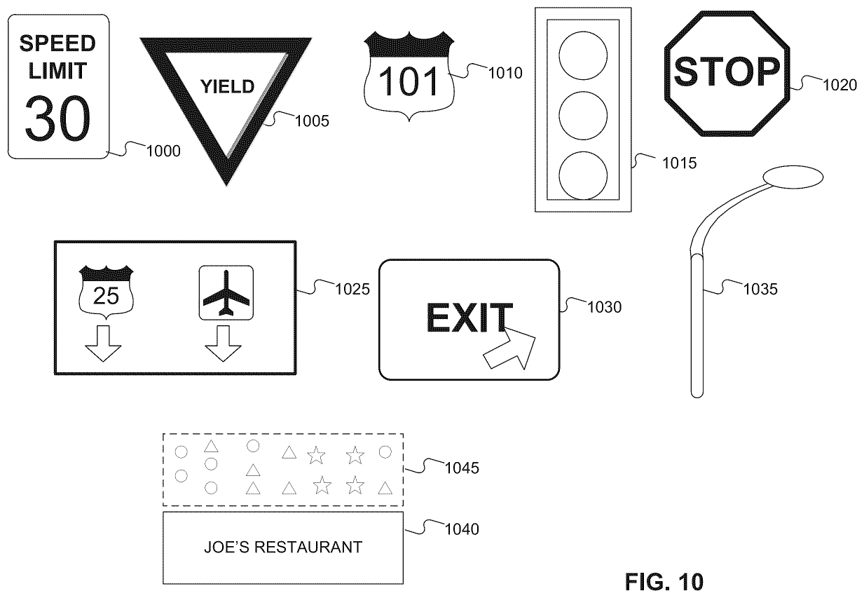

FIG. 10 illustrates examples of types of landmarks that may be represented in sparse map 800. The landmarks may include any visible and identifiable objects along a road segment. The landmarks may be selected such that they are fixed and do not change often with respect to their locations and/or content. The landmarks included in sparse map 800 may be useful in determining a location of vehicle 200 with respect to a target trajectory as the vehicle traverses a particular road segment. Examples of landmarks may include traffic signs, directional signs, general signs (e.g., rectangular signs), roadside fixtures (e.g., lampposts, reflectors, etc.), and any other suitable category. In some embodiments, lane marks on the road, may also be included as landmarks in sparse map 800.

Examples of landmarks shown in FIG. 10 include traffic signs, directional signs, roadside fixtures, and general signs. Traffic signs may include, for example, speed limit signs (e.g., speed limit sign 1000), yield signs (e.g., yield sign 1005), route number signs (e.g., route number sign 1010), traffic light signs (e.g., traffic light sign 1015), stop signs (e.g., stop sign 1020). Directional signs may include a sign that includes one or more arrows indicating one or more directions to different places. For example, directional signs may include a highway sign 1025 having arrows for directing vehicles to different roads or places, an exit sign 1030 having an arrow directing vehicles off a road, etc. Accordingly, at least one of the plurality of landmarks may include a road sign.

General signs may be unrelated to traffic. For example, general signs may include billboards used for advertisement, or a welcome board adjacent a border between two countries, states, counties, cities, or towns. FIG. 10 shows a general sign 1040 (“Joe's Restaurant”). Although general sign 1040 may have a rectangular shape, as shown in FIG. 10, general sign 1040 may have other shapes, such as square, circle, triangle, etc.

Landmarks may also include roadside fixtures. Roadside fixtures may be objects that are not signs, and may not be related to traffic or directions. For example, roadside fixtures may include lampposts (e.g., lamppost 1035), power line posts, traffic light posts, etc.

Landmarks may also include beacons that may be specifically designed for usage in an autonomous vehicle navigation system. For example, such beacons may include stand-alone structures placed at predetermined intervals to aid in navigating a host vehicle. Such beacons may also include visual/graphical information added to existing road signs (e.g., icons, emblems, bar codes, etc.) that may be identified or recognized by a vehicle traveling along a road segment. Such beacons may also include electronic components. In such embodiments, electronic beacons (e.g., RFID tags, etc.) may be used to transmit non-visual information to a host vehicle. Such information may include, for example, landmark identification and/or landmark location information that a host vehicle may use in determining its position along a target trajectory.

In some embodiments, the landmarks included in sparse map 800 may be represented by a data object of a predetermined size. The data representing a landmark may include any suitable parameters for identifying a particular landmark. For example, in some embodiments, landmarks stored in sparse map 800 may include parameters such as a physical size of the landmark (e.g., to support estimation of distance to the landmark based on a known size/scale), a distance to a previous landmark, lateral offset, height, a type code (e.g., a landmark type-what type of directional sign, traffic sign, etc.), a GPS coordinate (e.g., to support global localization), and any other suitable parameters. Each parameter may be associated with a data size. For example, a landmark size may be stored using 8 bytes of data. A distance to a previous landmark, a lateral offset, and height may be specified using 12 bytes of data. A type code associated with a landmark such as a directional sign or a traffic sign may require about 2 bytes of data. For general signs, an image signature enabling identification of the general sign may be stored using 50 bytes of data storage. The landmark GPS position may be associated with 16 bytes of data storage. These data sizes for each parameter are examples only, and other data sizes may also be used. Representing landmarks in sparse map 800 in this manner may offer a lean solution for efficiently representing landmarks in the database. In some embodiments, objects may be referred to as standard semantic objects or non-standard semantic objects. A standard semantic object may include any class of object for which there's a standardized set of characteristics (e.g., speed limit signs, warning signs, directional signs, traffic lights, etc. having known dimensions or other characteristics). A non-standard semantic object may include any object that is not associated with a standardized set of characteristics (e.g., general advertising signs, signs identifying business establishments, potholes, trees, etc. that may have variable dimensions). Each non-standard semantic object may be represented with 38 bytes of data (e.g., 8 bytes for size; 12 bytes for distance to previous landmark, lateral offset, and height; 2 bytes for a type code; and 16 bytes for position coordinates). Standard semantic objects may be represented using even less data, as size information may not be needed by the mapping server to fully represent the object in the sparse map.

Sparse map 800 may use a tag system to represent landmark types. In some cases, each traffic sign or directional sign may be associated with its own tag, which may be stored in the database as part of the landmark identification. For example, the database may include on the order of 1000 different tags to represent various traffic signs and on the order of about 10000 different tags to represent directional signs. Of course, any suitable number of tags may be used, and additional tags may be created as needed. General purpose signs may be represented in some embodiments using less than about 100 bytes (e.g., about 86 bytes including 8 bytes for size; 12 bytes for distance to previous landmark, lateral offset, and height; 50 bytes for an image signature; and 16 bytes for GPS coordinates).

Thus, for semantic road signs not requiring an image signature, the data density impact to sparse map 800, even at relatively high landmark densities of about 1 per 50 m, may be on the order of about 760 bytes per kilometer (e.g., 20 landmarks per km×38 bytes per landmark=760 bytes). Even for general purpose signs including an image signature component, the data density impact is about 1.72 KB per km (e.g., 20 landmarks per km×86 bytes per landmark=1,720 bytes). For semantic road signs, this equates to about 76 kB per hour of data usage for a vehicle traveling 100 km/hr. For general purpose signs, this equates to about 170 kB per hour for a vehicle traveling 100 km/hr. It should be noted that in some environments (e.g., urban environments) there may be a much higher density of detected objects available for inclusion in the sparse map (perhaps more than one per meter). In some embodiments, a generally rectangular object, such as a rectangular sign, may be represented in sparse map 800 by no more than 100 bytes of data. The representation of the generally rectangular object (e.g., general sign 1040) in sparse map 800 may include a condensed image signature or image hash (e.g., condensed image signature 1045) associated with the generally rectangular object. This condensed image signature/image hash may be determined using any suitable image hashing algorithm and may be used, for example, to aid in identification of a general purpose sign, for example, as a recognized landmark. Such a condensed image signature (e.g., image information derived from actual image data representing an object) may avoid a need for storage of an actual image of an object or a need for comparative image analysis performed on actual images in order to recognize landmarks.

Referring to FIG. 10, sparse map 800 may include or store a condensed image signature 1045 associated with a general sign 1040, rather than an actual image of general sign 1040. For example, after an image capture device (e.g., image capture device 122, 124, or 126) captures an image of general sign 1040, a processor (e.g., image processor 190 or any other processor that can process images either aboard or remotely located relative to a host vehicle) may perform an image analysis to extract/create condensed image signature 1045 that includes a unique signature or pattern associated with general sign 1040. In one embodiment, condensed image signature 1045 may include a shape, color pattern, a brightness pattern, or any other feature that may be extracted from the image of general sign 1040 for describing general sign 1040.

For example, in FIG. 10, the circles, triangles, and stars shown in condensed image signature 1045 may represent areas of different colors. The pattern represented by the circles, triangles, and stars may be stored in sparse map 800, e.g., within the 50 bytes designated to include an image signature. Notably, the circles, triangles, and stars are not necessarily meant to indicate that such shapes are stored as part of the image signature. Rather, these shapes are meant to conceptually represent recognizable areas having discernible color differences, textual areas, graphical shapes, or other variations in characteristics that may be associated with a general purpose sign. Such condensed image signatures can be used to identify a landmark in the form of a general sign. For example, the condensed image signature can be used to perform a same-not-same analysis based on a comparison of a stored condensed image signature with image data captured, for example, using a camera onboard an autonomous vehicle.

Accordingly, the plurality of landmarks may be identified through image analysis of the plurality of images acquired as one or more vehicles traverse the road segment. As explained below with respect to “crowdsourcing,” in some embodiments, the image analysis to identify the plurality of landmarks may include accepting potential landmarks when a ratio of images in which the landmark does appear to images in which the landmark does not appear exceeds a threshold. Furthermore, in some embodiments, the image analysis to identify the plurality of landmarks may include rejecting potential landmarks when a ratio of images in which the landmark does not appear to images in which the landmark does appear exceeds a threshold.

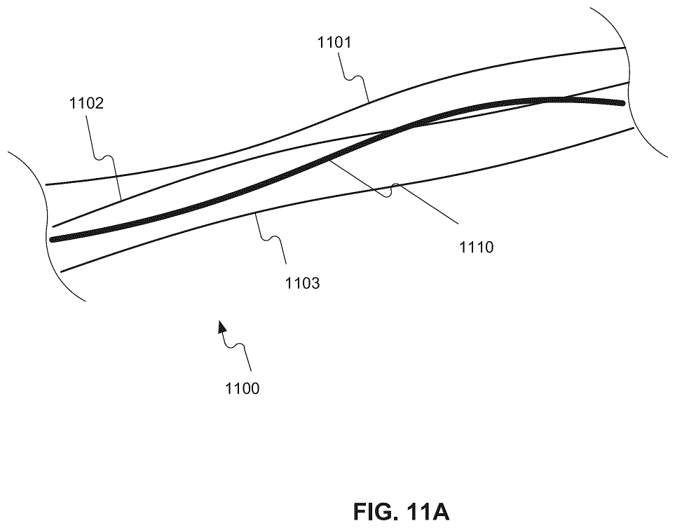

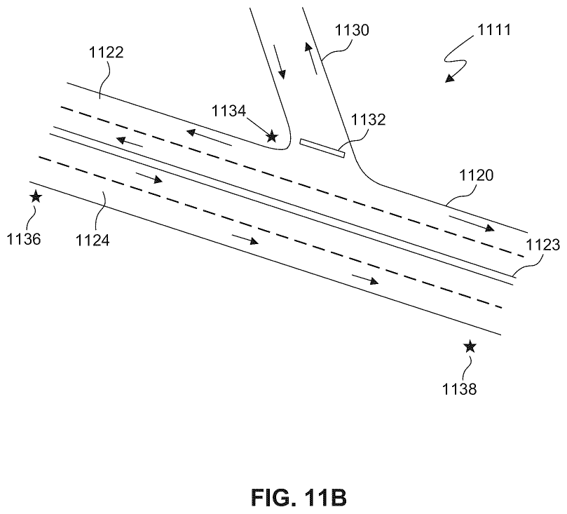

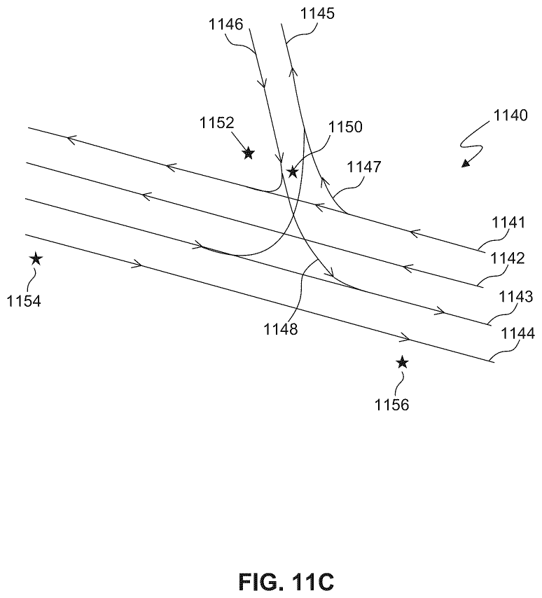

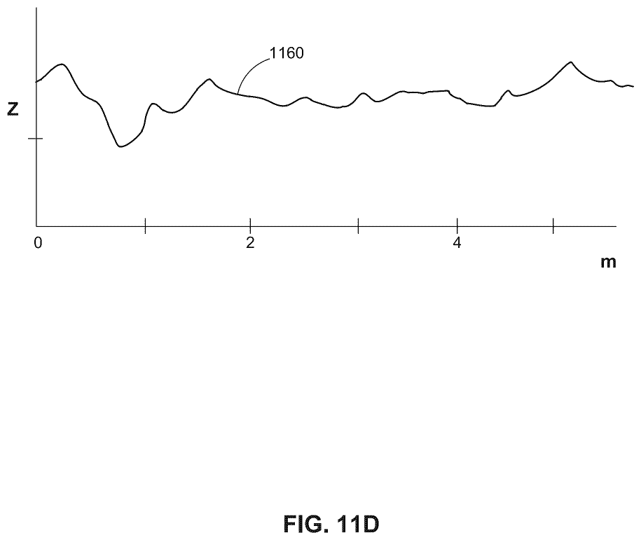

Returning to the target trajectories a host vehicle may use to navigate a particular road segment, FIG. 11A shows polynomial representations trajectories capturing during a process of building or maintaining sparse map 800. A polynomial representation of a target trajectory included in sparse map 800 may be determined based on two or more reconstructed trajectories of prior traversals of vehicles along the same road segment. In some embodiments, the polynomial representation of the target trajectory included in sparse map 800 may be an aggregation of two or more reconstructed trajectories of prior traversals of vehicles along the same road segment. In some embodiments, the polynomial representation of the target trajectory included in sparse map 800 may be an average of the two or more reconstructed trajectories of prior traversals of vehicles along the same road segment. Other mathematical operations may also be used to construct a target trajectory along a road path based on reconstructed trajectories collected from vehicles traversing along a road segment.

As shown in FIG. 11A, a road segment 1100 may be travelled by a number of vehicles 200 at different times. Each vehicle 200 may collect data relating to a path that the vehicle took along the road segment. The path traveled by a particular vehicle may be determined based on camera data, accelerometer information, speed sensor information, and/or GPS information, among other potential sources. Such data may be used to reconstruct trajectories of vehicles traveling along the road segment, and based on these reconstructed trajectories, a target trajectory (or multiple target trajectories) may be determined for the particular road segment. Such target trajectories may represent a preferred path of a host vehicle (e.g., guided by an autonomous navigation system) as the vehicle travels along the road segment.

In the example shown in FIG. 11A, a first reconstructed trajectory 1101 may be determined based on data received from a first vehicle traversing road segment 1100 at a first time period (e.g., day 1), a second reconstructed trajectory 1102 may be obtained from a second vehicle traversing road segment 1100 at a second time period (e.g., day 2), and a third reconstructed trajectory 1103 may be obtained from a third vehicle traversing road segment 1100 at a third time period (e.g., day 3). Each trajectory 1101, 1102, and 1103 may be represented by a polynomial, such as a three-dimensional polynomial. It should be noted that in some embodiments, any of the reconstructed trajectories may be assembled onboard the vehicles traversing road segment 1100.

Additionally, or alternatively, such reconstructed trajectories may be determined on a server side based on information received from vehicles traversing road segment 1100. For example, in some embodiments, vehicles 200 may transmit data to one or more servers relating to their motion along road segment 1100 (e.g., steering angle, heading, time, position, speed, sensed road geometry, and/or sensed landmarks, among things). The server may reconstruct trajectories for vehicles 200 based on the received data. The server may also generate a target trajectory for guiding navigation of autonomous vehicle that will travel along the same road segment 1100 at a later time based on the first, second, and third trajectories 1101, 1102, and 1103. While a target trajectory may be associated with a single prior traversal of a road segment, in some embodiments, each target trajectory included in sparse map 800 may be determined based on two or more reconstructed trajectories of vehicles traversing the same road segment. In FIG. 11A, the target trajectory is represented by 1110. In some embodiments, the target trajectory 1110 may be generated based on an average of the first, second, and third trajectories 1101, 1102, and 1103. In some embodiments, the target trajectory 1110 included in sparse map 800 may be an aggregation (e.g., a weighted combination) of two or more reconstructed trajectories.

At the mapping server, the server may receive actual trajectories for a particular road segment from multiple harvesting vehicles traversing the road segment. To generate a target trajectory for each valid path along the road segment (e.g., each lane, each drive direction, each path through a junction, etc.), the received actual trajectories may be aligned. The alignment process may include using detected objects/features identified along the road segment along with harvested positions of those detected objects/features to correlate the actual, harvested trajectories with one another. Once aligned, an average or “best fit” target trajectory for each available lane, etc. may be determined based on the aggregated, correlated/aligned actual trajectories.

FIGS. 11B and 11C further illustrate the concept of target trajectories associated with road segments present within a geographic region 1111. As shown in FIG. 11B, a first road segment 1120 within geographic region 1111 may include a multilane road, which includes two lanes 1122 designated for vehicle travel in a first direction and two additional lanes 1124 designated for vehicle travel in a second direction opposite to the first direction. Lanes 1122 and lanes 1124 may be separated by a double yellow line 1123. Geographic region 1111 may also include a branching road segment 1130 that intersects with road segment 1120. Road segment 1130 may include a two-lane road, each lane being designated for a different direction of travel. Geographic region 1111 may also include other road features, such as a stop line 1132, a stop sign 1134, a speed limit sign 1136, and a hazard sign 1138.

As shown in FIG. 11C, sparse map 800 may include a local map 1140 including a road model for assisting with autonomous navigation of vehicles within geographic region 1111. For example, local map 1140 may include target trajectories for one or more lanes associated with road segments 1120 and/or 1130 within geographic region 1111. For example, local map 1140 may include target trajectories 1141 and/or 1142 that an autonomous vehicle may access or rely upon when traversing lanes 1122. Similarly, local map 1140 may include target trajectories 1143 and/or 1144 that an autonomous vehicle may access or rely upon when traversing lanes 1124. Further, local map 1140 may include target trajectories 1145 and/or 1146 that an autonomous vehicle may access or rely upon when traversing road segment 1130. Target trajectory 1147 represents a preferred path an autonomous vehicle should follow when transitioning from lanes 1120 (and specifically, relative to target trajectory 1141 associated with a right-most lane of lanes 1120) to road segment 1130 (and specifically, relative to a target trajectory 1145 associated with a first side of road segment 1130. Similarly, target trajectory 1148 represents a preferred path an autonomous vehicle should follow when transitioning from road segment 1130 (and specifically, relative to target trajectory 1146) to a portion of road segment 1124 (and specifically, as shown, relative to a target trajectory 1143 associated with a left lane of lanes 1124.

Sparse map 800 may also include representations of other road-related features associated with geographic region 1111. For example, sparse map 800 may also include representations of one or more landmarks identified in geographic region 1111. Such landmarks may include a first landmark 1150 associated with stop line 1132, a second landmark 1152 associated with stop sign 1134, a third landmark associated with speed limit sign 1154, and a fourth landmark 1156 associated with hazard sign 1138. Such landmarks may be used, for example, to assist an autonomous vehicle in determining its current location relative to any of the shown target trajectories, such that the vehicle may adjust its heading to match a direction of the target trajectory at the determined location.

In some embodiments, sparse map 800 may also include road signature profiles. Such road signature profiles may be associated with any discernible/measurable variation in at least one parameter associated with a road. For example, in some cases, such profiles may be associated with variations in road surface information such as variations in surface roughness of a particular road segment, variations in road width over a particular road segment, variations in distances between dashed lines painted along a particular road segment, variations in road curvature along a particular road segment, etc. FIG. 11D shows an example of a road signature profile 1160. While profile 1160 may represent any of the parameters mentioned above, or others, in one example, profile 1160 may represent a measure of road surface roughness, as obtained, for example, by monitoring one or more sensors providing outputs indicative of an amount of suspension displacement as a vehicle travels a particular road segment.

Alternatively or concurrently, profile 1160 may represent variation in road width, as determined based on image data obtained via a camera onboard a vehicle traveling a particular road segment. Such profiles may be useful, for example, in determining a particular location of an autonomous vehicle relative to a particular target trajectory. That is, as it traverses a road segment, an autonomous vehicle may measure a profile associated with one or more parameters associated with the road segment. If the measured profile can be correlated/matched with a predetermined profile that plots the parameter variation with respect to position along the road segment, then the measured and predetermined profiles may be used (e.g., by overlaying corresponding sections of the measured and predetermined profiles) in order to determine a current position along the road segment and, therefore, a current position relative to a target trajectory for the road segment.

In some embodiments, sparse map 800 may include different trajectories based on different characteristics associated with a user of autonomous vehicles, environmental conditions, and/or other parameters relating to driving. For example, in some embodiments, different trajectories may be generated based on different user preferences and/or profiles. Sparse map 800 including such different trajectories may be provided to different autonomous vehicles of different users. For example, some users may prefer to avoid toll roads, while others may prefer to take the shortest or fastest routes, regardless of whether there is a toll road on the route. The disclosed systems may generate different sparse maps with different trajectories based on such different user preferences or profiles. As another example, some users may prefer to travel in a fast moving lane, while others may prefer to maintain a position in the central lane at all times.

Different trajectories may be generated and included in sparse map 800 based on different environmental conditions, such as day and night, snow, rain, fog, etc. Autonomous vehicles driving under different environmental conditions may be provided with sparse map 800 generated based on such different environmental conditions. In some embodiments, cameras provided on autonomous vehicles may detect the environmental conditions, and may provide such information back to a server that generates and provides sparse maps. For example, the server may generate or update an already generated sparse map 800 to include trajectories that may be more suitable or safer for autonomous driving under the detected environmental conditions. The update of sparse map 800 based on environmental conditions may be performed dynamically as the autonomous vehicles are traveling along roads.

Other different parameters relating to driving may also be used as a basis for generating and providing different sparse maps to different autonomous vehicles. For example, when an autonomous vehicle is traveling at a high speed, turns may be tighter. Trajectories associated with specific lanes, rather than roads, may be included in sparse map 800 such that the autonomous vehicle may maintain within a specific lane as the vehicle follows a specific trajectory. When an image captured by a camera onboard the autonomous vehicle indicates that the vehicle has drifted outside of the lane (e.g., crossed the lane mark), an action may be triggered within the vehicle to bring the vehicle back to the designated lane according to the specific trajectory.

### Crowdsourcing a Sparse Map

The disclosed sparse maps may be efficiently (and passively) generated through the power of crowdsourcing. For example, any private or commercial vehicle equipped with a camera (e.g., a simple, low resolution camera regularly included as OEM equipment on today's vehicles) and an appropriate image analysis processor can serve as a harvesting vehicle. No special equipment (e.g., high definition imaging and/or positioning systems) are required. As a result of the disclosed crowdsourcing technique, the generated sparse maps may be extremely accurate and may include extremely refined position information (enabling navigation error limits of 10 cm or less) without requiring any specialized imaging or sensing equipment as input to the map generation process. Crowdsourcing also enables much more rapid (and inexpensive) updates to the generated maps, as new drive information is continuously available to the mapping server system from any roads traversed by private or commercial vehicles minimally equipped to also serve as harvesting vehicles. There is no need for designated vehicles equipped with high-definition imaging and mapping sensors. Therefore, the expense associated with building such specialized vehicles can be avoided. Further, updates to the presently disclosed sparse maps may be made much more rapidly than systems that rely upon dedicated, specialized mapping vehicles (which by virtue of their expense and special equipment are typically limited to a fleet of specialized vehicles of far lower numbers than the number of private or commercial vehicles already available for performing the disclosed harvesting techniques).

The disclosed sparse maps generated through crowdsourcing may be extremely accurate because they may be generated based on many inputs from multiple (10s, hundreds, millions, etc.) of harvesting vehicles that have collected drive information along a particular road segment. For example, every harvesting vehicle that drives along a particular road segment may record its actual trajectory and may determine position information relative to detected objects/features along the road segment. This information is passed along from multiple harvesting vehicles to a server. The actual trajectories are aggregated to generate a refined, target trajectory for each valid drive path along the road segment. Additionally, the position information collected from the multiple harvesting vehicles for each of the detected objects/features along the road segment (semantic or non-semantic) can also be aggregated. As a result, the mapped position of each detected object/feature may constitute an average of hundreds, thousands, or millions of individually determined positions for each detected object/feature. Such a technique may yield extremely accurate mapped positions for the detected objects/features.

In some embodiments, the disclosed systems and methods may generate a sparse map for autonomous vehicle navigation. For example, disclosed systems and methods may use crowdsourced data for generation of a sparse map that one or more autonomous vehicles may use to navigate along a system of roads. As used herein, “crowdsourcing” means that data are received from various vehicles (e.g., autonomous vehicles) travelling on a road segment at different times, and such data are used to generate and/or update the road model, including sparse map tiles. The model or any of its sparse map tiles may, in turn, be transmitted to the vehicles or other vehicles later travelling along the road segment for assisting autonomous vehicle navigation. The road model may include a plurality of target trajectories representing preferred trajectories that autonomous vehicles should follow as they traverse a road segment. The target trajectories may be the same as a reconstructed actual trajectory collected from a vehicle traversing a road segment, which may be transmitted from the vehicle to a server. In some embodiments, the target trajectories may be different from actual trajectories that one or more vehicles previously took when traversing a road segment. The target trajectories may be generated based on actual trajectories (e.g., through averaging or any other suitable operation).

The vehicle trajectory data that a vehicle may upload to a server may correspond with the actual reconstructed trajectory for the vehicle or may correspond to a recommended trajectory, which may be based on or related to the actual reconstructed trajectory of the vehicle, but may differ from the actual reconstructed trajectory. For example, vehicles may modify their actual, reconstructed trajectories and submit (e.g., recommend) to the server the modified actual trajectories. The road model may use the recommended, modified trajectories as target trajectories for autonomous navigation of other vehicles.

In addition to trajectory information, other information for potential use in building a sparse data map 800 may include information relating to potential landmark candidates. For example, through crowd sourcing of information, the disclosed systems and methods may identify potential landmarks in an environment and refine landmark positions. The landmarks may be used by a navigation system of autonomous vehicles to determine and/or adjust the position of the vehicle along the target trajectories.

The reconstructed trajectories that a vehicle may generate as the vehicle travels along a road may be obtained by any suitable method. In some embodiments, the reconstructed trajectories may be developed by stitching together segments of motion for the vehicle, using, e.g., ego motion estimation (e.g., three dimensional translation and three dimensional rotation of the camera, and hence the body of the vehicle). The rotation and translation estimation may be determined based on analysis of images captured by one or more image capture devices along with information from other sensors or devices, such as inertial sensors and speed sensors. For example, the inertial sensors may include an accelerometer or other suitable sensors configured to measure changes in translation and/or rotation of the vehicle body. The vehicle may include a speed sensor that measures a speed of the vehicle.

In some embodiments, the ego motion of the camera (and hence the vehicle body) may be estimated based on an optical flow analysis of the captured images. An optical flow analysis of a sequence of images identifies movement of pixels from the sequence of images, and based on the identified movement, determines motions of the vehicle. The ego motion may be integrated over time and along the road segment to reconstruct a trajectory associated with the road segment that the vehicle has followed.

Data (e.g., reconstructed trajectories) collected by multiple vehicles in multiple drives along a road segment at different times may be used to construct the road model (e.g., including the target trajectories, etc.) included in sparse data map 800. Data collected by multiple vehicles in multiple drives along a road segment at different times may also be averaged to increase an accuracy of the model. In some embodiments, data regarding the road geometry and/or landmarks may be received from multiple vehicles that travel through the common road segment at different times. Such data received from different vehicles may be combined to generate the road model and/or to update the road model.

The geometry of a reconstructed trajectory (and also a target trajectory) along a road segment may be represented by a curve in three dimensional space, which may be a spline connecting three dimensional polynomials. The reconstructed trajectory curve may be determined from analysis of a video stream or a plurality of images captured by a camera installed on the vehicle. In some embodiments, a location is identified in each frame or image that is a few meters ahead of the current position of the vehicle. This location is where the vehicle is expected to travel to in a predetermined time period. This operation may be repeated frame by frame, and at the same time, the vehicle may compute the camera's ego motion (rotation and translation). At each frame or image, a short range model for the desired path is generated by the vehicle in a reference frame that is attached to the camera. The short range models may be stitched together to obtain a three dimensional model of the road in some coordinate frame, which may be an arbitrary or predetermined coordinate frame. The three dimensional model of the road may then be fitted by a spline, which may include or connect one or more polynomials of suitable orders.

To conclude the short range road model at each frame, one or more detection modules may be used. For example, a bottom-up lane detection module may be used. The bottom-up lane detection module may be useful when lane marks are drawn on the road. This module may look for edges in the image and assembles them together to form the lane marks. A second module may be used together with the bottom-up lane detection module. The second module is an end-to-end deep neural network, which may be trained to predict the correct short range path from an input image. In both modules, the road model may be detected in the image coordinate frame and transformed to a three dimensional space that may be virtually attached to the camera.

Although the reconstructed trajectory modeling method may introduce an accumulation of errors due to the integration of ego motion over a long period of time, which may include a noise component, such errors may be inconsequential as the generated model may provide sufficient accuracy for navigation over a local scale. In addition, it is possible to cancel the integrated error by using external sources of information, such as satellite images or geodetic measurements. For example, the disclosed systems and methods may use a GNSS receiver to cancel accumulated errors. However, the GNSS positioning signals may not be always available and accurate. The disclosed systems and methods may enable a steering application that depends weakly on the availability and accuracy of GNSS positioning. In such systems, the usage of the GNSS signals may be limited. For example, in some embodiments, the disclosed systems may use the GNSS signals for database indexing purposes only.

In some embodiments, the range scale (e.g., local scale) that may be relevant for an autonomous vehicle navigation steering application may be on the order of 50 meters, 100 meters, 200 meters, 300 meters, etc. Such distances may be used, as the geometrical road model is mainly used for two purposes: planning the trajectory ahead and localizing the vehicle on the road model. In some embodiments, the planning task may use the model over a typical range of 40 meters ahead (or any other suitable distance ahead, such as 20 meters, 30 meters, 50 meters), when the control algorithm steers the vehicle according to a target point located 1.3 seconds ahead (or any other time such as 1.5 seconds, 1.7 seconds, 2 seconds, etc.). The localization task uses the road model over a typical range of 60 meters behind the car (or any other suitable distances, such as 50 meters, 100 meters, 150 meters, etc.), according to a method called “tail alignment” described in more detail in another section. The disclosed systems and methods may generate a geometrical model that has sufficient accuracy over particular range, such as 100 meters, such that a planned trajectory will not deviate by more than, for example, 30 cm from the lane center.

As explained above, a three dimensional road model may be constructed from detecting short range sections and stitching them together. The stitching may be enabled by computing a six degree ego motion model, using the videos and/or images captured by the camera, data from the inertial sensors that reflect the motions of the vehicle, and the host vehicle velocity signal. The accumulated error may be small enough over some local range scale, such as of the order of 100 meters. All this may be completed in a single drive over a particular road segment.

In some embodiments, multiple drives may be used to average the resulted model, and to increase its accuracy further. The same car may travel the same route multiple times, or multiple cars may send their collected model data to a central server. In any case, a matching procedure may be performed to identify overlapping models and to enable averaging in order to generate target trajectories. The constructed model (e.g., including the target trajectories) may be used for steering once a convergence criterion is met. Subsequent drives may be used for further model improvements and in order to accommodate infrastructure changes.

Sharing of driving experience (such as sensed data) between multiple cars becomes feasible if they are connected to a central server. Each vehicle client may store a partial copy of a universal road model, which may be relevant for its current position. A bidirectional update procedure between the vehicles and the server may be performed by the vehicles and the server. The small footprint concept discussed above enables the disclosed systems and methods to perform the bidirectional updates using a very small bandwidth.

Information relating to potential landmarks may also be determined and forwarded to a central server. For example, the disclosed systems and methods may determine one or more physical properties of a potential landmark based on one or more images that include the landmark. The physical properties may include a physical size (e.g., height, width) of the landmark, a distance from a vehicle to a landmark, a distance between the landmark to a previous landmark, the lateral position of the landmark (e.g., the position of the landmark relative to the lane of travel), the GPS coordinates of the landmark, a type of landmark, identification of text on the landmark, etc. For example, a vehicle may analyze one or more images captured by a camera to detect a potential landmark, such as a speed limit sign.

The vehicle may determine a distance from the vehicle to the landmark or a position associated with the landmark (e.g., any semantic or non-semantic object or feature along a road segment) based on the analysis of the one or more images. In some embodiments, the distance may be determined based on analysis of images of the landmark using a suitable image analysis method, such as a scaling method and/or an optical flow method. As previously noted, a position of the object/feature may include a 2D image position (e.g., an X-Y pixel position in one or more captured images) of one or more points associated with the object/feature or may include a 3D real-world position of one or more points (e.g., determined through structure in motion/optical flow techniques, LIDAR or RADAR information, etc.). In some embodiments, the disclosed systems and methods may be configured to determine a type or classification of a potential landmark. In case the vehicle determines that a certain potential landmark corresponds to a predetermined type or classification stored in a sparse map, it may be sufficient for the vehicle to communicate to the server an indication of the type or classification of the landmark, along with its location. The server may store such indications. At a later time, during navigation, a navigating vehicle may capture an image that includes a representation of the landmark, process the image (e.g., using a classifier), and compare the result landmark in order to confirm detection of the mapped landmark and to use the mapped landmark in localizing the navigating vehicle relative to the sparse map.

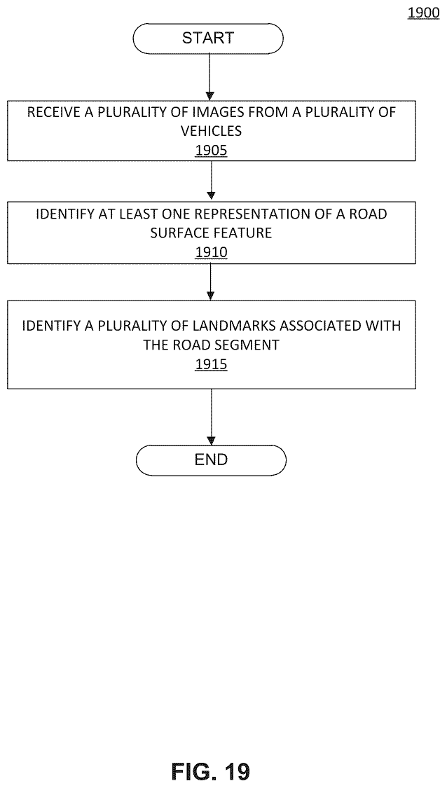

In some embodiments, multiple autonomous vehicles travelling on a road segment may communicate with a server. The vehicles (or clients) may generate a curve describing its drive (e.g., through ego motion integration) in an arbitrary coordinate frame. The vehicles may detect landmarks and locate them in the same frame. The vehicles may upload the curve and the landmarks to the server. The server may collect data from vehicles over multiple drives, and generate a unified road model. For example, as discussed below with respect to FIG. 19, the server may generate a sparse map having the unified road model using the uploaded curves and landmarks.

The server may also distribute the model to clients (e.g., vehicles). For example, the server may distribute the sparse map to one or more vehicles. The server may continuously or periodically update the model when receiving new data from the vehicles. For example, the server may process the new data to evaluate whether the data includes information that should trigger an updated, or creation of new data on the server. The server may distribute the updated model or the updates to the vehicles for providing autonomous vehicle navigation.

The server may use one or more criteria for determining whether new data received from the vehicles should trigger an update to the model or trigger creation of new data. For example, when the new data indicates that a previously recognized landmark at a specific location no longer exists, or is replaced by another landmark, the server may determine that the new data should trigger an update to the model. As another example, when the new data indicates that a road segment has been closed, and when this has been corroborated by data received from other vehicles, the server may determine that the new data should trigger an update to the model.

The server may distribute the updated model (or the updated portion of the model) to one or more vehicles that are traveling on the road segment, with which the updates to the model are associated. The server may also distribute the updated model to vehicles that are about to travel on the road segment, or vehicles whose planned trip includes the road segment, with which the updates to the model are associated. For example, while an autonomous vehicle is traveling along another road segment before reaching the road segment with which an update is associated, the server may distribute the updates or updated model to the autonomous vehicle before the vehicle reaches the road segment.

In some embodiments, the remote server may collect trajectories and landmarks from multiple clients (e.g., vehicles that travel along a common road segment). The server may match curves using landmarks and create an average road model based on the trajectories collected from the multiple vehicles. The server may also compute a graph of roads and the most probable path at each node or conjunction of the road segment. For example, the remote server may align the trajectories to generate a crowdsourced sparse map from the collected trajectories.

The server may average landmark properties received from multiple vehicles that travelled along the common road segment, such as the distances between one landmark to another (e.g., a previous one along the road segment) as measured by multiple vehicles, to determine an arc-length parameter and support localization along the path and speed calibration for each client vehicle. The server may average the physical dimensions of a landmark measured by multiple vehicles travelled along the common road segment and recognized the same landmark. The averaged physical dimensions may be used to support distance estimation, such as the distance from the vehicle to the landmark. The server may average lateral positions of a landmark (e.g., position from the lane in which vehicles are travelling in to the landmark) measured by multiple vehicles travelled along the common road segment and recognized the same landmark. The averaged lateral portion may be used to support lane assignment. The server may average the GPS coordinates of the landmark measured by multiple vehicles travelled along the same road segment and recognized the same landmark. The averaged GPS coordinates of the landmark may be used to support global localization or positioning of the landmark in the road model.

In some embodiments, the server may identify model changes, such as constructions, detours, new signs, removal of signs, etc., based on data received from the vehicles. The server may continuously or periodically or instantaneously update the model upon receiving new data from the vehicles. The server may distribute updates to the model or the updated model to vehicles for providing autonomous navigation. For example, as discussed further below, the server may use crowdsourced data to filter out “ghost” landmarks detected by vehicles.

In some embodiments, the server may analyze driver interventions during the autonomous driving. The server may analyze data received from the vehicle at the time and location where intervention occurs, and/or data received prior to the time the intervention occurred. The server may identify certain portions of the data that caused or are closely related to the intervention, for example, data indicating a temporary lane closure setup, data indicating a pedestrian in the road. The server may update the model based on the identified data. For example, the server may modify one or more trajectories stored in the model.

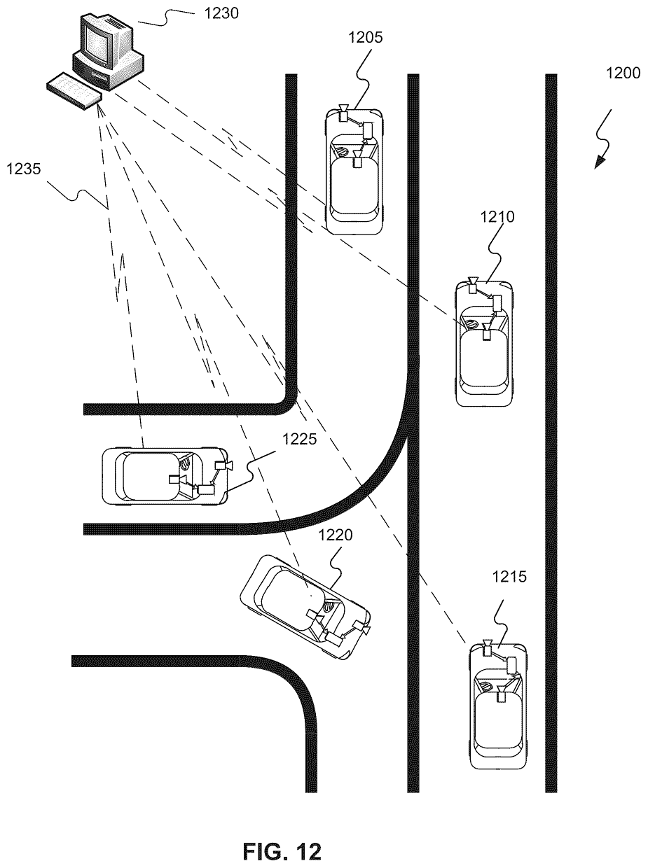

FIG. 12 is a schematic illustration of a system that uses crowdsourcing to generate a sparse map (as well as distribute and navigate using a crowdsourced sparse map). FIG. 12 shows a road segment 1200 that includes one or more lanes. A plurality of vehicles 1205, 1210, 1215, 1220, and 1225 may travel on road segment 1200 at the same time or at different times (although shown as appearing on road segment 1200 at the same time in FIG. 12). At least one of vehicles 1205, 1210, 1215, 1220, and 1225 may be an autonomous vehicle. For simplicity of the present example, all of the vehicles 1205, 1210, 1215, 1220, and 1225 are presumed to be autonomous vehicles.

Each vehicle may be similar to vehicles disclosed in other embodiments (e.g., vehicle 200), and may include components or devices included in or associated with vehicles disclosed in other embodiments. Each vehicle may be equipped with an image capture device or camera (e.g., image capture device 122 or camera 122). Each vehicle may communicate with a remote server 1230 via one or more networks (e.g., over a cellular network and/or the Internet, etc.) through wireless communication paths 1235, as indicated by the dashed lines. Each vehicle may transmit data to server 1230 and receive data from server 1230. For example, server 1230 may collect data from multiple vehicles travelling on the road segment 1200 at different times, and may process the collected data to generate an autonomous vehicle road navigation model, or an update to the model. Server 1230 may transmit the autonomous vehicle road navigation model or the update to the model to the vehicles that transmitted data to server 1230. Server 1230 may transmit the autonomous vehicle road navigation model or the update to the model to other vehicles that travel on road segment 1200 at later times.

As vehicles 1205, 1210, 1215, 1220, and 1225 travel on road segment 1200, navigation information collected (e.g., detected, sensed, or measured) by vehicles 1205, 1210, 1215, 1220, and 1225 may be transmitted to server 1230. In some embodiments, the navigation information may be associated with the common road segment 1200. The navigation information may include a trajectory associated with each of the vehicles 1205, 1210, 1215, 1220, and 1225 as each vehicle travels over road segment 1200. In some embodiments, the trajectory may be reconstructed based on data sensed by various sensors and devices provided on vehicle 1205. For example, the trajectory may be reconstructed based on at least one of accelerometer data, speed data, landmarks data, road geometry or profile data, vehicle positioning data, and ego motion data. In some embodiments, the trajectory may be reconstructed based on data from inertial sensors, such as accelerometer, and the velocity of vehicle 1205 sensed by a speed sensor. In addition, in some embodiments, the trajectory may be determined (e.g., by a processor onboard each of vehicles 1205, 1210, 1215, 1220, and 1225) based on sensed ego motion of the camera, which may indicate three dimensional translation and/or three dimensional rotations (or rotational motions). The ego motion of the camera (and hence the vehicle body) may be determined from analysis of one or more images captured by the camera.

In some embodiments, the trajectory of vehicle 1205 may be determined by a processor provided aboard vehicle 1205 and transmitted to server 1230. In other embodiments, server 1230 may receive data sensed by the various sensors and devices provided in vehicle 1205, and determine the trajectory based on the data received from vehicle 1205.

In some embodiments, the navigation information transmitted from vehicles 1205, 1210, 1215, 1220, and 1225 to server 1230 may include data regarding the road surface, the road geometry, or the road profile. The geometry of road segment 1200 may include lane structure and/or landmarks. The lane structure may include the total number of lanes of road segment 1200, the type of lanes (e.g., one-way lane, two-way lane, driving lane, passing lane, etc.), markings on lanes, width of lanes, etc. In some embodiments, the navigation information may include a lane assignment, e.g., which lane of a plurality of lanes a vehicle is traveling in. For example, the lane assignment may be associated with a numerical value “3” indicating that the vehicle is traveling on the third lane from the left or right. As another example, the lane assignment may be associated with a text value “center lane” indicating the vehicle is traveling on the center lane.

Server 1230 may store the navigation information on a non-transitory computer-readable medium, such as a hard drive, a compact disc, a tape, a memory, etc. Server 1230 may generate (e.g., through a processor included in server 1230) at least a portion of an autonomous vehicle road navigation model for the common road segment 1200 based on the navigation information received from the plurality of vehicles 1205, 1210, 1215, 1220, and 1225 and may store the model as a portion of a sparse map. Server 1230 may determine a trajectory associated with each lane based on crowdsourced data (e.g., navigation information) received from multiple vehicles (e.g., 1205, 1210, 1215, 1220, and 1225) that travel on a lane of road segment at different times. Server 1230 may generate the autonomous vehicle road navigation model or a portion of the model (e.g., an updated portion) based on a plurality of trajectories determined based on the crowd sourced navigation data. Server 1230 may transmit the model or the updated portion of the model to one or more of autonomous vehicles 1205, 1210, 1215, 1220, and 1225 traveling on road segment 1200 or any other autonomous vehicles that travel on road segment at a later time for updating an existing autonomous vehicle road navigation model provided in a navigation system of the vehicles. The autonomous vehicle road navigation model may be used by the autonomous vehicles in autonomously navigating along the common road segment 1200.

As explained above, the autonomous vehicle road navigation model may be included in a sparse map (e.g., sparse map 800 depicted in FIG. 8). Sparse map 800 may include sparse recording of data related to road geometry and/or landmarks along a road, which may provide sufficient information for guiding autonomous navigation of an autonomous vehicle, yet does not require excessive data storage. In some embodiments, the autonomous vehicle road navigation model may be stored separately from sparse map 800, and may use map data from sparse map 800 when the model is executed for navigation. In some embodiments, the autonomous vehicle road navigation model may use map data included in sparse map 800 for determining target trajectories along road segment 1200 for guiding autonomous navigation of autonomous vehicles 1205, 1210, 1215, 1220, and 1225 or other vehicles that later travel along road segment 1200. For example, when the autonomous vehicle road navigation model is executed by a processor included in a navigation system of vehicle 1205, the model may cause the processor to compare the trajectories determined based on the navigation information received from vehicle 1205 with predetermined trajectories included in sparse map 800 to validate and/or correct the current traveling course of vehicle 1205.

In the autonomous vehicle road navigation model, the geometry of a road feature or target trajectory may be encoded by a curve in a three-dimensional space. In one embodiment, the curve may be a three dimensional spline including one or more connecting three dimensional polynomials. As one of skill in the art would understand, a spline may be a numerical function that is piece-wise defined by a series of polynomials for fitting data. A spline for fitting the three dimensional geometry data of the road may include a linear spline (first order), a quadratic spline (second order), a cubic spline (third order), or any other splines (other orders), or a combination thereof. The spline may include one or more three dimensional polynomials of different orders connecting (e.g., fitting) data points of the three dimensional geometry data of the road. In some embodiments, the autonomous vehicle road navigation model may include a three dimensional spline corresponding to a target trajectory along a common road segment (e.g., road segment 1200) or a lane of the road segment 1200.

As explained above, the autonomous vehicle road navigation model included in the sparse map may include other information, such as identification of at least one landmark along road segment 1200. The landmark may be visible within a field of view of a camera (e.g., camera 122) installed on each of vehicles 1205, 1210, 1215, 1220, and 1225. In some embodiments, camera 122 may capture an image of a landmark. A processor (e.g., processor 180, 190, or processing unit 110) provided on vehicle 1205 may process the image of the landmark to extract identification information for the landmark. The landmark identification information, rather than an actual image of the landmark, may be stored in sparse map 800. The landmark identification information may require much less storage space than an actual image. Other sensors or systems (e.g., GPS system) may also provide certain identification information of the landmark (e.g., position of landmark). The landmark may include at least one of a traffic sign, an arrow marking, a lane marking, a dashed lane marking, a traffic light, a stop line, a directional sign (e.g., a highway exit sign with an arrow indicating a direction, a highway sign with arrows pointing to different directions or places), a landmark beacon, or a lamppost. A landmark beacon refers to a device (e.g., an RFID device) installed along a road segment that transmits or reflects a signal to a receiver installed on a vehicle, such that when the vehicle passes by the device, the beacon received by the vehicle and the location of the device (e.g., determined from GPS location of the device) may be used as a landmark to be included in the autonomous vehicle road navigation model and/or the sparse map 800.

The identification of at least one landmark may include a position of the at least one landmark. The position of the landmark may be determined based on position measurements performed using sensor systems (e.g., Global Positioning Systems, inertial based positioning systems, landmark beacon, etc.) associated with the plurality of vehicles 1205, 1210, 1215, 1220, and 1225. In some embodiments, the position of the landmark may be determined by averaging the position measurements detected, collected, or received by sensor systems on different vehicles 1205, 1210, 1215, 1220, and 1225 through multiple drives. For example, vehicles 1205, 1210, 1215, 1220, and 1225 may transmit position measurements data to server 1230, which may average the position measurements and use the averaged position measurement as the position of the landmark. The position of the landmark may be continuously refined by measurements received from vehicles in subsequent drives.

The identification of the landmark may include a size of the landmark. The processor provided on a vehicle (e.g., 1205) may estimate the physical size of the landmark based on the analysis of the images. Server 1230 may receive multiple estimates of the physical size of the same landmark from different vehicles over different drives. Server 1230 may average the different estimates to arrive at a physical size for the landmark, and store that landmark size in the road model. The physical size estimate may be used to further determine or estimate a distance from the vehicle to the landmark. The distance to the landmark may be estimated based on the current speed of the vehicle and a scale of expansion based on the position of the landmark appearing in the images relative to the focus of expansion of the camera. For example, the distance to landmark may be estimated by Z=V*dt*R/D, where V is the speed of vehicle, R is the distance in the image from the landmark at time t1 to the focus of expansion, and D is the change in distance for the landmark in the image from t1 to t2. dt represents the (t2−t1). For example, the distance to landmark may be estimated by Z=V*dt*R/D, where V is the speed of vehicle, R is the distance in the image between the landmark and the focus of expansion, dt is a time interval, and D is the image displacement of the landmark along the epipolar line. Other equations equivalent to the above equation, such as Z=V*ω/Δω, may be used for estimating the distance to the landmark. Here, V is the vehicle speed, ω is an image length (like the object width), and Δω is the change of that image length in a unit of time.

When the physical size of the landmark is known, the distance to the landmark may also be determined based on the following equation: Z=f*W/ω, where f is the focal length, W is the size of the landmark (e.g., height or width), ω is the number of pixels when the landmark leaves the image. From the above equation, a change in distance Z may be calculated using ΔZ=f*W*Δω/ω2+f*ΔW/ω, where ΔW decays to zero by averaging, and where Δω is the number of pixels representing a bounding box accuracy in the image. A value estimating the physical size of the landmark may be calculated by averaging multiple observations at the server side. The resulting error in distance estimation may be very small. There are two sources of error that may occur when using the formula above, namely ΔW and Δω. Their contribution to the distance error is given by ΔZ=f*W*Δω/ω2+f*ΔW/ω. However, ΔW decays to zero by averaging; hence ΔZ is determined by Δω (e.g., the inaccuracy of the bounding box in the image).

For landmarks of unknown dimensions, the distance to the landmark may be estimated by tracking feature points on the landmark between successive frames. For example, certain features appearing on a speed limit sign may be tracked between two or more image frames. Based on these tracked features, a distance distribution per feature point may be generated. The distance estimate may be extracted from the distance distribution. For example, the most frequent distance appearing in the distance distribution may be used as the distance estimate. As another example, the average of the distance distribution may be used as the distance estimate.

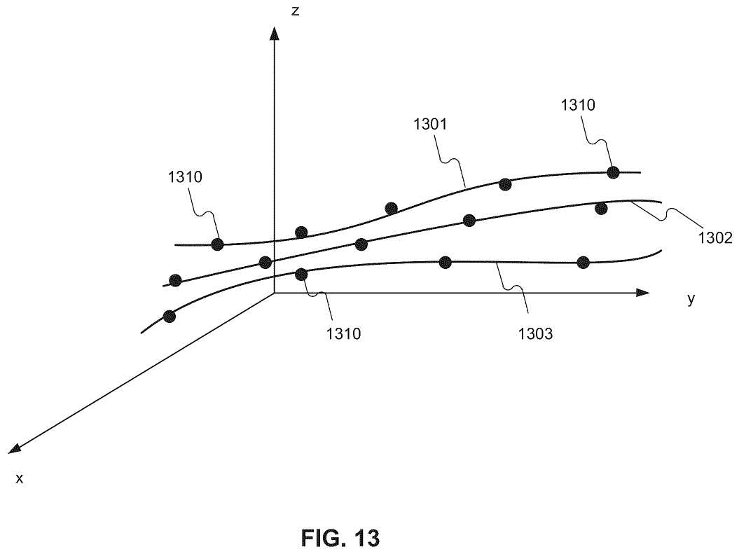

FIG. 13 illustrates an example autonomous vehicle road navigation model represented by a plurality of three dimensional splines 1301, 1302, and 1303. The curves 1301, 1302, and 1303 shown in FIG. 13 are for illustration purpose only. Each spline may include one or more three dimensional polynomials connecting a plurality of data points 1310. Each polynomial may be a first order polynomial, a second order polynomial, a third order polynomial, or a combination of any suitable polynomials having different orders. Each data point 1310 may be associated with the navigation information received from vehicles 1205, 1210, 1215, 1220, and 1225. In some embodiments, each data point 1310 may be associated with data related to landmarks (e.g., size, location, and identification information of landmarks) and/or road signature profiles (e.g., road geometry, road roughness profile, road curvature profile, road width profile). In some embodiments, some data points 1310 may be associated with data related to landmarks, and others may be associated with data related to road signature profiles.

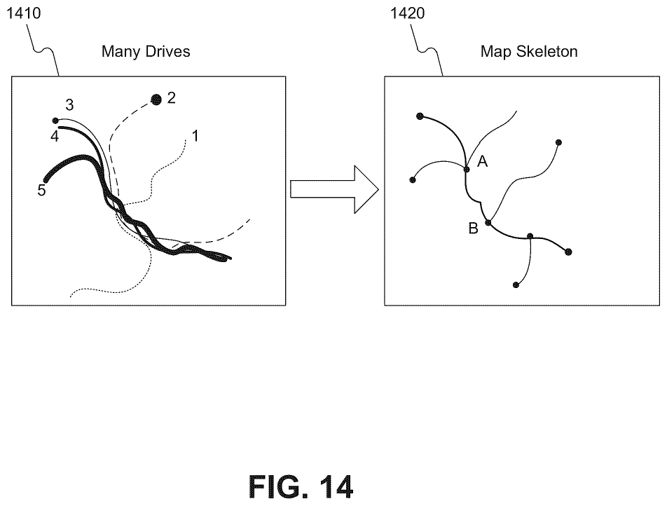

FIG. 14 illustrates raw location data 1410 (e.g., GPS data) received from five separate drives. One drive may be separate from another drive if it was traversed by separate vehicles at the same time, by the same vehicle at separate times, or by separate vehicles at separate times. To account for errors in the location data 1410 and for differing locations of vehicles within the same lane (e.g., one vehicle may drive closer to the left of a lane than another), server 1230 may generate a map skeleton 1420 using one or more statistical techniques to determine whether variations in the raw location data 1410 represent actual divergences or statistical errors. Each path within skeleton 1420 may be linked back to the raw data 1410 that formed the path. For example, the path between A and B within skeleton 1420 is linked to raw data 1410 from drives 2, 3, 4, and 5 but not from drive 1. Skeleton 1420 may not be detailed enough to be used to navigate a vehicle (e.g., because it combines drives from multiple lanes on the same road unlike the splines described above) but may provide useful topological information and may be used to define intersections.

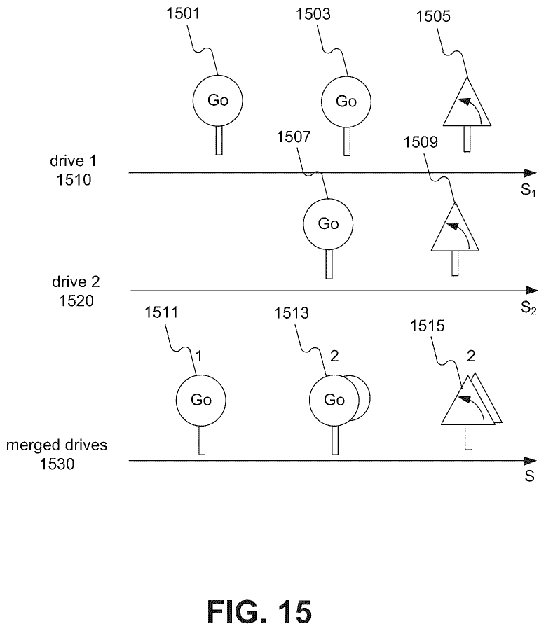

FIG. 15 illustrates an example by which additional detail may be generated for a sparse map within a segment of a map skeleton (e.g., segment A to B within skeleton 1420). As depicted in FIG. 15, the data (e.g., ego-motion data, road markings data, and the like) may be shown as a function of position S (or S1 or S2) along the drive. Server 1230 may identify landmarks for the sparse map by identifying unique matches between landmarks 1501, 1503, and 1505 of drive 1510 and landmarks 1507 and 1509 of drive 1520. Such a matching algorithm may result in identification of landmarks 1511, 1513, and 1515. One skilled in the art would recognize, however, that other matching algorithms may be used. For example, probability optimization may be used in lieu of or in combination with unique matching. Server 1230 may longitudinally align the drives to align the matched landmarks. For example, server 1230 may select one drive (e.g., drive 1520) as a reference drive and then shift and/or elastically stretch the other drive(s) (e.g., drive 1510) for alignment.

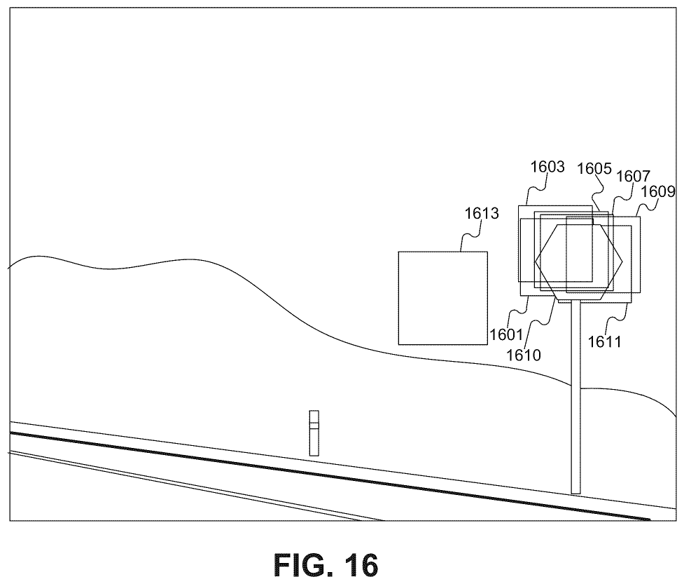

FIG. 16 shows an example of aligned landmark data for use in a sparse map. In the example of FIG. 16, landmark 1610 comprises a road sign. The example of FIG. 16 further depicts data from a plurality of drives 1601, 1603, 1605, 1607, 1609, 1611, and 1613. In the example of FIG. 16, the data from drive 1613 consists of a “ghost” landmark, and the server 1230 may identify it as such because none of drives 1601, 1603, 1605, 1607, 1609, and 1611 include an identification of a landmark in the vicinity of the identified landmark in drive 1613. Accordingly, server 1230 may accept potential landmarks when a ratio of images in which the landmark does appear to images in which the landmark does not appear exceeds a threshold and/or may reject potential landmarks when a ratio of images in which the landmark does not appear to images in which the landmark does appear exceeds a threshold.

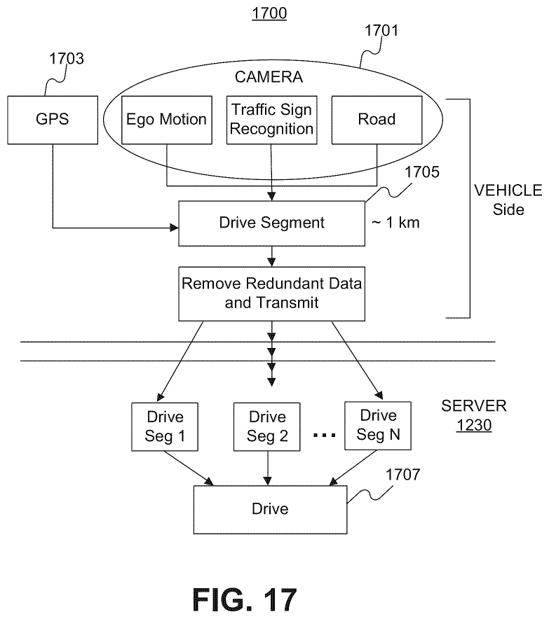

FIG. 17 depicts a system 1700 for generating drive data, which may be used to crowdsource a sparse map. As depicted in FIG. 17, system 1700 may include a camera 1701 and a locating device 1703 (e.g., a GPS locator). Camera 1701 and locating device 1703 may be mounted on a vehicle (e.g., one of vehicles 1205, 1210, 1215, 1220, and 1225). Camera 1701 may produce a plurality of data of multiple types, e.g., ego motion data, traffic sign data, road data, or the like. The camera data and location data may be segmented into drive segments 1705. For example, drive segments 1705 may each have camera data and location data from less than 1 km of driving.

In some embodiments, system 1700 may remove redundancies in drive segments 1705. For example, if a landmark appears in multiple images from camera 1701, system 1700 may strip the redundant data such that the drive segments 1705 only contain one copy of the location of and any metadata relating to the landmark. By way of further example, if a lane marking appears in multiple images from camera 1701, system 1700 may strip the redundant data such that the drive segments 1705 only contain one copy of the location of and any metadata relating to the lane marking.

System 1700 also includes a server (e.g., server 1230). Server 1230 may receive drive segments 1705 from the vehicle and recombine the drive segments 1705 into a single drive 1707. Such an arrangement may allow for reduced bandwidth requirements when transferring data between the vehicle and the server while also allowing for the server to store data relating to an entire drive.

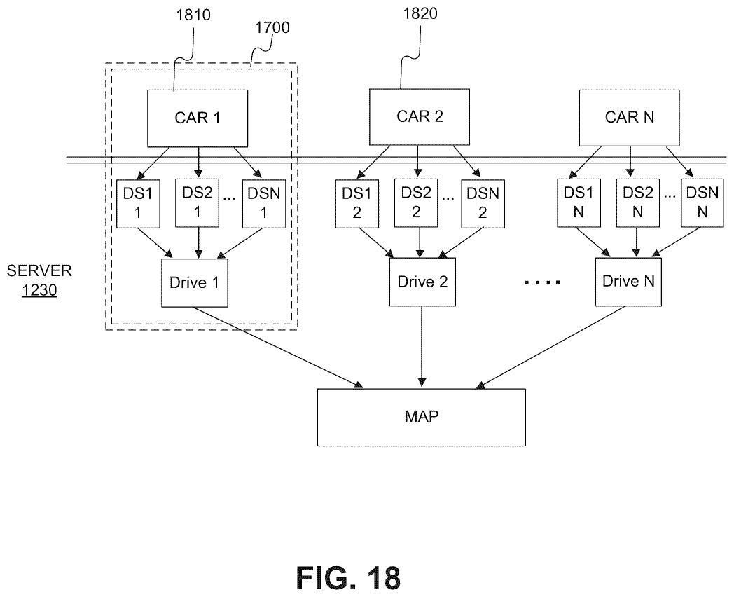

FIG. 18 depicts system 1700 of FIG. 17 further configured for crowdsourcing a sparse map. As in FIG. 17, system 1700 includes vehicle 1810, which captures drive data using, for example, a camera (which produces, e.g., ego motion data, traffic sign data, road data, or the like) and a locating device (e.g., a GPS locator). As in FIG. 17, vehicle 1810 segments the collected data into drive segments (depicted as “DS1 1,” “DS2 1,” “DSN 1” in FIG. 18). Server 1230 then receives the drive segments and reconstructs a drive (depicted as “Drive 1” in FIG. 18) from the received segments.

As further depicted in FIG. 18, system 1700 also receives data from additional vehicles. For example, vehicle 1820 also captures drive data using, for example, a camera (which produces, e.g., ego motion data, traffic sign data, road data, or the like) and a locating device (e.g., a GPS locator). Similar to vehicle 1810, vehicle 1820 segments the collected data into drive segments (depicted as “DS1 2,” “DS2 2,” “DSN 2” in FIG. 18). Server 1230 then receives the drive segments and reconstructs a drive (depicted as “Drive 2” in FIG. 18) from the received segments. Any number of additional vehicles may be used. For example, FIG. 18 also includes “CAR N” that captures drive data, segments it into drive segments (depicted as “DS1 N,” “DS2 N,” “DSN N” in FIG. 18), and sends it to server 1230 for reconstruction into a drive (depicted as “Drive N” in FIG. 18).

As depicted in FIG. 18, server 1230 may construct a sparse map (depicted as “MAP”) using the reconstructed drives (e.g., “Drive 1,” “Drive 2,” and “Drive N”) collected from a plurality of vehicles (e.g., “CAR 1” (also labeled vehicle 1810), “CAR 2” (also labeled vehicle 1820), and “CAR N”).

FIG. 19 is a flowchart showing an example process 1900 for generating a sparse map for autonomous vehicle navigation along a road segment. Process 1900 may be performed by one or more processing devices included in server 1230.

Process 1900 may include receiving a plurality of images acquired as one or more vehicles traverse the road segment (step 1905). Server 1230 may receive images from cameras included within one or more of vehicles 1205, 1210, 1215, 1220, and 1225. For example, camera 122 may capture one or more images of the environment surrounding vehicle 1205 as vehicle 1205 travels along road segment 1200. In some embodiments, server 1230 may also receive stripped down image data that has had redundancies removed by a processor on vehicle 1205, as discussed above with respect to FIG. 17.

Process 1900 may further include identifying, based on the plurality of images, at least one line representation of a road surface feature extending along the road segment (step 1910). Each line representation may represent a path along the road segment substantially corresponding with the road surface feature. For example, server 1230 may analyze the environmental images received from camera 122 to identify a road edge or a lane marking and determine a trajectory of travel along road segment 1200 associated with the road edge or lane marking. In some embodiments, the trajectory (or line representation) may include a spline, a polynomial representation, or a curve. Server 1230 may determine the trajectory of travel of vehicle 1205 based on camera ego motions (e.g., three dimensional translation and/or three dimensional rotational motions) received at step 1905.

Process 1900 may also include identifying, based on the plurality of images, a plurality of landmarks associated with the road segment (step 1910). For example, server 1230 may analyze the environmental images received from camera 122 to identify one or more landmarks, such as road sign along road segment 1200. Server 1230 may identify the landmarks using analysis of the plurality of images acquired as one or more vehicles traverse the road segment. To enable crowdsourcing, the analysis may include rules regarding accepting and rejecting possible landmarks associated with the road segment. For example, the analysis may include accepting potential landmarks when a ratio of images in which the landmark does appear to images in which the landmark does not appear exceeds a threshold and/or rejecting potential landmarks when a ratio of images in which the landmark does not appear to images in which the landmark does appear exceeds a threshold.

Process 1900 may include other operations or steps performed by server 1230. For example, the navigation information may include a target trajectory for vehicles to travel along a road segment, and process 1900 may include clustering, by server 1230, vehicle trajectories related to multiple vehicles travelling on the road segment and determining the target trajectory based on the clustered vehicle trajectories, as discussed in further detail below. Clustering vehicle trajectories may include clustering, by server 1230, the multiple trajectories related to the vehicles travelling on the road segment into a plurality of clusters based on at least one of the absolute heading of vehicles or lane assignment of the vehicles. Generating the target trajectory may include averaging, by server 1230, the clustered trajectories. By way of further example, process 1900 may include aligning data received in step 1905. Other processes or steps performed by server 1230, as described above, may also be included in process 1900.

The disclosed systems and methods may include other features. For example, the disclosed systems may use local coordinates, rather than global coordinates. For autonomous driving, some systems may present data in world coordinates. For example, longitude and latitude coordinates on the earth surface may be used. In order to use the map for steering, the host vehicle may determine its position and orientation relative to the map. It seems natural to use a GPS device on board, in order to position the vehicle on the map and in order to find the rotation transformation between the body reference frame and the world reference frame (e.g., North, East and Down). Once the body reference frame is aligned with the map reference frame, then the desired route may be expressed in the body reference frame and the steering commands may be computed or generated.

The disclosed systems and methods may enable autonomous vehicle navigation (e.g., steering control) with low footprint models, which may be collected by the autonomous vehicles themselves without the aid of expensive surveying equipment. To support the autonomous navigation (e.g., steering applications), the road model may include a sparse map having the geometry of the road, its lane structure, and landmarks that may be used to determine the location or position of vehicles along a trajectory included in the model. As discussed above, generation of the sparse map may be performed by a remote server that communicates with vehicles travelling on the road and that receives data from the vehicles. The data may include sensed data, trajectories reconstructed based on the sensed data, and/or recommended trajectories that may represent modified reconstructed trajectories. As discussed below, the server may transmit the model back to the vehicles or other vehicles that later travel on the road to aid in autonomous navigation.

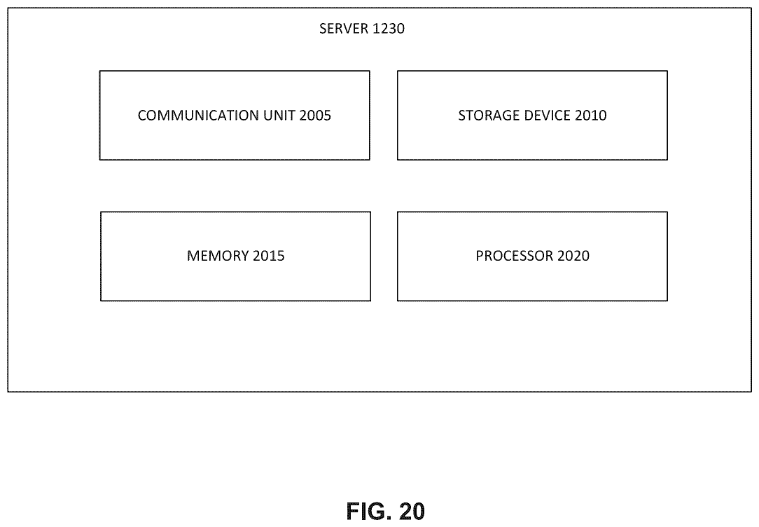

FIG. 20 illustrates a block diagram of server 1230. Server 1230 may include a communication unit 2005, which may include both hardware components (e.g., communication control circuits, switches, and antenna), and software components (e.g., communication protocols, computer codes). For example, communication unit 2005 may include at least one network interface. Server 1230 may communicate with vehicles 1205, 1210, 1215, 1220, and 1225 through communication unit 2005. For example, server 1230 may receive, through communication unit 2005, navigation information transmitted from vehicles 1205, 1210, 1215, 1220, and 1225. Server 1230 may distribute, through communication unit 2005, the autonomous vehicle road navigation model to one or more autonomous vehicles.

Server 1230 may include at least one non-transitory storage medium 2010, such as a hard drive, a compact disc, a tape, etc. Storage device 1410 may be configured to store data, such as navigation information received from vehicles 1205, 1210, 1215, 1220, and 1225 and/or the autonomous vehicle road navigation model that server 1230 generates based on the navigation information. Storage device 2010 may be configured to store any other information, such as a sparse map (e.g., sparse map 800 discussed above with respect to FIG. 8).

In addition to or in place of storage device 2010, server 1230 may include a memory 2015. Memory 2015 may be similar to or different from memory 140 or 150. Memory 2015 may be a non-transitory memory, such as a flash memory, a random access memory, etc. Memory 2015 may be configured to store data, such as computer codes or instructions executable by a processor (e.g., processor 2020), map data (e.g., data of sparse map 800), the autonomous vehicle road navigation model, and/or navigation information received from vehicles 1205, 1210, 1215, 1220, and 1225.

Server 1230 may include at least one processing device 2020 configured to execute computer codes or instructions stored in memory 2015 to perform various functions. For example, processing device 2020 may analyze the navigation information received from vehicles 1205, 1210, 1215, 1220, and 1225, and generate the autonomous vehicle road navigation model based on the analysis. Processing device 2020 may control communication unit 1405 to distribute the autonomous vehicle road navigation model to one or more autonomous vehicles (e.g., one or more of vehicles 1205, 1210, 1215, 1220, and 1225 or any vehicle that travels on road segment 1200 at a later time). Processing device 2020 may be similar to or different from processor 180, 190, or processing unit 110.

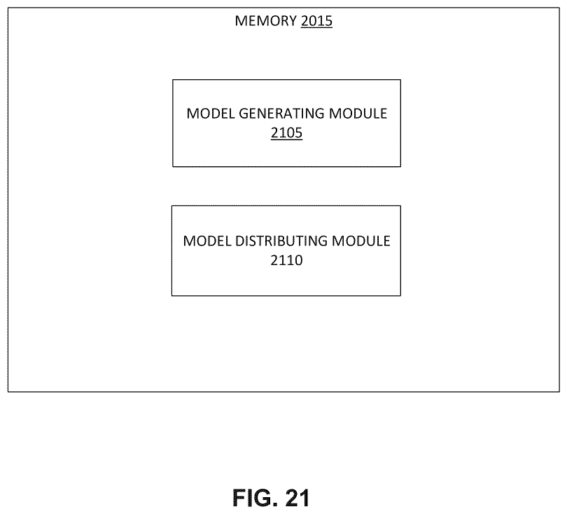

FIG. 21 illustrates a block diagram of memory 2015, which may store computer code or instructions for performing one or more operations for generating a road navigation model for use in autonomous vehicle navigation. As shown in FIG. 21, memory 2015 may store one or more modules for performing the operations for processing vehicle navigation information. For example, memory 2015 may include a model generating module 2105 and a model distributing module 2110. Processor 2020 may execute the instructions stored in any of modules 2105 and 2110 included in memory 2015.

Model generating module 2105 may store instructions which, when executed by processor 2020, may generate at least a portion of an autonomous vehicle road navigation model for a common road segment (e.g., road segment 1200) based on navigation information received from vehicles 1205, 1210, 1215, 1220, and 1225. For example, in generating the autonomous vehicle road navigation model, processor 2020 may cluster vehicle trajectories along the common road segment 1200 into different clusters. Processor 2020 may determine a target trajectory along the common road segment 1200 based on the clustered vehicle trajectories for each of the different clusters. Such an operation may include finding a mean or average trajectory of the clustered vehicle trajectories (e.g., by averaging data representing the clustered vehicle trajectories) in each cluster. In some embodiments, the target trajectory may be associated with a single lane of the common road segment 1200.

The road model and/or sparse map may store trajectories associated with a road segment. These trajectories may be referred to as target trajectories, which are provided to autonomous vehicles for autonomous navigation. The target trajectories may be received from multiple vehicles, or may be generated based on actual trajectories or recommended trajectories (actual trajectories with some modifications) received from multiple vehicles. The target trajectories included in the road model or sparse map may be continuously updated (e.g., averaged) with new trajectories received from other vehicles.

Vehicles travelling on a road segment may collect data by various sensors. The data may include landmarks, road signature profile, vehicle motion (e.g., accelerometer data, speed data), vehicle position (e.g., GPS data), and may either reconstruct the actual trajectories themselves, or transmit the data to a server, which will reconstruct the actual trajectories for the vehicles. In some embodiments, the vehicles may transmit data relating to a trajectory (e.g., a curve in an arbitrary reference frame), landmarks data, and lane assignment along traveling path to server 1230. Various vehicles travelling along the same road segment at multiple drives may have different trajectories. Server 1230 may identify routes or trajectories associated with each lane from the trajectories received from vehicles through a clustering process.

FIG. 22 illustrates a process of clustering vehicle trajectories associated with vehicles 1205, 1210, 1215, 1220, and 1225 for determining a target trajectory for the common road segment (e.g., road segment 1200). The target trajectory or a plurality of target trajectories determined from the clustering process may be included in the autonomous vehicle road navigation model or sparse map 800. In some embodiments, vehicles 1205, 1210, 1215, 1220, and 1225 traveling along road segment 1200 may transmit a plurality of trajectories 2200 to server 1230. In some embodiments, server 1230 may generate trajectories based on landmark, road geometry, and vehicle motion information received from vehicles 1205, 1210, 1215, 1220, and 1225. To generate the autonomous vehicle road navigation model, server 1230 may cluster vehicle trajectories 1600 into a plurality of clusters 2205, 2210, 2215, 2220, 2225, and 2230, as shown in FIG. 22.

Clustering may be performed using various criteria. In some embodiments, all drives in a cluster may be similar with respect to the absolute heading along the road segment 1200. The absolute heading may be obtained from GPS signals received by vehicles 1205, 1210, 1215, 1220, and 1225. In some embodiments, the absolute heading may be obtained using dead reckoning. Dead reckoning, as one of skill in the art would understand, may be used to determine the current position and hence heading of vehicles 1205, 1210, 1215, 1220, and 1225 by using previously determined position, estimated speed, etc. Trajectories clustered by absolute heading may be useful for identifying routes along the roadways.

In some embodiments, all the drives in a cluster may be similar with respect to the lane assignment (e.g., in the same lane before and after a junction) along the drive on road segment 1200. Trajectories clustered by lane assignment may be useful for identifying lanes along the roadways. In some embodiments, both criteria (e.g., absolute heading and lane assignment) may be used for clustering.

In each cluster 2205, 2210, 2215, 2220, 2225, and 2230, trajectories may be averaged to obtain a target trajectory associated with the specific cluster. For example, the trajectories from multiple drives associated with the same lane cluster may be averaged. The averaged trajectory may be a target trajectory associate with a specific lane. To average a cluster of trajectories, server 1230 may select a reference frame of an arbitrary trajectory C0. For all other trajectories (C1, . . . , Cn), server 1230 may find a rigid transformation that maps Ci to C0, where i=1, 2, . . . , n, where n is a positive integer number, corresponding to the total number of trajectories included in the cluster. Server 1230 may compute a mean curve or trajectory in the C0 reference frame.

In some embodiments, the landmarks may define an arc length matching between different drives, which may be used for alignment of trajectories with lanes. In some embodiments, lane marks before and after a junction may be used for alignment of trajectories with lanes.

To assemble lanes from the trajectories, server 1230 may select a reference frame of an arbitrary lane. Server 1230 may map partially overlapping lanes to the selected reference frame. Server 1230 may continue mapping until all lanes are in the same reference frame. Lanes that are next to each other may be aligned as if they were the same lane, and later they may be shifted laterally.

Landmarks recognized along the road segment may be mapped to the common reference frame, first at the lane level, then at the junction level. For example, the same landmarks may be recognized multiple times by multiple vehicles in multiple drives. The data regarding the same landmarks received in different drives may be slightly different. Such data may be averaged and mapped to the same reference frame, such as the C0 reference frame. Additionally or alternatively, the variance of the data of the same landmark received in multiple drives may be calculated.

In some embodiments, each lane of road segment 120 may be associated with a target trajectory and certain landmarks. The target trajectory or a plurality of such target trajectories may be included in the autonomous vehicle road navigation model, which may be used later by other autonomous vehicles travelling along the same road segment 1200. Landmarks identified by vehicles 1205, 1210, 1215, 1220, and 1225 while the vehicles travel along road segment 1200 may be recorded in association with the target trajectory. The data of the target trajectories and landmarks may be continuously or periodically updated with new data received from other vehicles in subsequent drives.

For localization of an autonomous vehicle, the disclosed systems and methods may use an Extended Kalman Filter. The location of the vehicle may be determined based on three dimensional position data and/or three dimensional orientation data, prediction of future location ahead of vehicle's current location by integration of ego motion. The localization of vehicle may be corrected or adjusted by image observations of landmarks. For example, when vehicle detects a landmark within an image captured by the camera, the landmark may be compared to a known landmark stored within the road model or sparse map 800. The known landmark may have a known location (e.g., GPS data) along a target trajectory stored in the road model and/or sparse map 800. Based on the current speed and images of the landmark, the distance from the vehicle to the landmark may be estimated. The location of the vehicle along a target trajectory may be adjusted based on the distance to the landmark and the landmark's known location (stored in the road model or sparse map 800). The landmark's position/location data (e.g., mean values from multiple drives) stored in the road model and/or sparse map 800 may be presumed to be accurate.

In some embodiments, the disclosed system may form a closed loop subsystem, in which estimation of the vehicle six degrees of freedom location (e.g., three dimensional position data plus three dimensional orientation data) may be used for navigating (e.g., steering the wheel of) the autonomous vehicle to reach a desired point (e.g., 1.3 second ahead in the stored). In turn, data measured from the steering and actual navigation may be used to estimate the six degrees of freedom location.

In some embodiments, poles along a road, such as lampposts and power or cable line poles may be used as landmarks for localizing the vehicles. Other landmarks such as traffic signs, traffic lights, arrows on the road, stop lines, as well as static features or signatures of an object along the road segment may also be used as landmarks for localizing the vehicle. When poles are used for localization, the x observation of the poles (i.e., the viewing angle from the vehicle) may be used, rather than the y observation (i.e., the distance to the pole) since the bottoms of the poles may be occluded and sometimes they are not on the road plane.

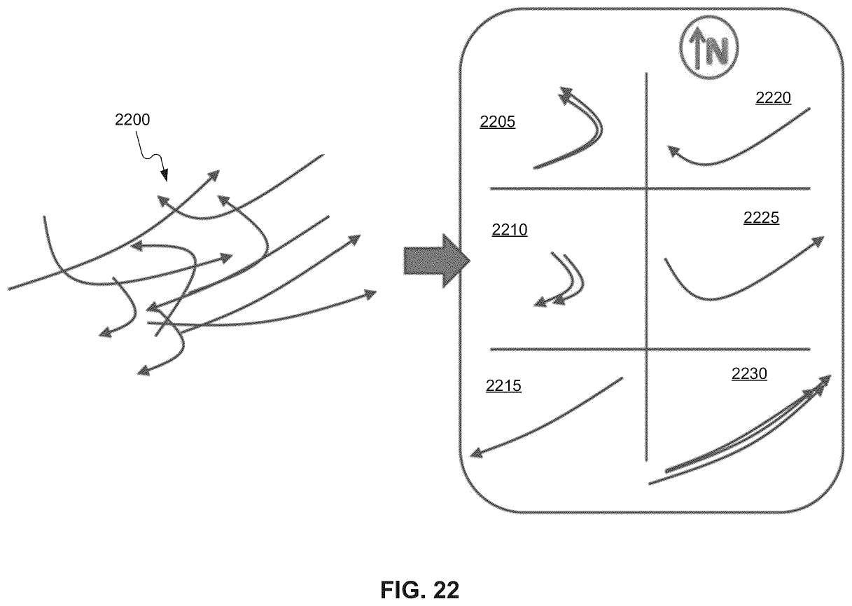

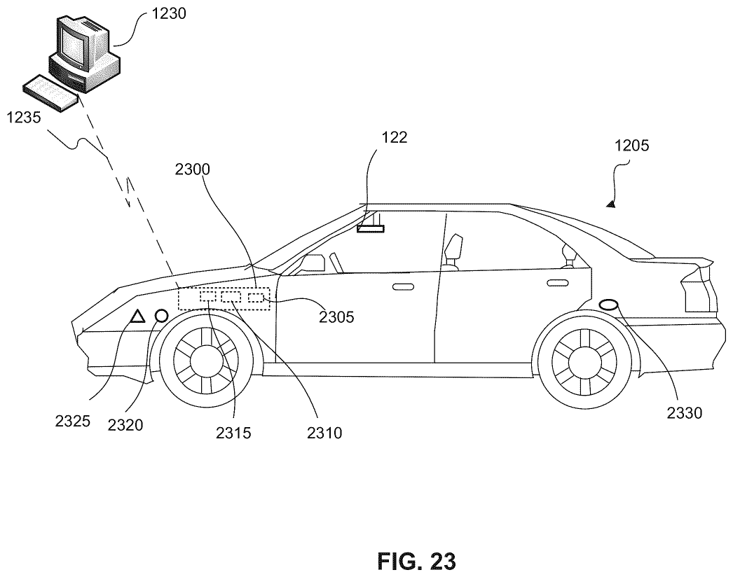

FIG. 23 illustrates a navigation system for a vehicle, which may be used for autonomous navigation using a crowdsourced sparse map. For illustration, the vehicle is referenced as vehicle 1205. The vehicle shown in FIG. 23 may be any other vehicle disclosed herein, including, for example, vehicles 1210, 1215, 1220, and 1225, as well as vehicle 200 shown in other embodiments. As shown in FIG. 12, vehicle 1205 may communicate with server 1230. Vehicle 1205 may include an image capture device 122 (e.g., camera 122). Vehicle 1205 may include a navigation system 2300 configured for providing navigation guidance for vehicle 1205 to travel on a road (e.g., road segment 1200). Vehicle 1205 may also include other sensors, such as a speed sensor 2320 and an accelerometer 2325. Speed sensor 2320 may be configured to detect the speed of vehicle 1205. Accelerometer 2325 may be configured to detect an acceleration or deceleration of vehicle 1205. Vehicle 1205 shown in FIG. 23 may be an autonomous vehicle, and the navigation system 2300 may be used for providing navigation guidance for autonomous driving. Alternatively, vehicle 1205 may also be a non-autonomous, human-controlled vehicle, and navigation system 2300 may still be used for providing navigation guidance.

Navigation system 2300 may include a communication unit 2305 configured to communicate with server 1230 through communication path 1235. Navigation system 2300 may also include a GPS unit 2310 configured to receive and process GPS signals. Navigation system 2300 may further include at least one processor 2315 configured to process data, such as GPS signals, map data from sparse map 800 (which may be stored on a storage device provided onboard vehicle 1205 and/or received from server 1230), road geometry sensed by a road profile sensor 2330, images captured by camera 122, and/or autonomous vehicle road navigation model received from server 1230. The road profile sensor 2330 may include different types of devices for measuring different types of road profile, such as road surface roughness, road width, road elevation, road curvature, etc. For example, the road profile sensor 2330 may include a device that measures the motion of a suspension of vehicle 2305 to derive the road roughness profile. In some embodiments, the road profile sensor 2330 may include radar sensors to measure the distance from vehicle 1205 to road sides (e.g., barrier on the road sides), thereby measuring the width of the road. In some embodiments, the road profile sensor 2330 may include a device configured for measuring the up and down elevation of the road. In some embodiment, the road profile sensor 2330 may include a device configured to measure the road curvature. For example, a camera (e.g., camera 122 or another camera) may be used to capture images of the road showing road curvatures. Vehicle 1205 may use such images to detect road curvatures.

The at least one processor 2315 may be programmed to receive, from camera 122, at least one environmental image associated with vehicle 1205. The at least one processor 2315 may analyze the at least one environmental image to determine navigation information related to the vehicle 1205. The navigation information may include a trajectory related to the travel of vehicle 1205 along road segment 1200. The at least one processor 2315 may determine the trajectory based on motions of camera 122 (and hence the vehicle), such as three dimensional translation and three dimensional rotational motions. In some embodiments, the at least one processor 2315 may determine the translation and rotational motions of camera 122 based on analysis of a plurality of images acquired by camera 122. In some embodiments, the navigation information may include lane assignment information (e.g., in which lane vehicle 1205 is travelling along road segment 1200). The navigation information transmitted from vehicle 1205 to server 1230 may be used by server 1230 to generate and/or update an autonomous vehicle road navigation model, which may be transmitted back from server 1230 to vehicle 1205 for providing autonomous navigation guidance for vehicle 1205.

The at least one processor 2315 may also be programmed to transmit the navigation information from vehicle 1205 to server 1230. In some embodiments, the navigation information may be transmitted to server 1230 along with road information. The road location information may include at least one of the GPS signal received by the GPS unit 2310, landmark information, road geometry, lane information, etc. The at least one processor 2315 may receive, from server 1230, the autonomous vehicle road navigation model or a portion of the model. The autonomous vehicle road navigation model received from server 1230 may include at least one update based on the navigation information transmitted from vehicle 1205 to server 1230. The portion of the model transmitted from server 1230 to vehicle 1205 may include an updated portion of the model. The at least one processor 2315 may cause at least one navigational maneuver (e.g., steering such as making a turn, braking, accelerating, passing another vehicle, etc.) by vehicle 1205 based on the received autonomous vehicle road navigation model or the updated portion of the model.

The at least one processor 2315 may be configured to communicate with various sensors and components included in vehicle 1205, including communication unit 2305, GPS unit 2310, camera 122, speed sensor 2320, accelerometer 2325, and road profile sensor 2330. The at least one processor 2315 may collect information or data from various sensors and components and transmit the information or data to server 1230 through communication unit 2305. Alternatively or additionally, various sensors or components of vehicle 1205 may also communicate with server 1230 and transmit data or information collected by the sensors or components to server 1230.

In some embodiments, vehicles 1205, 1210, 1215, 1220, and 1225 may communicate with each other, and may share navigation information with each other, such that at least one of the vehicles 1205, 1210, 1215, 1220, and 1225 may generate the autonomous vehicle road navigation model using crowdsourcing, e.g., based on information shared by other vehicles. In some embodiments, vehicles 1205, 1210, 1215, 1220, and 1225 may share navigation information with each other and each vehicle may update its own the autonomous vehicle road navigation model provided in the vehicle. In some embodiments, at least one of the vehicles 1205, 1210, 1215, 1220, and 1225 (e.g., vehicle 1205) may function as a hub vehicle. The at least one processor 2315 of the hub vehicle (e.g., vehicle 1205) may perform some or all of the functions performed by server 1230. For example, the at least one processor 2315 of the hub vehicle may communicate with other vehicles and receive navigation information from other vehicles. The at least one processor 2315 of the hub vehicle may generate the autonomous vehicle road navigation model or an update to the model based on the shared information received from other vehicles. The at least one processor 2315 of the hub vehicle may transmit the autonomous vehicle road navigation model or the update to the model to other vehicles for providing autonomous navigation guidance.

### Navigation Based on Sparse Maps

As previously discussed, the autonomous vehicle road navigation model including sparse map 800 may include a plurality of mapped lane marks and a plurality of mapped objects/features associated with a road segment. As discussed in greater detail below, these mapped lane marks, objects, and features may be used when the autonomous vehicle navigates. For example, in some embodiments, the mapped objects and features may be used to localized a host vehicle relative to the map (e.g., relative to a mapped target trajectory). The mapped lane marks may be used (e.g., as a check) to determine a lateral position and/or orientation relative to a planned or target trajectory. With this position information, the autonomous vehicle may be able to adjust a heading direction to match a direction of a target trajectory at the determined position.

Vehicle 200 may be configured to detect lane marks in a given road segment. The road segment may include any markings on a road for guiding vehicle traffic on a roadway. For example, the lane marks may be continuous or dashed lines demarking the edge of a lane of travel. The lane marks may also include double lines, such as a double continuous lines, double dashed lines or a combination of continuous and dashed lines indicating, for example, whether passing is permitted in an adjacent lane. The lane marks may also include freeway entrance and exit markings indicating, for example, a deceleration lane for an exit ramp or dotted lines indicating that a lane is turn-only or that the lane is ending. The markings may further indicate a work zone, a temporary lane shift, a path of travel through an intersection, a median, a special purpose lane (e.g., a bike lane, HOV lane, etc.), or other miscellaneous markings (e.g., crosswalk, a speed hump, a railway crossing, a stop line, etc.).

Vehicle 200 may use cameras, such as image capture devices 122 and 124 included in image acquisition unit 120, to capture images of the surrounding lane marks. Vehicle 200 may analyze the images to detect point locations associated with the lane marks based on features identified within one or more of the captured images. These point locations may be uploaded to a server to represent the lane marks in sparse map 800. Depending on the position and field of view of the camera, lane marks may be detected for both sides of the vehicle simultaneously from a single image. In other embodiments, different cameras may be used to capture images on multiple sides of the vehicle. Rather than uploading actual images of the lane marks, the marks may be stored in sparse map 800 as a spline or a series of points, thus reducing the size of sparse map 800 and/or the data that must be uploaded remotely by the vehicle.

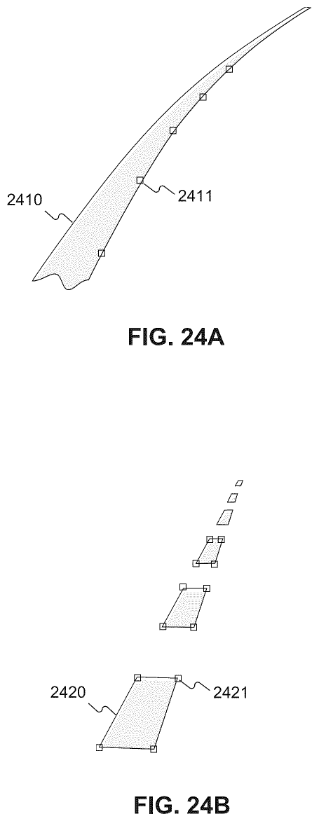

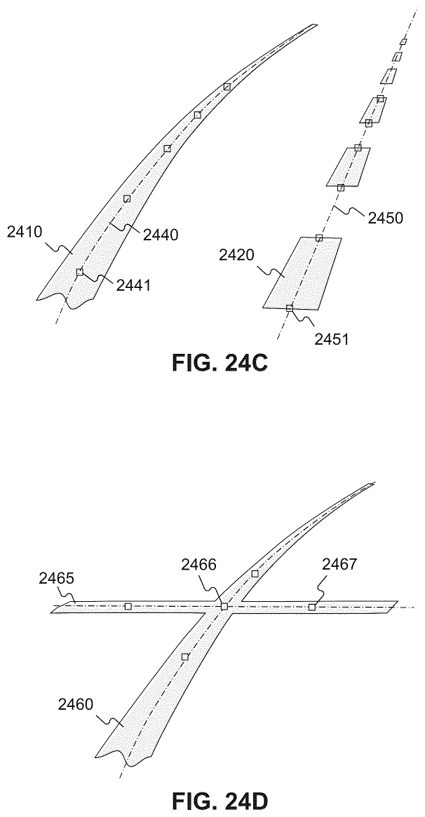

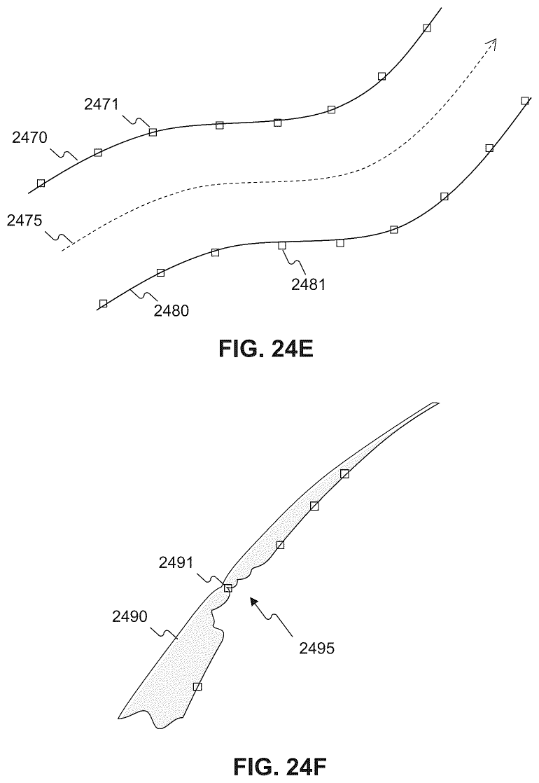

FIGS. 24A-24D illustrate exemplary point locations that may be detected by vehicle 200 to represent particular lane marks. Similar to the landmarks described above, vehicle 200 may use various image recognition algorithms or software to identify point locations within a captured image. For example, vehicle 200 may recognize a series of edge points, corner points or various other point locations associated with a particular lane mark. FIG. 24A shows a continuous lane mark 2410 that may be detected by vehicle 200. Lane mark 2410 may represent the outside edge of a roadway, represented by a continuous white line. As shown in FIG. 24A, vehicle 200 may be configured to detect a plurality of edge location points 2411 along the lane mark. Location points 2411 may be collected to represent the lane mark at any intervals sufficient to create a mapped lane mark in the sparse map. For example, the lane mark may be represented by one point per meter of the detected edge, one point per every five meters of the detected edge, or at other suitable spacings. In some embodiments, the spacing may be determined by other factors, rather than at set intervals such as, for example, based on points where vehicle 200 has a highest confidence ranking of the location of the detected points. Although FIG. 24A shows edge location points on an interior edge of lane mark 2410, points may be collected on the outside edge of the line or along both edges. Further, while a single line is shown in FIG. 24A, similar edge points may be detected for a double continuous line. For example, points 2411 may be detected along an edge of one or both of the continuous lines.

Vehicle 200 may also represent lane marks differently depending on the type or shape of lane mark. FIG. 24B shows an exemplary dashed lane mark 2420 that may be detected by vehicle 200. Rather than identifying edge points, as in FIG. 24A, vehicle may detect a series of corner points 2421 representing corners of the lane dashes to define the full boundary of the dash. While FIG. 24B shows each corner of a given dash marking being located, vehicle 200 may detect or upload a subset of the points shown in the figure. For example, vehicle 200 may detect the leading edge or leading corner of a given dash mark, or may detect the two corner points nearest the interior of the lane. Further, not every dash mark may be captured, for example, vehicle 200 may capture and/or record points representing a sample of dash marks (e.g., every other, every third, every fifth, etc.) or dash marks at a predefined spacing (e.g., every meter, every five meters, every 10 meters, etc.) Corner points may also be detected for similar lane marks, such as markings showing a lane is for an exit ramp, that a particular lane is ending, or other various lane marks that may have detectable corner points. Corner points may also be detected for lane marks consisting of double dashed lines or a combination of continuous and dashed lines.

In some embodiments, the points uploaded to the server to generate the mapped lane marks may represent other points besides the detected edge points or corner points. FIG. 24C illustrates a series of points that may represent a centerline of a given lane mark. For example, continuous lane 2410 may be represented by centerline points 2441 along a centerline 2440 of the lane mark. In some embodiments, vehicle 200 may be configured to detect these center points using various image recognition techniques, such as convolutional neural networks (CNN), scale-invariant feature transform (SIFT), histogram of oriented gradients (HOG) features, or other techniques. Alternatively, vehicle 200 may detect other points, such as edge points 2411 shown in FIG. 24A, and may calculate centerline points 2441, for example, by detecting points along each edge and determining a midpoint between the edge points. Similarly, dashed lane mark 2420 may be represented by centerline points 2451 along a centerline 2450 of the lane mark. The centerline points may be located at the edge of a dash, as shown in FIG. 24C, or at various other locations along the centerline. For example, each dash may be represented by a single point in the geometric center of the dash. The points may also be spaced at a predetermined interval along the centerline (e.g., every meter, 5 meters, 10 meters, etc.). The centerline points 2451 may be detected directly by vehicle 200, or may be calculated based on other detected reference points, such as corner points 2421, as shown in FIG. 24B. A centerline may also be used to represent other lane mark types, such as a double line, using similar techniques as above.

In some embodiments, vehicle 200 may identify points representing other features, such as a vertex between two intersecting lane marks. FIG. 24D shows exemplary points representing an intersection between two lane marks 2460 and 2465. Vehicle 200 may calculate a vertex point 2466 representing an intersection between the two lane marks. For example, one of lane marks 2460 or 2465 may represent a train crossing area or other crossing area in the road segment. While lane marks 2460 and 2465 are shown as crossing each other perpendicularly, various other configurations may be detected. For example, the lane marks 2460 and 2465 may cross at other angles, or one or both of the lane marks may terminate at the vertex point 2466. Similar techniques may also be applied for intersections between dashed or other lane mark types. In addition to vertex point 2466, various other points 2467 may also be detected, providing further information about the orientation of lane marks 2460 and 2465.

Vehicle 200 may associate real-world coordinates with each detected point of the lane mark. For example, location identifiers may be generated, including coordinate for each point, to upload to a server for mapping the lane mark. The location identifiers may further include other identifying information about the points, including whether the point represents a corner point, an edge point, center point, etc. Vehicle 200 may therefore be configured to determine a real-world position of each point based on analysis of the images. For example, vehicle 200 may detect other features in the image, such as the various landmarks described above, to locate the real-world position of the lane marks. This may involve determining the location of the lane marks in the image relative to the detected landmark or determining the position of the vehicle based on the detected landmark and then determining a distance from the vehicle (or target trajectory of the vehicle) to the lane mark. When a landmark is not available, the location of the lane mark points may be determined relative to a position of the vehicle determined based on dead reckoning. The real-world coordinates included in the location identifiers may be represented as absolute coordinates (e.g., latitude/longitude coordinates), or may be relative to other features, such as based on a longitudinal position along a target trajectory and a lateral distance from the target trajectory. The location identifiers may then be uploaded to a server for generation of the mapped lane marks in the navigation model (such as sparse map 800). In some embodiments, the server may construct a spline representing the lane marks of a road segment. Alternatively, vehicle 200 may generate the spline and upload it to the server to be recorded in the navigational model.

FIG. 24E shows an exemplary navigation model or sparse map for a corresponding road segment that includes mapped lane marks. The sparse map may include a target trajectory 2475 for a vehicle to follow along a road segment. As described above, target trajectory 2475 may represent an ideal path for a vehicle to take as it travels the corresponding road segment, or may be located elsewhere on the road (e.g., a centerline of the road, etc.). Target trajectory 2475 may be calculated in the various methods described above, for example, based on an aggregation (e.g., a weighted combination) of two or more reconstructed trajectories of vehicles traversing the same road segment.

In some embodiments, the target trajectory may be generated equally for all vehicle types and for all road, vehicle, and/or environment conditions. In other embodiments, however, various other factors or variables may also be considered in generating the target trajectory. A different target trajectory may be generated for different types of vehicles (e.g., a private car, a light truck, and a full trailer). For example, a target trajectory with relatively tighter turning radii may be generated for a small private car than a larger semi-trailer truck. In some embodiments, road, vehicle and environmental conditions may be considered as well. For example, a different target trajectory may be generated for different road conditions (e.g., wet, snowy, icy, dry, etc.), vehicle conditions (e.g., tire condition or estimated tire condition, brake condition or estimated brake condition, amount of fuel remaining, etc.) or environmental factors (e.g., time of day, visibility, weather, etc.). The target trajectory may also depend on one or more aspects or features of a particular road segment (e.g., speed limit, frequency and size of turns, grade, etc.). In some embodiments, various user settings may also be used to determine the target trajectory, such as a set driving mode (e.g., desired driving aggressiveness, economy mode, etc.).

The sparse map may also include mapped lane marks 2470 and 2480 representing lane marks along the road segment. The mapped lane marks may be represented by a plurality of location identifiers 2471 and 2481. As described above, the location identifiers may include locations in real world coordinates of points associated with a detected lane mark. Similar to the target trajectory in the model, the lane marks may also include elevation data and may be represented as a curve in three-dimensional space. For example, the curve may be a spline connecting three dimensional polynomials of suitable order the curve may be calculated based on the location identifiers. The mapped lane marks may also include other information or metadata about the lane mark, such as an identifier of the type of lane mark (e.g., between two lanes with the same direction of travel, between two lanes of opposite direction of travel, edge of a roadway, etc.) and/or other characteristics of the lane mark (e.g., continuous, dashed, single line, double line, yellow, white, etc.). In some embodiments, the mapped lane marks may be continuously updated within the model, for example, using crowdsourcing techniques. The same vehicle may upload location identifiers during multiple occasions of travelling the same road segment or data may be selected from a plurality of vehicles (such as 1205, 1210, 1215, 1220, and 1225) travelling the road segment at different times. Sparse map 800 may then be updated or refined based on subsequent location identifiers received from the vehicles and stored in the system. As the mapped lane marks are updated and refined, the updated road navigation model and/or sparse map may be distributed to a plurality of autonomous vehicles.

Generating the mapped lane marks in the sparse map may also include detecting and/or mitigating errors based on anomalies in the images or in the actual lane marks themselves. FIG. 24F shows an exemplary anomaly 2495 associated with detecting a lane mark 2490. Anomaly 2495 may appear in the image captured by vehicle 200, for example, from an object obstructing the camera's view of the lane mark, debris on the lens, etc. In some instances, the anomaly may be due to the lane mark itself, which may be damaged or worn away, or partially covered, for example, by dirt, debris, water, snow or other materials on the road. Anomaly 2495 may result in an erroneous point 2491 being detected by vehicle 200. Sparse map 800 may provide the correct the mapped lane mark and exclude the error. In some embodiments, vehicle 200 may detect erroneous point 2491 for example, by detecting anomaly 2495 in the image, or by identifying the error based on detected lane mark points before and after the anomaly. Based on detecting the anomaly, the vehicle may omit point 2491 or may adjust it to be in line with other detected points. In other embodiments, the error may be corrected after the point has been uploaded, for example, by determining the point is outside of an expected threshold based on other points uploaded during the same trip, or based on an aggregation of data from previous trips along the same road segment.

The mapped lane marks in the navigation model and/or sparse map may also be used for navigation by an autonomous vehicle traversing the corresponding roadway. For example, a vehicle navigating along a target trajectory may periodically use the mapped lane marks in the sparse map to align itself with the target trajectory. As mentioned above, between landmarks the vehicle may navigate based on dead reckoning in which the vehicle uses sensors to determine its ego motion and estimate its position relative to the target trajectory. Errors may accumulate over time and vehicle's position determinations relative to the target trajectory may become increasingly less accurate. Accordingly, the vehicle may use lane marks occurring in sparse map 800 (and their known locations) to reduce the dead reckoning-induced errors in position determination. In this way, the identified lane marks included in sparse map 800 may serve as navigational anchors from which an accurate position of the vehicle relative to a target trajectory may be determined.

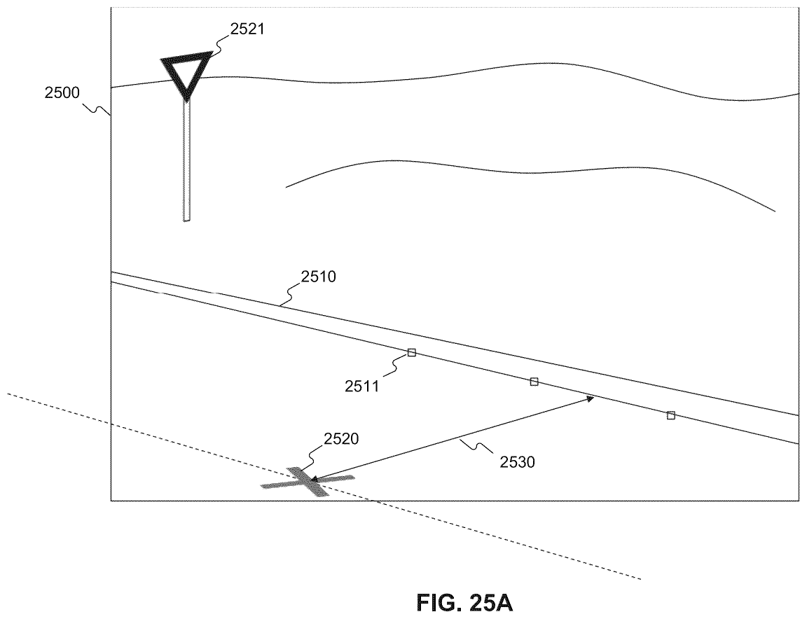

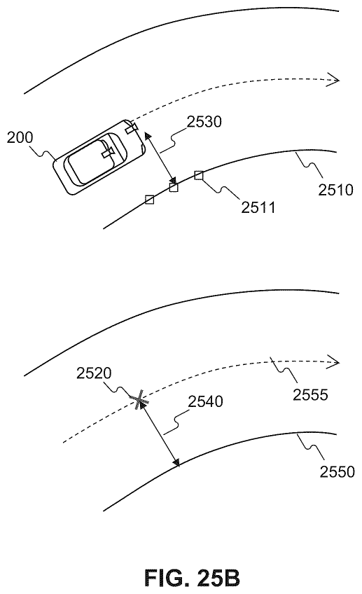

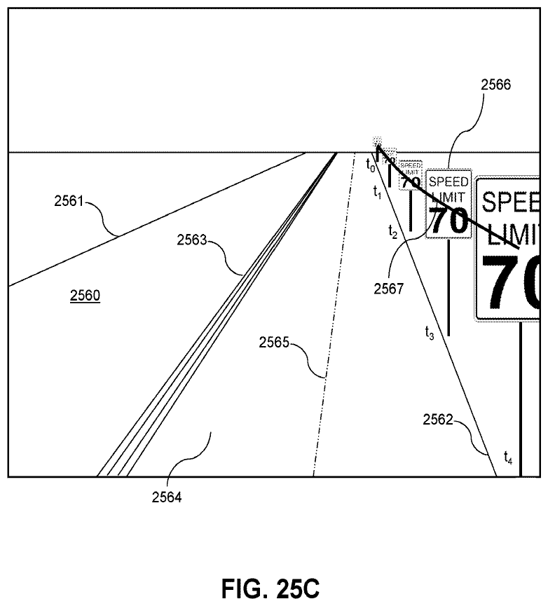

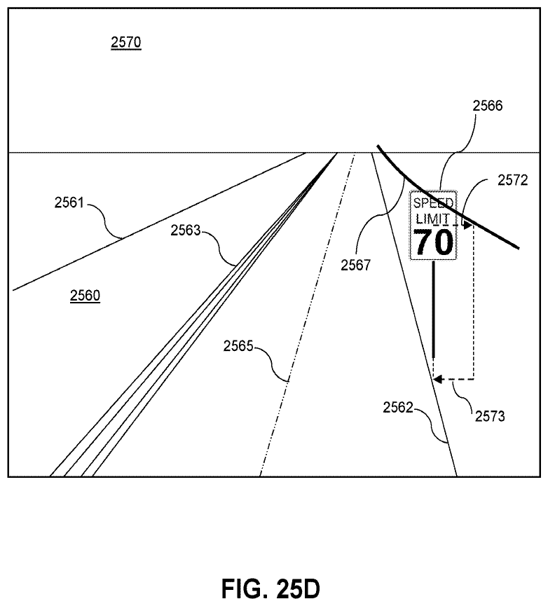

FIG. 25A shows an exemplary image 2500 of a vehicle's surrounding environment that may be used for navigation based on the mapped lane marks. Image 2500 may be captured, for example, by vehicle 200 through image capture devices 122 and 124 included in image acquisition unit 120. Image 2500 may include an image of at least one lane mark 2510, as shown in FIG. 25A. Image 2500 may also include one or more landmarks 2521, such as road sign, used for navigation as described above. Some elements shown in FIG. 25A, such as elements 2511, 2530, and 2520 which do not appear in the captured image 2500 but are detected and/or determined by vehicle 200 are also shown for reference.

Using the various techniques described above with respect to FIGS. 24A-D and 24F, a vehicle may analyze image 2500 to identify lane mark 2510. Various points 2511 may be detected corresponding to features of the lane mark in the image. Points 2511, for example, may correspond to an edge of the lane mark, a corner of the lane mark, a midpoint of the lane mark, a vertex between two intersecting lane marks, or various other features or locations. Points 2511 may be detected to correspond to a location of points stored in a navigation model received from a server. For example, if a sparse map is received containing points that represent a centerline of a mapped lane mark, points 2511 may also be detected based on a centerline of lane mark 2510.

The vehicle may also determine a longitudinal position represented by element 2520 and located along a target trajectory. Longitudinal position 2520 may be determined from image 2500, for example, by detecting landmark 2521 within image 2500 and comparing a measured location to a known landmark location stored in the road model or sparse map 800. The location of the vehicle along a target trajectory may then be determined based on the distance to the landmark and the landmark's known location. The longitudinal position 2520 may also be determined from images other than those used to determine the position of a lane mark. For example, longitudinal position 2520 may be determined by detecting landmarks in images from other cameras within image acquisition unit 120 taken simultaneously or near simultaneously to image 2500. In some instances, the vehicle may not be near any landmarks or other reference points for determining longitudinal position 2520. In such instances, the vehicle may be navigating based on dead reckoning and thus may use sensors to determine its ego motion and estimate a longitudinal position 2520 relative to the target trajectory. The vehicle may also determine a distance 2530 representing the actual distance between the vehicle and lane mark 2510 observed in the captured image(s). The camera angle, the speed of the vehicle, the width of the vehicle, or various other factors may be accounted for in determining distance 2530.

FIG. 25B illustrates a lateral localization correction of the vehicle based on the mapped lane marks in a road navigation model. As described above, vehicle 200 may determine a distance 2530 between vehicle 200 and a lane mark 2510 using one or more images captured by vehicle 200. Vehicle 200 may also have access to a road navigation model, such as sparse map 800, which may include a mapped lane mark 2550 and a target trajectory 2555. Mapped lane mark 2550 may be modeled using the techniques described above, for example using crowdsourced location identifiers captured by a plurality of vehicles. Target trajectory 2555 may also be generated using the various techniques described previously. Vehicle 200 may also determine or estimate a longitudinal position 2520 along target trajectory 2555 as described above with respect to FIG. 25A. Vehicle 200 may then determine an expected distance 2540 based on a lateral distance between target trajectory 2555 and mapped lane mark 2550 corresponding to longitudinal position 2520. The lateral localization of vehicle 200 may be corrected or adjusted by comparing the actual distance 2530, measured using the captured image(s), with the expected distance 2540 from the model.

FIGS. 25C and 25D provide illustrations associated with another example for localizing a host vehicle during navigation based on mapped landmarks/objects/features in a sparse map. FIG. 25C conceptually represents a series of images captured from a vehicle navigating along a road segment 2560. In this example, road segment 2560 includes a straight section of a two-lane divided highway delineated by road edges 2561 and 2562 and center lane marking 2563. As shown, the host vehicle is navigating along a lane 2564, which is associated with a mapped target trajectory 2565. Thus, in an ideal situation (and without influencers such as the presence of target vehicles or objects in the roadway, etc.) the host vehicle should closely track the mapped target trajectory 2565 as it navigates along lane 2564 of road segment 2560. In reality, the host vehicle may experience drift as it navigates along mapped target trajectory 2565. For effective and safe navigation, this drift should be maintained within acceptable limits (e.g., +/−10 cm of lateral displacement from target trajectory 2565 or any other suitable threshold). To periodically account for drift and to make any needed course corrections to ensure that the host vehicle follows target trajectory 2565, the disclosed navigation systems may be able to localize the host vehicle along the target trajectory 2565 (e.g., determine a lateral and longitudinal position of the host vehicle relative to the target trajectory 2565) using one or more mapped features/objects included in the sparse map.

As a simple example, FIG. 25C shows a speed limit sign 2566 as it may appear in five different, sequentially captured images as the host vehicle navigates along road segment 2560. For example, at a first time, t0, sign 2566 may appear in a captured image near the horizon. As the host vehicle approaches sign 2566, in subsequentially captured images at times t1, t2, t3, and t4, sign 2566 will appear at different 2D X-Y pixel locations of the captured images. For example, in the captured image space, sign 2566 will move downward and to the right along curve 2567 (e.g., a curve extending through the center of the sign in each of the five captured image frames). Sign 2566 will also appear to increase in size as it is approached by the host vehicle (i.e., it will occupy a great number of pixels in subsequently captured images).

These changes in the image space representations of an object, such as sign 2566, may be exploited to determine a localized position of the host vehicle along a target trajectory. For example, as described in the present disclosure, any detectable object or feature, such as a semantic feature like sign 2566 or a detectable non-semantic feature, may be identified by one or more harvesting vehicles that previously traversed a road segment (e.g., road segment 2560). A mapping server may collect the harvested drive information from a plurality of vehicles, aggregate and correlate that information, and generate a sparse map including, for example, a target trajectory 2565 for lane 2564 of road segment 2560. The sparse map may also store a location of sign 2566 (along with type information, etc.). During navigation (e.g., prior to entering road segment 2560), a host vehicle may be supplied with a map tile including a sparse map for road segment 2560. To navigate in lane 2564 of road segment 2560, the host vehicle may follow mapped target trajectory 2565.

The mapped representation of sign 2566 may be used by the host vehicle to localize itself relative to the target trajectory. For example, a camera on the host vehicle will capture an image 2570 of the environment of the host vehicle, and that captured image 2570 may include an image representation of sign 2566 having a certain size and a certain X-Y image location, as shown in FIG. 25D. This size and X-Y image location can be used to determine the host vehicle's position relative to target trajectory 2565. For example, based on the sparse map including a representation of sign 2566, a navigation processor of the host vehicle can determine that in response to the host vehicle traveling along target trajectory 2565, a representation of sign 2566 should appear in captured images such that a center of sign 2566 will move (in image space) along line 2567. If a captured image, such as image 2570, shows the center (or other reference point) displaced from line 2567 (e.g., the expected image space trajectory), then the host vehicle navigation system can determine that at the time of the captured image it was not located on target trajectory 2565. From the image, however, the navigation processor can determine an appropriate navigational correction to return the host vehicle to the target trajectory 2565. For example, if analysis shows an image location of sign 2566 that is displaced in the image by a distance 2572 to the left of the expected image space location on line 2567, then the navigation processor may cause a heading change by the host vehicle (e.g., change the steering angle of the wheels) to move the host vehicle leftward by a distance 2573. In this way, each captured image can be used as part of a feedback loop process such that a difference between an observed image position of sign 2566 and expected image trajectory 2567 may be minimized to ensure that the host vehicle continues along target trajectory 2565 with little to no deviation. Of course, the more mapped objects that are available, the more often the described localization technique may be employed, which can reduce or eliminate drift-induced deviations from target trajectory 2565.

The process described above may be useful for detecting a lateral orientation or displacement of the host vehicle relative to a target trajectory. Localization of the host vehicle relative to target trajectory 2565 may also include a determination of a longitudinal location of the target vehicle along the target trajectory. For example, captured image 2570 includes a representation of sign 2566 as having a certain image size (e.g., 2D X-Y pixel area). This size can be compared to an expected image size of mapped sign 2566 as it travels through image space along line 2567 (e.g., as the size of the sign progressively increases, as shown in FIG. 25C). Based on the image size of sign 2566 in image 2570, and based on the expected size progression in image space relative to mapped target trajectory 2565, the host vehicle can determine its longitudinal position (at the time when image 2570 was captured) relative to target trajectory 2565. This longitudinal position coupled with any lateral displacement relative to target trajectory 2565, as described above, allows for full localization of the host vehicle relative to target trajectory 2565, as the host vehicle navigates along road 2560.

FIGS. 25C and 25D provide just one example of the disclosed localization technique using a single mapped object and a single target trajectory. In other examples, there may be many more target trajectories (e.g., one target trajectory for each viable lane of a multi-lane highway, urban street, complex junction, etc.) and there may be many more mapped available for localization. For example, a sparse map representative of an urban environment may include many objects per meter available for localization.

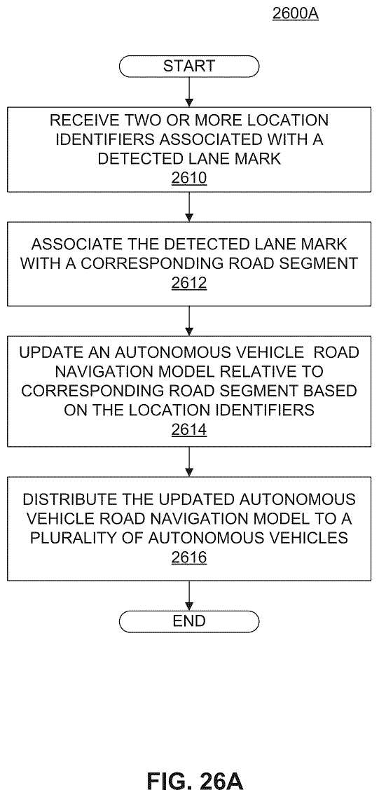

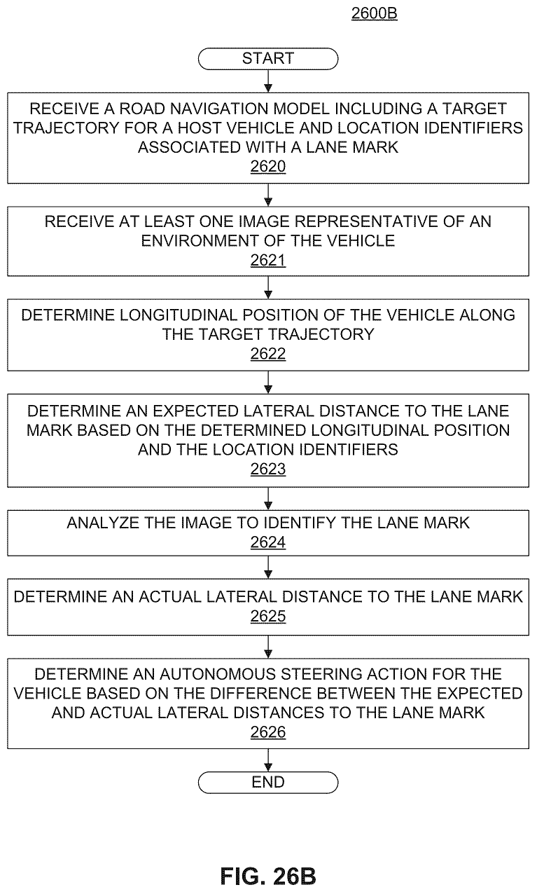

FIG. 26A is a flowchart showing an exemplary process 2600A for mapping a lane mark for use in autonomous vehicle navigation, consistent with disclosed embodiments. At step 2610, process 2600A may include receiving two or more location identifiers associated with a detected lane mark. For example, step 2610 may be performed by server 1230 or one or more processors associated with the server. The location identifiers may include locations in real-world coordinates of points associated with the detected lane mark, as described above with respect to FIG. 24E. In some embodiments, the location identifiers may also contain other data, such as additional information about the road segment or the lane mark. Additional data may also be received during step 2610, such as accelerometer data, speed data, landmarks data, road geometry or profile data, vehicle positioning data, ego motion data, or various other forms of data described above. The location identifiers may be generated by a vehicle, such as vehicles 1205, 1210, 1215, 1220, and 1225, based on images captured by the vehicle. For example, the identifiers may be determined based on acquisition, from a camera associated with a host vehicle, of at least one image representative of an environment of the host vehicle, analysis of the at least one image to detect the lane mark in the environment of the host vehicle, and analysis of the at least one image to determine a position of the detected lane mark relative to a location associated with the host vehicle. As described above, the lane mark may include a variety of different marking types, and the location identifiers may correspond to a variety of points relative to the lane mark. For example, where the detected lane mark is part of a dashed line marking a lane boundary, the points may correspond to detected corners of the lane mark. Where the detected lane mark is part of a continuous line marking a lane boundary, the points may correspond to a detected edge of the lane mark, with various spacings as described above. In some embodiments, the points may correspond to the centerline of the detected lane mark, as shown in FIG. 24C, or may correspond to a vertex between two intersecting lane marks and at least one two other points associated with the intersecting lane marks, as shown in FIG. 24D.

At step 2612, process 2600A may include associating the detected lane mark with a corresponding road segment. For example, server 1230 may analyze the real-world coordinates, or other information received during step 2610, and compare the coordinates or other information to location information stored in an autonomous vehicle road navigation model. Server 1230 may determine a road segment in the model that corresponds to the real-world road segment where the lane mark was detected.

At step 2614, process 2600A may include updating an autonomous vehicle road navigation model relative to the corresponding road segment based on the two or more location identifiers associated with the detected lane mark. For example, the autonomous road navigation model may be sparse map 800, and server 1230 may update the sparse map to include or adjust a mapped lane mark in the model. Server 1230 may update the model based on the various methods or processes described above with respect to FIG. 24E. In some embodiments, updating the autonomous vehicle road navigation model may include storing one or more indicators of position in real world coordinates of the detected lane mark. The autonomous vehicle road navigation model may also include a at least one target trajectory for a vehicle to follow along the corresponding road segment, as shown in FIG. 24E.

At step 2616, process 2600A may include distributing the updated autonomous vehicle road navigation model to a plurality of autonomous vehicles. For example, server 1230 may distribute the updated autonomous vehicle road navigation model to vehicles 1205, 1210, 1215, 1220, and 1225, which may use the model for navigation. The autonomous vehicle road navigation model may be distributed via one or more networks (e.g., over a cellular network and/or the Internet, etc.), through wireless communication paths 1235, as shown in FIG. 12.

In some embodiments, the lane marks may be mapped using data received from a plurality of vehicles, such as through a crowdsourcing technique, as described above with respect to FIG. 24E. For example, process 2600A may include receiving a first communication from a first host vehicle, including location identifiers associated with a detected lane mark, and receiving a second communication from a second host vehicle, including additional location identifiers associated with the detected lane mark. For example, the second communication may be received from a subsequent vehicle travelling on the same road segment, or from the same vehicle on a subsequent trip along the same road segment. Process 2600A may further include refining a determination of at least one position associated with the detected lane mark based on the location identifiers received in the first communication and based on the additional location identifiers received in the second communication. This may include using an average of the multiple location identifiers and/or filtering out “ghost” identifiers that may not reflect the real-world position of the lane mark.

FIG. 26B is a flowchart showing an exemplary process 2600B for autonomously navigating a host vehicle along a road segment using mapped lane marks. Process 2600B may be performed, for example, by processing unit 110 of autonomous vehicle 200. At step 2620, process 2600B may include receiving from a server-based system an autonomous vehicle road navigation model. In some embodiments, the autonomous vehicle road navigation model may include a target trajectory for the host vehicle along the road segment and location identifiers associated with one or more lane marks associated with the road segment. For example, vehicle 200 may receive sparse map 800 or another road navigation model developed using process 2600A. In some embodiments, the target trajectory may be represented as a three-dimensional spline, for example, as shown in FIG. 9B. As described above with respect to FIGS. 24A-F, the location identifiers may include locations in real world coordinates of points associated with the lane mark (e.g., corner points of a dashed lane mark, edge points of a continuous lane mark, a vertex between two intersecting lane marks and other points associated with the intersecting lane marks, a centerline associated with the lane mark, etc.).

At step 2621, process 2600B may include receiving at least one image representative of an environment of the vehicle. The image may be received from an image capture device of the vehicle, such as through image capture devices 122 and 124 included in image acquisition unit 120. The image may include an image of one or more lane marks, similar to image 2500 described above.

At step 2622, process 2600B may include determining a longitudinal position of the host vehicle along the target trajectory. As described above with respect to FIG. 25A, this may be based on other information in the captured image (e.g., landmarks, etc.) or by dead reckoning of the vehicle between detected landmarks.

At step 2623, process 2600B may include determining an expected lateral distance to the lane mark based on the determined longitudinal position of the host vehicle along the target trajectory and based on the two or more location identifiers associated with the at least one lane mark. For example, vehicle 200 may use sparse map 800 to determine an expected lateral distance to the lane mark. As shown in FIG. 25B, longitudinal position 2520 along a target trajectory 2555 may be determined in step 2622. Using spare map 800, vehicle 200 may determine an expected distance 2540 to mapped lane mark 2550 corresponding to longitudinal position 2520.

At step 2624, process 2600B may include analyzing the at least one image to identify the at least one lane mark. Vehicle 200, for example, may use various image recognition techniques or algorithms to identify the lane mark within the image, as described above. For example, lane mark 2510 may be detected through image analysis of image 2500, as shown in FIG. 25A.

At step 2625, process 2600B may include determining an actual lateral distance to the at least one lane mark based on analysis of the at least one image. For example, the vehicle may determine a distance 2530, as shown in FIG. 25A, representing the actual distance between the vehicle and lane mark 2510. The camera angle, the speed of the vehicle, the width of the vehicle, the position of the camera relative to the vehicle, or various other factors may be accounted for in determining distance 2530.

At step 2626, process 2600B may include determining an autonomous steering action for the host vehicle based on a difference between the expected lateral distance to the at least one lane mark and the determined actual lateral distance to the at least one lane mark. For example, as described above with respect to FIG. 25B, vehicle 200 may compare actual distance 2530 with an expected distance 2540. The difference between the actual and expected distance may indicate an error (and its magnitude) between the vehicle's actual position and the target trajectory to be followed by the vehicle. Accordingly, the vehicle may determine an autonomous steering action or other autonomous action based on the difference. For example, if actual distance 2530 is less than expected distance 2540, as shown in FIG. 25B, the vehicle may determine an autonomous steering action to direct the vehicle left, away from lane mark 2510. Thus, the vehicle's position relative to the target trajectory may be corrected. Process 2600B may be used, for example, to improve navigation of the vehicle between landmarks.

Processes 2600A and 2600B provide examples only of techniques that may be used for navigating a host vehicle using the disclosed sparse maps. In other examples, processes consistent with those described relative to FIGS. 25C and 25D may also be employed.

In some embodiments, the disclosed systems, methods, and non-transitory computer-readable media may use one or more AV maps. An autonomous vehicle (AV) map (or AV map) may include information to support and/or implement one or more autonomous vehicle (AV) functions of a vehicle in manner such that the vehicle operates in a safe manner and/or navigates in an accurate manner. The AV functions supported and/or implemented by an autonomous vehicle (or a semi-autonomous vehicle) may include one or more autonomously controlled functions (e.g., functions determined, selected, and/or implemented based on instructions executed by at least one processor) such as steering, accelerating, and/or braking the vehicle. The AV functions may be part of a driving policy, such as RSS, for example, which was developed and is implemented by Mobileye, of Jerusalem, Israel. The information for operating the vehicle in a safe manner may include, but is not limited to, information pertaining to one or more regulations applicable to a location of the vehicle or a jurisdiction (e.g., a right-hand traffic or left-hand traffic jurisdiction), information related to an environment in which the vehicle is located (e.g., information related to a drivable path, stop sign, traffic light, speed limit, lane markings, landmarks, free space, virtual or physical stop lines, traffic light relevancy information, etc.), and/or information related to adjusting and/or adapting navigation of the vehicle to account for one or more objects (e.g., other vehicles, pedestrians, objects, obstacles, occlusions, hazards, road work zones, traffic cones, etc.) in an environment of the vehicle. The vehicle may sense objects in the environment of the vehicle using one or more sensors (e.g., cameras, radar, lidar), as discussed herein. The AV map may serve as a redundant source of information for the sensed information and, in some cases, may also supplement the sensed information (e.g., provide a location of a virtual stop line, where no stop line is marked on the road). In some embodiments, operating the vehicle in a safe manner may further include operating the vehicle to maintain a comfort level for one or more passengers in the vehicle. The comfort level may include one or more predetermined criteria (e.g., related to speed, acceleration, and/or turning) selected to cause the vehicle to operate in a manner that meets or exceeds a designated or selected level of passenger comfort. The level of comfort may be formalized and expressed in appropriate mathematical formulae. For example, mathematical formulae that limit the extent of jerk or acceleration in different directions that is applied to a passenger may be used. The information for operating the vehicle in an accurate manner may include, but is not limited to, information pertaining to a planned or designated navigational path (e.g., a trajectory, as discussed herein) or a route (e.g., from a particular location, such as a starting location, to a destination). In some embodiments, the information included in an AV map may further include information that supports and/or implements one or more AV functions in an efficient manner. The information for operating the vehicle in an efficient manner may include information pertaining to speed, acceleration, lane changes, and/or lane positioning, and/or traveling and/or selecting a path or route based on traffic conditions (e.g., traveling a route that is a greater distance than a shorter route experiencing traffic conditions) and/or other factors or attributes related to potential routes (e.g., weather conditions, road conditions, or other characteristics of routes, such as traveling a highway without traffic lights instead of a road with traffic lights). In some embodiments, the AV map may further include at least some information from a high-definition (HD) map. In some embodiments, the AV map may be a sparse map, as described above. In some embodiments, the AV map may be crowdsourced, as discussed herein. In this disclosure, the terms “AV map” and “sparse map” are used interchangeable.

### Clustering Objects

As one or more vehicles drive along a road, some or all of the vehicles may obtain various types of information regarding the surroundings of the vehicles or regarding the vehicles themselves using one or more sensors (e.g., 122, 124, 126, 130). For example, a vehicle traveling along a road segment may obtain one or more images of the environment surrounding that particular vehicle. As discussed elsewhere in this disclosure, the images may be obtained using imaging devices such as cameras or via radar or LIDAR sensors. The vehicle may also obtain position information of the vehicle and/or position information of various location in the surroundings of the vehicle relative to the vehicle. Each instance of travel by a particular vehicle along a road segment may be referred to as a drive of that particular vehicle. One or more objects may be detected in the one or more images (and/or detected in other sensor data) obtained by the vehicles during each drive of a respective vehicle. Such objects may include, for example, landmarks as described elsewhere in this disclosure. In some embodiments, images and other information (e.g., position information) obtained by the plurality of vehicles may be combined and the combined information may be used to detect one or more objects. A plurality of objects detected using the combined information may be grouped into one or more clusters of objects. A group or cluster of objects may form an object detection cluster.

A post processing system may allow for determination of whether a particular object detection cluster corresponds to a single object or to multiple objects. The technique may include splitting the object detection cluster into groups or splitting the object detection cluster by area. The technique may also include determining objects were detected for a particular drive in each of the groups or areas. When objects are detected for a particular drive in more than one group or area, the object detection cluster may be determined as having more than one object. In contrast, when an object is detected for a particular drive in only one group or one area out of the plurality of groups or areas corresponding to an object detection cluster, the object detection cluster may be determined as having a single object. Dividing an object detection cluster in an image into multiple groups or areas may be useful, especially for certain types of landmarks that may include different sized components (e.g., two road signs placed adjacent to each other or attached to the same post). Methods and systems for determining one or more landmarks detected in the one or more images obtained during one or more drives of one or more vehicles are discussed below.

Some embodiments include a method for determining one or more harvested landmarks. As discussed elsewhere in this disclosure, a landmark may include any visible and/or identifiable object along a road segment. For example, a landmark may include a road sign, traffic sign, directional sign, a general sign (e.g., rectangular or circular sign), roadside fixtures (e.g., lampposts, reflectors, etc.), beacons, road markings or any other identifiable object. In some examples, a landmark may include a sequence of objects, for example, a sequence of lane marks, a lane width measurement over a certain road segment, etc. A harvested landmark refers to a landmark that has been detected and information associated with which has been stored in a memory or database. For example, as discussed elsewhere in this disclosure, the presence of one or more semantic features or objects along a road segment may be detected by the disclosed system. In some examples, non-semantic features can also be detected using a non-semantic feature detection techniques and information with respect to such non-semantic features can be collected and used in a manner that is similar to that of semantic features. The detected semantic and/or non-semantic features or objects may correspond to harvested landmarks. Landmark information and/or data associated with the harvested landmarks may be stored in a memory, database, or sparse map. For example, a processor (e.g., processing unit 110, including processor 180 or image processor 190, processor 2230 of a server, or any other processor disclosed in this disclosure) may analyze one or more images obtained by one or more vehicles (e.g., 200, 1205, 1210, 1215, 1220, and 1225) and harvest one or more landmarks from the one or more images. It should be understood that some or all the steps of the method of determining a harvested landmark may be performed by one or more of or a combination of processing unit 110, including processor 180 or image processor 190, processor 2230 of a server, or any other processor disclosed in this disclosure.

Determining a harvested landmark may refer to identifying or classifying the one or more semantic and/or non-semantic features or objects detected in the one or more images. In some instances, a detected object may be a single object, for example, including a single road sign, traffic sign, directional sign, general sign, road fixture, or beacon. In other instances, a detected object may include more than one object, for example, two road signs placed adjacent to each other or a plurality of traffic lights one next to the other. Determining a harvested landmark may include determining whether the harvested landmark includes a single object or more than one object and further identifying the detected single object or plurality of objects. A detected object may include any visual feature that is recognizable by a driving assistant system, an autonomous navigation system, and/or a mapping system onboard a vehicle. As discussed earlier, the visual feature may include a sematic feature. In some embodiments, the visual feature may include a non-sematic feature.

In some embodiments, the method includes obtaining drive information captured during drives by a plurality of vehicles traversing or having traversed a road segment. One or more vehicles in the plurality of vehicles may be an autonomous or non-autonomous vehicle as discussed elsewhere in this disclosure. A road segment refers to a portion of a road along which the one or more vehicles travel. A drive refers to a single instance of a vehicle travelling over, traversing, or moving over a road segment from one end of the road segment to an opposite end of the road segment in either direction. As a vehicle travels over a road segment during a drive, one or more sensors of the vehicle may capture and store drive information that may include data as disclosed elsewhere in this disclosure. For example, the drive information may include data collected from the vehicle such as a trajectory of the vehicle, speed of the vehicle, change or rate of change of speed of the vehicle, position of the vehicle on the road segment (e.g., travelling in the left lane or right lane of the road segment), time of day (e.g., whether the vehicle is traversing the road segment at dawn, dusk, during the day, or during the night), range of visibility, temperature, humidity, vehicle type, and/or any other parameters associated with travel of the vehicle over the road segment. In some embodiments, the drive information may also include position information of one or more objects surrounding the vehicle and/or a distance of the vehicle from the one or more objects surrounding the vehicle. Drive information, including image data obtained by the one or more sensors of a vehicle, may also include position information associated with one or more pixels in the image data relative to an image coordinate system, relative to an imaging device on the vehicle, or relative to a real-world coordinate system.

The disclosed method may include receiving the drive information from one or more vehicles that may be travelling on the road segment at any given time. Similarly, drive information may be received from one or more vehicles that may have previously travelled on the road segment at a prior time. In some embodiments, the received drive information may be stored in a memory or a database for further processing.

In some embodiments, the drive information for each of the plurality of vehicles comprises a drive identifier and landmark detection information corresponding to one or more landmark detections. A drive identifier may include an alphanumeric code, an image, a graphical icon, or a scannable image (e.g., QR code or Bar code) that is uniquely associated with a particular drive. In some embodiments, the drive identifier may uniquely identify a single instance of a vehicle travelling over, traversing, or moving over a road segment from one end of the road segment to an opposite end of the road segment in either direction. In some embodiments, the drive identifier may not reveal an identity of a particular vehicle (i.e., the identity of the vehicle may be anonymous) and may provide a unique identifier of a particular drive. For example, a drive identifier may include a unique code or alphanumeric representation arbitrarily assigned to each vehicle or each drive. In other embodiments, the drive identifier may represent an identifier of a particular vehicle. For example, in some embodiments, a drive identifier may include a vehicle identifier. A vehicle identifier may include a unique identifier assigned to a particular vehicle for purposes of identifying that vehicle such as a combination of letters and numbers constituting a vehicle identification number (or VIN number). In some embodiments, a drive identifier may include an image of a license plate or the textual and/or graphical information included on the license plate associated with that particular vehicle. For example, a first vehicle may have a drive identifier V1, a second vehicle may have a drive identifier V2, and so on. In some embodiments, in addition to the contents of the drive information discussed elsewhere in this disclosure, the drive information may include a drive identifier corresponding to a vehicle from which the drive information may have been received during a drive of that vehicle along a road segment.

As discussed elsewhere in this disclosure, landmark detection information may include information associated with a landmark that has been detected in the one or more images obtained from one or more vehicles traversing over a road segment. For example, landmark detection information may include a representation of a landmark, data describing characteristics of the landmark, including physical properties of the landmark, dimensions of the landmark, location of the landmark, an orientation of the landmark (a normal to a point along a trajectory in the map) and/or any other suitable parameters for identifying the particular landmark. In some embodiments, in addition to the contents of drive information discussed above, the drive information may include landmark detection information associated with one or more landmarks detected in the one or more images obtained from one or more vehicles traversing over a road segment.

In some embodiments, the landmark detection information comprises one or more three-dimensional real-world coordinates corresponding to a surface of a landmark of the one or more landmarks. As discussed elsewhere in this disclosure, three-dimensional real-world coordinates may include, for example, latitude/longitude coordinates. In some embodiments, three-dimensional real-world coordinates may be defined relative to other features on or around the road segment. For example, the three-dimensional real-world coordinates may be based on a longitudinal position along a target trajectory and a lateral distance from the target trajectory. As discussed elsewhere in this disclosure, the three-dimensional coordinates may be determined using structure in motion and/or optical flow techniques or any other depth or 3D measurement technique (in particular, but not limited to, vision or image-based techniques). A surface of a landmark refers to an exterior curved or plane layer or portion of an object such as a landmark. The surface or exterior layer may be defined by a plurality of points, and the locus of those points may correspond to the surface of the landmark. Each of the points defining the surface or exterior layer of a landmark may be similar to the points representing edges of lane marks as discussed elsewhere in this disclosure. Like the points representing edges of the lane marks, the points defining the surface of a landmark may also be represented by three-dimensional real-world coordinates. In some embodiments, the drive information may include three-dimensional real-world coordinates of the one or more points defining the surface or exterior layer of a detected landmark.

In some embodiments, the one or more three-dimensional real-world coordinates determine one or more edges of the surface of the landmark. An edge of a surface of a landmark refers to a boundary of the surface. One or more edges of the surface of a landmark may be detected by identifying edge points associated with the one or more edges of the surface using techniques similar to those discussed elsewhere in this disclosure for detecting lane edges or road edges. Each of the detected edge points of a surface of a landmark may have associated three-dimensional real-world coordinates similar to the points defining edges of lane marks. Thus, the three-dimensional real-world coordinates of the edge points of a surface of a landmark may represent or determine the one or more edges of the surface of the landmark.

In some embodiments, the landmark detection information comprises a type identifier identifying a type of a corresponding landmark. A type of landmark may refer to a description or representation of one or more traits or characteristics that distinguish the landmark. For example, landmarks such as signs indicating directions, allowable speeds, warnings, or caution warnings placed along a road segment may be characterized as signs associated with the road segment and may be designated as road signs. Other types of landmarks may include, for example, traffic signs or signals, directional signs, general signs (e.g., rectangular signs), roadside fixtures, beacons, road markings or any other category that may represent particular traits or characteristics of a landmarks. In some embodiments, each type of landmark may be represented by an identifier that may be a unique alphanumeric code, an icon, an image, or a scannable code (e.g., QR code, bar code) that uniquely represents the type of the landmark. In some exemplary embodiments, each type of landmark may be represented by a unique alphanumeric code. For example, road signs may have an identifier 1, traffic signs may have an identifier 2, and so on.

In some embodiments, the landmark detection information comprises sensor data obtained by at least one sensor of one or more of the plurality of vehicles. As discussed elsewhere in this disclosure, the one or more vehicles (autonomous or non-autonomous) may include one or more sensors (e.g., image capture devices 122, 124, 126, position sensor 130, radar sensor, LIDAR sensor). In some embodiments, the at least one sensor includes a camera, a radar, or a lidar. In some embodiments, the sensor data includes at least one of images captured by an image capture device, radar data, or lidar data. The one or more sensors associated with a particular vehicle may collect data and information from surroundings of that particular vehicle. For example, when the sensor includes a camera, the sensor may obtain one or more images of the surroundings of a vehicle associated with that sensor. As discussed elsewhere in this disclosure, for example, a vehicle (e.g., 200) may be equipped with image capture devices or cameras 122, 124 that may be configured to obtain one or more image of the surroundings of vehicle 200. Similarly, for example, when the sensor is a radar sensor, the sensor may obtain radar data representing the surroundings of a vehicle associated with that sensor. As another example, when the sensor is a lidar sensor, the sensor may obtain lidar data representing the surroundings of a vehicle associated with that sensor.

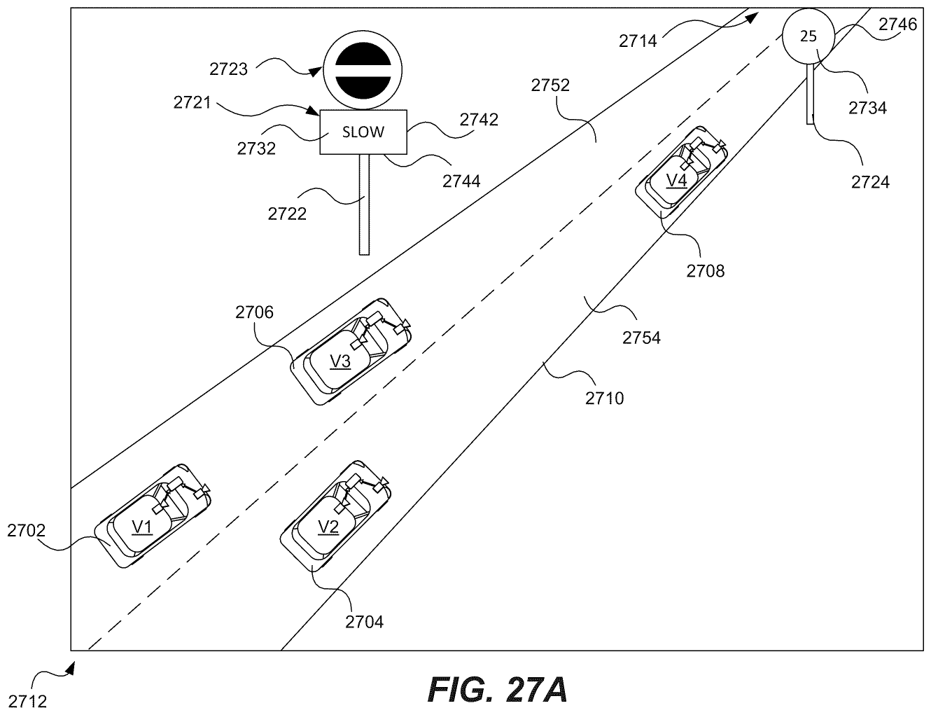

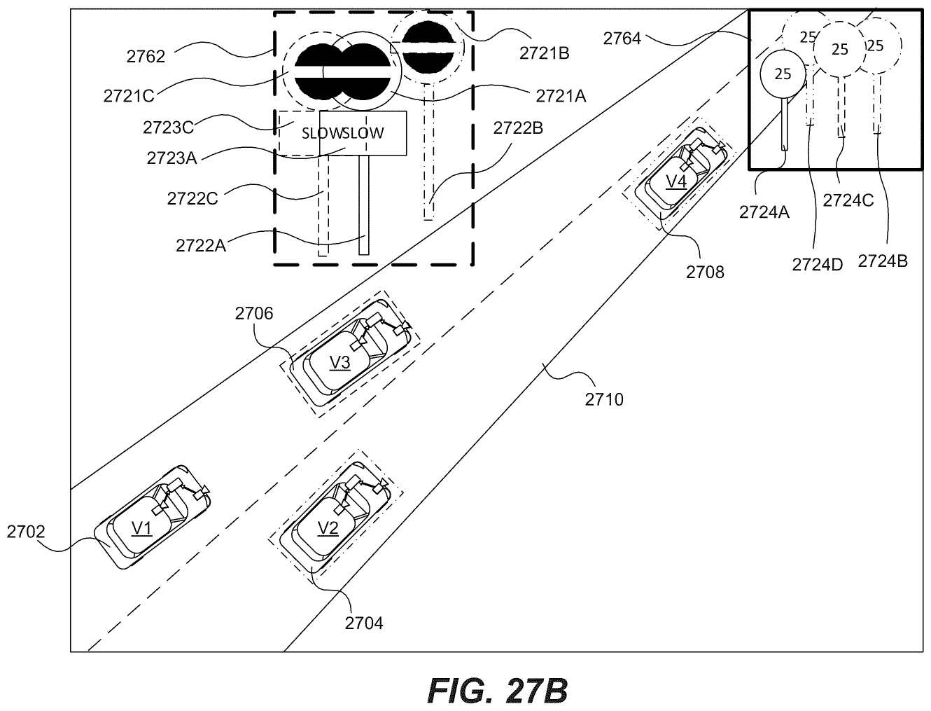

By way of example, FIG. 27A illustrates a plurality of vehicles traversing a road segment including a plurality of landmarks along the road segment. As shown in FIG. 27A, vehicles 2702, 2704, 2706, 2708 travel over road segment 2710 that may extend from one end 2712 to an opposing end 2714. Vehicles 2702, 2704, 2706, and/or 2708 may be similar to vehicles 200, 1205, 1210, 1215, 1220, or 1225, and may include one or more sensors similar to those of vehicle 200. As also illustrated in FIG. 27A, road segment 2710 includes landmarks 2722 and 2724 that may be road signs. For example, landmark 2722 includes two road signs, road sign 2721 and road sign 2723 (including arrow 2821) positioned above road sign 2721. Sensors on the one or more vehicles 2702, 2704, 2706, 2708 may obtain drive information as vehicles 2702, 2704, 2706, and/or 2708 traverse over road segment 2710 from one end 2712 to opposing end 2714. As further illustrated in FIG. 27A, each of vehicles 2702, 2704, 2706, 2708 may have an identifier. For example, vehicle 2702 has a drive identifier V1, vehicle 2704 has a drive identifier V2, vehicle 2706 has a drive identifier V3, and vehicle 2708 has a drive identifier V4. Drive identifiers V1, V2, V3, and V4 may be included in the drive information obtained by vehicles 2702, 2704, 2706, 2708, respectively.

Landmarks 2722 and 2724 may each have two surfaces, a front surface (e.g., 2732 or 2734) facing vehicles 2702, 2704, 2706, 2708, and a rear surface disposed on an opposite side of the front surface and not visible from vehicles 2702, 2704, 2706, 2708. Surface 2732 of landmark 2722 may have edges 2742 and 2744, whereas surface 2734 of landmark 2724 may have an edge 2746. Surfaces 2732 and 2734 may each be defined by one or more points. Likewise, edges 2742, 2744, and/or 2746 may each be defined by one or more points. The points defining surfaces 2732 and 2734 and edges 2742, 2744, and/or 2746 may each have three-dimensional real-world coordinates that may also be included in the drive information obtained by the one or more vehicles 2702, 2704, 2706, and/or 2708.

In some embodiments, the method for determining one or more harvested landmarks includes aggregating the landmark detection information included in the obtained drive information from the plurality of vehicles. Aggregating refers to collecting or gathering into a sum total or whole amount. Thus, aggregating landmark detection information may refer to generating a combination of the landmark detection information obtained from some or all of the plurality of vehicles. A variety of different criteria may be used to aggregate or combine the landmark detection information. For example, landmark detection information may be aggregated for landmarks of a particular type, landmarks having a particular size, landmarks located close to each other, landmarks located at a particular location relative to the road segment, landmarks having the same type identifier, landmarks located within a predetermined distance from the one or more vehicles, or may be based on other criteria. As another example, the landmark detection information obtained by the plurality of vehicles and corresponding to a particular landmark or a landmark detected at a particular location along the road segment may be combined to generate aggregated landmark detection information. By way of another example, the landmark detection information obtained by the plurality of vehicles and corresponding to a predetermined type of landmark may be combined to generate aggregated landmark detection information. As another example, the landmark detection information obtained by the plurality of vehicles and corresponding to landmarks located on a left side (or alternatively a right side) of the road segment may be combined to generate aggregated landmark detection information. The aggregated landmark detection information may include one or more items of data or information collected by each of the vehicles that are currently traversing or that may have previously traversed a road segment.

In some embodiments, aggregating the landmark detection information included in the obtained drive information from the plurality of vehicles is based on one or more drivable paths of a road segment. A drivable path of a road segment may refer to a portion of the road segment on which a vehicle may be able to drive. For example, a road segment may include two adjacent lanes, such as a left lane and a right lane, and vehicles may be able to travel either on the left lane or the right lane. In some embodiments, landmark detection information may be aggregated based on the portion of the road segment (e.g., lane) on which a vehicle is travelling. For example, landmark detection information obtained from a plurality of vehicles travelling on the road segment along a left lane may be aggregated while landmark detection information obtained from any vehicle traveling along a right lane may not be included in that aggregated landmark detection information. Although only two drivable paths (or lanes) have been discussed above, a road segment may have any number of drivable paths (or lanes) and landmark detection information may be aggregated by using landmark detection information obtained by vehicles traversing the road segment along any of the drivable paths and different combinations of drivable paths.

By way of example, FIG. 27A illustrates road segment 2710 that may include left lane 2752 and right lane 2754. As illustrated in FIG. 27A, vehicles 2702 and 2706 traverse road segment 2710 from one end 2712 to the other end 2714 along left lane 2752, whereas vehicles 2704 and 2708 traverse road segment 2710 from one end 2712 to the other end 2714 along right lane 2754. Thus, for example, landmark detection information obtained by vehicles 2702 and 2706 may be aggregated and/or landmark detection information obtained by vehicles 2704 and 2708 may be aggregated to generate aggregated landmark detection information based on a drivable path of road segment 2710.

As another example, the drivable path associated with the one or more vehicles may be used to determine a position of the one or more detected landmarks relative to the drivable path. For example, landmark detection information may be aggregated only corresponding to landmarks located on one side or within a predetermined distance relative to the travel path. Thus, for example, when a plurality of vehicles traverses a road segment along either a left lane or a right lane, landmark detection information obtained by the vehicles may be aggregated corresponding to landmarks that are closer to the left lane (e.g., landmarks located on the left side of the road segment).

By way of example, referring to FIG. 27A, drive information obtained by each of vehicles 2702, 2704, 2706, and/or 2708 may include landmark detection information corresponding to landmark 2722 located on the left side of roadway 2710 and landmark 2724 located on the right side of roadway 2710. Thus, landmark 2722 may be located closer to left lane 2752 as compared to landmark 2724, and similarly landmark 2724 may be located closer to right lane 2754 compared to landmark 2722. Landmark detection information corresponding to landmarks located on the left side of roadway 2710 (e.g., corresponding to landmark 2722) may be aggregated based on the drive information collected by vehicles 2702, 2704, 2706, and/or 2708. Similarly, landmark detection information corresponding to landmarks located on the right side of roadway 2710 (e.g., corresponding to landmark 2724) may be separately aggregated based on the drive information collected by vehicles 2702, 2704, 2706, and/or 2708.

In some embodiments, the method for determining one or more harvested landmarks includes identifying at least two landmark clusters based on the aggregated landmark detection information. A cluster may refer to a group of things or objects that may be located close to each other or that may be associated with common parameters, traits, or characteristics. The aggregated landmark detection information may be used to group landmarks detected by the one or more vehicles into two or more groups or clusters based on one or more criteria. Clustering may be performed using various criteria. For example, such criteria may be based on location of the detected landmark relative to a road segment or relative to a vehicle that obtained the drive information, size of the landmark, features detected in the landmark, type of the landmark and its semantic meaning or criteria based on any other traits or characteristics (e.g., color, reflectivity, landmark type) of the detected landmarks.

In some embodiments, the at least two landmark clusters are identified based on one or more regions identified in the aggregated landmark detection information. A region may refer to an area, portion, or subdivision. As discussed above, aggregated landmark detection information may include aggregated data obtained by one or more sensors of different vehicles or during different drives that traverse a road segment. For example, aggregated landmark detection information may include image data obtained by more than one vehicle that traverses a road segment or during more than one drive. As another example, aggregated landmark detection information may include radar data or lidar data obtained by more than one vehicle that traverses a road segment or during more than one drive. One or more areas, portions, or subdivisions of the combined image information may be identified or selected for additional analysis. The one or more areas, portions, or subdivisions of the combined image information may be identified based on image recognition techniques or analysis of the image, radar, and/or lidar data, indicating that the identified region includes image, radar, and/or lidar data having similar characteristics. For example, when aggregated landmark detection information includes image data, the one or more one or more areas, portions, or subdivisions may be identified based on parameters like intensity, saturation, luminosity, or other characteristics of the image data. Thus, for example, areas of the aggregated image information having maximum or average intensities that differ by more than a threshold amount may be identified as different regions corresponding to different landmark clusters. In some embodiments, regions containing one or more detected objects may be identified in the aggregated landmark detection information.

In some embodiments, the one or more regions are determined based on map information. As discussed elsewhere in this disclosure, map information may include data related to a road and potentially one or more landmarks. As also discussed, map information may include one or more three-dimensional contours that may represent predetermined trajectories that autonomous vehicles may traverse as they move along associated road segments, data representing one or more road features, recognized landmarks, road signature profiles, and any other road-related features useful in navigating a vehicle, a type of a landmark, location of landmark, position info for landmark locations, road profile locations. In some embodiments, map information may be used to identify regions in the aggregated landmark detection information. For example, the map information may indicate that an actual landmark is physically present at a particular location. A region encompassing or surrounding the particular location identified using map information may be selected based on the three-dimensional real-world coordinates associated with the data included in the aggregated landmark detection information. For example, aggregated image data may be obtained by analyzing image data obtained from different vehicles or from a same vehicle traversing a road segment multiple times. Different portions of the image data (e.g., different pixels in the aggregated image data) may be associated with different three-dimensional real-world coordinates. A region may be identified in the aggregated image data by selecting pixels that may lie within a predetermined distance from a likely location (e.g., likely three-dimensional real-world coordinates) of the landmark as determined from the map information.

By way of example, FIG. 27B illustrates a conceptual aggregation of landmark detection information based on drive information collected by a plurality of vehicles. As shown in FIG. 27B, vehicles 2702, 2704, 2706, 2708 may travel over road segment 2710 and may obtain drive information based on, for example, the data collected by the one or more sensors associated with each of vehicles 2702, 2704, 2706, and/or 2708. Due to variations in sensor capabilities, speed of the vehicle, movements of the vehicle on road segment 2710, there may be slight variations in the data, obtained by the different vehicles 2702, 2704, 2706, and/or 2708, corresponding to one or more detected landmarks. For example, as illustrated in FIG. 27B, vehicle 2702 (V1) may detect landmark 2722 and a camera associated with vehicle 2702 may capture images of landmark 2722 that may be represented by landmark 2722A (shown in solid line) in the aggregated landmark detection information. As also shown in FIG. 27B, vehicle 2704 (V2) may detect landmark 2722 and a camera associated with vehicle 2704 may capture images of landmark 2722 that may be represented by landmark 2722B (shown in dot-dash line) in the aggregated landmark detection information. Similarly, vehicle 2706 (V3) may detect landmark 2722 and a camera associated with vehicle 2706 may capture images of landmark 2722 that may be represented by landmark 2722C (shown in dash-dash line) in the aggregated landmark detection information. Although each vehicle 2702, 2704, and 2706 may detect the same landmark 2722, there may be slight variations in the images of the detected landmark 2722 captured by vehicles 2702, 2704, 2706. Thus, the aggregated landmark detection information may include images 2722A, 2722B, and 2722C each representing landmark 2722. In a similar manner, vehicles 2702 (V1), 2704 (V2), 2706 (V3), and 2708 (V4) may capture images of landmark 2724 that may be represented as landmark 2724A (solid line), landmark 2724B (dot-dash line), landmark 2724C (dash-dash line), and landmark 2724D (dot-dot-dash line) in aggregated landmark detection information.

Image analysis of the aggregated landmark information may reveal two distinct areas containing objects. For example, area or region 2762 may include detected objects 2722A, 2722B, and 2722C corresponding to landmark 2722 and area 2764 may include detected objects 2724A, 2724B, 2724C, and 2724D. Thus, image analysis may be used to define two regions 2762 and 2764 based on the aggregated landmark detection information. Further because landmark 2722 includes two objects, road sign 2721 and road sign 2722, objects 2721A, 2721B, 2721C, and objects 2723A, 2723C may be detected in region 2762. As illustrated in FIG. 27B, image information obtained from vehicle 2704 may not include information about road sign 2723 because of, for example, a high vehicle speed, an obstruction in front of an image sensor of vehicle 2706, or a malfunction in the image sensor of vehicle 2706.

In some embodiments, map information may be used to determine a location of landmark 2722 or 2724. The aggregated image information obtained based on images captured by each of vehicles 2702, 2704, 2706, and 2708 may be analyzed to detect objects that may be present in the image within a threshold distance from a location of landmark 2722 or 2724 as identified using the map information. For example, pixels in the aggregated image information correspond to locations within a threshold distance from a location of landmark 2722 as determined by the map information may be included in a region (e.g., region 2762). Likewise, for example, pixels in the aggregated image information that correspond to locations within a threshold distance from a location of landmark 2724 as determined by the map information may be included in a region (e.g., region 2764).

In some embodiments, each of the at least two landmark clusters are representative of a potential real world location of an actual landmark positioned along the road segment. An actual landmark refers to a physical landmark that may be present in the real world on or near a road segment on which the one or more vehicles travel. As discussed above, the aggregated landmark detection information may be used to group landmarks detected by the one or more vehicles into two or more groups or clusters. Each of the clusters may correspond to a physical landmark that may be present adjacent to the road segment for which drive information is obtained from the one or more vehicles. For example, as discussed above, one or more regions are identified in the aggregated landmark detection information based on image analysis that helps to detect the presence of objects such as landmarks in the aggregated landmark detection information. Alternatively, the one or more regions may be identified in the aggregated landmark detection information based on location information for an actual landmark obtained from map information. Thus, the regions identified in the aggregated landmark detection information may correspond to actual landmarks physically present adjacent to the road segment for which drive information is obtained from the one or more vehicles. In some embodiments, the one or more actual landmarks includes at least a traffic sign, a traffic light, a road marking, a pole, or a construction indicator.

By way of example, as illustrated in FIG. 27B, regions 2762 and 2764 may correspond to clusters including one or more landmarks. For example, road signs 2721 and 2723 detected in region 2762, using aggregated landmark detection information, may correspond to an actual landmark 2722, which may be a road sign physically present on one side of road segment 2710. Similarly, objects detected in region 2764, using aggregated landmark detection information, may correspond to an actual landmark 2724, which may be a road sign physically present on an opposite side of road segment 2710.

In some embodiments, the at least two landmark clusters are identified based on one or more regions identified in the aggregated landmark detection information in which an actual landmark of the one or more actual landmarks comprises features of different sizes. Features of actual landmarks may include shapes, sizes, colors, fonts, textures, and/or visual characteristics (e.g., intensity, reflectivity, luminosity) of one or more portions of the actual landmarks. Thus, features of actual landmarks may refer to any physical, dimensional, visual, or other characteristics of the actual landmarks. As discussed above, the aggregated landmark detection information may be used to group landmarks into two or more groups or clusters. In some embodiments, the clusters may be determined based on differences in feature size detected in the aggregated landmark detection information. Thus, objects detected in the aggregated landmark detection information and having a first size may be grouped in a first cluster and objects detected in the aggregated landmark detection information and having a second size different from the first size may be grouped in a second cluster. For example, as discussed elsewhere in this disclosure, one or more image processors may perform image analysis, using image processing software to detect one or more objects in an aggregated image including images obtained by one or more vehicles traversing a road segment. The image analysis may also determine the sizes of the detected objects, which may be used to group the detected objects into different clusters.

By way of example, as illustrated in FIG. 27B, aggregated landmark detection information obtained from vehicles 2702, 2704, and 2706 may include image information corresponding to landmark 2722. One or more processors (e.g., applications processor 180 and/or image processor 190) may perform image analysis to detect larger size objects such as landmark 2722 (represented as 2722A, 2722B, 2722C) in region 2762. Further, the one or more processors may detect objects of smaller size such as landmark 2724 (represented as 2724A, 2724B, 2724C, and 2724D). The one or more processors may group the larger sized objects found in region 2762 in one cluster and the relatively smaller sized objects found in region 2764 in a different cluster.

In some embodiments, the at least two landmark clusters are identified based on topology information included in the aggregated landmark detection information. Topology information may refer to data regarding positions and elevations of one or more locations. In some exemplary embodiments, the drive information obtained from the one or more vehicles during one or more drives on a road segment may include data regarding positions and or elevations of one or more objects or features surrounding the road segment. The aggregated landmark detection information derived from the drive information obtained by one or more vehicles may also include topological information (e.g., position and elevation) of one or more locations surrounding each of the vehicles as the vehicles traverse the road segment.

In some exemplary embodiments, landmark clusters may be identified in the aggregated landmark detection information based on the topological information. For example, portions of the aggregated landmark detection information corresponding to a particular range of elevations may be grouped or clustered together. By way of example, the aggregated landmark detection information may include at least two landmarks, one of which may be located at an elevation greater than the other landmark. Portions of the aggregated landmark detection information corresponding to regions associated with the higher elevation (e.g., pixels in aggregated image data corresponding to elevation greater than a threshold) may be grouped in one cluster. Similarly, portions of the aggregated landmark detection information corresponding to regions associated with the lower elevation (e.g., pixels in aggregated image data corresponding to elevation less than a threshold) may be grouped in a different cluster. In some embodiments, clustering may be performed by a trained network (e.g., a neural network). The network may be trained on actual landmarks (road signs, road marks) and ground truth information may be used to train the network to identify a cluster.

Although only two clusters are discussed, any number of clusters may be defined based on corresponding ranges of elevations. For example, in some exemplary embodiments, two elevation thresholds may be defined with a second threshold elevation being greater than a first threshold elevation. Portions of the aggregated landmark detection information corresponding to elevations less than the first elevation threshold may be grouped into a first cluster. Portions of the aggregated landmark detection information corresponding to elevations greater than the first elevation threshold and less than the second elevation threshold may be grouped into a second cluster. Additionally, portions of the aggregated landmark detection information corresponding to elevations greater than the second elevation threshold may be grouped into a third cluster.

In some embodiments, the topology information is determined based on map information. For example, as discussed elsewhere in this disclosure, map information may include data related to a road and potentially one or more landmarks. Further, the map information may include positions and corresponding elevations associated with different locations on the map. The aggregated landmark detection information generated based on drive information obtained from a plurality of vehicles (or drives) may include position information for different locations surrounding each of the vehicles as the vehicles traverse a road segment. For example, when drive information includes image information, the aggregated landmark detection information may include aggregated image information obtained from the vehicles. Pixels in the aggregated image information may have elevation information associated with them. The map information may be used to determine elevations of one or more landmarks and for defining threshold elevations based on the determined elevations of landmarks. Portions of the aggregated landmark detection information (e.g., pixels in aggregated image information) corresponding to different elevations may be grouped into different clusters in a manner similar to that described above.

By way of example, referring to FIG. 27A, landmark 2724 may be located at a higher elevation relative to the ground as compared to landmark 2724. One or more sensors of the one or more vehicles 2702, 2704, 2706, and/or 2708 may capture images of landmarks 2722 and 2724 as the one or more vehicles 2702, 2704, 2706, and/or 2708 travel on road segment 2710 from one end 2712 to an opposite end 2714 of road segment 2710. The captured images may include image information for one or more pixels representing the surrounding of the one or more vehicles 2702, 2704, 2706, and/or 2708. The image information may also include elevation data for pixels corresponding to landmarks 2722 and 2724. Aggregated landmark detection information, as illustrated in FIG. 27B, may be obtained by aggregating or combining the image information obtained by the one or more vehicles 2702, 2704, 2706, and/or 2708. An elevation threshold may be defined based on the elevations of one or more landmarks determined from the map information. For example, when landmark 2724 is at a higher elevation relative to landmark 2722, a threshold elevation may be defined that lies between the elevations of landmarks 2722 and 2724. Pixels in the aggregated landmark detection information having elevation greater than the threshold elevation (e.g., pixels in region 2764 of FIG. 27B) may be grouped into a cluster representing landmark 2724. In contrast, pixels in the aggregated landmark detection information having elevation smaller than the threshold elevation (e.g., pixels in region 2762 of FIG. 27B) may be grouped into a cluster representing landmark 2722.

In some embodiments, the at least two landmark clusters are identified based on orientation information included in the aggregated landmark detection information. Orientation information may refer to information indicating or associated with an arrangement, alignment, or direction of one or more features of a landmark. As discussed above, the aggregated landmark detection information may be used to group landmarks detected by the one or more vehicles into two or more groups or clusters. The aggregated landmark detection information may include data indicating an arrangement, alignment, or direction of one or more features of objects detected in the aggregated landmark detection information. For example, aggregated landmark detection information may include image data obtained via imaging devices, radar, and/or lidar associated with one or more vehicles that traverse a road segment. Image analysis of the aggregated landmark detection information may be used to detect one or more objects. The image analysis may also detect one or more features such as edges or one or more other shapes and an arrangement, alignment, or direction of the detected shapes. Portions of the aggregated image may be included in a particular group or cluster based on the detected arrangement, alignment, or direction of one or more features of the objects identified in the aggregated landmark detection information.

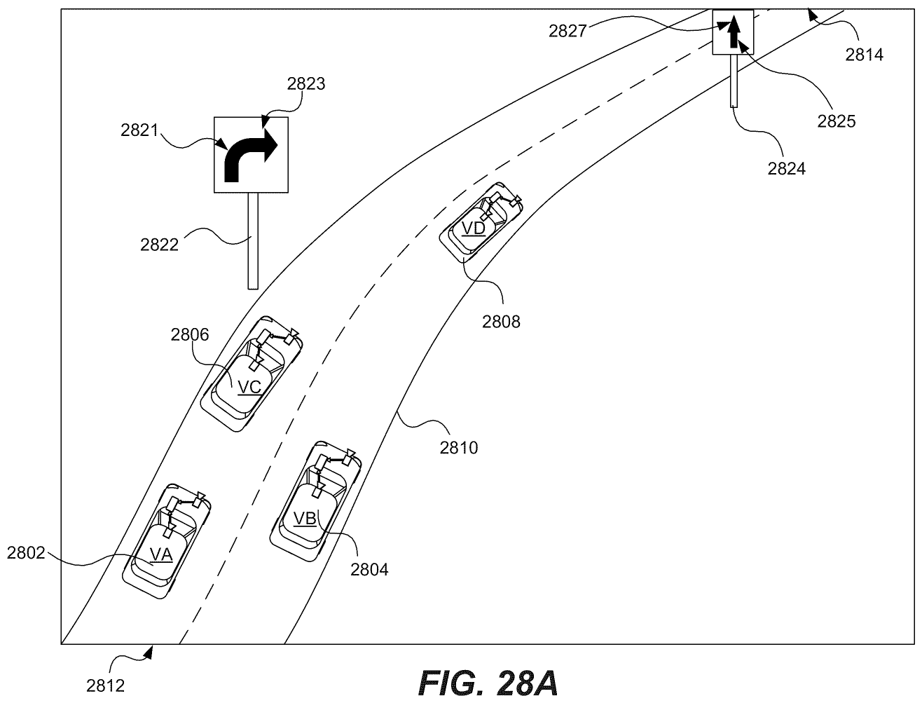

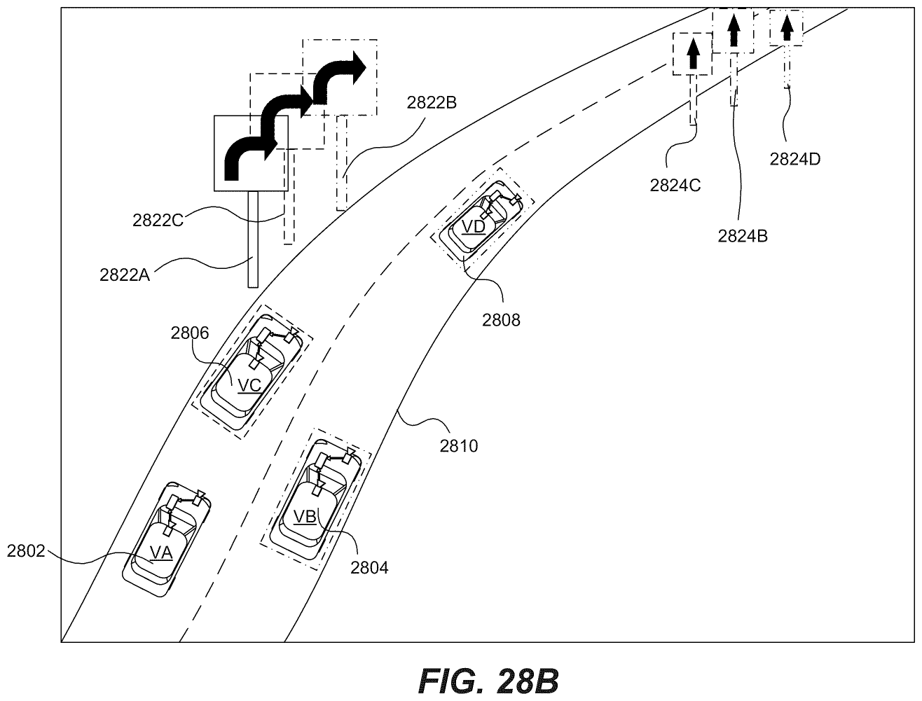

By way of example, FIG. 28A illustrates a schematic showing a plurality of vehicles traversing a road segment 2810. As shown in FIG. 28A, vehicles 2802, 2804, 2806, 2808 may travel over road segment 2810 that may extend from one end 2812 to an opposing end 2814. Vehicles 2802, 2804, 2806, and/or 2808 may be similar to vehicles 200, and may include one or more sensors similar to those of vehicle 200. As also illustrated in FIG. 28A, road segment 2810 may include landmarks 2822 and 2824 (including arrow 2827) that are road signs. As illustrated in FIG. 28A, landmark 2822 may have an arrow feature 2821 that includes an arrowhead 2823 pointing towards a right side (relative to a direction of travel of vehicles 2802, 2804, 2806, and/or 2808) and landmark 2824 may have an arrow feature 2825 that includes an arrowhead 2827 pointing upwards at right angles to the arrowhead of landmark 2822. Thus, the arrowheads in landmarks 2822 and 2824 may be arranged in different orientations. Sensors on the one or more vehicles 2802, 2804, 2806, 2808 may obtain drive information as vehicles (e.g., 2802, 2804, 2806, 2808) traverse over road segment 2810 from one end 2812 to opposing end 2814. As further illustrated in FIG. 28A, each of vehicles 2802, 2804, 2806, 2808 may have an identifier. For example, vehicle 2802 may have a drive identifier VA, vehicle 2804 may have a drive identifier VB, vehicle 2806 may have a drive identifier VC, and vehicle 2808 may have a drive identifier VD. Drive identifiers VA, VB, VC, and VD may be included in the drive information obtained by vehicles 2802, 2804, 2806, 2808, respectively.

FIG. 28B illustrates a conceptual aggregation of landmark detection information based on drive information collected by the plurality of vehicles 2802, 2804, 2806, 2808. As shown in FIG. 28B, vehicles 2802, 2804, 2806, 2808 may travel over road segment 2810 and may obtain drive information based on, for example, the data collected by the one or more sensors associated with each of vehicles 2802, 2804, 2806, and/or 2808. Due to variations in sensor capabilities, speed of the vehicle, movements of the vehicle on road segment 2810, there may be slight variations in the data, obtained by the different vehicles 2802, 2804, 2806, and/or 2808, corresponding to one or more detected landmarks. For example, as illustrated in FIG. 28B, vehicle 2802 (VA) may detect landmark 2822 and a camera associated with vehicle 2802 may capture images representing landmark 2822 in a position corresponding to 2822A (shown in solid line). As also shown in FIG. 28B, vehicle 2804 (VB) may detect landmark 2822 and a camera associated with vehicle 2804 may capture images representing landmark 2822 in a position corresponding to 2822B (shown in dot-dash line). Similarly, vehicle 2806 (VC) may detect landmark 2822 and a camera associated with vehicle 2806 may capture images representing landmark 2822 in a position corresponding to 2822C (shown in dash-dash line). Although each vehicle 2802, 2804, 2806 may detect the same landmark 2822, there may be slight variations in the images of the detected landmark 2822 captured by vehicles 2802, 2804, and 2806. In a similar manner, vehicles 2802 (VA), 2806 (VC), and 2808 (VD) may detect landmark 2824 as 2824B (shown in dot-dash line), 2824C (shown in dash-dash line), and 2824D (shown in dot-dot-dash line) in the images captured by imaging devices associated with vehicles 2804, 2806, and 2808, respectively. The aggregated landmark detection information corresponding to landmarks 2822 and 2824 may include the image information obtained imaging devices associated with vehicles 2802, 2804, 2806, and 2808.

Image analysis of the aggregated image obtained from vehicles 2802, 2804, 2806, and 2808 may identify objects 2822A, 2822B, 2822C, and objects 2824B, 2824C, and 2824D. Further, the image analysis may detect the presence of arrowhead 2823 in identified objects 2822A, 2822B, 2822C, and the presence of arrowhead 2827 in identified objects 2824B, 2824C, and 2824D. Image analysis may also determine that arrowhead 2823 in identified objects 2822A, 2822B, 2822C is oriented in a different direction than arrowhead 2823 in identified objects 2824B, 2824C, and 2824D. Accordingly, identified objects 2822A, 2822B, 2822C may be grouped in a first cluster of landmarks and identified objects 2824B, 2824C, 2824D may be grouped in a second cluster of landmarks based on the orientation of arrowheads 2823 and 2827, respectively.

In some embodiments, the at least two landmark clusters are identified based on a partial least squares (PLS) analysis of the aggregated landmark detection information.

In some embodiments, the method for determining one or more harvested landmarks includes determining, based on the drive identifier associated with the drive information received from each of the plurality of vehicles, a distribution of drive identifiers relative to the at least two landmark clusters. As discussed elsewhere in this disclosure, drive information obtained by a vehicle may include a drive identifier corresponding to a drive of a particular vehicle along a road segment. As also discussed above, drive information from a plurality of vehicles may be aggregated to generate aggregated landmark detection information, which may also include the drive identifier associated with various data included in the aggregated landmark detection information. As further discussed above, the aggregated landmark detection information may be used to identify at least two landmark clusters. Because the aggregated landmark detection information includes drive identifier information, it is possible to determine the drive identifiers associated with each of the landmark clusters. That is, it may be possible to determine which of the vehicles (and the drive identifiers) provided the drive information corresponding to objects in a particular cluster. The set of drive identifiers may represent the distribution of drive identifiers relative to each cluster.

By way of example, referring to FIG. 27B, a first cluster (e.g., in region 2762) may include objects 2722A (shown in solid line), 2722B (shown in dot-dash line), and 2722C shown in dash-dash line) detected based on drive information obtained from vehicles 2702, 2704, and 2706, respectively. Thus, drive identifiers V1, V2, and V3 corresponding to vehicles 2702, 2704, and 2706, respectively, may be associated with the cluster in region 2762. Moreover, because landmark 2722 includes two road signs 2721 and 2723, as illustrated in FIG. 27B, drive identifiers V1, V2, and V3 may be associated with objects 2721A, 2721B, and 2721C corresponding to road sign 2721. However, only drive identifiers V2 and V3 may be associated with objects 2723B and 2723C corresponding to road sign 2723. In contrast, a second cluster (e.g., in region 2764) may include objects 2724A, 2724B, 2724C, and 2724D detected by vehicles 2702, 2704, 2706, and 2708, respectively, and corresponding to landmark 2724. Thus, drive identifiers V1, V2, V3, and V4 may be associated with objects 2724A, 2724B, 2724C, and 2724D corresponding to landmark 2724.

By way of another example, referring to FIG. 28B, a first cluster may include objects (2822A, 2822B, and 2822C) detected based on drive information obtained from vehicles 2802 (e.g., 2822A shown in solid line), 2804 (e.g., 2822B shown in dot-dash line), and 2806 (e.g., 2822C shown in dashed line). Thus, drive identifiers VA, VB, and VC corresponding to vehicles 2802, 2804, and 2806, respectively, may be associated with the cluster of landmarks 2822A, 2822B, and 2822C. In contrast, a second cluster may include objects (e.g., 2824B, 2824C, and 2824D) detected based on drive information obtained from vehicle 2804 (e.g., 2824B shown in dot-dash line), vehicle 2806 (e.g., 2824C shown in dashed line), and vehicle 2808 (e.g., shown in dot-dot-dash line). Thus, drive identifiers VB, VC, and VD corresponding to vehicles 2804, 2806, and 2808, respectively, may be associated with the cluster of landmarks 2824B, 2824C, and 2824D.

In some embodiments, the method for determining one or more harvested landmarks includes determining a location identifier for one or more actual landmarks positioned along the road segment based on the distribution of drive identifiers. A location identifier may include three-dimensional real-world coordinates for the one or more actual landmark similar to the location identifiers for points discussed elsewhere in this disclosure. As also discussed elsewhere in this disclosure, the location identifier for a landmark may be represented as absolute coordinates (e.g., latitude/longitude coordinates), or may be relative to other features, such as based on a longitudinal position along a target trajectory or a drivable path and a lateral distance from the target trajectory or the drivable path.

As discussed above, drive information obtained from vehicles traversing a road segment may include position information for the vehicle as well as position information for locations surrounding the vehicles. For example, the obtained drive information may include image data for locations surrounding the vehicles. The image data, in turn, may include position information, for example, for the pixels representing the locations surrounding the vehicles. The position information included in the image data may be determined relative to a coordinate system of the vehicle. As also discussed above, drive identifiers may be determined corresponding to a cluster of objects detected using the aggregated landmark detection information. In some embodiments, for example, the aggregated landmark detection information may include image data obtained from the vehicles. Thus, based on the position information associated with pixels in the image data, it may be possible to extract position information for an actual landmark relative to a particular vehicle, which detected the actual landmark. The extracted position information together with position information of the vehicle may be used to determine the location information (e.g., location identifier in three-dimensional real-world coordinates) of the detected actual landmark. The location information of the actual landmark may be determined using drive information obtained from a plurality of vehicles that may have detected that landmark. Location information derived from drive information of different vehicles may be averaged or combined in any other statistical manner (e.g., by determining a median, a mode, or any other statistical variable) to determine a more precise location identifier (e.g., three-dimensional real-world coordinates) for the actual landmark.

By way of example, as illustrated in FIG. 27B, objects 2721A, 2721B, and 2721C may be detected in region 2762 in aggregated sensor (e.g., image) data obtained by aggregating the drive information obtained from vehicles 2702, 2704, and 2706. Thus, drive identifiers V1 (for vehicle 2702), V2 (for vehicle 2704), and V3 (for vehicle 2706) may be included in a distribution of drive identifiers associated with objects 2721A, 2721B, and 2721C detected in region 2762. Drive information obtained from each of vehicles 2702, 2704, and 2706 may include position information of the vehicle and position information of various locations surrounding the vehicle. For example, drive information obtained from vehicle 2702 may include an image of the vehicle surroundings, and position information for each of the pixels in the image relative to vehicle 2702 at the time the image was captured. Similar information may be included in the drive information obtained from any of vehicles 2702, 2704, and 2706. The aggregated landmark detection information may include the image information including the position information from each of the three vehicles 2702, 2704, 2706. Once a drive identifier V1 is associated with a cluster of objects (e.g., 2721A, 2721B, and 2721C), a position of landmark 2721A may be determined based on the position information included in the aggregated landmark detection information and obtained from the drive information obtained from vehicle 2702 corresponding to drive identifier V1. Thus, location information (e.g., three-dimensional real-world coordinates) of an actual landmark 2721 may be determined based on drive identifier V1. Location information (e.g., three-dimensional real-world coordinates) of the actual landmark 2721 may be determined in a similar manner based on drive identifiers V2 and V3 that may be associated with the cluster of objects (e.g., 2721A, 2721B, and 2721C). As previously discussed, although the same landmark 2721 is detected by each vehicle 2702, 2704, 2706, the image information obtained from the three vehicles may have variations. The location information determined using the three identifiers V1, V2, V3 may be averaged or may be combined using any other statistical parameter to determine a more precise location for the actual landmark 2721 to mitigate the effect of the variations observed in the image information received from vehicles 2702, 2704, and 2706.

In some embodiments, the method for determining one or more harvested landmarks includes storing the location identifier for the one or more actual landmarks in a map. The location identifiers (e.g., three-dimensional real-world coordinates) corresponding to the one or more actual landmarks may be stored in a sparse map in a manner similar to storing location identifiers of points corresponding to lane marks as discussed elsewhere in this disclosure. In some embodiments, the method for determining one or more harvested landmarks includes distributing the map to one or more autonomous vehicles for use in navigating along the road segment. The updated map may be distributed to one or more autonomous vehicle as discussed elsewhere in this disclosure. Further, one or more autonomous vehicles may use the distributed map for navigating along a road segment as discussed elsewhere in this disclosure.

In some embodiments, navigating along the road segment comprises determining at least one navigational response based on the location identifier for the one or more actual landmarks. A navigational response may be understood as discussed elsewhere in this disclosure. In some embodiments, the at least one navigational response includes at least one of steering, braking, or accelerating the one or more autonomous vehicles. As discussed above, a location identifier for the one or more actual landmarks may include three-dimensional real-world coordinates for the one or more actual landmark. As also discussed above, each vehicle may include a position sensor to determine a position of the vehicle. The location identifier of the one or more landmarks and the position information of a vehicle may be used to determine a position of the vehicle on the road segment. One or more navigational responses such as steering, braking, or acceleration may be used to localize or orient the vehicle on the roadway based on the determined position of the vehicle on the road segment.

By way of example, the aggregated landmark detection information as depicted in FIG. 27B may be used to determine a location identifier (e.g., three-dimensional real-world coordinates) for landmark 2721 in FIG. 27A using techniques discussed above. As also discussed above, vehicle 2702 may include position sensor 130 that may provide a position (e.g., three-dimensional real-world coordinates) for vehicle 2702. Furthermore, positions (e.g., three-dimensional real-world coordinates) for edges of road segment 2710 and of lanes 2752 and 2754 may be determined using map information. Processing unit 110 of vehicle 2702 may use this position information to determine a location of vehicle 2702 relative to the edges of road segment 2710 and of lanes 2752 and 2754 and relative to landmark 2721. Based on the determined vehicle location, processing unit 110 may cause steering, braking, and/or acceleration of vehicle 2702 to locate vehicle 2702 within, for example, lane 2752 or 2754. Thus, processing unit 110 may determine at least one navigational response based on the location identifier for landmark 2721.

In some embodiments, a count of the one or more actual landmarks positioned along the road segment for one of the at least two landmark clusters is equal to one when a same drive identifier is not included in the distribution of the drive identifiers for the one of the at least two landmark clusters. In some embodiments, a count of the one or more actual landmarks positioned along the road segment for one of the at least two landmark clusters is greater than one when a same drive identifier is included in the distribution of the drive identifiers for the one of the at least two landmark clusters. As discussed above, a set of drive identifiers corresponding to each landmark cluster may be determined using the aggregated landmark detection information. When a particular landmark cluster includes multiple objects, the same drive identifier may be associated with more than one object in the cluster. The presence of more than one instances of a particular drive identifier may indicate the presence of more than one object. Thus, the count of one or more actual landmarks positioned along the road segment may be greater than 1. On the other hand, when a particular landmark cluster includes only one object, a particular drive identifier may be associated once with that object in that cluster. The occurrence of only one instance of a particular drive identifier in a cluster may indicate that that particular landmark cluster includes only one object. Thus, the count of one or more actual landmarks positioned along the road segment may be greater than 1.

By way of example, referring to FIG. 27B, drive identifiers V1, V2, and V3 may be determined as corresponding to objects 2721A, 2721B, and 2721C that may each represent road sign 2721 in a cluster of objects in region 2762. Further, drive identifiers V1 and V3 may be determined as corresponding to objects 2723A and 2723C that may each represent road sign 2723 in the cluster of objects in region 2762. Thus, each of drive identifiers V1 and V3 may be included twice in the collection of drive identifiers associated with the landmark cluster in region 2762. Because at least one of the drive identifiers V1 or V3 is included more than once, the landmark cluster associated with region 2762 may be determined as including two actual landmarks, namely the two road signs 2721 and 2723.

In contrast, drive identifiers V1, V2, V3, and V4 may be determined as corresponding to objects 2724A, 2724B, 2724C, and 2724D, respectively, that may each represent landmark 2724 in a cluster of objects in region 2762. Because none of the drive identifiers V1, V2, V3, or V4 is included more than once relative to the landmark cluster associated with region 2762, that cluster may be determined as including only one actual landmark, namely landmark 2724.

Some embodiments include a system for determining one or more harvested landmarks. For example, the method of determining one or more harvested landmarks may be performed by a system similar to system 100 as discussed elsewhere in this disclosure. As discussed previously, system 100 may be included in one or more of vehicles 200 (or 2702, 2704, 2706, 2708, 2802, 2804, 2806, 2808). One or more sensors (e.g., imaging devices 122, 124, 126), position sensor 130, lidar or radar sensors, or other sensors associated with vehicles 200 (or 2702, 2704, 2706, 2708, 2802, 2804, 2806, 2808) may obtain drive information as the one or more vehicles traverse a road segment. In some embodiments, the system includes a memory comprising instructions. Some embodiments include non-transitory computer-readable media storing instructions that, when executed by at least one processor may perform the methods for determining the one or more landmarks as discussed above. In some embodiments, the system includes at least one processor comprising circuitry and configured to execute the instructions in the memory. For example, system 100 includes memory 140 or 150 that may include instructions for execution by processing unit 110 (e.g., image processor 190 and/or application processor 180). As one example, image processor 190 may aggregate landmark detection information included in the drive information and may identify at least two landmark clusters as discussed elsewhere in this disclosure. One or both of application processor 180 and image processor 190 may determine a distribution of drive identifiers relative to the identified landmark clusters as discussed above. One or both of application processor 180 and image processor 190 may also determine a location identifier for one or more actual landmarks based on the distribution of drive identifiers. The determined location identifiers may be stored in a map in map database 160. One or both of application processor 180 and image processor 190 may transmit the map from map database 160 via wireless transceiver 172 to one or more vehicles 200, and vehicles 200 may navigate along a road segment using the map as discussed elsewhere in this disclosure.

In some embodiments, a method for determining one or more harvested landmarks may include obtaining drive information captured during drives by a plurality of vehicles traversing or having traversed a road segment. The drive information for each of the plurality of vehicles may comprise landmark detection information corresponding to one or more landmark detections. The method may include aggregating the landmark detection information included in the obtained drive information from the plurality of vehicles, and based on the aggregated landmark detection information, identifying at least two landmark clusters. Each of the at least two landmark clusters may be representative of a potential real world location of an actual landmark positioned along the road segment. The method may further include determining a location identifier for one or more actual landmarks positioned along the road segment. The method may further include storing the location identifier for the one or more actual landmarks in a map. The method may further include distributing the map to one or more autonomous vehicles for use in navigating along the road segment. The navigating may include determining at least one navigational response based on the location identifier for the one or more actual landmarks.

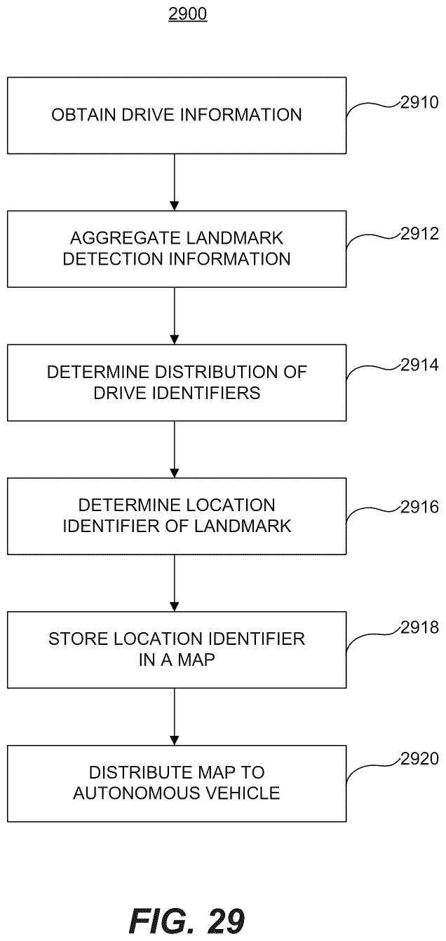

FIG. 29 is a flowchart showing an exemplary process 2900 for determining one or more harvested landmarks, consistent with the disclosed embodiments. Process 2900 may be performed by at least one processing device, such as processing unit 110 and/or 2020, as described above, or any other processing device. It is to be understood that throughout the present disclosure, the term “processor” is used as a shorthand for “at least one processor.” In other words, a processor may include one or more structures that perform logic operations whether such structures are collocated, connected, or dispersed. In some embodiments, a non-transitory computer readable medium may contain instructions that when executed by a processor cause the processor to perform process 2900. Further, process 2900 is not necessarily limited to the steps shown in FIG. 29, and any steps or processes of the various embodiments described throughout the present disclosure may also be included in process 2900.

At step 2910, process 2900 may include obtaining drive information captured during drives by a plurality of vehicles traversing or having traversed a road segment and/or during a plurality of drives along the road segment. Receiving two or more location identifiers associated with a detected lane mark. For example, as discussed above, one or more sensors (e.g., imaging devices 122, 124, 126), position sensor 130, lidar or radar sensors, or other sensors associated with vehicles 200 (or 2702, 2704, 2706, 2708, 2802, 2804, 2806, 2808) may obtain drive information as the one or more vehicles traverse a road segment (e.g., 2710, 2810). In some exemplary embodiments, the drive information for each of the plurality of vehicles comprises a drive identifier or a drive identifier and landmark detection information corresponding to one or more landmark detections, as discussed above.

At step 2912, process 2900 may include aggregating the landmark detection information included in the obtained drive information from the plurality of vehicles. For example, as discussed above, processing unit 110 may aggregate the landmark detection information included in the drive information obtained from one or more of vehicles 200 (or 2702, 2704, 2706, 2708, 2802, 2804, 2806, 2808). Further, processing unit 110 may identify at least two landmark clusters, each of the at least two landmark clusters being representative of a potential real world location of an actual landmark positioned along the road segment as discussed above.

At step 2914, process 2900 may include determining, based on the vehicle or drive identifier associated with the drive information received from each of the plurality of vehicles, a distribution of drive identifiers relative to the at least two landmark clusters. For example, processing unit 110 may determine a distribution of vehicle or drive identifiers relative to the identified landmark clusters as discussed above.

At step 2916, process 2900 may include determining, based on the distribution of vehicle or drive identifiers, a location identifier for one or more actual landmarks positioned along the road segment. For example, processing unit 110 may determine a location identifier for one or more actual landmarks positioned along the road segment based on the distribution of vehicle or drive identifiers as discussed above.

At step 2918, process 2900 may include storing the location identifier for the one or more actual landmarks in a map. For example, processing unit 110 may store the location identifier in a map which may be stored in map database 160. At step 2920, process 2900 may include distributing the map to one or more autonomous vehicles for use in navigating along the road segment, where the navigating comprises determining at least one navigational response based on the location identifier for the one or more actual landmarks. For example, processing unit 110 may transmit the map from map database 160 via wireless transceiver 172 to one or more vehicles 200, and vehicles 200 may navigate along a road segment using the map as discussed elsewhere in this disclosure.

### Landmark Existence Over Time

As discussed herein, systems, including those for autonomous vehicles or semi-autonomous vehicles, may detect, or fail to detect, landmarks (e.g., signs) in driving environments. Multiple reports from multiple vehicles can be received at a mapping server. Over time, this information may be aggregated and analyzed to determine whether a sign has been intentionally removed, such that vehicles should no longer abide by its information. Many conventional systems, however, lack the ability to distinguish between signs that are undetected or unintentionally not visible (e.g., obscured, mis-detected, etc.) and signs that are intentionally removed. Without these capabilities, systems may be unable to provide up-to-date navigational information so that vehicles (e.g., autonomously or semi-autonomously) may safely and reliably navigate. Hence, a need exists for systems and methods that accurately identify and maintain sign information for vehicle navigation, even when signs are detected by or are not visible to a vehicle.

To address these and other issues, landmark information may be captured and analyzed over time. This information may be captured by one or more vehicles, for example, as they travel along one or more roadways positioned near (e.g., within camera-vision distance of) one or more signs.

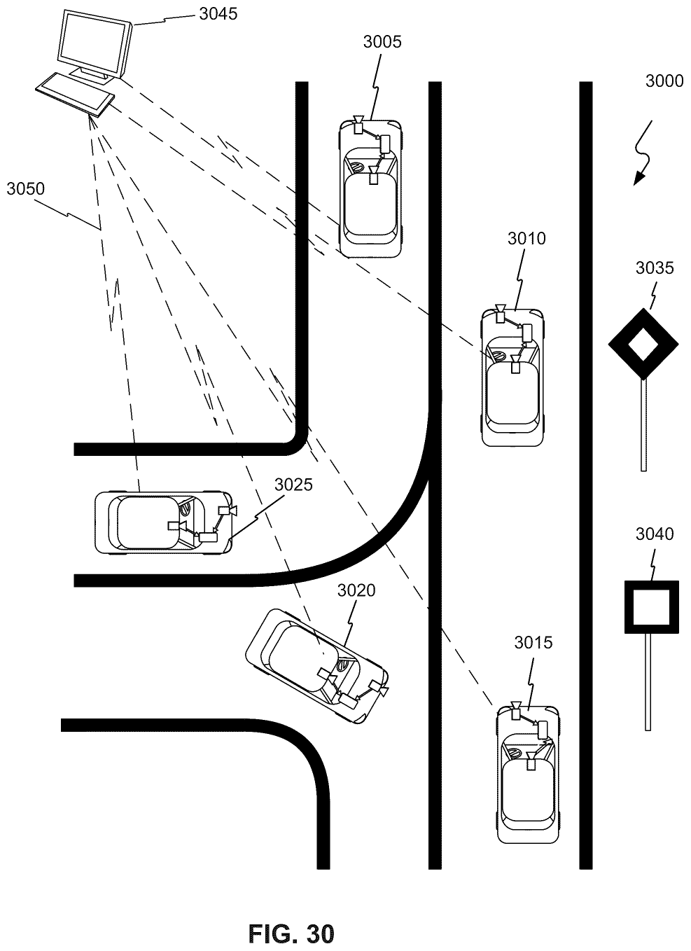

FIG. 30 depicts a schematic illustration of a system that uses crowd sourcing sign information received from a plurality of vehicles for autonomous vehicle navigation, consistent with the disclosed embodiments. FIG. 30 shows a road segment 3000 that includes one or more lanes, and road segment 300 is shown as a “T” intersection. Any combination or format of a road segment is contemplated (e.g., a road segment without an intersection, a road segment bordered by curbs, a road segment bordered by guardrails, a road segment connecting to an exit ramp, a road segment with a dead end, a road segment with closed portions, a raised road segment, a road segment through a tunnel, etc.) A plurality of vehicles 3005, 3010, 3015, 3020, and 3025 may travel on road segment 3000 at the same time or at different times (although shown as appearing on road segment 3000 at the same time in FIG. 30). At least one of vehicles 3005, 3010, 3015, 3020, and 3025 may be an autonomous vehicle. For the present example, vehicles 3005, 3010, 3015, 3020, and 3025 are presumed to be autonomous vehicles. Each vehicle may be similar to vehicles disclosed in other embodiments (e.g., vehicle 200), and may include components or devices included in or associated with vehicles disclosed in other embodiments.

As a vehicle (e.g., vehicle 3015) travels along road segment 3000, it may pass by a sign, such as sign 3035 and/or sign 3040. While signs are discussed with respect to FIG. 30, it is appreciated that any type of landmark may also be present, in addition to, or instead of, a sign 3035 or sign 3040. While only two signs are shown in FIG. 30, any number of signs may exist near (e.g., adjacent to) a road segment. In some embodiments, a vehicle (e.g., vehicle 3015) may pass near a sign (e.g., within a distance at which a camera of the vehicle is in visual range of the sign), but may or may not pass by the sign (e.g., when the vehicle makes a turn). When passing by or near a sign (e.g., within a predetermined distance of, within a detection range of, within a visual range of, within a camera range of), a vehicle may capture one or more images of the sign and/or surroundings of the sign. For example, when vehicle 3015 approaches sign 3040, it may capture one or more images of it.

Vehicles (e.g., vehicles 3005, 3010, 3015, 3020, and 3025) may transmit sign information (e.g., images of one or more signs, or non-image information identifying the sign, including for example, the type of the sign, its location, dimensions of the sign, data associated with its orientation, etc.). Each vehicle (e.g., each of vehicles 3005, 3010, 3015, 3020, and 3025) may communicate with a remote server 3045 (or other device or system) via one or more networks (e.g., over a cellular network and/or the Internet, etc.) through wireless communication paths 3050, as indicated by the dashed lines. Remote server 3045 may aggregate, analyze, and/or use information received from one or more vehicles. For example, remote server 3045 may perform all or part of process 3200, described below. Remote server 3045 may share any characteristic from remote server 1230, and wireless communication paths 3050 may share any characteristic from wireless communication paths 1235.

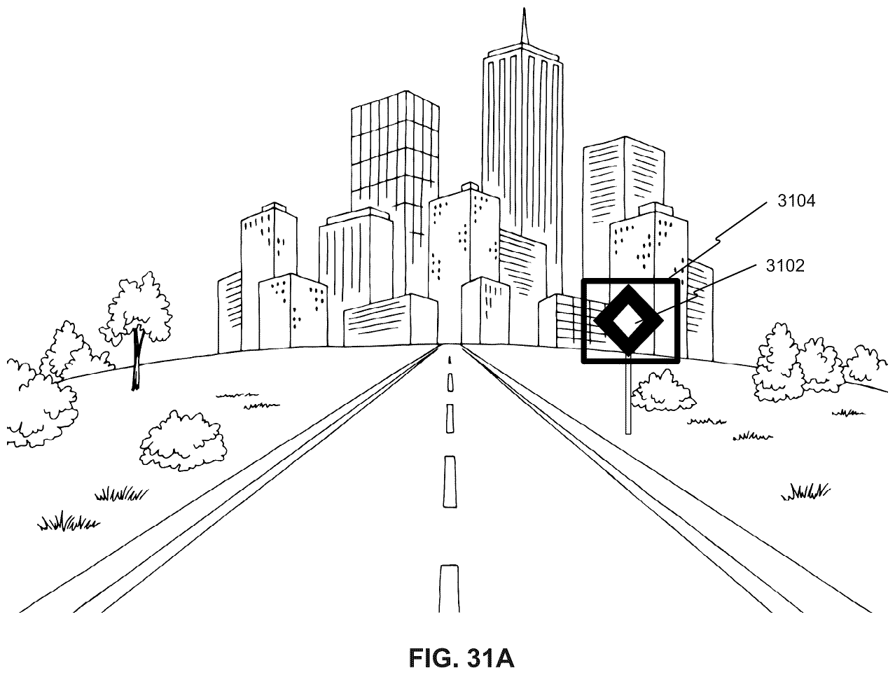

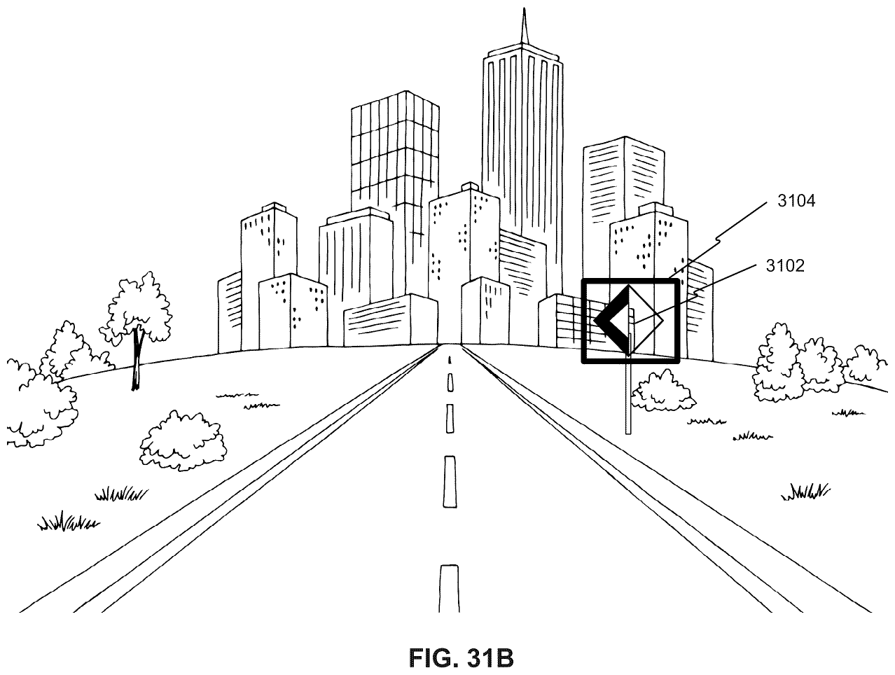

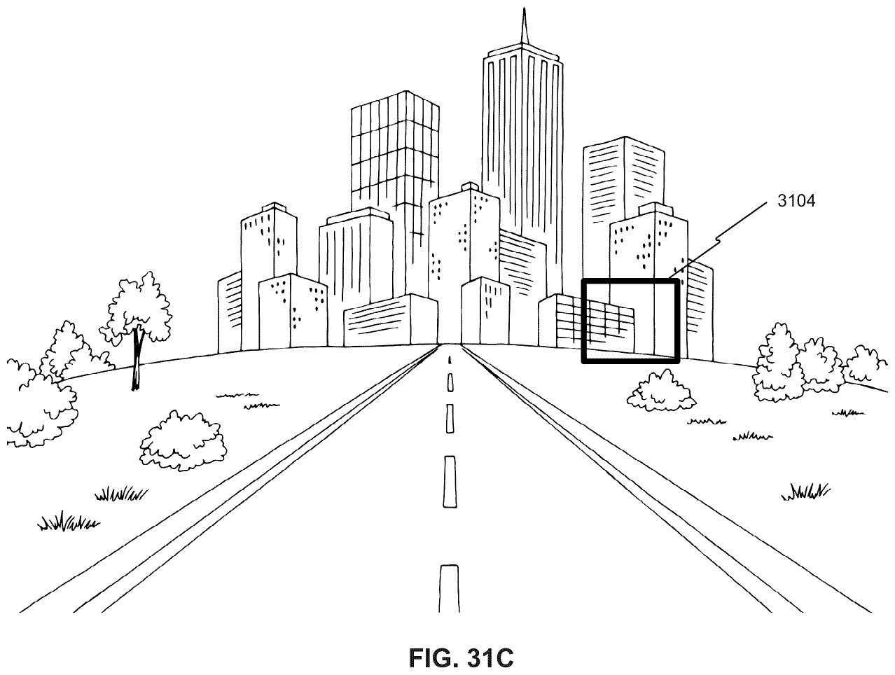

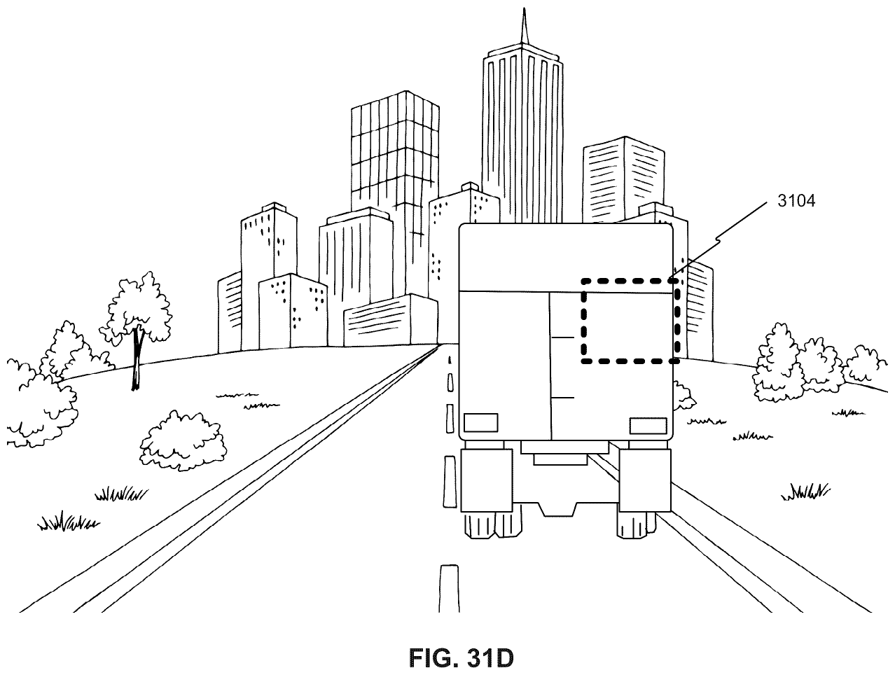

FIGS. 31A, 31B, 31C, and 31D depict sign environment images in which sign information may or may not be detectable. FIG. 31A depicts an image (e.g., captured by a camera of a vehicle) showing a roadway with adjacent areas, with a sign 3102 being present in an area to the right of the roadway. While signs are discussed with respect to FIGS. 31A-31D, it is appreciated that any type of landmark may also be present, in addition to, or instead of, a sign 3102 (e.g., a banner, a flag, painted surface such as a lane marking, road marking, or a painted wall, or any object). As shown in FIG. 31A, sign 3102 is in a visible condition (e.g., fully visible condition, fully detectable condition), such that it (or an indicator of it, consistent with disclosed embodiments) may be detected to exist within a region 3104. While shown as a two-dimensional box in FIG. 31A, region 3104 may be represented as a two-dimensional area or a three-dimensional area. Region 3104 may be represented within an image and/or within map information. In some embodiments, region 3104 may be associated with position information (e.g., associated with a sign), such as at least one of coordinates (e.g., GPS coordinates), coordinates relative to a map (e.g., coordinates according to a coordinate system of a map), or a distance to (e.g., to a nearest point of, from one or more edges of the sign) a representation (e.g., line, spline, point) in a map (e.g., distance to a drivable path, such as a 3D spline representing a path taken by one or more vehicles, distance to a curb, distance to a road barrier, distance to a lane, distance to landmark, distance to a lane marking, etc.). In some embodiments, according to the environment shown in FIG. 31A, sign 3102 may be captured by a camera of a vehicle and represented in a resulting image, and may be detectable through analysis of such image (e.g., a processor onboard the host vehicle or by a remote server). Additionally, information indicated by the sign may also be detectable (e.g., a speed limit, a road condition, a road shape, a road connection, an intersection, a building identifier, a caution indicator, a pedestrian indicator, a road type indicator, a distance indicator, a town name, etc.). Sign 3102 may be associated with a particular status or indication (e.g., present, visible, detected, not detected), consistent with disclosed embodiments.

FIG. 31B depicts an image where sign 3102 is in a damaged and/or partially visible condition. Sign 3102 may still be present in region 3104. In some embodiments, according to the environment shown in FIG. 31B, sign 3102 (i.e., in its damaged or partially visible state) may be captured by a camera of a vehicle and represented in a resulting image, and may or may not be detectable (or an indicator of sign 3102 may or may not be detectable, consistent with disclosed embodiments) through analysis of such image (e.g., by the host vehicle or by a server). In some embodiments, sign 3102 may be detectable as present, but information indicated by the sign may not be detectable. Sign 3102 may be associated with a particular status or indication (e.g., a damaged and/or present landmark, a partially visible landmark), consistent with disclosed embodiments.

FIG. 31C depicts an image where sign 3102 is not present (e.g., is missing, has been removed, is not detected). In some embodiments, according to the environment shown in FIG. 31C, sign 3102 (or an indicator of it, consistent with disclosed embodiments) may not be captured by a camera of a vehicle and represented in a resulting image, and may not be detectable (or an indicator of it may not be detectable, consistent with disclosed embodiments) through analysis of such image (e.g., by the host vehicle or by a server). Sign 3102 may be associated with a particular status or indication (e.g., a removed landmark, a missing landmark, a partially visible landmark), consistent with disclosed embodiments. In some embodiments, a partially visible landmark which is not eligible for detection and/or analysis (its semantic meaning cannot be confidently ascertained) can be considered a missing landmark or a special designation can be provided in such circumstances.

FIG. 31D depicts an image where sign 3102 is obscured by a vehicle. Region 3104 may still be present, though a device analyzing the image of FIG. 31D may detect that region 3104 exists behind an obscuring object (as depicted in FIG. 31D in the form of a dashed line), and therefore a presence or absence of sign 3102 cannot be determined. In some embodiments, according to the environment shown in FIG. 31C, sign 3102 (or an indicator of it, consistent with disclosed embodiments) may not be captured by a camera of a vehicle and represented in a resulting image, and may not be detectable (or an indicator of it may not be detectable, consistent with disclosed embodiments) through analysis of such image (e.g., by a host vehicle or by a server). Sign 3102 may be associated with a particular status or indication (e.g., an obscured landmark), consistent with disclosed embodiments. While FIG. 31D depicts sign 3102 as obscured by a vehicle, it is appreciated that sign 3102 may be obscured by any type of object, such as a construction barrier, another sign, vegetation (e.g., overgrowth), debris, and/or weather elements (e.g., rainwater). Additionally or alternatively, a sign may be not visible or not detectable due to environmental or ambient conditions, such as glaring or other lighting conditions. Additionally or alternatively, sign 3102 may be obscured by material affecting the lens of a camera of a vehicle. For example, dirt, mud, water, dust, debris, or any other disruptive material may be present on the lens of a camera of a vehicle.

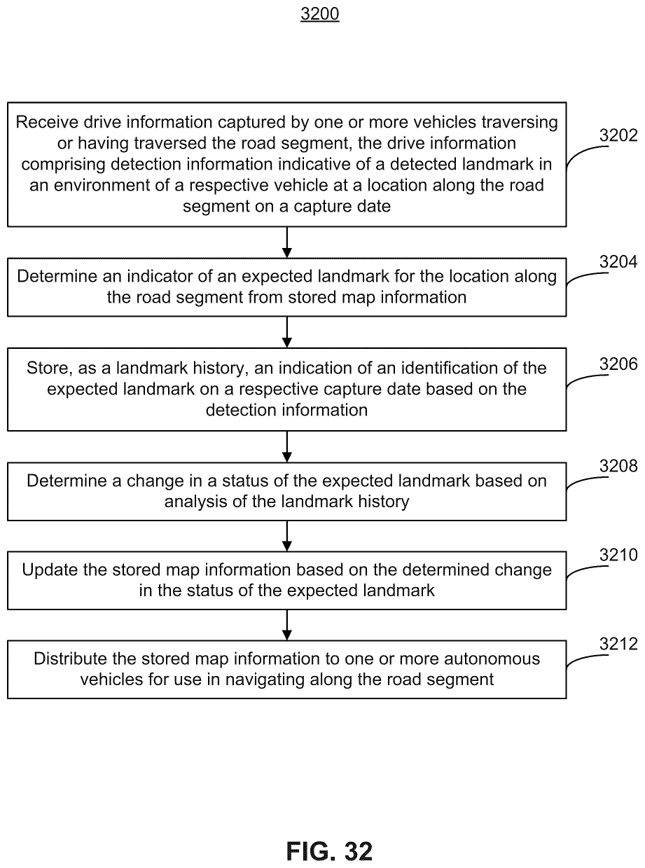

FIG. 32 is a flowchart showing an exemplary process 3200 for using landmark indicators to enhance map information. Process 3200 may be performed by at least one processing device, such as processing unit 110 and/or 2020, as described above, or any other processing device. It is to be understood that throughout the present disclosure, the term “processor” is used as a shorthand for “at least one processor.” In other words, a processor may include one or more structures that perform logic operations whether such structures are collocated, connected, or dispersed. In some embodiments, a non-transitory computer readable medium may contain instructions that when executed by a processor cause the processor to perform process 3200. Further, process 3200 is not necessarily limited to the steps shown in FIG. 32, and any steps or processes of the various embodiments described throughout the present disclosure may also be included in process 3200.

At step 3202, process 3200 may include receiving drive information captured by one or more vehicles traversing or having traversed the road segment. Drive information may include one or more images, radar detections, lidar information such as one or more depth maps, location information (e.g., a location indication of the vehicle and/or of an object in an environment of the vehicle), or any data indicating a trait of an object or parameter of an environment of a vehicle. In some embodiments, drive information may be captured as a vehicle (e.g., an autonomous vehicle) is traversing along a road segment (e.g., while the vehicle is simultaneously autonomously navigating). Drive information may be received as a vehicle (e.g., an autonomous vehicle) is traversing along a road segment. Additionally or alternatively, drive information may be received after the vehicle has traversed a road segment (e.g., after the vehicle has finished a trip, after the vehicle has moved to another road segment). In some embodiments, the drive information may be received at one or more vehicles and/or a remote server, consistent with disclosed embodiments.

In some embodiments, the drive information may comprise detection information indicative of a detected landmark in an environment of a respective vehicle at a location along the road segment on a capture date. Additionally or alternatively, detection information may be generated (e.g., by server 3045) based on received drive information. Detection information may include at least one of an image, an identified region (e.g., a region 3104), an outline of a landmark, a landmark color, a landmark dimension, a landmark shape, a landmark type, a sign type (e.g., a type of information displayed by the sign), landmark content (e.g., information displayed by the landmark), an orientation of the landmark (e.g. relative to at least one drivable path adjacent to the landmark), or any landmark or landmark environment attributes. A landmark (e.g., a detected landmark) may include at least one of a sign (e.g., a static sign or an adaptive sign), a banner, a flag, painted surface (e.g., lane marking, road marking, painted wall), or any object. For example, detection information indicative of a detected landmark may include an image of a sign near (e.g., within a detection range of, within a predetermined distance of) the location along the road segment. In some embodiments, the sign may indicate information associated with the road segment (e.g., an upcoming curve, a speed limit, a road condition, geography information, proximity to a location). The location along the road segment may be a location adjacent to the road segment, a location on one side of the road segment, a location within a predetermined distance of the road segment, a location within a visual range from the road segment, a location within a camera-capturing range from the road segment, or any combination thereof. A capture date may include at least one of a calendar date or a day of the week. In some embodiments, a capture date may be represented by a datestamp. In some embodiments, a capture date may include a capture time.

A capture time may include at least one of a clock time (e.g., an hour value, minute value, second value, and/or millisecond value), a time of day, a time associated with a particular day. In some embodiments, a capture time may be represented in a 12 or 24-hour format (e.g., 5:00 a.m., 5:00 p.m., 1400 hrs, 1930 hrs). In some embodiments, a capture time may be represented by a timestamp. (e.g., a timestamp indicating a time of day, a time associated with a particular day). In some embodiments, each captured date may include a capture time. In some embodiments, a capture date and/or a capture time may be a date or time (respectively) at which detection information (e.g., an image) was captured. A capture date and/or a capture time may also be associated with detection information (e.g., an image) when (or within a predetermined time of when) it is captured. For example, a timestamp and/or datestamp may be embedded within metadata of detection information or may be associated (e.g., via a common data structure) with the detection information. Camera parameters, such as camera operation parameters may also be included, such a contrast, saturation, white balance, gain, etc.

In some embodiments, the detection information may not include a detection of a landmark (e.g., the detection information may fail to indicate that a landmark is detected) corresponding to the expected landmark. For example, server 3045 may determine, based on the detection information, that a positive identification of a landmark (e.g., a landmark with a present and/or visible status) is associated with a confidence score below a threshold and in response may determine that a landmark is not present (e.g., detected) at a location. Additionally or alternatively, server 3045 may determine, based on the detection information, that a negative identification of a landmark (e.g., a landmark with a removed, missing, and/or replaced status) is associated with a confidence score above a threshold and in response may determine that a landmark is not present (e.g., detected) at a location.

In some embodiments, the drive information captured by each of the one or more vehicles includes a plurality of images. For example, each of the one or more vehicles may capture images (e.g., using a camera) during travel along the road segment. In some embodiments, multiple images captured by one vehicle may include detection information indicative of the detected landmark (e.g., a representation of a sign). In some embodiments, multiple images captured by multiple vehicles may include detection information indicative of the detected landmark (e.g., a representation of a sign).

In some embodiments, the road segment may comprise a plurality of drivable paths. For example, the road segment may include at least one lane, such as a single lane, two lanes designated for driving in opposite directions, two lanes designated for driving in a same direction, or more than two lanes designated for driving in opposite directions. A drivable path may include a path associated with a lane (e.g., multiple paths associated with multiple respective lanes), and such a path may be determined from relevant drive information collected from a plurality of vehicles traveling the lane. For example, a drivable path may be determined by averaging the path taken by a plurality of vehicles traveling in the same lane over a certain road segment. In other examples, a drivable path is determined (e.g., by a mapping server) from lane marking information, road edge information, and/or any other geometrical road features reported through the drive information collected from multiple vehicles. In some embodiments, the detection information may be grouped based on a respective drivable path from which a respective image was captured. For example, detection information from multiple vehicles that is also based on information captured while those vehicles traveled along a same lane may be grouped together. As another example, detection information from multiple vehicles that is also based on information captured while those vehicles traveled along a same direction may be grouped together.

In some embodiments, a dedicated landmark history may be generated for each of the plurality of drivable paths. A dedicated landmark history may include a unique landmark history (e.g., different from at least one other landmark history) and/or a landmark history associated with a single drivable path. For example, different sequences of detected landmark information (e.g., landmarks and associated statuses and capture dates) may be associated with each of the plurality of drivable paths.

At step 3204, process 3200 may include determining an indicator of an expected landmark for the location along the road segment from stored map information. An expected landmark may include at least one of a landmark previously associated with (e.g., present at) the location, a landmark previously detected to be at the location (e.g., detected a threshold number of times, detected a threshold number of times within a threshold amount of time, detected with a threshold confidence level), or a landmark represented in a navigation map (e.g., a map usable by a vehicle for autonomous or semiautonomous navigation, such as a sparse map, discussed above). An indicator of the expected landmark may include at least one of location information of the expected landmark, dimension information of the expected landmark (e.g., one or more dimensions associated with the landmark), shape information of the expected landmark, size information of the expected landmark, information of the content of the expected landmark, orientation information of the expected landmark, one or more detection dates and/or times of the expected landmark, or a type of the expected landmark (e.g., a type indicating the expected landmark is a sign related to speed information, a type indicating the expected landmark is a sign related to geography information, a type indicating the expected landmark is a sign related to road condition information, a type indicating the expected landmark is a sign related to lane information, a type indicating the expected landmark is a lane marking indicating a lane merges into another lane, a type indicating the expected landmark is a banner indicating a lane closure, etc.). Location information of the expected landmark may include at least one of coordinates (e.g., GPS coordinates), coordinates relative to a map (e.g., coordinates according to a coordinate system of a map), or a distance to (e.g., to a nearest point of) a representation in a map (e.g., distance to a curb, distance to a road barrier, distance to a lane, distance to a lane marking, a distance to a drivable path, etc.).

Stored map information may include drive information and/or detection information (e.g., detection information based on drive information captured by one or more vehicles), which may be associated with (e.g., based on, derived from, sourced from) one or more drives of one or more vehicles (e.g., times when one or more vehicles traveled along the road segment). Additionally or alternatively, stored map information may include roadway travel control information (e.g., lane direction designations, traffic yield areas or rules, traffic light information, lane merge information (e.g., roadway narrowing through lane reduction), added lane indications, a speed limit), road condition information (e.g., construction zone indications, road weather conditions, a hazard associated with a road segment), landmark information (e.g., landmark content, at least one landmark indication, a landmark type, at least one landmark location, at least one landmark dimension, at least one landmark location, and/or at least one landmark orientation), roadway surface information (e.g., roadway location and/or roadway dimensions), roadway boundary information, lane boundary information, or any information associated with a sparse map, discussed above. In some embodiments, certain stored map information may be associated with a particular road segment. For example, a speed limit may be associated with (e.g., mapped to) a particular road segment. As another example, a roadway narrowing may be associated with (e.g., mapped to) a particular road segment. Stored map information may be stored at a device remote from one or more vehicles that captured drive information included in the stored map information or upon with the map information is based. For example, remote server 3045 may store the stored map information.

At step 3206, process 3200 may include storing, as a landmark history, an indication of an identification of the expected landmark on a respective capture date based on the detection information. An indication of an identification of the expected landmark may include a determination of whether the expected landmark has been detected (e.g., determined to be present and/or applicable to a road segment) and/or identified (e.g., having content of the landmark determined or its semantic meaning), or any information about the expected landmark (e.g., a status of the expected landmark). For example, an indication of an identification of the expected landmark may include an indication that the expected landmark has been detected (e.g., positive detection). As another example, an indication of an identification of the expected landmark may include an indication that the expected landmark has not been detected (e.g., negative detection). As yet an additional example, an indication of an identification of the expected landmark may include content information associated with the expected landmark (e.g., extracted through image analysis). In some embodiments, an indication of an identification of the expected landmark may be based on a confidence score, which may express a likelihood of whether the indication of the identification of the expected landmark is accurate, consistent with disclosed embodiments. In some embodiments, an indication of an identification of the expected landmark may include a unique alphanumeric code, an icon, an image, or a scannable code (e.g., QR code, bar code) that uniquely represents the type of the landmark and/or information displayed on the landmark (e.g., a speed limit). In some exemplary embodiments, each type of landmark may be represented by a unique alphanumeric code. For example, road signs may have an identifier 1, traffic signs may have an identifier 2, and so on. In further example, the identifier may be globally unique or locally unique (different regions or countries can have different codes for the same road signs and (some) different road signs).

In some embodiments, process 3200 may include determining a state or status of the expected landmark, such as the expected landmark being at least one of present, visible, not visible, covered, uncovered, blocked, obscured, undamaged, damaged, missing, removed, replaced, changed, or having an indeterminate condition (e.g., where an object blocks a view to the expected landmark). A state or status of the expected landmark may be part of the indication of an identification of the expected landmark and/or the indicator of the expected landmark. In some embodiments, a state of a landmark may be associated with a current state of the landmark, such that if the map information indicates a presence of a landmark, and a host vehicle cannot detect the landmark, the indication from the host vehicle with respect to the landmark (in its respective drive information) may be that the landmark is missing or undetected, etc.

A landmark history may include one or more indications of identification of the expected landmark, which may be based on drive information from one or more vehicles from one or more times (e.g., captured by multiple different vehicles during different periods of travel along the road segment). For example, the landmark history may include multiple indications of identification of the expected landmark, which may be associated with different times (e.g., based on times at which drive information, from which the indications were determined, was captured). In some embodiments, storing, as a landmark history, an indication of an identification of the expected landmark may include aggregating the indication of the identification of the expected landmark with already stored indications (e.g., indications based on previously received drive information).

In some embodiments, process 3200 may include storing, in the landmark history, an indication of a missed identification of the expected landmark on a respective capture date. For example, process 3200 may include updating or adding the indication of the identification of the expected landmark and/or the indicator of the expected landmark, such as by updating or adding a status of the indicator of the expected landmark. In some embodiments, process 3200 may store, in the landmark history, an indication of a missed identification of the expected landmark on a respective capture date in response to the detection information failing to detect a landmark corresponding to the expected landmark, discussed above.

In some embodiments, a weight value may be applied to indications of identifications of the expected landmark and to indications of missed identifications of the expected landmark. A weight value may include a number (e.g., decimal number, percentage, fraction), score, or any numerical or symbolic representation indicating a degree of importance of one piece of information (e.g., an indication of identification) to at least one other piece of information. For example, one single weight value may be applied to indications of identifications of the expected landmark and another different single weight value may be applied to indications of missed identifications of the expected landmark. In some embodiments, different weight values may be applied between indications of identifications of the expected landmark (e.g., based on respective associated confidence scores), which may or may not overlap with weight values applied to indications of missed identifications of the expected landmark, which may or may not be different with each other (e.g., based on respective associated confidence scores). Weight values may total to 1, 100%, 0 to 1, or any other fixed value. Additionally, in some embodiments, the indications of the identifications of the expected landmark may be weighted higher than the indications of the missed identifications of the expected landmark. For example, the indications of the identifications of the expected landmark may be weighted with a decimal number of 0.8, and the indications of the missed identifications of the expected landmark may be weighted with a decimal number of 0.2.

At step 3208, process 3200 may include determining a change in a status of the expected landmark based on analysis of the landmark history. A change in a status of the expected landmark may include a transition from one type of status of the expected landmark to another. For example, the expected landmark may be considered (e.g., designated as, based on detection information and/or computerized image analysis) at least one of present, visible, not visible, covered, uncovered, blocked, undamaged, damaged, missing, removed, replaced, changed, or having an indeterminate condition. These statuses may change based on received drive information (e.g., from which detection information can be determined). For example, an expected landmark may transition from present to missing, from removed to replaced, from not visible to visible, or between any combination of states. In some embodiments, an expected landmark may be associated with more than one status, which may change together. For example, an expected landmark may transition from present and damaged to replaced and visible.

In some embodiments, the expected landmark may be an adaptive landmark, such as a landmark that changes its appearance, shape, and/or location over time. For example, an adaptive landmark may include a sign that is configured to change its appearance (e.g., displayed content) over time (e.g., automatically according to predetermined times, according to a received command, etc.). By way of further example, an adaptive landmark may be an electronic sign (e.g., an LED sign) whose displayed content may be changed based on received commands from a remote entity, or during different times of day, etc. In some embodiments, determining the change in the status of the expected landmark may include determining one or more changes in an appearance of the adaptive landmark. For example, process 3200 may include determining an appearance of the adaptive landmark at a first time (e.g., based on first detection information based on first drive information received from one or more first vehicles), determining an appearance of the adaptive landmark at a second time (e.g., based on second detection information based on second drive information received from the one or more first vehicles and/or one or more second vehicles), and determining a difference between the appearance at the first time and the appearance at the second time. For example, process 3200 may determine that an adaptive landmark has (e.g., displays, indicates) a first combination of graphical elements (e.g., letters, numbers, pictograms, and/or symbols) at a first time and has a second combination of graphical elements at a second time. Process 3200 may compare the first combination to the second combination and determine a difference between at least a portion of the two. Additionally or alternatively, process 3200 may determine a first group of pixels associated with (e.g., representing, corresponding to) the expected landmark in one image and a second group of pixels associated with (e.g., representing, corresponding to) the expected landmark in another image, and may determine a difference between at least some of the respective pixels between the images. In some embodiments, process 3200 may determine that there is a change in the appearance of the expected landmark when there is a change in a threshold number of pixels associated with the expected landmark between images. In some embodiments, a change in the appearance of the expected landmark may indicate a change in information associated with a road segment (e.g., direction of travel information, a speed limit applicable to the road segment, a lane open or closed status for one or more lanes of the road segment, an open or closed status for the road segment, etc.).

In some embodiments, the one or more changes in the appearance of the adaptive landmark may include a change to a travel direction indicator represented by the adaptive landmark. A travel direction indicator may be any visual information that associates a direction of traffic flow with one or more lanes of a road segment. For example, at a first time, an adaptive landmark may have an appearance (e.g., displayed content, such as graphical elements) indicating that one or more lanes are associated with a particular direction of travel (e.g., in a direction along a road segment), and, at a second time, the adaptive landmark may have another appearance (e.g., displayed content, such as graphical elements) indicating that the one or more lanes are associated with a different direction of travel (e.g., in an opposite direction along a road segment). More than one change in appearance is possible, such that the appearance of the adaptive landmark may change at a first time, a second time, a third time, and/or at any number of times. In some embodiments, the one or more changes in the appearance of the adaptive landmark may occur during one or more times of day. For example, the first time may be during the morning and the second time may be during the afternoon. As another example, the appearance of the adaptive landmark may change during the morning of a day (e.g., a first time), during the afternoon of the same day (e.g., at 2 p.m., a second time), and during the evening of the same day (e.g., at 8:00 p.m., a third time). In some embodiments, the appearance of the adaptive landmark may change at the same times for certain days (e.g., weekdays, Monday-Thursday, weekdays during the spring, autumn, and winter) and/or may change at different times for different days (e.g., change at different times with respect to Saturday and Sunday versus Monday-Friday, change at different times with respect to summer versus spring, autumn, and winter).

In some embodiments, determining the change in the status of the expected landmark may be based on a respective capture time for a respective capture date (e.g., a respective capture data for an indication of an identification of the expected landmark). For example, an indication of an identification of the expected landmark may be determined on a respective date and/or detection information may be captured on a respective date. Either or both of these may have a respective time associated with their respective capture date (e.g., Nov. 22, 2023 at 5:52 a.m.). For example, at a first time on a particular day (e.g., Jan. 7, 2024 at 7:00 a.m.), the expected landmark may have a first status, and at a second time on the same particular day (e.g., Jan. 7, 2024 at 5:55 p.m.), the expected landmark may have a second status different from the first status. Process 3200 may compare the first status to the second to determine the change in the status of the expected landmark.

In some embodiments, process 3200 may include obtaining weather conditions for the respective capture date at the respective capture time. Alternatively, process 3200 may include obtaining a single weather condition or a composite whether condition for the respective capture date at the respective capture time. One or more weather conditions may include at least one of a presence of precipitation (e.g., rain, snow, sleet, hail, fog), a wind speed, a temperature, an amount of cloud coverage, a position of the sun, an amount of sunlight (e.g., based on a time of day, day of the year, and/or geographic location), a position of the moon, or an amount of moonlight (e.g., based on a time of day, day of the year, and/or geographic location). Obtaining weather conditions may include requesting, receiving, or any accessing of the weather conditions, such as by receiving the weather conditions from a remote source (e.g., a database, a web resource, a vehicle) or from at least one (e.g., each one) of the plurality of host vehicles that provided the drive information including the indications related to the landmark. In some embodiments, at least one weather condition may be determined by a vehicle and associated drive information captured during the presence of the at least one weather condition. In some embodiments, determining the change in the status of the expected landmark may be further based on the weather conditions. For example, process 3200 may determine, in response to determining a particular weather condition or combination of weather conditions associated with detection information, a particular an indicator of an expected landmark and/or a particular indication of an identification of the expected landmark, which may impact the change in the status of the expected landmark. For example, process 3200 may determine that the detection information is associated with weather information including an indication of a sunny day, and cause a change in the status of the expected landmark. Additionally or alternatively, process 3200 may determine that a particular weather condition or combination of weather conditions corresponds to a change to a confidence score associated with detection information. For example, predictive algorithms or trained networks together with drive information collected by a plurality of vehicles can be used to determine the state of a landmark (e.g., a road sign), where the predictive algorithms or trained networks can be used to weight the indication provided in the drive information.

In some embodiments, determining the change in the status of the expected landmark may be further based on analysis of the indicator of the expected landmark for the location along the road segment from the stored map information. For example, process 3200 may compare at least one feature of the indicator of the expected landmark to detection information, to determine if an aspect of the expected landmark has changed (e.g., at a later time relative to the capturing of information that the indicator of the expected landmark includes or is based upon). For example, process 3200 may compare a dimension associated with the indicator of the expected landmark with a dimension determined from the detection information to identify a difference in the two dimensions that corresponds to a change in the status of the expected landmark.

At step 3210, process 3200 may include updating the stored map information based on the determined change in the status of the expected landmark. Updating the stored map information may include adding, deleting, or changing the stored map information. Updating the stored map information may be based on the determined change in the status of the expected landmark by occurring in response to a determined change in the status, by being dependent on the change in the status, by being influenced by the change in the status, or by having a computer logic connection to the change in the status. For example, based on an expected landmark changing to a status of removed, at least a portion of the stored map information may be deleted, such as location information of the expected landmark, dimensional information of the expected landmark, content of the expected landmark, or a type indicator of the expected landmark. As another example, based on an expected landmark changing from covered to uncovered, at least a portion of the stored map information may be added, such as location information of the expected landmark, dimensional information of the expected landmark, content of the expected landmark, or a type indicator of the expected landmark. In some embodiments, deleting stored map information may include delinking landmark information from a particular road segment. For example, deleting stored map information may include delinking a speed limit from a particular road segment, such that a different speed limit (e.g., a speed limit associated with a connecting road segment) becomes linked to the particular road segment. In some embodiments, adding stored map information may include linking landmark information to a particular road segment. For example, adding stored map information may include linking a roadway widening (e.g., due to a lane addition) indicator to a particular road segment.

In some embodiments, updating the stored map information may include classifying the expected landmark as at least one of a damaged landmark, an obscured landmark, an adaptive landmark, or a removed landmark. For example, process 3200 may classify an aspect of the expected landmark based on computerized image analysis of one or more images and/or a determined status (which may be determined based on the computerized image analysis). In some embodiments, classifying the expected landmark may include determining a status of the expected landmark and/or a change in the status of the expected landmark. In some embodiments, the classification of a particular landmark may include a unique alphanumeric code, an icon, an image, or a scannable code (e.g., QR code, bar code) that uniquely represents the status of the landmark.

In some embodiments, updating the stored map information may include at least one of maintaining the indicator, removing the indicator (e.g., deleting the indicator), flagging the indicator, changing a designation for an indicator from fixed to adaptive (or vise-versa), or modifying a confidence score for the indicator. Maintaining the indicator may include preserving the indicator as it exists in the map information or modifying the indicator and preserving the modified version of the indicator in the map information. Flagging the indicator may include generating and/or attaching a data annotation to the indicator, which may represent a warning associated with the indicator (e.g., the indicator is associated with a confidence score below a threshold, the indicator has been changed within a threshold time period, the indicator has not been changed within a threshold time period).

A confidence score for the indicator may include a value, number, statistic, grade, a probability, or any expression of likelihood of whether information is accurate (e.g., information associated with the indicator, such as a location of the expected landmark represented by the indicator, a status of the expected landmark represented by the indicator, or any part of an indicator of the expected landmark). In some embodiments, the confidence score may be based on at least one of capturing context associated with at least one image (e.g., weather conditions when at least one image was captured, lighting conditions when at least one image was captured, a resolution of a camera that captured at least one image, a time at which at least one image was captured), image attributes (e.g., a focus metric of at least one image, a blurriness metric of at least one image, a contrast of at least one image, a resolution of at least one image, a timestamp associated with at least one image), or timing and detection information (e.g., a detected status, detected landmark content) associated with multiple images.

Changing a designation for an indicator may include adding, removing, or modifying information associated with (e.g., that is part of) the indicator of the expected landmark. For example, changing a designation for an indicator may include changing a value of a field associated with the indicator from fixed to adaptive. Alternatively, changing a designation for an indicator may include changing a value of a field associated with the indicator from adaptive to fixed.

Modifying a confidence score for the indicator may be based on received or generated detection information. For example, server 3045 may generate detection information based on at least one first image received from at least one vehicle, and the detection information may indicate that a status of a landmark is the same as an earlier-determined status (e.g., based on detection information based on at least one second image captured prior to the first image). In this example, server 3045 may increase a confidence score for the indicator. As another example, server 3045 may generate detection information based on at least one first image received from at least one vehicle, and the detection information may indicate that a status of a landmark is different from an earlier-determined status and/or that the detection information has a confidence score below a threshold (e.g., where the detection information indicates the sign is blocked or where the detection information is associated with at least one image with an image attribute below a threshold).

In some embodiments, process 3200 may include determining a confidence score for whether the expected landmark exists at the location along the road segment based on the landmark history. For example, process 3200 may determine a number and timing of occurrences where the expected landmark was detected and statuses of the landmark associated, respectively, with the occurrences (e.g., landmark history information), to determine a degree or confidence of the presence of the expected landmark at the location (e.g., according to an algorithm). Additionally or alternatively, process 3200 may determine a number and timing of occurrences where the expected landmark was not detected to determine a degree or confidence of the presence of the expected landmark at the location. For example, process 3200 may determine that in a one-week period of time, the landmark history includes nine indications of the presence of a same expected landmark (e.g., based on detection information), and one indication of the expected landmark being missing, and may determine that this represents a 9/1 ratio of detected/not detected, which may result in a particular confidence score (e.g., based on inputting the ratio to an algorithm). As another example, process 3200 may determine that the landmark history includes five indications of the presence of an expected landmark (e.g., based on detection information), followed (e.g., temporally) by two indications of no landmark, followed by five indications of the presence of a landmark different from the expected landmark, which may result in a particular confidence score associated with the different landmark and/or expected landmark.

In some embodiments, the confidence score may be stored in association with the indicator of the expected landmark in the stored map information. For example, the confidence score and the indicator of the expected landmark may be included as part of a same data structure or data object (e.g., within the stored map information).

In some embodiments, process 3200 may include comparing the confidence score (e.g., for whether the expected landmark exists at the location along the road segment based on the landmark history) to a threshold. For example, process 3200 may determine whether the confidence score is less than, equal to, greater than, or within a range of, the threshold. Process 3200 may also include, based on the comparison, flagging the indicator of the expected landmark in the stored map information or removing the indicator of the expected landmark from the stored map information. For example, process 3200 may determine that the confidence score is within a threshold range (e.g., 10% below the threshold) and in response may flag the indicator of the expected landmark (e.g., tagging the indicator with an indication that the indicator of the expected landmark has weak confidence, tagging the indicator with an indication that the indicator of the expected landmark is a candidate for updating, tagging the indicator with an indication that the indicator of the expected landmark is a candidate for removal). As another example, process 3200 may determine that the confidence score is below the threshold and in response may remove the indicator of the expected landmark from the stored map information. In some embodiments, process 3200 may use one threshold for determining whether to flag the indicator of the expected landmark in the stored map information and another threshold for determining whether to remove the indicator of the expected landmark from the stored map information.

In some embodiments, process 3200 may include updating the indicator of the expected landmark in the map information based on the determined change in the status of the expected landmark. For example, updating the indicator of the expected landmark may include changing any aspect of the indicator, such as changing at least one of location information of the expected landmark, shape information of the expected landmark, size information of the expected landmark, information of the content of the expected landmark, orientation information of the expected landmark, one or more detection dates and/or times of the expected landmark, or a type of the expected landmark.

In some embodiments, in addition to or instead of updating the stored map information based on the determined change in the status of the expected landmark, process 3200 may include determining to not update the stored map information based on the determined change in the status of the expected landmark. For example, based on an expected landmark changing from a status of present to a status of damaged (e.g., partially visible), it may be determined that the expected landmark (e.g., a sign) is still associated with (e.g., applicable to) a road segment, even though it may not be completely visible (e.g., due to its damaged state). As another example, based on an expected landmark changing from a status of visible to missing (e.g., when a sign is missing but it is detected that sign pole remains), it may be determined that the expected landmark (e.g., a sign) is still associated with (e.g., applicable to) a road segment, even though it may be missing.

At step 3212, process 3200 may include distributing the stored map information to one or more autonomous vehicles for use in navigating along the road segment. Distributing the stored map information may include transmitting the stored map information, authorizing access of the stored map information, or any action to make the stored map information available to one or more autonomous vehicles. Navigating along the road segment may include autonomously or semi-autonomously controlling at least one vehicle to travel on the roadway corresponding to the road segment or to take one or more navigational actions (e.g., one or more of accelerating, steering, or braking), consistent with disclosed embodiments.

In some embodiments, the expected landmark may be associated with at least one landmark characteristic in the stored map information. A landmark characteristic may include at least one of a landmark shape, a landmark dimension, a landmark color, a landmark location, a landmark orientation, a landmark location (e.g., relative to other map information), landmark content, a landmark type indicator, or any part of an indicator of the expected landmark, discussed above. Associating he expected landmark with the at least one landmark characteristic may include the expected landmark may being included in a same data structure or data object with the at least one landmark characteristic, being linked to with the at least one landmark characteristic, or including a pointer to the at least one landmark characteristic.

In some embodiments, process 3200 may include comparing at least one feature of the detected landmark to the landmark characteristic. A feature of the detected landmark may include information about the detected landmark that is determined through image analysis (e.g., analyzing one or more images from one or more vehicles), such as at least one of a landmark shape, a landmark dimension, a landmark color, a landmark location, a landmark orientation, a landmark location (e.g., relative to other map information), landmark content, a landmark type indicator, or any information that may be included as part of an indicator of the expected landmark, discussed above. In some embodiments, process 3200 may include based on the comparison, determining whether the detected landmark corresponds to the expected landmark. For example, process 3200 may compare a location of the detected landmark to a location of the expected landmark (e.g., a landmark characteristic) and determine whether the locations are the same or are within a threshold distance of each other. Additionally or alternatively, process 3200 may compare a dimension of the detected landmark to a dimension of the expected landmark (e.g., a landmark characteristic) and determine whether the dimensions are the same or are within a threshold fixed amount or percentage of each other. Additionally or alternatively, process 3200 may compare a type indicator of the detected landmark to a type indicator of the expected landmark (e.g., a landmark characteristic) and determine whether the type indicators are the same. In some embodiments, process 3200 may include in response to determining that the detected landmark does not correspond to the expected landmark, storing an indication of a missed identification of the expected landmark on the respective capture date.

### Sign Orientation Determination

As described herein an autonomous (or semi-autonomous) vehicle may identify various landmarks in the environment of the vehicle, and may use these landmarks for navigation. For example, this may include localizing the vehicle relative to a road map or making various navigation decisions based on the presence of the landmarks or other objects. In some embodiments, orientation of a landmark, such as a traffic sign can be useful in determining whether the landmark is relevant to a particular path the vehicle is navigating along. For example, a sign facing an oncoming vehicle directly may be relevant to the vehicle, whereas a sign angled away from the vehicle may not be relevant. Orientation may also be useful in localizing the vehicle, as the orientation information can be used to confirm how a particular sign or other landmark should appear in a captured image from a particular point along a drivable path.

Using conventional techniques, orientation of various landmarks is often assumed to be in the direction opposite to the travel direction of the harvesting vehicle. For example, a sign detected in an image of a vehicle may be assumed to be directly facing the camera used to capture the image. However, this is often not the case. Accordingly, the resulting navigational maps may include inaccurate orientations of traffic signs, which may lead to errors in navigation and/or localization of an autonomous vehicle, at least in some cases. In a multilane road, for example, a sign may be relevant for only some of the lanes, but may not be relevant for one or more other lanes going in the same direction.

To resolve these and other issues, the disclosed embodiments provide a system for accurately detecting an orientation of a sign or other landmark. The disclosed embodiments include receiving drive information from vehicles traversing a road segment, which may include location indicators associated with a sign. For example, the location indicators may correspond to edges of the sign or other features that, when taken together, may define a planar surface of the sign. The disclosed embodiments may include aggregating the drive information from multiple vehicles to determine refined locations indicators. These refined 3D point locations can then be used to determine a sign width and a facing direction of the sign (e.g., a direction of a line normal to the sign face). This information can be stored in navigational maps and used for localization and relevancy determination. The disclosed embodiments thus provide improved efficiency, accuracy, and performance over conventional navigation and mapping techniques.

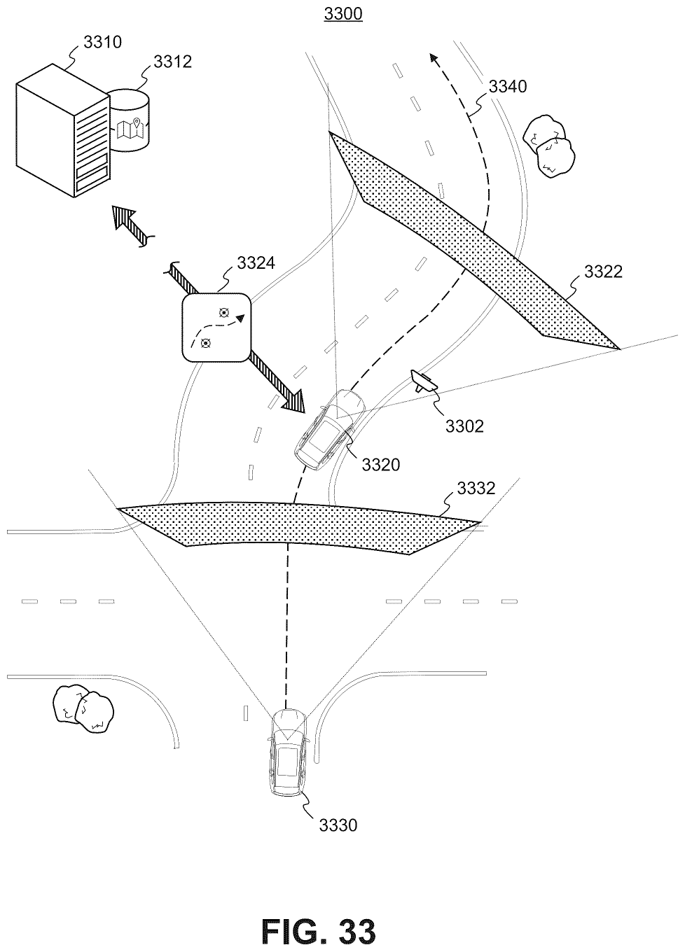

FIG. 33 illustrates an example environment of a host vehicle 3320 for determining landmark orientation consistent with the disclosed embodiments. In this example, one or more host vehicles 3320 and 3330 may navigate along a road segment 3300. Host vehicles 3320 and 3330 may be configured to communicate with a server 3310. For example, host vehicle 3320 may collect various drive information 3324 as it traverses road segment 3300 along a path 3340, and may transmit drive information 3324 to server 3310. In some embodiments, server 2720 may correspond to sever 1230 described above. Accordingly, any of the descriptions or disclosures made herein in reference to server 1230 may also apply to server 3310, and vice versa. For example, server 3310 may be configured to crowdsource drive information from many vehicles traversing road segment 3300, which may include drive information similarly captured by host vehicle 3330. In some embodiments, server 3310 may be configured to generate and/or update a navigational map based on drive information 3324. For example, server 3310 may access a map database 3312, which may include location information for various landmarks along road segment 3300. Map database 3312 may further include orientation information for various landmarks consistent with the disclosed embodiments. Server 3310 may be configured to distribute the navigational map to one or more autonomous vehicles for use in navigating along road segment 3300.

In some embodiments, drive information 3324 may include images captured by one or more cameras included in vehicles that traversed the at least one road segment. For example, host vehicle 3320 may capture an image 3322 as it travels along road segment 3300. Similarly, host vehicle 3330 may capture an image 3332, as shown in FIG. 33. Accordingly, drive information 3324 may include image 3322 as well as various other images captured by host vehicle 3320. Alternatively or additionally, drive information 3324 may include information determined by host vehicle 3320 based on image 3322 and/or various other sensor data. For example, drive information 3324 may include one or more location indicators associated with a landmark, as described further below, and may not necessarily include the image data itself. In some embodiments, host vehicle 3320 (and host vehicle 3330) may correspond to vehicle 200 discussed above. Accordingly, any of the features or embodiments described herein in reference to vehicle 200 may equally apply to host vehicle 3320. Host vehicle 3320 may be equipped with at least one camera, which may correspond to one or more of image capture devices 122, 124, and 126 described above. Further, host vehicle 3320 may include at least one processing device, which may correspond to processing unit 110. Host vehicle 2710 may include various other sensors as described herein.

Consistent with the disclosed embodiments, server 3310 may be configured to determine an orientation or various other spatial information for landmarks along road segment 3300 based on drive information collected by host vehicles 3320 and 3330. For example, road segment 3300 may include a sign 3302, as shown in FIG. 33. Determining an orientation of sign 3302 may be beneficial for various autonomous vehicles when navigating along road segment 3300. For example, the orientation of sign 3302 may allow an autonomous vehicle (or server 3310) to assess whether sign 3302 is relevant to a vehicle navigating along path 3340. Accordingly, server 3310 may determine an orientation of sign 3302 and store the orientation of sign 3302 in a navigational map (e.g., in map database 3312). Server 3310 may be configured to determine the orientation of sign 3302 based on drive information crowdsourced from a plurality of host vehicles, such as host vehicles 3320 and 3330. While a sign is used by way of example throughout the present disclosure, one of skill in the art would recognize that the same or similar techniques may be applied to other landmarks, especially landmarks having similar properties to a road sign. For example, the landmarks may include a road marking, a traffic light, a convex blind spot mirror, a construction indicator, or various other forms of landmarks along a road segment.

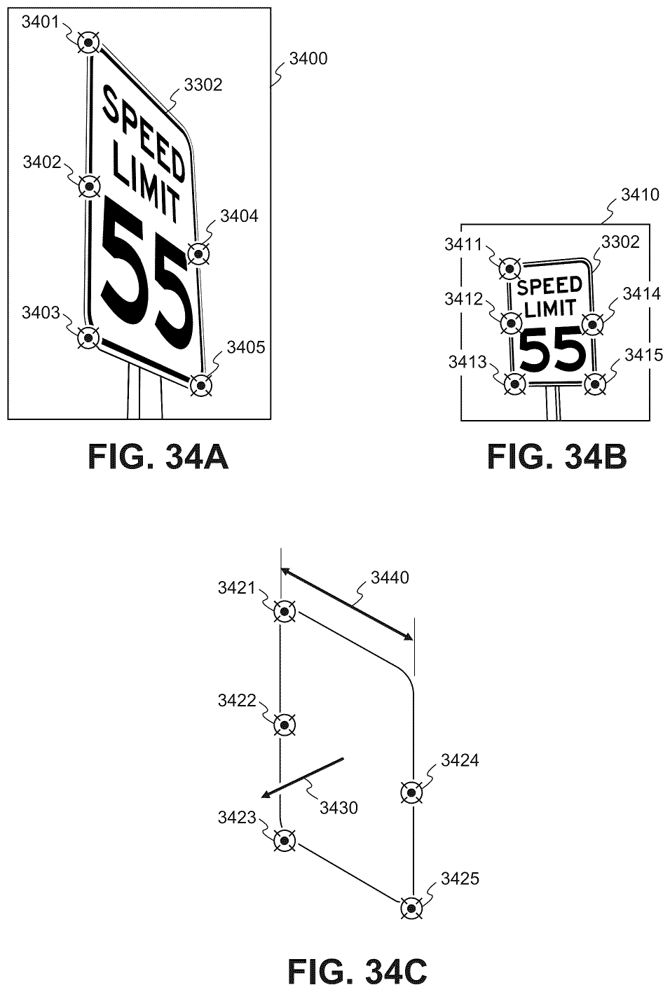

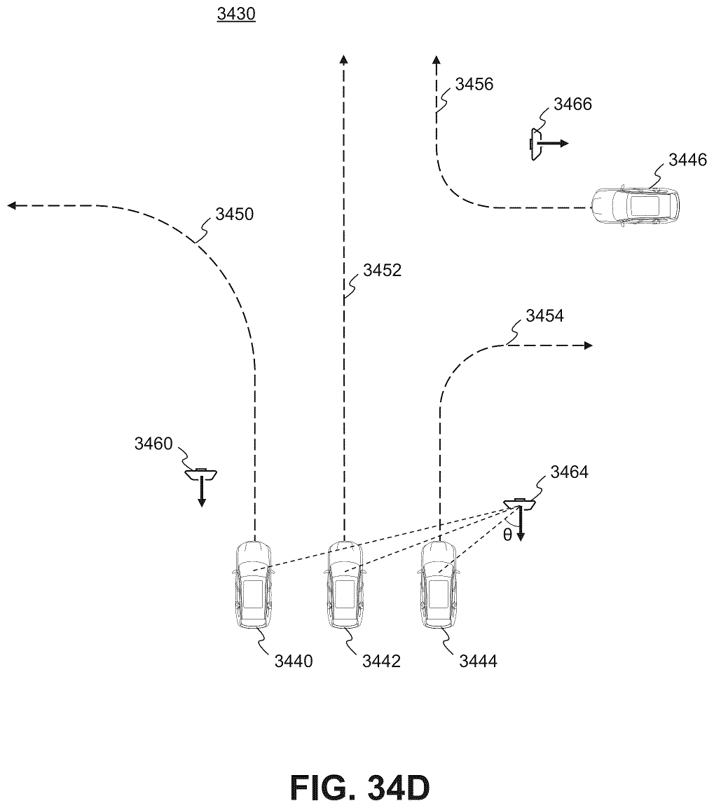

As discussed above, drive information 3324 may include landmark detection information corresponding to a landmark located along the road segment. For example, drive information 3324 may include landmark detection information for sign 3302. In some embodiments, this landmark detection information may include various location indicator associated with the landmark. FIGS. 34A and 34B illustrate various location indicators that may be identified for a landmark, consistent with the disclosed embodiments. For example, FIG. 34A shows an example image (or portion of an image) 3400 including a representation of sign 3302. In this example, image 3400 may be an image captured by host vehicle 3320 when traveling along road segment 3300. For example, image 3400 may represent a portion of image 3322, as described above. Host vehicle 3320 may be configured to determine various location indicators associated with sign 3302. By way of example, host vehicle 3320 may determine one or more of location indicators 3401, 3402, 3403, 3404, and 3405, as shown in FIG. 34A. While FIG. 34A illustrates a front face of sign 3302, it is to be understood that landmark detection information as used herein may include detections of a front face of the landmark, a back face of the landmark, or both.

In some embodiments, the location indicators may include three-dimensional (3D) points. For example, the 3D points may be based on 2D image coordinates of a feature point as well range or depth data indicating a distance from the host vehicle to the feature point. Various other methods for determining and or representing a 3D location may also be used. The location indicators may be positioned at a variety of locations relative to the landmark. In some embodiments, the location indicators may at least partially define a planar surface of the landmark. For example, as one of skill in the art would recognize, any three of location indicators 3401, 3402, 3403, 3404, and 3405 may define a planar surface of sign 3302 in 3D space. In some embodiments, the location indicators may include three-dimensional locations along an edge of the planar surface. For example, location indicators 3401, 3402, and 3403 may represent three-dimensional locations along a left edge of sign 3302 and location indicators 3405 and 3405 may represent three-dimensional locations along a right edge of sign 3302. In this example, “left” and “right” may be defined relative to a position on a trajectory associated with the landmark, such as path 3340. As another example, the location indicators may include three-dimensional locations of three or more corners of the planar surface, such as location indicators 3401, 3403, and 3405. While location indicators 3401, 3402, 3403, 3404, and 3405 are shown in FIG. 34A by way of example, the location indicators that may be determined relative to a landmark are not limited to any specific locations.

Location indicators 3401, 3402, 3403, 3404, and 3405 may be included in drive information 3324 and provided to server 3310. Consistent with the disclosed embodiments, various other vehicles may determine similar location indicators relative to the same landmark. FIG. 34B shows an example image (or portion of an image) 3410 also including a representation of sign 3302. In this example, image 3410 may be an image captured by host vehicle 3330 when traveling along road segment 3300. For example, image 3410 may represent a portion of image 3332, as described above. Host vehicle 3330 may be configured to determine various location indicators associated with sign 3302, similar to host vehicle 3320. For example, host vehicle 3330 may determine one or more of location indicators 3411, 3412, 3413, 3414, and 3415, as shown in FIG. 34B. As with location indicators 3401, 3402, 3403, 3404, and 3405, location indicators 3411, 3412, 3413, 3414, and 3415 may represent various 3D positions on a surface of sign 3302, such as three-dimensional locations along a first edge of the planar surface, three-dimensional locations along a second edge of the planar surface, and/or three-dimensional locations of three or more corners of the planar surface. Location indicators 3411, 3412, 3413, 3414, and 3415 may be uploaded to server 3310 along with various other drive information, similar to drive information 3324.

Server 3310 may aggregate drive information obtained from a plurality of vehicles to determine refined location indicators associated with the landmark. FIG. 34C illustrates example refined location indicators that may be determined relative to a landmark, consistent with the disclosed embodiments. As shown in FIG. 34C, server 3310 may determine refined location indicators 3421, 3422, 3423, 3424, and 3425. In this example, refined location indicator 3421 may be determined by aggregating location indicators 3401 and 3411. Similarly, refined location indicators 3422, 3423, 3424, and 3425 may be determined by aggregating location indicators 3402 and 3412, 3403 and 3413, 3404 and 3414, and 3405 and 3415, respectively. The aggregation of location indicators to determine a refined location indicator may be performed using various techniques. In some embodiments, the aggregation may include determining an average location. For example, refined location indicator 3421 may represent an average position in three-dimensional space of location indicators 3401 and 3411 (and any corresponding location indicators crowdsourced from other host vehicles). In some embodiments, the aggregation of drive information may be based on one or more drivable paths of the road segment. For example, server 3310 may only aggregate drive information collected from vehicles traveling along path 3400. In some embodiments, the aggregation may be performed based on various other common characteristics within the drive information, such as the same direction of travel, the same time of day (and thus similar brightness and other image properties), the same weather conditions (increasing the likelihood of a similar appearance of the landmark in the image), or various other factors that may improve the accuracy of the aggregation. Accordingly, drive information 3324 may include various other environmental information from which these characteristics may be ascertained by server 3310.

Based on one or more of refined location indicators 3421, 3422, 3423, 3424, and 3425, server 3310 may determine a landmark orientation for at least one feature of the landmark based on the refined first location indicator and the refined second location indicator. In some embodiments, the landmark orientation may be an orientation within a coordinate system of a navigational map. For example, the landmark orientation may be represented as a vector normal to a plane defined by the refined first location indicator and the refined second location indicator, such as normal vector 3430. Normal vector 3430 may be determined based on geometry using refined location indicators 3421, 3422, 3423, 3424, and 3425. In some embodiments, determining the normal to the plane is performed via a triangulation process.

Consistent with the disclosed embodiments, server 3310 may be configured to determine various other physical properties of sign 3320 based on refined location indicators 3421, 3422, 3423, 3424, and 3425. For example, server 3310 may be configured to determine an actual width 3440 of sign 3302 based on the refined location indicators. Actual width 3440 may represent the actual physical width of sign 3302, which may not necessarily be the same as a width of sign 3302 in image space. For example, sign 3302 may appear to have significantly different widths depending on the position of the vehicle relative to the sign when the image is captured, as illustrated by images 3400 and 3410. However, using the refined location indicators, server 3310 may determine a more accurate actual width of sign 3302. In some embodiments, the direction of normal vector 3430 (relative to a surface of the landmark) may be determined based on the actual width.

In some embodiments, the orientation of a landmark may be determined at least in part based on known properties of the landmark. For example, server 3310 or host vehicle 3320 may be configured to determine a type of landmark represented in the landmark identification information. In the example discussed above, the landmark type may be a road sign (or, more specifically, a speed limit sign). Server 3310 may obtain various geometric characteristics of the landmark based on the landmark type, which may be used in conjunction with the refined location indicators to determine the orientation. For example, server 3310 may access information defining a width of a speed limit sign and this predefined width may be compared to actual width 3440. As a result, the orientation and/or other properties of sign 3302 may be fine-tuned based on the predefined geometric characteristics. In some embodiments, server 3310 may access a database or other data structure storing predefined geometric characteristics corresponding to various landmark types. While width is used by way of example, various other geometric characteristics may be used. In some embodiments, server 3310 may obtain one or more color features of the landmark based on the landmark type, which may be used in conjunction with the refined location indicators to refine the landmark orientation. For example, the refined location indicators may correspond to color features of the landmark and a known spacing or orientation of the color features may be used to refine the calculated orientation.

According to some embodiments, a machine learning model may be used to determine an orientation of a landmark. For example, a neural network may be trained to output an indicator of an orientation for a landmark based on various position indicators. For example, the trained model may be configured to receive, as an input, location indicators collected from a plurality of vehicles and output an orientation of the landmark. As another example, the trained model may be configured to receive, as an input, refined location indicators and output an orientation of the landmark. To develop the trained model, a training set of location indicators may be provided to a machine learning algorithm to generate a trained model. The training set of location indicators may be labeled to designate an orientation of a corresponding landmark. As a result of the training process, the neural network may be configured to generate an orientation based on various location indicators input to the model. Various other training or machine learning algorithms may be used, including a logistic regression, a linear regression, a regression, a random forest, a K-Nearest Neighbor (KNN) model, a K-Means model, a decision tree, a cox proportional hazards regression model, a Naïve Bayes model, a Support Vector Machines (SVM) model, a gradient boosting algorithm, or any other form of machine learning model or algorithm.

Server 3310 may be configured to store the orientation of the landmark in a map. For example, this may include storing the determined orientation of sign 3302 in map database 3312, as discussed above. This orientation information may be useful for autonomous vehicles navigating along the road segment. For example, if an autonomous vehicle (e.g., host vehicle 3320) is traveling along path 3340, the orientation of sign 3302 may indicate whether sign 3302 is relevant to host vehicle 3320. Accordingly, the host vehicle 3320 may determine a navigational response based whether sign 3302 is relevant to host vehicle 3320. As used herein, a path may refer to a specific mapped trajectory among a plurality of mapped trajectories. In some embodiments, the path may include a mapped trajectory among a plurality of trajectories headed generally in the same direction. The plurality of trajectories headed generally in the same direction can be, for example, associated with each one of a plurality of lanes and each or some of the lanes in the same direction can proceed to a different direction at a junction located some distance ahead of the current location of the host vehicle. While host vehicle 3320 is used by way of example, one of skill in the art would recognize that the same vehicle that captured drive information 3324 may not necessarily be the same vehicle that receives the map and navigates along road segment 3300 based on the stored landmark orientation. Accordingly, the navigational response may be determined by a different autonomous vehicle.

FIG. 34D is a diagrammatic illustration of an example road segment 3430 along which vehicles may navigate based on stored orientations of landmarks, consistent with the disclosed embodiments. In this example, road segment 3430 may include multiple lanes of travel heading in the same direction, represented by paths 3450, 3452, and 3454. In this example, paths 3450, 3452, and 3454 may be approaching a lane split feature, such as an intersection or a junction. As shown, path 3450 may diverge to the left (relative to a vehicle traveling along path 3450) and path 3454 may diverge to the right (relative to a vehicle traveling along path 3454). Path 3452 may proceed straight through the lane split feature. Another path 3456 may merge in to road segment 3430, as shown. Road segment 3430 may further include traffic signs 3460, 3464, and 3466, as shown in FIG. 34D. In this example, traffic sign 3460 may be relevant to vehicles traveling along path 3450, traffic sign 3464 may be relevant to vehicles traveling along path 3454, and traffic sign 3466 may be relevant to vehicles traveling along path 3456. A navigational map associated with road segment 3430 may store representations of paths 3450, 3452, 3454, and 3456 as target trajectories for vehicles to navigate along. The navigational map associated with road segment 3430 may also include representations of traffic signs 3460, 3464, and 3466 and corresponding orientation indicators as described above.

Various autonomous or semiautonomous vehicles may navigate along road segment 3430 using the navigational map. For example, vehicles 3440, 3442, 3444, and 3446 may travel along paths 3450, 3452, 3454, and 3456, respectively. Vehicles 3440, 3442, 3444, and 3446 may navigate at least partially based on orientation indicators associated with traffic signs 3460, 3464, and 3466. In some embodiments, the orientation indicators may be useful in determining which traffic signs are applicable to individual lanes within a multilane road segment. For example, as noted above, traffic sign 3464 may be relevant to path 3454 but not relevant to paths 3450 or 3452. As vehicles 3440, 3442, and 3444 approach traffic sign 3464, the orientation of traffic sign 3464 becomes very different based on which lane the vehicle is traveling in. For example, as shown in FIG. 34D, the orientation angle θ of traffic sign 3464 relative to vehicle 3444 may be significantly different from the orientation angle of traffic sign 3464 relative to vehicles 3442 and 3440. While orientation angle θ is shown by way of example, various other angles or geometrical relationships may be used to determine the relevancy of a traffic sign.

This orientation angle may be useful in determining (and/or verifying) which paths or vehicles traffic sign 3464 is relevant to. For example, vehicle 3444 may compare orientation angle θ to a threshold angle, which may indicate whether traffic sign 3464 is relevant. Vehicle 3440 may determine that traffic sign 3464 is not relevant but that traffic sign 3460 is relevant using similar techniques. And vehicle 3442 may determine that neither of traffic signs 3460 or 3464 are relevant. Further, each of vehicles 3440, 3442, and 3444 may determine (or verify) that traffic sign 3466 is not relevant based on an orientation indicator for traffic sign 3466.

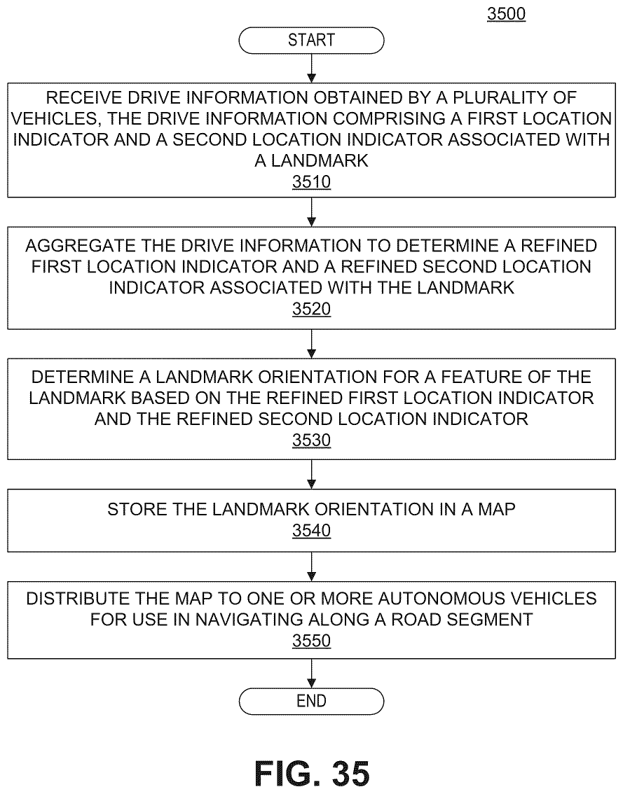

FIG. 35 is a flowchart showing an example process 3500 for determining landmark orientation, consistent with the disclosed embodiments. For example, process 3500 may be used to generate a map including landmark orientations for use in navigation along a road segment by an autonomous vehicle. Process 3500 may be performed by at least one processing device of a server, such as a processor of server 3310. It is to be understood that throughout the present disclosure, the term “processor” is used as a shorthand for “at least one processor.” In other words, a processor may include one or more structures that perform logic operations whether such structures are collocated, connected, or dispersed. In some embodiments, a non-transitory computer readable medium may contain instructions that when executed by a processor cause the processor to perform process 3500. Further, process 3500 is not necessarily limited to the steps shown in FIG. 35, and any steps or processes of the various embodiments described throughout the present disclosure may also be included in process 3500, including those described above with respect to FIGS. 33, 34A, 34B, 34C, and 34D.

In step 3510, process 3500 includes receiving drive information obtained by a plurality of vehicles traversing or having traversed a road segment. For example, step 3510 may include receiving drive information 3324 from host vehicle 3320 along with additional drive information from host vehicle 3330 and/or other host vehicles traversing or having traversed road segment 3300. The landmark may include various forms of landmarks, such as a traffic sign, a road marking, a traffic light, a convex blind spot mirror, or a construction indicator.

The drive information may comprise landmark detection information corresponding to a landmark located along the road segment. For example, the drive information may include landmark detection information corresponding to sign 3302. As described above, the landmark detection information may include at least a first location indicator associated with the landmark and a second location indicator associated with the landmark. For example, the drive information may include two or more of location indicators 3401, 3402, 3403, 3404, and 3405, as described above. According to some embodiments, the landmark detection information may include detections of both a front face and a back face of the landmark.

In some embodiments, the first location indicator and the second location indicator may each comprise information that, when taken in combination, represent a planar surface of the landmark. As described above, the information may comprise three-dimensional locations along a first edge of the planar surface and/or three-dimensional locations along a second edge of the planar surface. The first edge of the planar surface may correspond to a right edge of the landmark and the second edge may correspond to a left edge of the landmark. For example, the information may include location indicators 3401, 3402, 3403, 3404, and 3405, as described above. In some embodiments, the information may comprise three-dimensional locations of three or more corners of the planar surface. For example, the information may include location indicators 3401, 3403, and 3405.

In step 3520, process 3500 includes aggregating the drive information obtained from the plurality of vehicles to determine a refined first location indicator and a refined second location indicator associated with the landmark. For example, step 3520 may include determining two or more of refined location indicators 3421, 3422, 3423, 3424, and 3425, as described above. In some embodiments, the refined first location indicator or the refined second location indicator may represent a three-dimensional location for at least one edge of a planar surface of the landmark. Accordingly, aggregating the drive information may include determining an average three-dimensional location for the at least one edge of the planar surface of the landmark based on the refined first location indicator and the refined second location indicator. In some embodiments, aggregating the drive information may be based on one or more drivable paths of the road segment, such as path 3340.

In step 3530, process 3500 includes determining a landmark orientation for at least one feature of the landmark based on the refined first location indicator and the refined second location indicator. For example, step 3530 may include determining an orientation for sign 3302 based on refined location indicators 3421, 3422, 3423, 3424, and 3425, as described above. In some embodiments, determining the landmark orientation for the at least one feature of the landmark based on the refined first location indicator and the refined second location indicator may comprise determining a normal to a plane defined by the refined first location indicator and the refined second location indicator. For example, step 3530 may include determining normal vector 3430, as described above. Determining the normal to the plane may be performed via a triangulation process or various other geometric techniques. According to some embodiments, step 3530 may include determining various other dimensions or properties of the landmark. For example, process 3500 may further comprise determining an actual width of the landmark. In some embodiments, step 3530 may include determining a direction of a line normal relative to a surface of the landmark based on the actual width.

The landmark orientation may be determined in various ways. In some embodiments, the landmark orientation may be determined at least in part based on information associated with a type of the landmark. For example, determining the landmark orientation for the at least one feature of the landmark based on the refined first location indicator and the refined second location indicator may comprise: determining a landmark type; obtaining one or more geometric characteristics of the landmark based on the landmark type; and using the one or more geometric characteristics in conjunction with the refined first location indicator and a refined second location indicator to refine the landmark orientation. As another example, determining the landmark orientation for the at least one feature of the landmark based on the refined first location indicator and the refined second location indicator may comprise: determining a landmark type; obtaining one or more color features of the landmark based on the landmark type; and using the one or more color features in conjunction with the refined first location indicator and a refined second location indicator to refine the landmark orientation. In some embodiments, determining the landmark orientation for the at least one feature of the landmark based on the refined first location indicator and the refined second location indicator may comprise applying a machine learning model, as described above. For example, the first location indicator and the second location indicator may be inputs to the machine learning model.

In step 3540, process 3500 includes storing the landmark orientation in a map. For example, step 3540 may include storing the landmark orientation in map database 3312, as described above.

In step 3550, process 3500 includes distributing the map to one or more autonomous vehicles for use in navigating along the road segment. For example, step 3550 may include distributing the map to host vehicle 3320 (or a similar vehicle). The navigating may comprise determining at least one navigational response based on the stored landmark orientation. For example, determining the at least one navigational response based on the stored landmark orientation may comprise determining a relevancy of the landmark to a vehicle among the one or more autonomous vehicles. The at least one navigational response may include at least one of steering, braking, or accelerating the one or more autonomous vehicles.

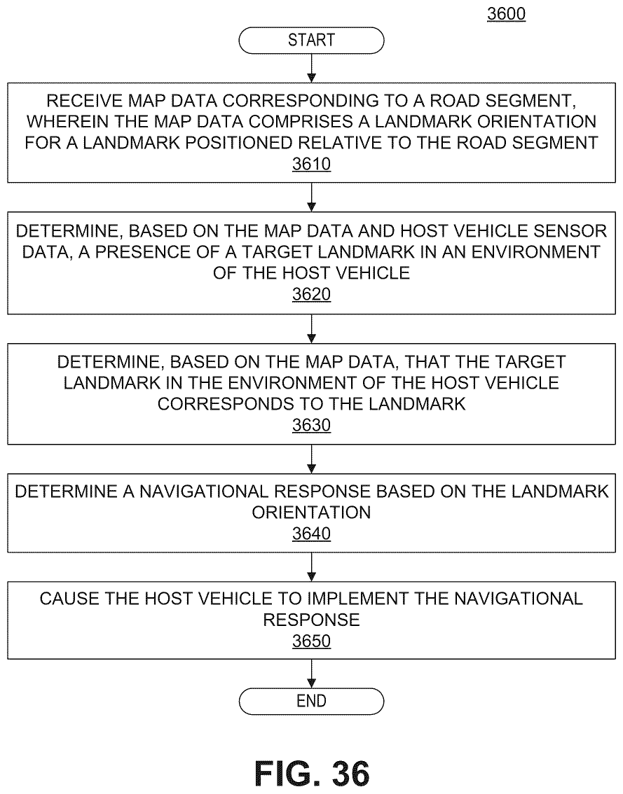

FIG. 36 is a flowchart showing an example process 3600 for navigating a host vehicle, consistent with the disclosed embodiments. Process 3600 may be performed by at least one processing device of a host vehicle, such as a processing device 110. In some embodiments, a non-transitory computer readable medium may contain instructions that when executed by a processor cause the processor to perform process 3600. Further, process 3600 is not necessarily limited to the steps shown in FIG. 36, and any steps or processes of the various embodiments described throughout the present disclosure may also be included in process 3600, including those described above with respect to FIGS. 33, 34A, 34B, 34C, 34D, and 35.

In step 3610, process 3600 includes receiving map data corresponding to a road segment on which the host vehicle is navigating or will navigate. For example, step 3610 may include receiving map data associated with map database 3312, which may include map data corresponding to road segment 3300. As described herein, the map data may comprise a landmark orientation for a landmark positioned relative to the road segment. For example, the map data may include normal vector 3430 associated with sign 3302, as described above. Accordingly, the landmark orientation may have been determined using some or all of process 3500 described above. Consistent with the disclosed embodiments, the landmark may include a traffic sign, a road marking, a traffic light, a convex blind spot mirror, a construction indicator, or various other types of landmarks, as described herein.

In step 3620, process 3600 includes determining, based at least on the map data and host vehicle sensor data, a presence of a target landmark in an environment of the host vehicle. For example, host vehicle 3320 (or a similar host vehicle) may capture image 3322, which may include a representation of sign 3302, as shown in FIG. 33. Step 3620 may include identifying sign 3302 in image 3322 and verifying the location based on the map data, or vice versa.

In step 3630, process 3600 includes determining, based on at least the map data, that the target landmark in the environment of the host vehicle corresponds to the landmark. For example, step 3630 may include comparing a location of the landmark determined based on analysis of image data (or other sensor data) with a location of the target landmark stored in the map data.

In step 3640, process 3600 includes determining at least one navigational response based on the landmark orientation stored in the map data in association with the landmark. In some embodiments, determining the at least one navigational response includes determining a relevancy of the landmark to a drivable path associated with the road segment. For example, this may include comparing the landmark orientation with an angle of a corresponding portion of path 3340. If the landmark orientation differs by the angle of the corresponding portion of path 3340 by more than a threshold value, for example, the sign may be deemed not relevant to the host vehicle. Similarly, determining the at least one navigational response may include determining a relevancy of the landmark to the host vehicle. For example, this may include determining, based on the landmark orientation, a path for which the landmark is relevant, and determining whether the host vehicle will travel along that path. For example, this may include applying the various techniques described above with respect to FIG. 34D.

In step 3650, process 3600 includes causing the host vehicle to implement the at least one navigational response. For example, the at least one navigational response may include at least one of steering, braking, or accelerating the host vehicle.

### Traffic Light Orientation Determination

As discussed above, it may be beneficial to determine and store the orientation of various landmarks in a navigational map. For example, this may enable autonomous vehicles to more accurately determine whether a landmark detected through sensor data corresponds to a landmark represented in the map. As another example, the orientation information may enable the autonomous vehicle to determine whether the landmark, such as a traffic sign or traffic light, is relevant to the vehicle. In some embodiments, the orientation of a landmark may be determined based on aggregation of drive information acquired by a plurality of vehicles to determine refined location indicators associated with the edges or other portions of the landmark. This may work especially well in situations where the landmark is relatively flat, such as a traffic sign. For other landmarks, such as three-dimensional traffic lights, other approaches disclosed herein may provide even more accurate results.

As described above, using conventional techniques, orientation of various landmarks is often assumed to be in the direction opposite to the travel direction of the harvesting vehicle. For example, a traffic light detected in an image of a vehicle may be assumed to be directly facing the camera used to capture the image and thus relevant to the vehicle. However, this is often not the case. Accordingly, the resulting navigational maps may include inaccurate orientations of traffic lights, which may lead to errors in navigation and/or localization of an autonomous vehicle, at least in some cases.

To resolve these and other issues, the disclosed embodiments provide a system for accurately detecting an orientation of a traffic light. The disclosed embodiments may monitor detections of valid color states associated with traffic light. For example, detecting a valid color of a traffic light may indicate the traffic light is facing the vehicle that captured the image. Because color may be detected at a relatively wide angular range relative to a traffic light, detection of color alone as the basis for an orientation determination will result in an equally wide angular range of possible orientations. Thus, the disclosed embodiments may also account for distances between the camera and the traffic light for which color is detected. Among the traffic light detections, the correct orientation of the traffic light (e.g., a vector normal to the face of the traffic light) may be closest to a vector point from a detected traffic light to the farthest point or points where a harvesting vehicle detected color. In some embodiments, a traffic light detection cluster can be subclustered (e.g., based on detection distance), and the final traffic light orientation may be determined based on a “best” subcluster. Once a traffic light orientation has been determined using the disclosed techniques, the orientation can be stored in a navigational map and used for localization and relevancy determination. The disclosed embodiments thus provide improved efficiency, accuracy, and performance over conventional navigation and mapping techniques.

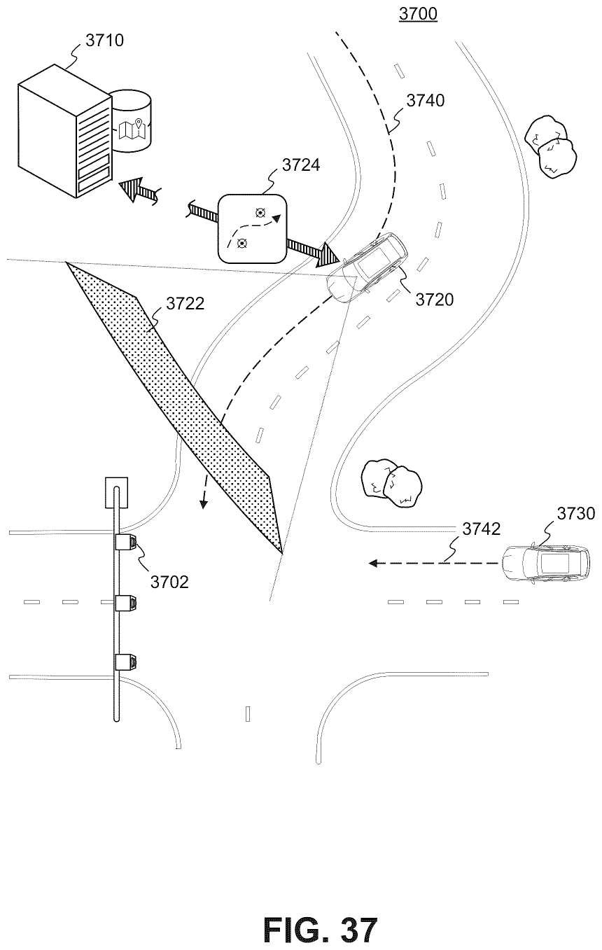

FIG. 37 illustrates an example environment of a host vehicle 3720 for determining traffic light orientation, consistent with the disclosed embodiments. In this example, host vehicles 3720 may navigate along a road segment 3700. Host vehicle 3720 may be configured to communicate with a server 3710. For example, host vehicle 3720 may collect various drive information 3724 as it traverses road segment 3700 along a path 3740, and may transmit drive information 3724 to server 3710. Although not shown in detail, host vehicle 3730 may similarly collect various drive information as it traverses road segment 3700 along a path 3742. In some embodiments, server 2720 may correspond to sever 1230 (or server 3310) described above. Accordingly, any of the descriptions or disclosures made herein in reference to server 1230 may also apply to server 3710, and vice versa. For example, server 3710 may be configured to crowd source drive information from many vehicles traversing road segment 3700. In some embodiments, server 3710 may be configured to generate and/or update a navigational map based on drive information 3724. For example, server 3710 may access a map database 3712, which may include location information for various traffic lights along road segment 3700. Map database 3712 may further include orientation information for various traffic lights consistent with the disclosed embodiments. Server 3710 may be configured to distribute the navigational map to one or more autonomous vehicles for use in navigating along road segment 3700.

In some embodiments, drive information 3724 may include images captured by one or more cameras included in vehicles that traversed the at least one road segment. For example, host vehicle 3720 may capture an image 3722 as it travels along road segment 3700. Accordingly, drive information 3724 may include image 3722 as well as various other images captured by host vehicle 3720. Alternatively or additionally, drive information 3724 may include information determined by host vehicle 3720 based on image 3722 and/or various other sensor data. For example, drive information 3724 may include traffic light color state information and vehicle location information, as described further below, and may not necessarily include the image data itself. In some embodiments, host vehicle 3720 may correspond to vehicle 200 discussed above. Accordingly, any of the features or embodiments described herein in reference to vehicle 200 may equally apply to host vehicle 3720. Host vehicle 3720 may be equipped with at least one camera, which may correspond to one or more of image capture devices 122, 124, and 126 described above. Further, host vehicle 3720 may include at least one processing device, which may correspond to processing unit 110. Host vehicle 2710 may include various other sensors as described herein.

Consistent with the disclosed embodiments, server 3710 may be configured to determine an orientation or various other spatial information for traffic lights located along road segment 3700 based on drive information collected by host vehicle 3720 and various other host vehicles (e.g., host vehicle 3730). For example, road segment 3700 may include a traffic light 3702, as shown in FIG. 37. Determining an orientation of traffic light 3702 may be beneficial for various autonomous vehicles when navigating along road segment 3700. For example, the orientation of traffic light 3702 may allow an autonomous vehicle (or server 3710) to assess whether traffic light 3702 is relevant to a vehicle navigating along path 3740. Accordingly, server 3710 may determine an orientation of traffic light 3702 and store the orientation of traffic light 3702 in an navigational map (e.g., in map database 3712). Server 3710 may be configured to determine the orientation of traffic light 3702 based on drive information crowdsourced from a plurality of host vehicles, such as host vehicles 3720 and 3730.

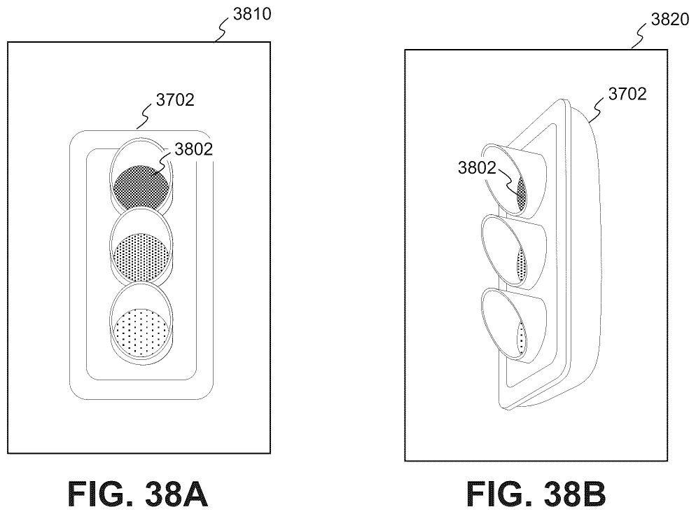

As discussed above, drive information 3324 may include traffic light detection information corresponding to a traffic light located along the road segment. For example, drive information 3324 may include traffic light detection information for traffic light 3702. In some embodiments, this traffic light detection information may include traffic light color state information associated with the traffic light. FIGS. 38A and 38B illustrate various images (or portions of images) from which traffic light color state information may be ascertained, consistent with the disclosed embodiments. For example, FIG. 38A shows an example image (or portion of an image) 3810 including a representation of traffic light 3702. In this example, image 3810 may be an image captured by host vehicle 3730 when traveling along path 3742. As shown, traffic light 3702 may include a lamp portion 3802, which may be associated with a color. For example, lamp portion 3802 may be a red lamp associated with a red color state of traffic light 3702. Traffic light 3702 may further include various other lamps associated with other color states, such as yellow or green. Host vehicle 3730 may be configured to detect lamp portion 3802 in image 3810. Host vehicle 3720 may further determine color state information based on whether lamp portion 3802 (or other lamp portions) are detected. While circular lamp portions are shown in FIGS. 38A and 38B by way of example, the same or similar techniques may be applied to lamp portions of various other shapes, such as an arrow, a pedestrian walk (or do not walk) sign, a text-based signal, a do not enter signal, or the like. Moreover, the disclosed techniques are not limited to traffic lights but may apply to various other landmarks having color states or indicators, such as construction signs, detour signs, traffic message boards, express lane signs, or the like.

FIG. 38B shows an example image (or portion of an image) 3820 including a representation of traffic light 3702 from an alternate angle. In this example, image 3820 may be an image captured by host vehicle 3720 when traveling along path 3740. For example, image 3820 may represent a portion of image 3722, as described above. As with host vehicle 3730, host vehicle 3720 may be configured to detect lamp portion 3802 in image 3820. As shown in FIG. 38B, however, the angle from which traffic light 3702 is observed may affect the appearance of lamp portion 3802 in the corresponding image. Accordingly, a color state of traffic light 3702 may be more difficult to determine in image 3820 than in image 3810 as the representation of lamp portion 3802 in image 3820 is much smaller than the representation of lamp portion 3802 in image 3810. This effect may be exaggerated further based on the distance from the traffic light at which the image is captured. For example, as the distance increases, the representation of lamp portion 3802 in the image will decrease, thus making the color state of traffic light 3702 more difficult to determine.

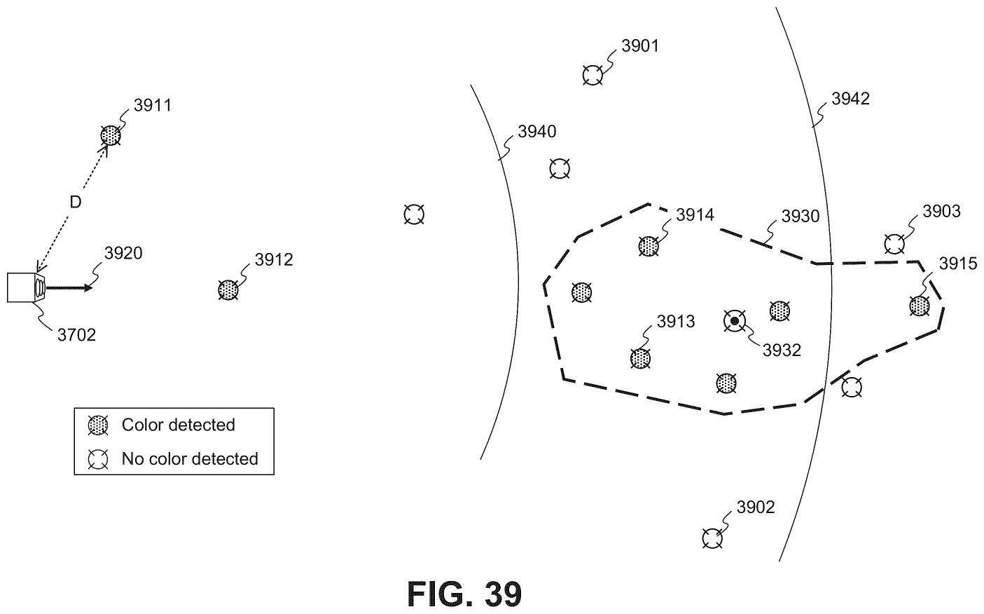

The disclosed embodiments may capitalize on the effect described above for purposes of determining an orientation of traffic light 3702. For example, an orientation of traffic light 3702 may be determined based on how readily the color state information for traffic light 3702 may be determined at various angles and distances. FIG. 39 is a diagrammatic representation of various traffic light detection events that may be used to determine an orientation indicator for the traffic light, consistent with the disclosed embodiments. For example, server 3710 may determine various traffic light detection events 3901, 3902, 3903, 3911, 3912, 3913, 3914, and 3915 (among other traffic light detection events, as shown in FIG. 39), based on drive information received from various vehicles. For example, drive information 3724 may include traffic light color state information indicating a detected stat of traffic light 3702. In some embodiments, the traffic light color state information may include a current state of the traffic light at the time an image was captured. For example, the traffic light color state information may include a designation of “red,” “yellow,” or “green.” Alternatively or additionally, the traffic light color state information may be unconclusive (e.g., indicating a traffic light color state was not determined from the image). Drive information 3724 may further include vehicle location information associated with the traffic light color state information. For example, the vehicle location information may include a current location of host vehicle 3720 at the time the traffic light color state information was determined. Based on drive information 3724, server 3710 may identify one or more traffic light detection events relative to traffic light 3702. For example, server 3710 may identify traffic light detection event 3911 based on drive information 3724. Server 3710 may determine various other traffic light detection events based on drive information 3724 and drive information received from various other host vehicles.

Server 3710 may further be configured to determine, for each of the traffic light detection events, a color state indicator and a traffic light detection distance for the traffic light. In some embodiments, the color state indicator may be a binary indicator of whether or not a color state was detected. For example, in FIG. 39, the shaded traffic light event markers, such as those associated with traffic light detection events 3911, 3912, 3913, 3914, and 3915 may represent traffic light events in which a color of traffic light 3702 was detected, and unshaded traffic light event markers, such as those associated with traffic light events 3901, 3902, and 3903 may represent traffic light events in which a color of traffic light 3702 was not detected. Alternatively, or additionally, the color state indicator may include a specific color or state that was detected, such as “red,” “yellow,” “green,” or “none.” In some embodiments, the color state indicator may indicate whether a correct color state was detected. For example, server 3710 may access timing information associated with traffic light 3702 and may determine whether a timing of a reported color state of a traffic light detection event corresponds with a color state indicated by the timing information. In some embodiments, the color state indicator may be a value, such as an amount of color detected, a degree of confidence associated with a detected color, a score associated with a detected color state, or various other values. Accordingly, as used herein, a “valid” color state may refer to whether or not a color state (e.g., “red,” “yellow,” “green,”) was detected at all, whether the detected state was correct, whether a value (e.g., a degree of confidence) exceeds a threshold value, or various other metrics depending on how the color state indicator is defined.

Accordingly, server 3710 may analyze traffic light detection information received from a plurality of vehicles and determine color state indicators for each of the identified traffic light detection events. In some embodiments, server 3710 may also determine a traffic light detection distance for each of the identified traffic light detection events. This traffic light detection distance may be determined based on the vehicle location information included in the traffic light detection information received from various host vehicles. For example, drive information 3724 may indicate a position of host vehicle 3720 associated with traffic light detection event 3911. Based on this information, server 3710 may determine a distance D between traffic light detection event 3911 and traffic light 3702, as shown in FIG. 39. Server 3710 may similarly determine distances for various other traffic light detection events.

This distance, in combination with the color state indicators for the traffic light detection events may indicate a facing direction of traffic light 3702. For example, as the distance away from traffic light 3702 increases, whether or not a valid color state is detected will depend on how closely aligned the traffic light detection event is with the facing direction of traffic light 3702. For example, although color is detected in traffic light detection event 3911, it may be less indicative of a facing direction of traffic light 3702 due to its relative proximity to traffic light 3702. As the distance increases, traffic light detection events in which a color state is detected will tend to be aligned with the facing direction of traffic light 3702. For example, color may be detected in traffic light detection event 3914, but not in traffic light detection event 3901, despite having similar distances to traffic light 3702. Accordingly, based on an analysis of the color state indictors and traffic light detection distances, server 3710 may determine an orientation indicator for the traffic light, such as orientation indicator 3920. For example, orientation indicator 3920 may be a vector normal to traffic light 3702.

Orientation indicator 3920 may be determined in various ways. In some embodiments, orientation indicator 3920 may be based on the furthest traffic light detection event having a valid color state. In the example, shown in FIG. 39, this may correspond to traffic light detection event 3915 as it is the traffic light detection event having the greatest traffic light detection distance while still having a valid color state. In some embodiments, only a greatest distance over a predetermined threshold will be considered. For example, a predetermined threshold distance 3942 may be defined and a furthest traffic light detection event may be used to determine orientation indicator 3920 only if it exceeds this threshold. One skilled in the art would recognize that the value of threshold distance 3942 may vary depending on a specific implementation or use case. In some embodiments, threshold distance 3942 greater than or equal to 150 meters may be defined (e.g., 150 meters, 200 meters, 250 meters, etc.).

Alternatively or additionally, server 3710 may identify various traffic light detection event clusters based on the traffic light detection events. In some embodiments, this may include clustering traffic light detection events for which a color state has been detected. For example, this may include determining cluster 3930, as shown in FIG. 39. Orientation indicator 3920 may be determined at least in part based on a property of cluster 3930. For example, server 3710 may determine a representative point 3932 for cluster 3930 and o orientation indicator 3920 may represent a vector from traffic light 3702 to representative point 3932. Representative point 3932 may be determined in various ways. In some embodiments, representative point 3932 may be an average of the positions of traffic light detection events included in cluster 3920. As another example, representative point 3932 may be a centroid of a shape defined by cluster 3920. Various other representative points may be used, consistent with the disclosed embodiments.

In some embodiments, distances traffic light detection distances may be accounted for in determining clusters of traffic light detection events. For example, traffic light clusters may be identified based on a comparison of the traffic light detection distances to a predetermined threshold. In the example shown in FIG. 39, cluster 3930 may be determined based on a predetermined threshold distance 3940 and thus traffic light detection events 3911 and 3912 may be excluded from cluster 3930. In some embodiments, traffic light clusters may be identified based on one or more range bands. For example, a range band may be defined between threshold distance 3940 and 3942. Each range band may therefore correspond to a common traffic light detection distance. Accordingly, only traffic light detection event within the band would be clustered together. In some embodiments, multiple bands may be defined and thus multiple clusters (or subclusters) may be defined. In some embodiments, a top percentile range band may be used to define at least one cluster. For example, rather than a rigid predetermined distance value, various bands may be defined based on a statistical analysis of the traffic light detection events. As one example, a range band may be defined for the top 90th percentile of traffic light detection distances, and traffic light detection events with valid color states within this range band may form a cluster. Various other range bands may be defined according to other percentile ranges or other statistical values. In some embodiments, the traffic light detection events may be filtered based on other factors. For example, the traffic light detection events may be filtered based on a detection history of a respective traffic light (e.g., indicating a date in which a status of traffic light 3702 may have changed as described herein). Accordingly, a cutoff date or time range may be defined and used to filter traffic light detection events.

According to some embodiments, a machine learning model may be used to determine an orientation of traffic light 3702. For example, a neural network may be trained to output an indicator of an orientation for a traffic light based on drive information. For example, the trained model may be configured to receive, as an input, drive information collected from a plurality of vehicles and output an orientation of the traffic light. As another example, the trained model may be configured to receive, as an input, traffic light detection event information (e.g., including color state indicators and corresponding traffic light detection distance or locations) and output an orientation of the traffic light. To develop the trained model, a training set of drive information (or traffic light detection event information) may be provided to a machine learning algorithm to generate a trained model. The training set may be labeled to designate an orientation of a corresponding traffic light. As a result of the training process, the neural network may be configured to generate an orientation based on various drive information or traffic light detection event information input to the model. Various other training or machine learning algorithms may be used, including a logistic regression, a linear regression, a regression, a random forest, a K-Nearest Neighbor (KNN) model, a K-Means model, a decision tree, a cox proportional hazards regression model, a Naïve Bayes model, a Support Vector Machines (SVM) model, a gradient boosting algorithm, or any other form of machine learning model or algorithm.

Server 3710 may be configured to store the orientation of the traffic light in a map. For example, this may include storing the determined orientation of traffic light 3702 in map database 3712, as discussed above. This orientation information may be useful for autonomous vehicles navigating along the road segment. For example, if an autonomous vehicle (e.g., host vehicle 3720) is traveling along path 3740, the orientation of traffic light 3702 may indicate whether traffic light 3702 is relevant to host vehicle 3720. Accordingly, the host vehicle 3720 may determine a navigational response based whether traffic light 3702 is relevant to host vehicle 3720. Accordingly, orientation indicator 3920 may represent an orientation in which a longitudinal axis of a vehicle is most closely normal to a plane aligned with a plane projected parallel to a face of traffic light 3702. In the scenario shown in FIG. 37, for example, host vehicle 3730 may have a longitudinal axis relatively normal to a plane aligned with a plane projected parallel to a face of traffic light 3702. Accordingly, in this example, traffic light 3702 may be relevant to host vehicle 3730 but not relevant to host vehicle 3720. While host vehicle 3720 (and host vehicle 3730) are used by way of example, one of skill in the art would recognize that the same vehicle that captured drive information 3724 may not necessarily be the same vehicle that receives the map and navigates along road segment 3700 based on the stored traffic light orientation. Accordingly, the navigational response may be determined by a different autonomous vehicle.

In some embodiments, traffic light relevancy may be determined using techniques similar to those described above with respect to FIG. 34D. Although not shown in FIG. 34D, road segment 3430 may include various traffic lights, which may be relevant to only some lanes of travel. For example, road segment 3430 may include a traffic light associated with path 3450, such as a turn indicator. Vehicle 3440 may determine (or verify) that the traffic light is relevant based on an orientation angle of the traffic light relative to vehicle 3440. Similarly, vehicles 3442 and 3444 may determine the traffic light is not relevant.

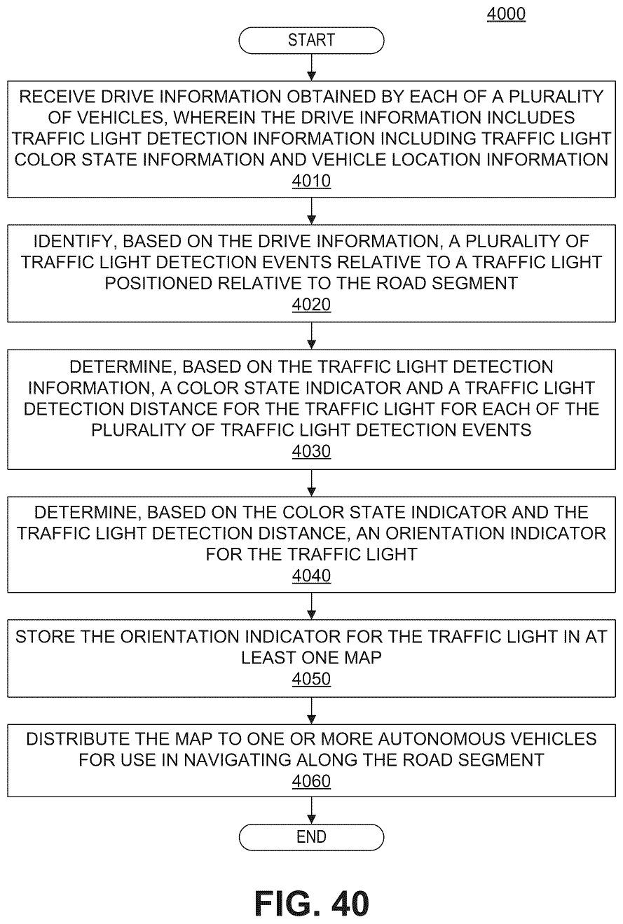

FIG. 40 is a flowchart showing an example process 4000 for determining traffic light orientation, consistent with the disclosed embodiments. For example, process 4000 may be used to generate a map including traffic light orientations for use in navigation along a road segment by an autonomous vehicle. Process 4000 may be performed by at least one processing device of a server, such as a processor of server 3710. In some embodiments, a non-transitory computer readable medium may contain instructions that when executed by a processor cause the processor to perform process 4000. Further, process 4000 is not necessarily limited to the steps shown in FIG. 40, and any steps or processes of the various embodiments described throughout the present disclosure may also be included in process 4000, including those described above with respect to FIGS. 37, 38A, 38B, and 39.

In step 4010, process 4000 includes receiving drive information obtained by each of a plurality of vehicles traversing or having traversed a road segment. For example, step 4010 may include receiving drive information 3724 from host vehicle 3720 along with additional drive information from host vehicle 3730 and/or other host vehicles traversing or having traversed road segment 3700. The drive information obtained by each of the plurality of vehicles may include traffic light detection information. For example, as described above, the traffic light detection information may include traffic light color state information and vehicle location information. For example, the drive information may include a detected color state of traffic light 3702 and position of host vehicle 3720 when the color state of traffic light 3702 was detected.

In step 4020, process 4000 includes identifying, based on the drive information, a plurality of traffic light detection events relative to a traffic light positioned relative to the road segment. For example, step 4020 may include identifying traffic light detection events 3901, 3902, 3903, 3911, 3912, 3913, 3914, and 3915, as described above. In some embodiments, process 4000 may further include filtering the plurality of traffic light detection events based on a detection history of a respective traffic light.

In step 4030, process 4000 includes determining, for each of the plurality of traffic light detection events and based on the traffic light detection information included in the received drive information, a color state indicator and a traffic light detection distance for the traffic light. For example, step 4030 may include determining color state indicators for traffic light detection events 3901, 3902, 3903, 3911, 3912, 3913, 3914, and 3915, as described above. Step 4030 may further include determining distances for each of the traffic light detection events, such as distance D between traffic light 3702 and traffic light detection event 3911. For example, the color state indicator for each of the plurality of traffic light detection events may include an indicator of a green state, a yellow state, or a red state. In some embodiments, the color state indicator for each of the plurality of traffic light detection events may further be based on a shape determined from an analysis of the traffic light detection information. For example, the shape may be a left arrow, a right arrow, a straight arrow, or various other shapes.

In step 4040, process 4000 includes determining, based on the color state indictor and the traffic light detection distance determined for each of the plurality of traffic light detection events, an orientation indicator for the traffic light. For example, step 4040 may include determining orientation indicator 3920, as described above. In some embodiments, the stored orientation indicator may comprise a vector normal to the traffic light.

The orientation indicator for the traffic light may be determined in various ways, as described herein. For example, process 4000 may include identifying one or more traffic light clusters based on the plurality of traffic light detection events. For example, this may include determining cluster 3930, as described above. In some embodiments, the orientation indicator for the traffic light may further be determined based on an estimated normal to the traffic light determined based on the one or more traffic light clusters. For example, determining the estimated normal to the traffic light may comprise selecting a traffic light cluster positioned greater than a predetermined distance from the traffic light and determining a normal line extending from the traffic light through a region of the traffic light cluster corresponding to a centroid of the traffic light cluster. As another example, determining the estimated normal to the traffic light may comprise selecting a traffic light cluster positioned greater than a predetermined distance from the traffic light and determining a normal line extending from the traffic light through a region corresponding to an average of vehicle locations for traffic light detection events associated with the traffic light cluster.

In some embodiments, the one or more traffic light clusters may be identified based on a comparison of the traffic light detection distance to a predetermined threshold. For example, this may include comparing the traffic light detection distances for the traffic light detection events to threshold distance 3940, as described above. In some embodiments, the one or more traffic light clusters may be identified based on one or more range bands, each range band corresponding to a common traffic light detection distance. As described above, the one or more traffic light clusters may be identified based on a top percentile range band among the one or more range bands. For example, the top percentile may range between the 80th and 95th percentile of the traffic light detection distance, or any other suitable range.

According to some embodiments, the orientation indicator for the traffic light may further be determined based on a traffic light detection distance among the plurality of traffic light detection events that has a greatest distance and a valid color state. For example, the orientation indicator may be determined based on traffic light detection event 3915, as described above. The valid color state may be green, red, or yellow, as described above. In some embodiments, the greatest distance may be greater than a predetermined threshold, such as a predetermined threshold greater than 150 meters. In one example, the predetermined threshold may be 200 meters. In some embodiments, determining the orientation indicator for the traffic light may comprise applying a machine learning model, where the drive information is input to the machine learning model, as described above.

In step 4050, process 4000 includes storing the orientation indicator for the traffic light in at least one map. For example, step 4050 may include storing the orientation indicator in map database 3712, as described above. In some embodiments, the stored orientation indicator for the traffic light may represent an orientation in which a longitudinal axis of a vehicle is most closely normal to a plane aligned with a plane projected parallel to a face of the traffic light. The orientation indicator can be stored relative to one or more trajectories associated with the traffic light. The one or more trajectories can be one or more 3D splines each representing a drivable path in the map.

In step 4060, process 4000 includes distributing the map to one or more autonomous vehicles for use in navigating along the road segment. For example, step 4060 may include distributing the map to host vehicle 3720 (or a similar vehicle). The navigating may include determining at least one navigational response based on the stored orientation indicator for the traffic light. For example, determining the at least one navigational response may include determining a relevancy of the traffic light to a navigating vehicle among the one or more autonomous vehicles or determining a relevancy of the traffic light to one or more drivable paths of the road segment. The at least one navigational response may include at least one of steering, braking, or accelerating the one or more autonomous vehicles.

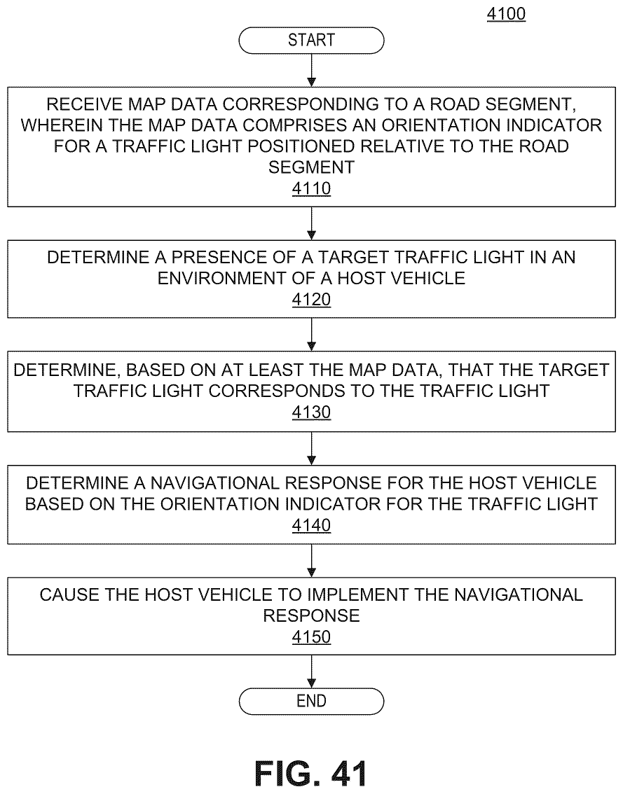

FIG. 41 is a flowchart showing an example process 4100 for navigating a host vehicle, consistent with the disclosed embodiments. Process 4100 may be performed by at least one processing device of a host vehicle, such as a processing device 110. In some embodiments, a non-transitory computer readable medium may contain instructions that when executed by a processor cause the processor to perform process 4100. Further, process 4100 is not necessarily limited to the steps shown in FIG. 41, and any steps or processes of the various embodiments described throughout the present disclosure may also be included in process 4100, including those described above with respect to FIGS. 37, 38A, 38B, 35, and 36.

In step 4110, process 4100 includes receiving map data corresponding to a road segment on which the host vehicle is navigating or will navigate. For example, step 4110 may include receiving map data associated with map database 3712, which may include map data corresponding to road segment 3700. As described herein, the map data may comprise an orientation indicator for a traffic light positioned relative to the road segment. For example, the map data may include orientation indicator 3920 associated with traffic light 3702, as described above. Accordingly, the orientation indicator may have been determined using some or all of process 4000 described above.

In step 4120, process 4100 includes determining a presence of a target traffic light in an environment of the host vehicle. For example, host vehicle 3720 (or a similar host vehicle) may capture image 3722, which may include a representation of traffic light 3702, as shown in FIG. 37. Step 4120 may include identifying traffic light 3702 in image 3322 and verifying the location based on the map data, or vice versa.

In step 4130, process 4100 includes determining, based on at least the map data, that the target traffic light in the environment of the host vehicle corresponds to the traffic light. For example, step 4130 may include comparing a location of the traffic light determined based on analysis of image data (or other sensor data) with a location of the target traffic light stored in the map data.

In step 4140, process 4100 includes determining at least one navigational response for the host vehicle based on the orientation indicator for the traffic light. In some embodiments, determining the at least one navigational response includes determining a relevancy of the traffic light to a drivable path associated with the road segment. For example, this may include comparing the orientation indicator with an angle of a corresponding portion of path 3740. Similarly, determining the at least one navigational response may include determining a relevancy of the traffic light to the host vehicle. For example, this may include determining, based on the orientation indicator, a path for which the traffic light is relevant, and determining whether the host vehicle will travel along that path. In some embodiments, step 4140 may include applying the various techniques described above with respect to FIG. 34D, which may equally apply in determining traffic light relevancy.

In step 4150, process 4100 includes causing the host vehicle to implement the at least one navigational response. For example, the at least one navigational response may include at least one of steering, braking, or accelerating the host vehicle.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A method for determining one or more harvested landmarks, the method comprising:
obtaining drive information captured during drives by a plurality of vehicles traversing or having traversed a road segment, the drive information for each of the plurality of vehicles comprising a drive identifier and landmark detection information corresponding to one or more landmark detections;
aggregating the landmark detection information included in the obtained drive information from the plurality of vehicles, and based on the aggregated landmark detection information, identifying at least two landmark clusters, each of the at least two landmark clusters being representative of a potential real world location of an actual landmark positioned along the road segment;
determining, based on the drive identifier associated with the drive information received from each of the plurality of vehicles, a distribution of drive identifiers relative to the at least two landmark clusters;
determining, based on the distribution of drive identifiers, a location identifier for one or more actual landmarks positioned along the road segment;
storing the location identifier for the one or more actual landmarks in a map; and
distributing the map to one or more autonomous vehicles for use in navigating along the road segment, the navigating comprising determining at least one navigational response based on the location identifier for the one or more actual landmarks.

2. The method of claim 1, wherein the at least two landmark clusters are identified based on one or more regions identified in the aggregated landmark detection information.

3. The method of claim 2, wherein the one or more regions are determined based on map information.

4. The method of claim 1, wherein the at least two landmark clusters are identified based on topology information included in the aggregated landmark detection information.

5. The method of claim 4, wherein the topology information is determined based on map information.

6. The method of claim 1, wherein the at least two landmark clusters are identified based on orientation information included in the aggregated landmark detection information.

7. The method of claim 1, wherein the at least two landmark clusters are identified based on a PLS analysis of the aggregated landmark detection information.

8. The method of claim 1, wherein the at least two landmark clusters are identified based on one or more regions identified in the aggregated landmark detection information in which an actual landmark of the one or more actual landmarks comprises features of different sizes.

9. The method of claim 1, wherein a count of the one or more actual landmarks positioned along the road segment for one of the at least two landmark clusters is equal to one when a same drive identifier is not included in the distribution of the drive identifiers for the one of the at least two landmark clusters.

10. The method of claim 1, wherein a count of the one or more actual landmarks positioned along the road segment for one of the at least two landmark clusters is greater than one when a same drive identifier is included in the distribution of the drive identifiers for the one of the at least two landmark clusters.

11. The method of claim 1, wherein the one or more actual landmarks include at least a traffic sign, a traffic light, a road marking, a pole, or a construction indicator.

12. The method of claim 1, wherein aggregating the landmark detection information included in the obtained drive information from the plurality of vehicles is based on one or more drivable paths of a road segment.

13. The method of claim 1, wherein the at least one navigational response includes at least one of steering, braking, or accelerating the one or more autonomous vehicles.

14. The method of claim 1, wherein the landmark detection information comprises one or more three-dimensional real-world coordinates corresponding to a surface of a landmark of the one or more landmarks.

15. The method of claim 14, wherein the one or more three-dimensional real-world coordinates determine one or more edges of the surface of the landmark.

16. The method of claim 1, wherein the landmark detection information comprises a type identifier identifying a type of a corresponding landmark.

17. The method of claim 1, wherein the landmark detection information comprises sensor data obtained by at least one sensor of one or more of the plurality of vehicles.

18. The method of claim 17, wherein the at least one sensor includes a camera, a radar, or a lidar.

19. The method of claim 17, wherein the sensor data includes at least one of images, radar data, or lidar data.

20. A system for determining one or more harvested landmarks, the system comprising:
a memory comprising instructions;
at least one processor programmed to:
obtain drive information captured during drives by a plurality of vehicles traversing or having traversed a road segment, the drive information for each of the plurality of vehicles comprising a drive identifier and landmark detection information corresponding to one or more landmark detections;
aggregate the landmark detection information included in the obtained drive information from the plurality of vehicles, and based on the aggregated landmark detection information, identifying at least two landmark clusters, each of the at least two landmark clusters being representative of a potential real world location of an actual landmark positioned along the road segment;
determine, based on the drive identifier associated with the drive information received from each of the plurality of vehicles, a distribution of drive identifiers relative to the at least two landmark clusters;
determine, based on the distribution of drive identifiers, a location identifier for one or more actual landmarks positioned along the road segment;
store the location identifier for the one or more actual landmarks in a map; and
distribute the map to one or more autonomous vehicles for use in navigating along the road segment, the navigating comprising determining at least one navigational response based on the location identifier for the one or more actual landmarks.

21. A non-transitory computer-readable medium storing instructions that, when executed by at least one processor, cause the at least one processor to perform operations comprising:
obtaining drive information captured during drives by a plurality of vehicles traversing or having traversed a road segment, the drive information for each of the plurality of vehicles comprising a drive identifier and landmark detection information corresponding to one or more landmark detections;
aggregating the landmark detection information included in the obtained drive information from the plurality of vehicles, and based on the aggregated landmark detection information, identifying at least two landmark clusters, each of the at least two landmark clusters being representative of a potential real world location of an actual landmark positioned along the road segment;
determining, based on the drive identifier associated with the drive information received from each of the plurality of vehicles, a distribution of drive identifiers relative to the at least two landmark clusters;
determining, based on the distribution of drive identifiers, a location identifier for one or more actual landmarks positioned along the road segment;
storing the location identifier for the one or more actual landmarks in a map; and
distributing the map to one or more autonomous vehicles for use in navigating along the road segment, the navigating comprising determining at least one navigational response based on the location identifier for the one or more actual landmarks.

22-96. (canceled)

97. The system of claim 20, wherein the at least two landmark clusters are identified based on topology information included in the aggregated landmark detection information.

98. The system of claim 20, wherein the at least two landmark clusters are identified based on orientation information included in the aggregated landmark detection information.

99. The system of claim 20, wherein the at least two landmark clusters are identified based on a PLS analysis of the aggregated landmark detection information.

100. The system of claim 20, wherein a count of the one or more actual landmarks positioned along the road segment for one of the at least two landmark clusters is equal to one when a same drive identifier is not included in the distribution of the drive identifiers for the one of the at least two landmark clusters.

101. The system of claim 20, wherein a count of the one or more actual landmarks positioned along the road segment for one of the at least two landmark clusters is greater than one when a same drive identifier is included in the distribution of the drive identifiers for the one of the at least two landmark clusters.

102. The system of claim 20, wherein the landmark detection information comprises one or more three-dimensional real-world coordinates corresponding to a surface of a landmark of the one or more landmarks.

103. The system of claim 102, wherein the one or more three-dimensional real-world coordinates determine one or more edges of the surface of the landmark.

104. The non-transitory computer-readable medium of claim 21, wherein the at least two landmark clusters are identified based on topology information included in the aggregated landmark detection information.

105. The non-transitory computer-readable medium of claim 21, wherein the at least two landmark clusters are identified based on orientation information included in the aggregated landmark detection information.

106. The non-transitory computer-readable medium of claim 21, wherein the at least two landmark clusters are identified based on a PLS analysis of the aggregated landmark detection information.

107. The non-transitory computer-readable medium of claim 21, wherein a count of the one or more actual landmarks positioned along the road segment for one of the at least two landmark clusters is equal to one when a same drive identifier is not included in the distribution of the drive identifiers for the one of the at least two landmark clusters.

108. The non-transitory computer-readable medium of claim 21, wherein a count of the one or more actual landmarks positioned along the road segment for one of the at least two landmark clusters is greater than one when a same drive identifier is included in the distribution of the drive identifiers for the one of the at least two landmark clusters.

109. The non-transitory computer-readable medium of claim 21, wherein the landmark detection information comprises one or more three-dimensional real-world coordinates corresponding to a surface of a landmark of the one or more landmarks.

110. The non-transitory computer-readable medium of claim 109, wherein the one or more three-dimensional real-world coordinates determine one or more edges of the surface of the landmark.
